(19) United States
(12) Patent Application Publication
(10) Pub. No.: US 2026/0370965 A1
(43) Pub. Date: Nov. 19, 2026

(54) LIGHTFIELD IMAGING AND REAL-TIME PLENOPTIC DISPLAY SYSTEM AND METHOD OF OPERATING SAME

(71) Applicant: Raytrx, LLC, Tulsa, OK (US)

(72) Inventors: Jordan Boss, Tulsa, OK (US); Steven Von der Porten, Aliso Viejo, CA (US); Kenbe Goertzen, Topeka, KS (US)

(73) Assignee: Raytrx, LLC, Tulsa, OK (US)

(21) Appl. No.: 19/659,727

(22) Filed: Apr. 27, 2026

Related U.S. Application Data
(60) Provisional application No. 63/795,006, filed on Apr. 25, 2025.

(51) Int. Cl. H04N 23/957; G03H 1/00; G03H 1/04; H04N 23/951

(52) U.S. Cl. CPC H04N 23/957; G03H 1/0005; G03H 1/0402; H04N 23/951; G03H 2001/005; G03H 2001/0088; G03H 2001/0436

(57) ABSTRACT

A lightfield imaging system is described herein. The lightfield imaging system includes a display device for displaying three-dimensional (3D) video images of a volume of interest and a lightfield microscope assembly. The lightfield microscope assembly includes a microscope housing, a Multiple Angle Capture (MAC) sensor array including a plurality of sensors mounted to the microscope housing, an objective lens assembly mounted to the microscope housing and configured to direct light rays from a volume of interest to each of the sensors, and a microscope controller coupled to the display device and the sensors. The microscope controller includes a memory device for storing computer-executable instructions thereon and one or more processors for executing the computer-executable instructions for performing an algorithm for rendering 3D video images of the volume of interest onto the display device.

### CROSS REFERENCE TO RELATED APPLICATIONS

This application claims priority to Provisional Patent Application U.S. 63/795,006 filed on Apr. 25, 2025 (OCUTRX-P0011P), the entire disclosure of which is hereby incorporated by reference and relied upon.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file, or records, but reserves all copyrights whatsoever in the subject matter presented herein.

### TECHNICAL FIELD

The present disclosure generally relates to a real-time lightfield 3d video imaging and display system which Ocutrx calls LightField3D™ System. The system is a camera and display system which can be incorporated into a surgery microscope, a hand-held or mounted camera system, or shrunk down to fit into a laparoscopic camera system. In each case the image capture system is presented on a plenoptic monitor in real-time holographic 3D or it can be augmented to a stereoscopic 3D system and displayed on a stereoscopic 3D monitor; or it can be augmented to display on a 2D monitor.

### BACKGROUND

For a surgery application, the Standard Optical Microscope or SOM has been used for about 100 years perform imaging using the same basic optical paradigm wherein light is magnified by a common main objective and then split into two channels which relay different perspectives of the image to eyepieces. From this configuration the image is observed by the human eye. Over time significant advances have been made such as telescopic systems with long working distance and increased magnification, high-power coaxial illumination and variable magnification using optical zoom. However, the basic stereoscopic implementation has remained the same. In recent years, technologies have emerged that have the potential to disrupt this venerable methodology. There has been much interest in digitally enhanced surgical microscopes which have recently entered the market, however, they continue to operate based on the principle of common main objective with two (2) optical channels where cameras or camera sensors are used in place of the eye pieces.

In contrast, technology has been developed in the area of lightfield image capture and plenoptic display particularly for use in the field of photography. However, this has been limited to pre-produced video or still images. This patent will teach how this dynamic can be improved to be a real-time image capture using multiple cameras or sensors, with a playback on a plenoptic display which provides the viewer with a holographic 3D image that has less than a 60 millisecond lag time from capture to display. The increased richness of the data acquired by lightfield technology enables computational imaging to take advantage of the angular information contained in the recorded light rays which is not available to traditional digital imaging or to traditional stereoscopic image capture. This enables, for example, the reconstruction of the three-dimensional surface of the object being viewed and therefore, the generation of a multitude of perspectives for image analysis and display. This also permits, and this patent teaches, how to correlate all pixels in the streaming video at a analog or digital signal stage before an actual image is created, thus permitting images to be manipulated, augmented, or in whole or part to be replaced from images from a different type of sensor, such as an infrared sensor. This permits the display of a camera sensor image to be displayed with infrared features incorporated into the image in real-time.

Lightfield based optical systems have shown great potential for supporting an expanded range of features and create a 3d image that looks holographic. However, early examples suffered from low resolutions and long processing times which prevented real-time applications and widespread adoption.

The present invention solves one or more of the problems identified above.

### SUMMARY OF INVENTION

In one aspect of the present invention, a signal processing system having a plurality of image sensors, a configuration subsystem, and a reconfigurable signal processing fabric is provided.

The plurality of image sensors produce input sample streams.

The configuration subsystem is configured to accept a specification. The specification includes calibration data characterizing the plurality of image sensors and a selected output configuration. The configuration subsystem is further configured to derive, from the specification, configuration data.

The configuration data includes a topology specification defining a plurality of elastic convolution transforms and data connections between the elastic convolution transforms. The configuration data also includes, for each said elastic convolution transform, a corresponding transformational operation comprising a sequence of parameter entries. Each parameter entry specifies an offset in a source sample space and a selection from among a plurality of operators wrapped by the elastic convolution transform.

The reconfigurable signal processing fabric is tuned by the configuration data to realize the plurality of elastic convolution transforms connected according to the topology specification. Each elastic convolution transform includes a local context buffer, a random-access memory, a sequencer, and an operator array.

The random-access memory holds or stores; (i) the corresponding transformational operation as a sequence of parameter entries and (ii) coefficient and table data for non-linear operations. The operator array includes one or more operators selectable for application to sample data held in the local context buffer. The sequencer is configured to iterate through the operator array in accordance with the transformational operation.

Each elastic convolution transform is configured within the reconfigurable signal processing fabric to apply, continuously to a respective input sample stream. The operator or operators of the operator array, as specified by the transformational operation, at the source sample space offsets specified by the parameter entries, produce an output sample stream.

The output sample streams propagate through the tuned fabric according to the topology specification at a sample rate higher than a frame rate of said plurality of image sensors. Each sample is a value within a defined sample space including zero. Propagation of the sample streams through the tuned fabric is independent of the particular values carried by the samples. The specification influences operation of the tuned fabric solely via the derived configuration data. The reconfigurable signal processing fabric is arranged such that each elastic convolution transform produces output samples with a per-ECT latency determined by the local context size required by the the operator array. The per-ECT latency is independent of frame completion of the plurality of image sensors.

A total latency from arrival of an input sample to production of the corresponding output sample is a sum of per-ECT latencies along the path through the topology traversed by the input sample, the total latency being less than one frame time of the plurality of image sensors;

The plurality of image sensors receive light from a physical scene and produces the input sample streams in response thereto. The output sample streams produced by the tuned fabric are provided to one or more display devices to generate a visible image of the physical scene. The visible image includes a corrected and recombined representation of said physical scene with geometric, optical, and inter-sensor variations compensated in real time.

### BRIEF DESCRIPTION OF THE DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIGS. 1-3 are perspective views of a lightfield imaging system, according to embodiments of the present invention;

FIGS. 4-8 are schematic views of the lightfield imaging system shown in FIG. 1;

FIG. 9 is a perspective view of a display visualization system that may be used with the lightfield imaging system;

FIG. 10 is a functional block diagram of the lightfield imaging system;

FIGS. 11-13 are flow charts illustrating algorithms used during operation of the lightfield imaging system to display computer-generated images; and

FIGS. 14-15 are exemplary illustrations of data files that may be generated by the lightfield imaging system when performing the algorithms illustrated in FIGS. 11-13.

FIG. 16 is a perspective view of a multiple angle capture sensor array used in a laparoscopic imaging device.

FIGS. 17A-17V are perspective views of a lightfield imaging system, according to other embodiments of the present invention.

FIGS. 18-30 are perspective views of, graphics and graphs related to a lightfield imaging system, according to other embodiments of the present invention.

FIG. 31 is a block diagram of an exemplary ECT, according to an embodiment of the present invention.

FIG. 32 is a function block diagram an exemplary ECT.

FIG. 33 is a graph of source sample grid and graph of phase offsets of an exemplary ECT.

FIG. 34 is an exemplary graph illustrating improved neurological surgical procedure visibility.

FIG. 35 is a rendering of an Camtrx LightField3D™ system, according to an embodiment of the present invention.

FIG. 36 is a block diagram of a signal processing system, associated with a lightfield system, according to an embodiment of the present invention.

FIG. 37 is a data and control signal flow diagram associated with the signal processing system of of FIG. 36, according to an embodiment of the present invention.

Corresponding reference characters indicate corresponding parts throughout the drawings.

### DETAILED DESCRIPTION

The detailed description of this lightfield device and all the features of this section will focus primarily on surgical microscope applications, although other embodiments are also described herein.

With reference to the figures, and in operation, the present invention is directed to a lightfield microscope imaging system for use in rendering three-dimensional (3D) video images of a source, which could be a patient or surgery site in real time. “Lightfield” or “lightfield 3D” or lightfield 3D holographic” is defined as a technology that creates a 3D model by capturing with camera and other types of sensors the direction, intensity, wavelength, and other features of rays in a volume of interest and spectrum of interest from different angles. While traditional lightfield sacrifices spatial resolution to gain angular information, our patent teaches a lightfield version that captures spatial information, while angular information is derived from the physical position of the known angle of the camera or sensor. While this invention's system is called a “Lightfield3D™ Microscope,” it's important to understand how it differs from traditional lightfield imaging technology. Traditional Lightfield Imaging use a single lens with a microlens array placed in front of the sensor to capture both spatial position (where light hits) and angular information (direction light is traveling). The microlens array splits incoming light rays to record different angles on different pixels. Thus, traditional lightfield technologies sacrifice spatial resolution to gain angular information and allow for post-capture refocusing but with limited perspective shift range which usually requires significant processing to extract usable 3D information.

Unlike the typical lightfield approach, this patent teaches the use of multiple discrete cameras and sensors arranged around a central axis. In this configuration each camera captures a complete high-resolution image from a unique perspective which creates a Common Reference Framework (CRF) through precise auto-calibration and then generates a depth map using either perspective analysis or dedicated depth sensors and then combines multiple perspectives through computational algorithm methods such as Elastic Convolution Transforms (ECT). In this manner this invention achieves a higher resolution output than a traditional lightfield video through computational super-resolution techniques. It also maintains high angular disparity due to the precise separation between cameras and sensors. This lightfield invention also teaches that at the signal level a controller can interpose different information from different types of sensors. For instance, information from a visual light sensor can be combined with information from a near infrared or near ultraviolet sensor to provide views from different sensors in the same video frame. In this configuration each camera is calibrated into a combined data source or common reference framework. In the next step the system creates a Calibrated Volume of Interest (CVI) into a combined signal; and then uses the spatial information combined with the signal information from the CVI to create a visual image. The resulting signal information from the CVI is converted to a digital video frame image is then combined into a series of video frames, and those frames are set to a certain frame rate which provides real-time streaming video. When these are viewed on a plenoptic monitor, the viewer can see a slightly different viewpoint depending on their position to the monitor presenting a real-time holographic 3D video of the source image(s). Volume of Interest, when used in this patent means the source, scene or surgery-site information. Plenoptic, when used in this patent means relating to the displaying computationally derived images from a given angular source or signal, from the CVI; and displaying the same with multiple images on the same monitor or display.

The key differences in this invention's lightfield technique is the acquisition method, where multiple discrete cameras and or sensors are used versus a single camera with microlens array. Another key difference is that there is a resolution advantage with this invention's method. This invention's approach maintains high base resolution and can achieve super-resolution, while traditional lightfield cameras trade spatial resolution for angular information. Another aspect of the invention is the enhanced display output. While both types of light field technologies can output to lightfield displays, the teaching of this patent has more flexibility in output formats and can generate enhanced views beyond what was directly captured.

In another enhancement of typical lightfield technology, this invention teaches that depth information can use various methods to create a high-resolution depth map, rather than extracting depth solely from angular information. Likewise, the perspective range of the physical separation between the sensors in the MAC sensor array provides greater perspective differences than can typically be extracted from a single-lens lightfield camera. Likewise, the perspective range of the physical separation between the sensors in the MAC sensor array provides greater perspective differences than can typically be extracted from a single-lens lightfield camera.

### Super Resolution

Super-resolution, as used herein, means digitally boosting resolution by geometric merit-based processing. Or super-resolution can be produced by Bayesian techniques. Or, super-resolution can be achieved by oversampling approaches. The result of super-resolution is that an image can be seen in a higher resolution than it was originally captured in. The lightfield imaging system 10 provides Interpolated Perspective views which exhibit Constructive Super-Resolution. An interesting consequence of perspective view interpolation is that an output perspective view which is produced by combining two or more source perspectives needs more resolution than the individual input views. If a field of interest contains areas with a slope relative to a single perspective view, where the surface is not perpendicular to the axis of view, that area will have reduced resolution proportional to the slope, while perpendicular areas will have full resolution. Perspectives with different axis of view will see these sloping areas with ether more or less resolution than the original perspective. This additional resolution can be preserved by the perspective interpolation process, if additional resolution is available in the constructed output. The magnitude of this increase is dependent on the angle of slopes in the surface of interest as seen from various axis of view, and the divergence of the various axis of the contributing perspectives. Even a fairly modest sample perspective axis distribution and a relatively flat surface of interest can require more than a linear factor of two increase in output resolution relative to resolution of input perspectives, requiring more than four times the pixels in the output to preserve the available information. A subtle but similar aspect is that each of the source perspectives has a different effective sampling grid due to axis tilt, relative to other perspectives, even when the surface of interest is completely flat and view axis separation is small. These viewpoints therefore contribute additional phase information as well, which can largely be preserved by using a higher resolution for the extracted perspective.

### Hyperspectral Imaging

The hyperspectral imaging system operates within an extended optical spectrum spanning from near ultraviolet (NUV) at approximately 250 nm through the visible spectrum (400-750 nm) to near infrared (NIR) at approximately 1000 nm, with particular emphasis on the 750-950 nm NIR window where biological tissues exhibit distinctive optical properties. The system employs a hybrid sensor configuration 22 wherein a portion of the standard imaging sensors are replaced with broad-spectrum sensors sensitive to wavelengths from 250 nm to 1000 nm. In the preferred embodiment, four of eight standard cameras are replaced with unmasked broad-spectrum sensors while maintaining compatible resolution and optical characteristics. Alternative configurations including but not limited to a 6+3 or 8+4 arrangements of standard and hyperspectral cameras may be implemented, or in some embodiments, complete conversion to broad-spectrum sensors. Narrow-band illumination sources 302, primarily light-emitting diodes (LEDs) with approximately 10 nm spectral width, provide specific wavelength illumination across the extended spectrum. Key illumination bands include primary visible wavelengths (450 nm, 550 nm, 650 nm+5 nm), critical NIR bands (810 nm, 830 nm, 850 nm) for hemoglobin transparency, and specific wavelengths for collagen detection (520-570 nm). The illumination system incorporates synchronization with sensor integration time, enabling pulsed operation for differential imaging techniques. Individual spectral bands can be independently controlled for intensity and timing, allowing sequential or simultaneous multi-spectral illumination patterns.

Optical filters and polarization components can add to the system's spectral selectivity. NIR pass filters, narrow band-pass filters, and an interchangeable filter system accommodate different clinical applications. Polarizers for light sources and analyzers for camera lenses enable cross-polarization techniques critical for birefringence detection, particularly in the 520-570 nm range used for collagen structure visualization. An expanded auto-calibration database 308 accommodates the extended spectral range, utilizing specialized calibration targets with spectral reference materials. The calibration process 306 measures sensor response curves for each spectral band, corrects for chromatic aberration across the extended spectrum, and calibrates polarization response characteristics.

The image processing pipeline incorporates separate paths for visible and extended spectrum data 318, with specific functions for cross-talk elimination between spectral channels and dark current/flat-field correction for each spectral band. Differential analysis algorithms process synchronized frames acquired with different illumination spectra to enhance feature extraction through background subtraction and comparative analysis 316. Then spectral mapping algorithms convert hyperspectral data into meaningful pseudo-color representations visible to the human eye 320. Tissue-specific spectral signature detection algorithms identify structures based on their unique spectral or biometric characteristics, with specialized functions for collagen birefringence detection, hemoglobin transparency mapping, and Cytochrome C detection for tissue viability assessment.

This lightfield system integrates the main imaging pipeline through data fusion processes that merge visible and hyperspectral information, incorporating spectral data into depth map generation 310 312, and then enhances the super-resolution processes with additional spectral dimensions. All processing maintains low latency (<20 ms total) using sliding-stripe processing approaches and Elastic Convolution Transform (ECT) operators for spectral transformations.

### ECT Image Processing

ECT is a method of resampling and remapping computational framework which transforms image data from one sample domain to another while implementing precise geometric corrections, convolution-based filtering, and frequency response modifications. The ECT allows traversal along arbitrary paths through source data, interpolation at sub-pixel locations using position-specific convolutions, and application of potentially unique processing operations at each sample point. This framework enables simultaneous correction of geometric distortion, modulated transfer function characteristics, and focus aberrations while maintaining sampling theory compliance and introducing minimal processing latency. ECTs are implemented in hardware to provide the high-speed, low latency processing necessary for real-time perspective correction, merging, and enhancement in multi-perspective imaging systems. The user interface provides predefined hyperspectral modes optimized for common surgical procedures including ILM visualization, ERM detection, neural tissue viability assessment, and hemoglobin-transparent viewing. Interactive controls allow adjustment of the balance between visible and spectral information, modification of spectral enhancement parameters, and selection of visualization options.

Visualization methods include blended or merged views from different sensors which can combine visible and spectral information, highlighting operator selected and then detected features, and opacity controls for spectral overlays. The system provides options for operator real-time feedback on spectral feature detection and adjustment of pseudo-color mapping parameters.

System integration considerations address lens transmission efficiency across the extended spectrum and slight differences in focal length between visible and NIR wavelengths. Compensation strategies for focal length variation include dedicated lens adjustments for NIR-specific sensors and computational focus enhancement techniques. Performance specifications include minimum detectable concentration thresholds for key biomarkers, signal-to-noise ratios for each spectral band, and minimum birefringence detection thresholds. Processing performance maintains consistency with the main system (minimum 30 fps) while adding differential analysis computation in under 60 ms due to algorithms and FPGA processing.

The implementation approach follows a phased development starting with integration of broad-spectrum sensors, followed by implementation of basic NIR illumination, addition of polarization components, and finally full integration of the complete spectral range and differential analysis capabilities.

Two primary clinical applications drive the system design: retinal surgery and neurological procedures. For retinal surgery, the system enables a non-dye visualization of an Internal Limiting Membrane (ILM) or through collagen birefringence detection, which is cross-polarization rotation for an enhanced visualization of Epiretinal Membranes (ERMs), and detection of metabolic activity through autofluorescence captured by visible light sensors. In the case of an ILM or ERM we see the tissue better by exciting the tissue with pulses of a specific wavelength from a narrow-band light source, and then For neurological surgery, the system improves visibility through blood using the NIR transparency window and differentiates between viable and non-viable neural tissue through Cytochrome C detection. Unique birefringent polarization effects in collagen structures near 520 nm wavelength provide a signature for ILM and ERM identification without dyes. Auto-fluorescence characteristics of NADH and flavins concentrated in these membranes provide additional identification mechanisms. Lipofuscin auto-fluorescence and Cytochrome C photo-reactivity in NIR provide additional markers for tissue identification.

Turning Blood into Water for Surgery Transparence

Hemoglobin, the primary oxygen-carrying protein in blood, presents a significant visibility challenge in surgical visualization due to its high optical absorption across the visible spectrum (400-750 nm). This high absorption results in substantial opacity of blood at even minimal thicknesses, severely limiting visibility of underlying tissues during surgical procedures, particularly in neurosurgery where bleeding is common and visualization of delicate neural structures is critical. Thus, the hyperspectral imaging extant in this system specifically addresses this challenge by exploiting a critical physical property of hemoglobin: its dramatic reduction in optical absorption within specific near-infrared (NIR) wavelength bands. A spectroscopic analysis indicates that hemoglobin exhibits approximately 100 to 1000 times lower absorption in the 750-850 nm range compared to visible wavelengths, with a particular transparency window centered around 810 nm. This physical phenomenon creates an opportunity to effectively “see through” blood that would be completely opaque in conventional visible light imaging.

The system implements this capability through precisely calibrated narrow-band NIR illumination sources centered at 810 nm (+5 nm), with additional supporting bands at 830 nm and 850 nm to provide complementary spectral information. These wavelengths are carefully selected at the sensor signal level prior to the step where a visual frame is created to maximize hemoglobin transparency while maintaining adequate tissue contrast and sensor sensitivity. Specialized processing algorithms enhance the hemoglobin transparency effect by creating a synthesized pseudo-color visualization derived from the NIR spectral bands. The system can selectively replace visible-spectrum luminance information that would otherwise exist in a visible video frame, and replaces the same with NIR-derived data while maintaining chrominance information from visible channels, and combining the two or more images creating a natural-appearing image that reveals structures behind or beneath blood.

Variable blending controls 318 allow surgeons to adjust the contribution of visible and NIR spectral components, enabling them to optimize the visualization for specific surgical situations. For superficial bleeding, a partial blend may be preferable, while for visualization through substantial blood accumulation, a higher weighting of NIR information to the combined image provides maximum transparency.

Differential spectral analysis further enhances blood transparency by comparing multiple NIR bands to differentiate between various blood states (oxygenated, deoxygenated, and partially clotted) and surrounding tissues. This analysis helps to distinguish between active bleeding, stagnant blood, and underlying tissues based on their distinct spectral signatures in the NIR range giving a surgeon areas which are either bleeding, stagnant blood or clotting in a visual reference, which can either be words or an outline color indication.

The blood transparency capability is particularly valuable during neurosurgical procedures where even minimal bleeding can obscure critical structures. By providing visibility through blood accumulation, through the combined video images, the system may reduce the need for continuous irrigation and suction to maintain visibility, potentially decreasing procedure time and reducing the risk of damage to delicate neural structures from these clearing techniques.

For neurological applications, the system exploits the approximately 100-fold increase in hemoglobin transparency in the near infrared (750-850 nm) to provide visualization through blood. Myelin birefringence effects are detected and visualized in the final video frames to easily identify tissue types such as nerve fibers. While in other instances, enhancers to the surgeon include methods such as identification of Cytochrome C presence which indicates viable nerve cells, enabling distinction between metabolically active and non-viable neural tissue. These can be represented by words, color, image overlays, lines, geometric shape, or other indicators.

The blood transparency capability can be combined with other hyperspectral features, particularly Cytochrome C detection, to provide simultaneous visualization of neural structures through blood while assessing their metabolic activity and viability for the surgeon to see in real-time. This integrated approach delivers critical information to the surgeon without requiring physical clearing of the surgical field.

In another embodiment of the invention, the hyperspectral system in this lightfield invention enhances the fundamental capabilities of the system by providing tissue discrimination capabilities beyond what is possible with visible light alone, while maintaining the core performance characteristics of low latency processing and high-resolution imaging necessary for real-time surgical applications. Moreover, application focus is enhanced with this invention's version of lightfield technology such that the system is specifically designed for surgical applications with features like Occlusion Resistance and tissue-specific enhancement (TSE). Occlusion Resistance is the capability to make part or all of surgical tools or other obstructions disappear or control the opacity of the object in the CDI which is fed into the final video stream.

In another embodiment of the invention the CVI model can be displayed in a stereoscopic fashion on a stereoscopic monitor or display like an augmented reality headset 70. In another embodiment of the invention, the CVI model can be displayed as a 2D version of a monitor or other display by calibrating the CVI model to output stereoscopic video 76.

In another embodiment, when used in an augmented or virtual reality headset, then the addition of headtracking input in which the headset sends it position and orientation data to the controller system in real-time; the system then computationally derives stereoscopic views precisely matching the uses current viewpoint in 3D space to display to the user. For instance, as a user moves their head the system continually renders new perspectives related to where the user's head is permitting the user to look around occlusions, such as tools or obstructions, examine the Volume of Interest from different angles, and move closer for a more detailed inspection or view without actually moving the camera sensor array which captures the source.

Lightfield based optical systems have shown great potential for supporting an expanded range of features, however, early examples suffered from low resolutions and excess processing time which prevented widespread application. The lightfield imaging system 10 of the present invention employs novel lightfield processing techniques to combine high resolution, deep field operation, low processing latency, freedom of perspective, and advanced image processing analytical tools such as phase contrast and other specialize filtering and feature recognition all in an integrated product.

Early lightfield systems acquired hundreds of perspectives simultaneously but this approach severely limited available resolution per perspective as well as quantifying available perspectives. Serious applications need both high resolution and complete perspective freedom over the area of interest. For realistic binocular vision and good hand-eye coordination, right and left perspectives with proper relative angular displacement are needed anywhere within the range of interest in real time. The lightfield imaging system 10 accomplishes this by acquiring a small number of high-resolution perspective views as well as depth information in the field of interest. This information goes through a high speed computational optics optimization process and renders any two perspectives for binocular vision with the desired viewpoint and ocular separation.

Support of emerging lightfield display devices is also possible by rendering a larger number of perspectives, but the current generation of lightfield displays operate at far lower resolutions than the lightfield imaging system 10.

In addition, critical hand-eye coordinated work using a computational and signal processing visual aid can provide tremendous benefits including vastly improved ergonomics which improves safety and accuracy. However, to achieve this benefit, any signal processing employed must be accomplished with very low latency. The lightfield imaging system 10 achieves this with ultra-high speed optical optimization, perspective interpolation and image enhancement processes.

A single high-resolution view of a surface of interest, combined with an accurate depth map allows computation of high-quality perspective views of a surface from a wide range of angles. There are two primary weaknesses of a single view approach. One is the inability to “look around” or “look through” an occluding object to see an occluded area of the surface of interest. The second weakness occurs when areas of interest are “steep” relative to the single perspective. Perspective view resolution in that “steep” area is reduced, and in extreme cases is entirely lost.

Using two perspective views greatly improve the ability to “see around” or “see through” occlusions, although there is still some dependence on shape and orientation. Two views address the loss of resolution for slopes along the axis connecting the views. Slopes with other alignments see less or no improvement. The use of multiple source perspectives to produce a single perspective introduces the need to weight the importance of each pixel in intermediate views. Slopes which approximate the view axis of a given perspective provide reduced resolution while slopes orthogonal to the view axis have resolution increased. Three views in an equilateral triangle improve slope resolution over a broad range of slope orientation, while a central view with surrounding views preserves resolution on flat surfaces. Above a modest number of source perspective views, the relative improvement from additional perspectives rapidly becomes less dramatic. The performance trade off soon prefers increased resolution of each view over more perspective viewing angles. A central view surrounded by a modest number of peripheral views is probably the ideal way to deal with occlusion, slope and resolution simultaneously.

The lightfield imaging system 10 also provides computational optimization of lens focus, chromatic alignment and modulated transfer function to support desired resolution, field of view, and depth of field of multiple perspective views. Whereas super-achromatic or apochromatic lens designs strive to focus a few specific color wavelengths at a specific focal depth and view axis alignment. This does not provide full color spectrum focus and consistent modulated transfer function at a range of depths or off axis perspectives. Therefor multiple types of computational improvements of lens performance are required over the desired depth of field and various perspectives is required.

The lightfield imaging system 10 provides precise geometrical color component focus over a substantial depth of field as well as a corrected Modulated Transfer Function to assure sharp images at any position, depth or orientation within the 3D volume of interest. Correction is enabled by the collection of optical system performance data during auto-calibration, and the application of that data and the depth data during operation, to the optimization of optical performance. This involves the real time collection of dynamic depth profile information, auto-calibration measurement of all sensor pixel positions and orientations relative to the volume of interest, and a complete geometric distortion map for each color component, and measurement of the realized modulated transfer function. Use of the optional single frequency color primaries mode allows even more precision. Optical correction utilizes the same Elastic Convolution Transform hardware and processing time used to generate the perspective interpolations. Optical correction and perspective interpolation are very similar operations and can be folded into the same transformations.

A Lightfield image acquisition approach using multiple source perspectives provides many novel capabilities, including the ability to see around or through occlusions such as tools between the microscope and the subject of interest. Combining optical calibration and optical performance optimization with the perspective processing pipeline synergistically enhances the Lightfield visualization benefits. The result is a microscope system which provides a dramatic width and depth of view and allows the subject volume to be viewed from any perspective and magnification without movement of either the subject or the microscope. Benefits resulting from the required multi-perspective processing include arbitrary pan and zoom of the viewing perspective and magnification, multiple forms of image resolution enhancement, and a calibrated volume of interest providing direct precision measurements.

The combination of Lightfield multi-perspectives, measurement and calibration of optical performance, iterative refinement of optimization, computationally corrected optics performance, and the signal quality and resolution advantages resulting from interpolated perspectives yield a new level of performance and a new class of instrument.

The following is a detailed description of the preferred embodiments of the disclosure, reference being made to the figures in which the same reference numerals identify the same elements of structure in each of the several figures.

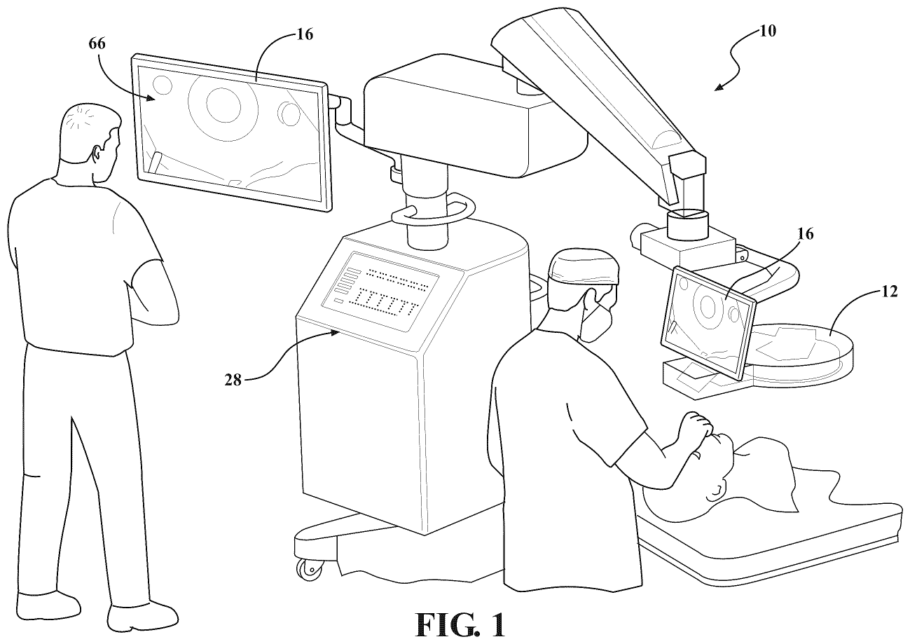

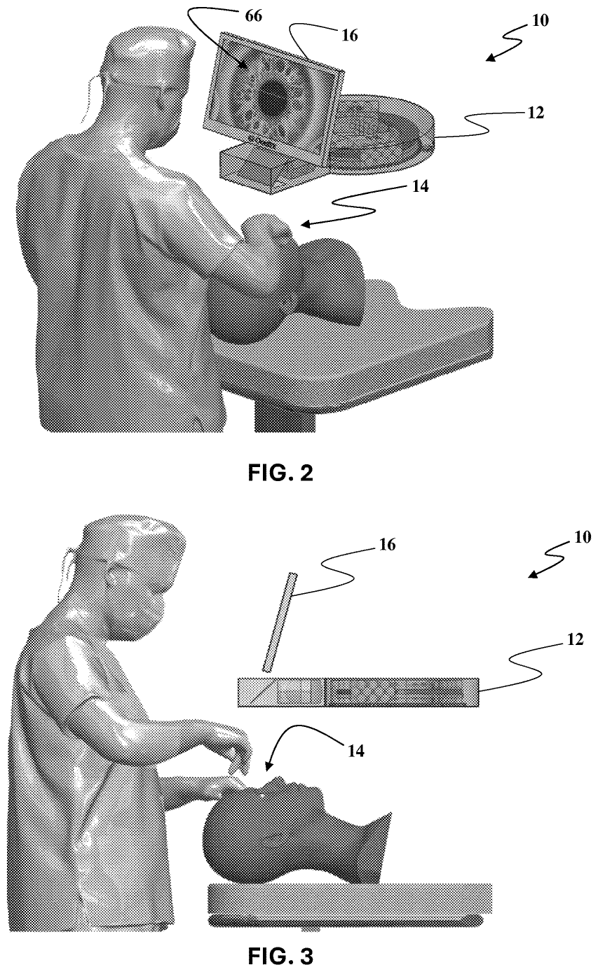

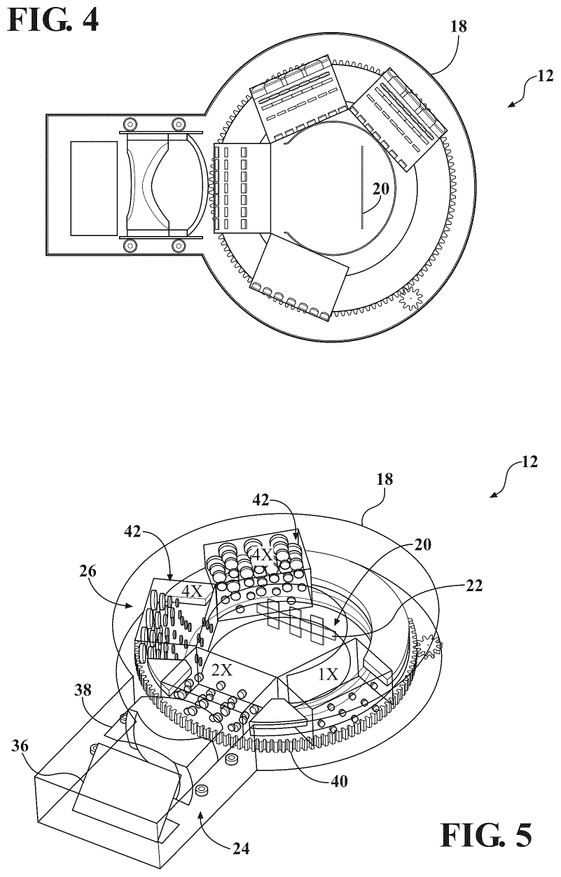

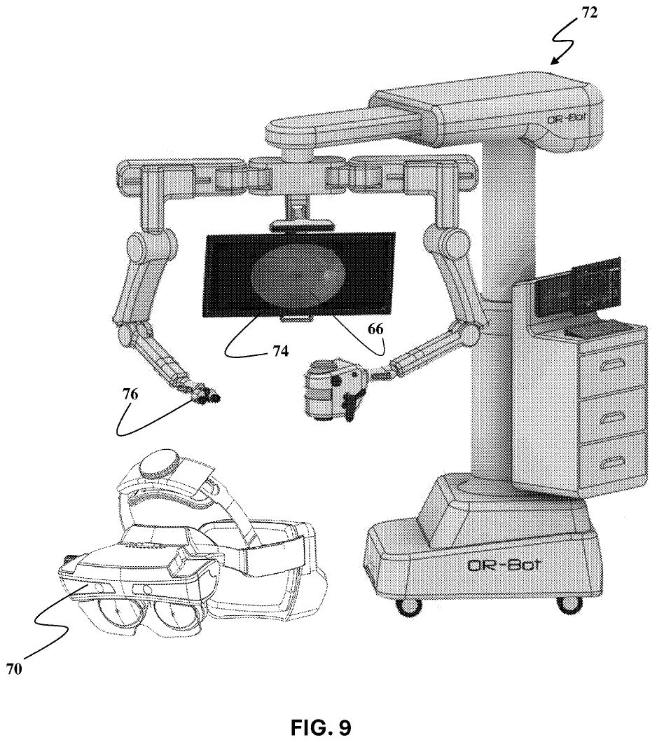

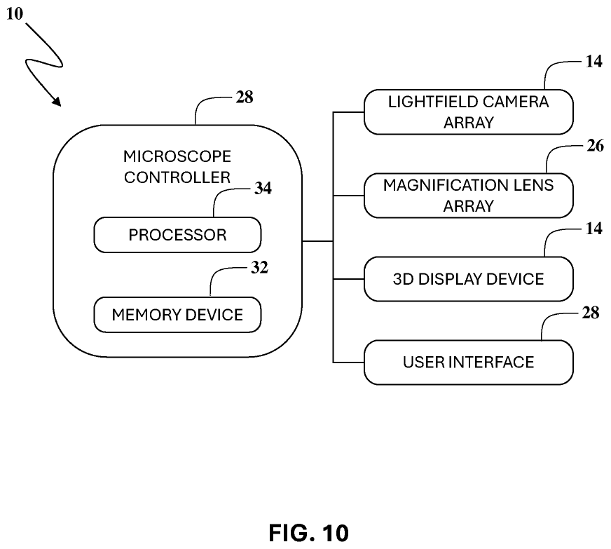

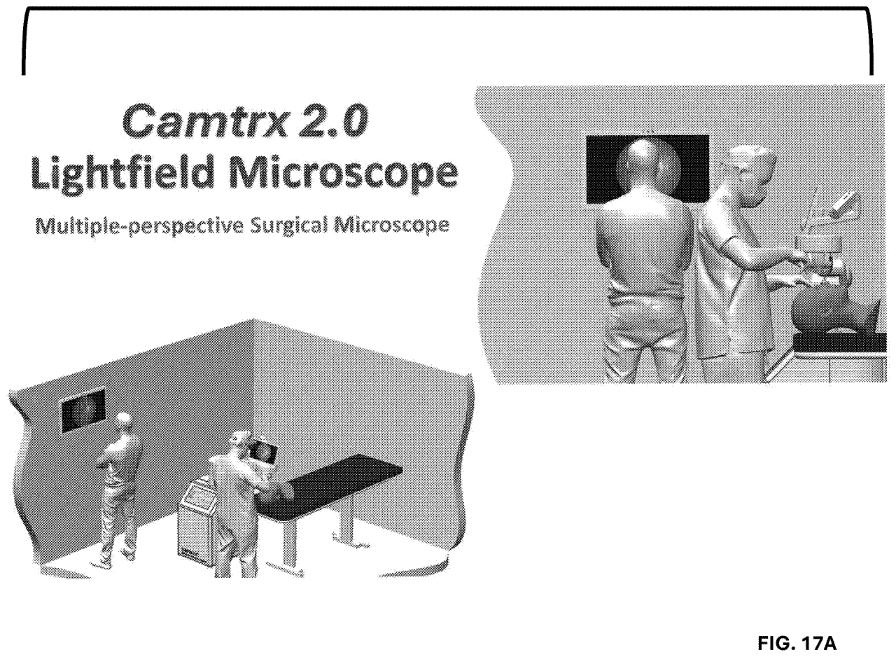

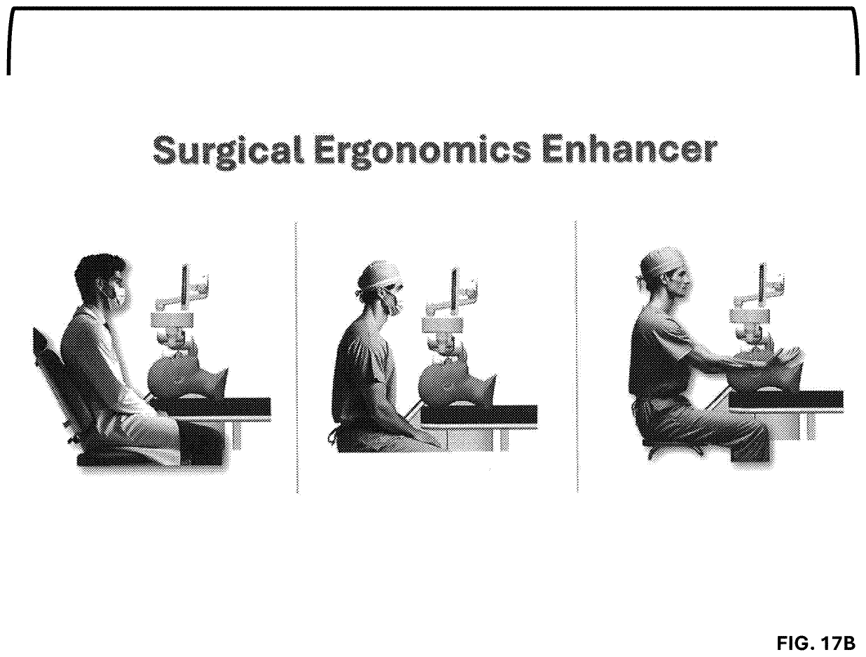

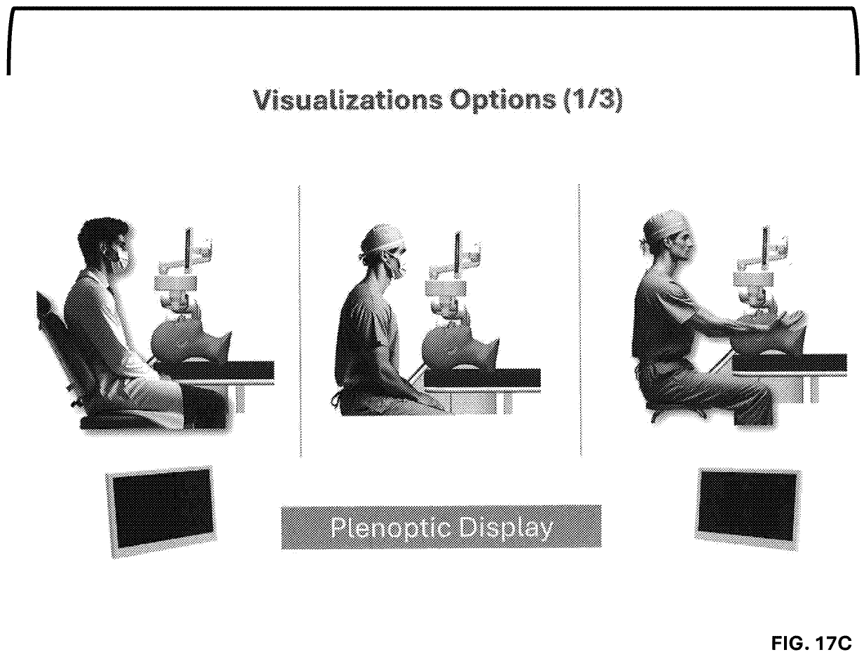

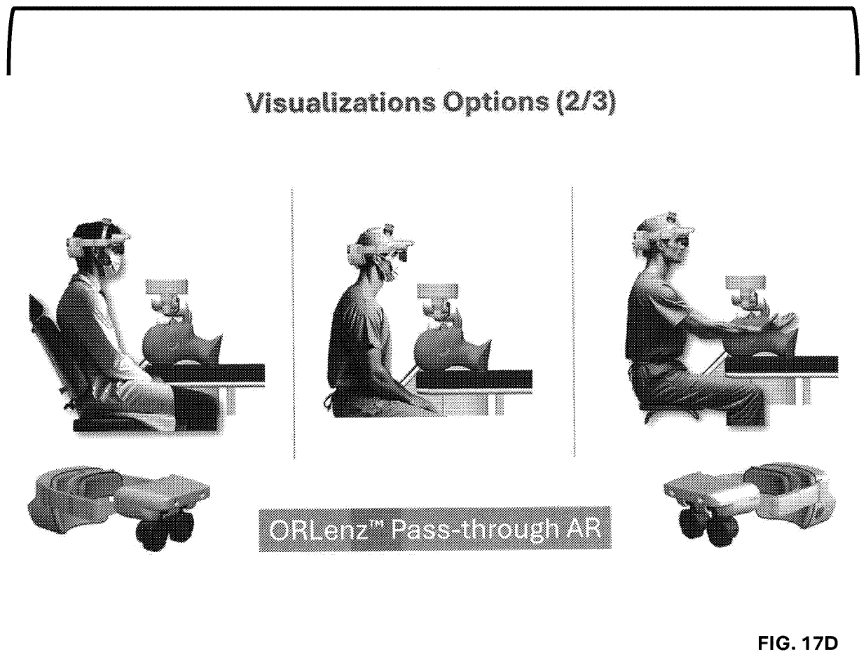

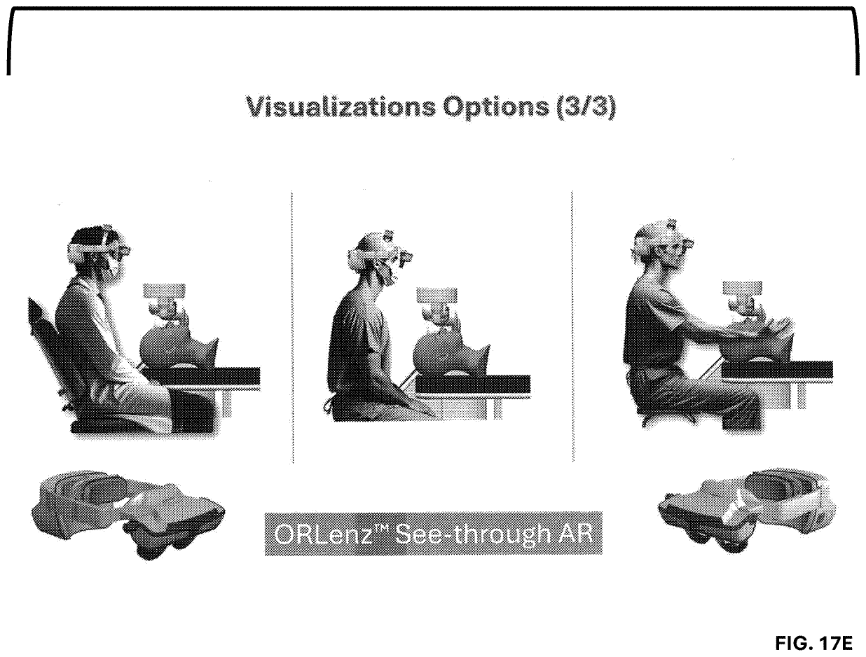

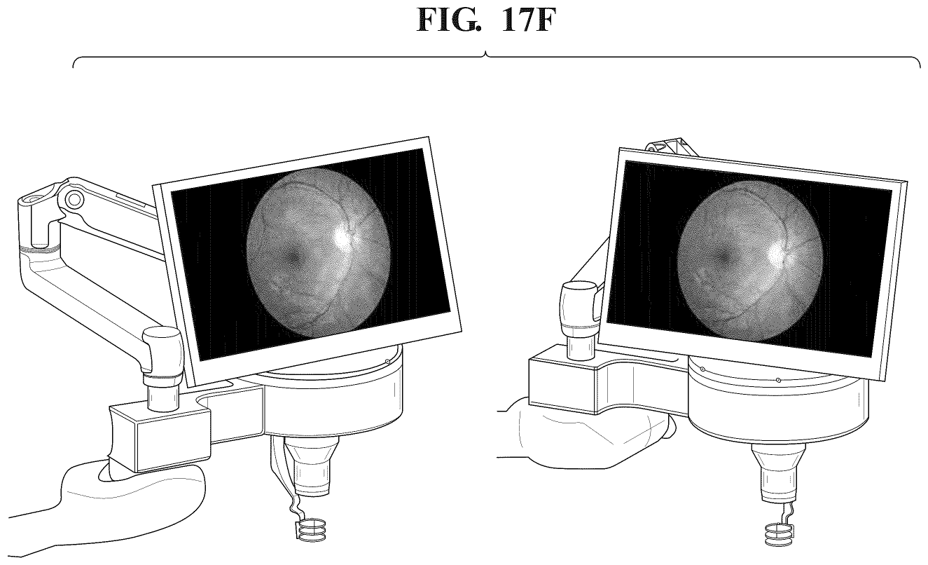

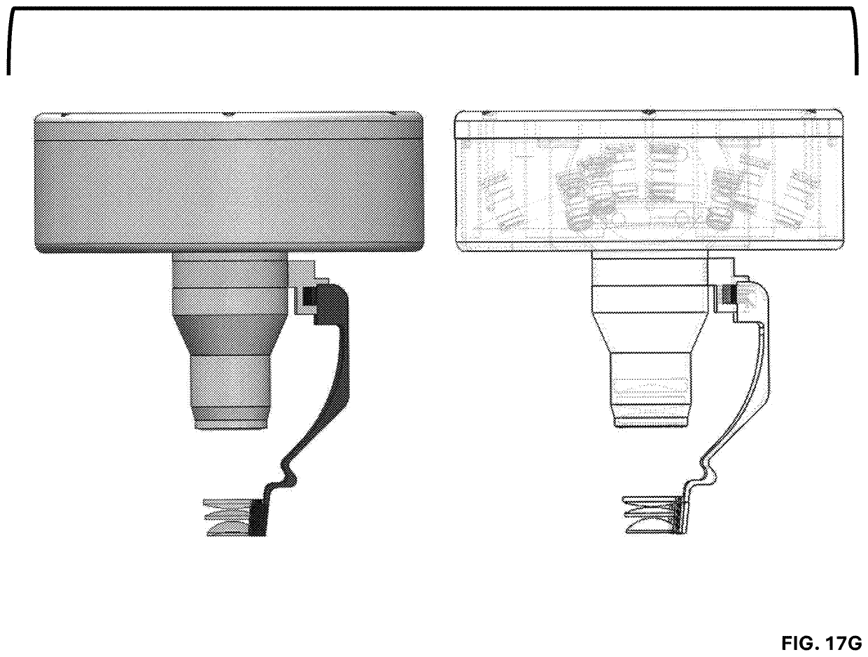

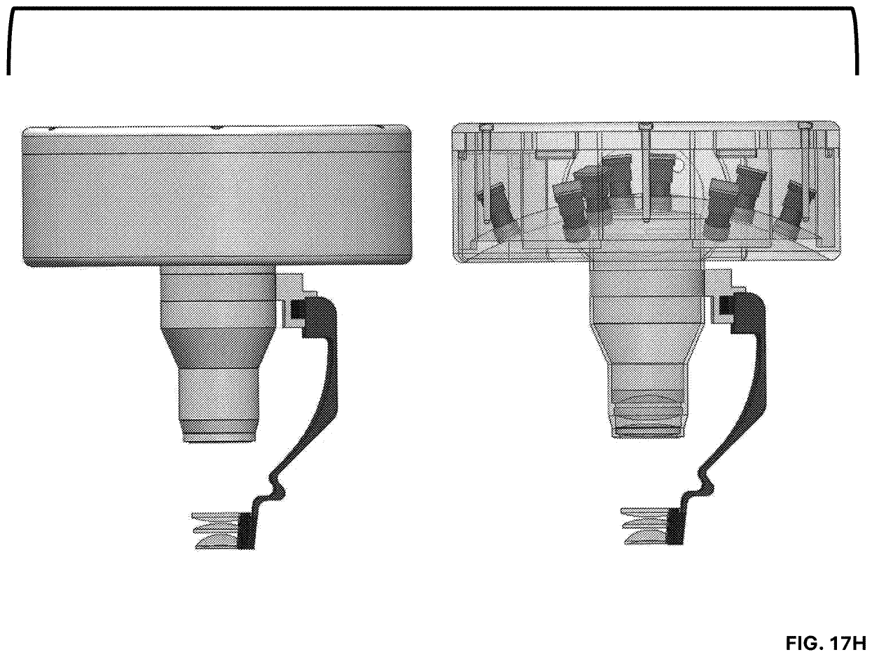

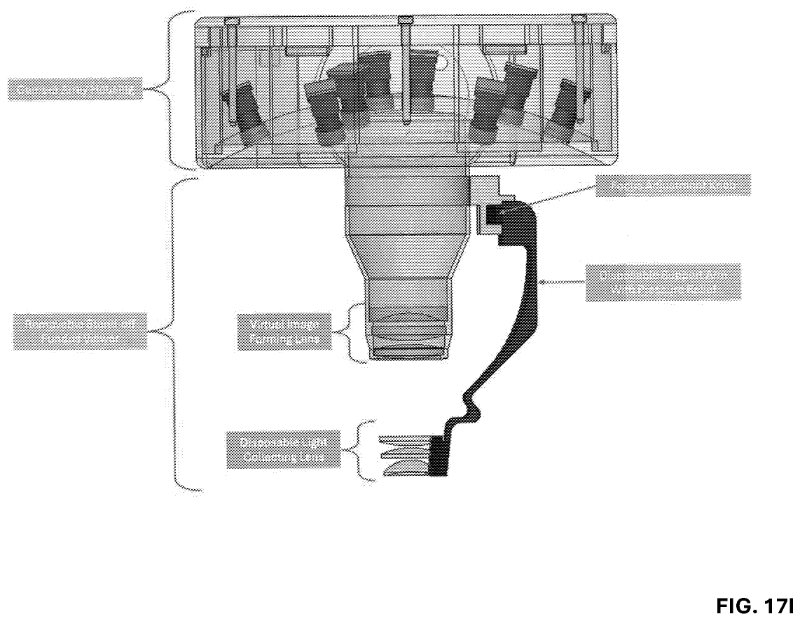

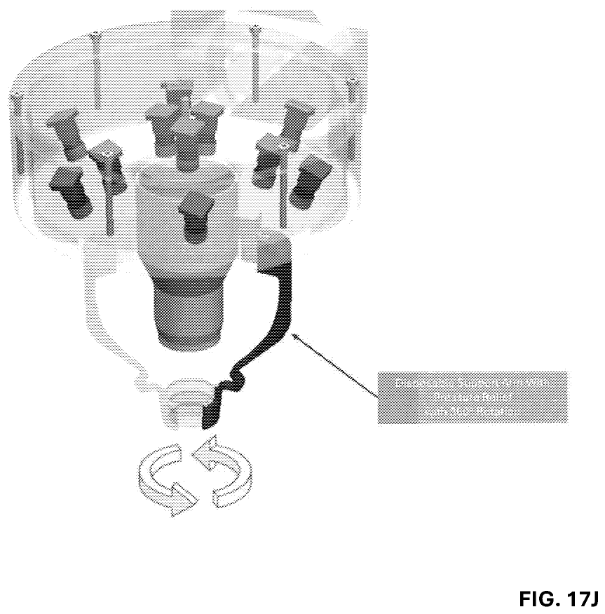

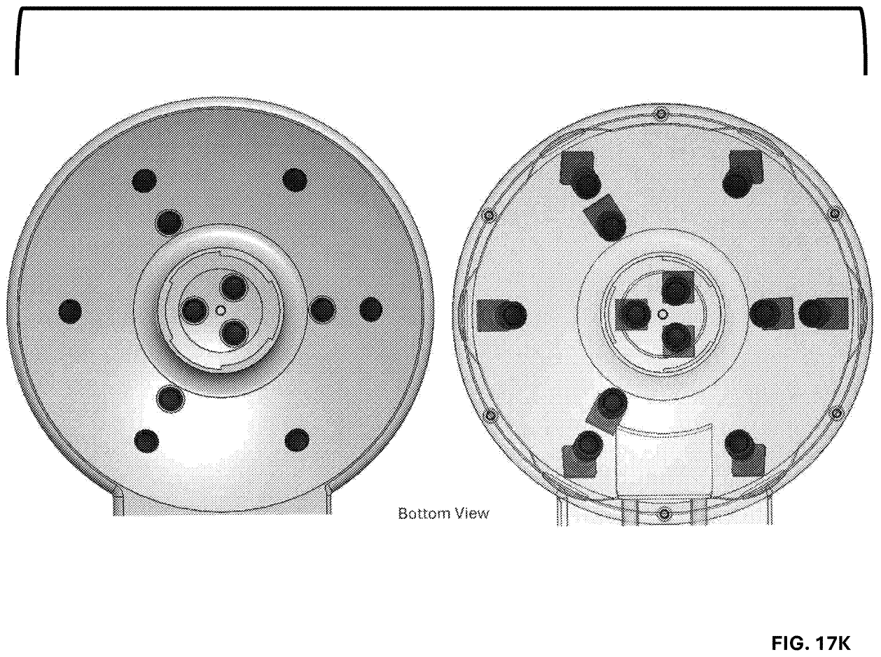

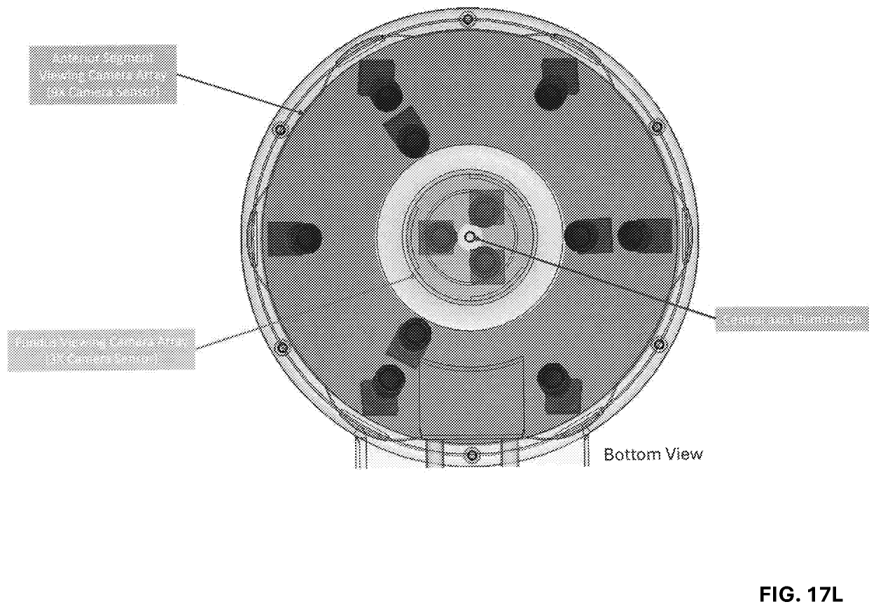

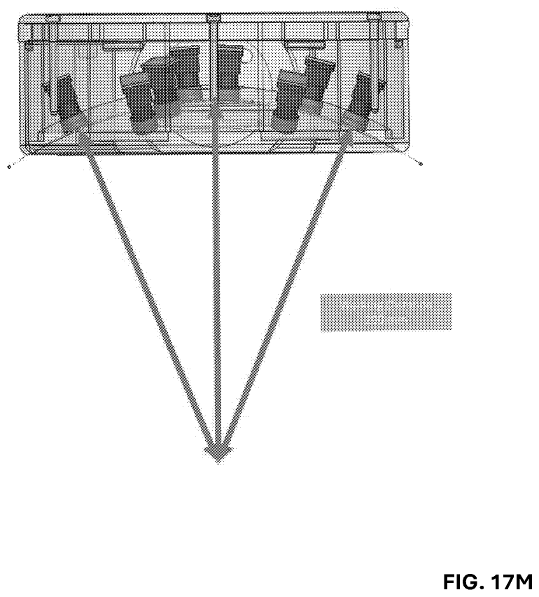

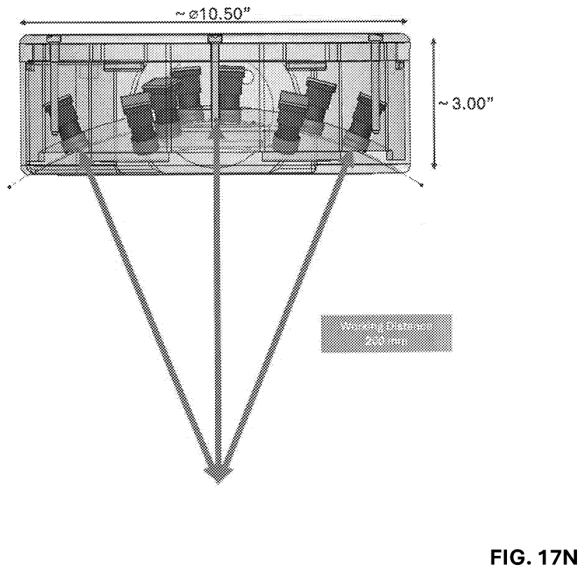

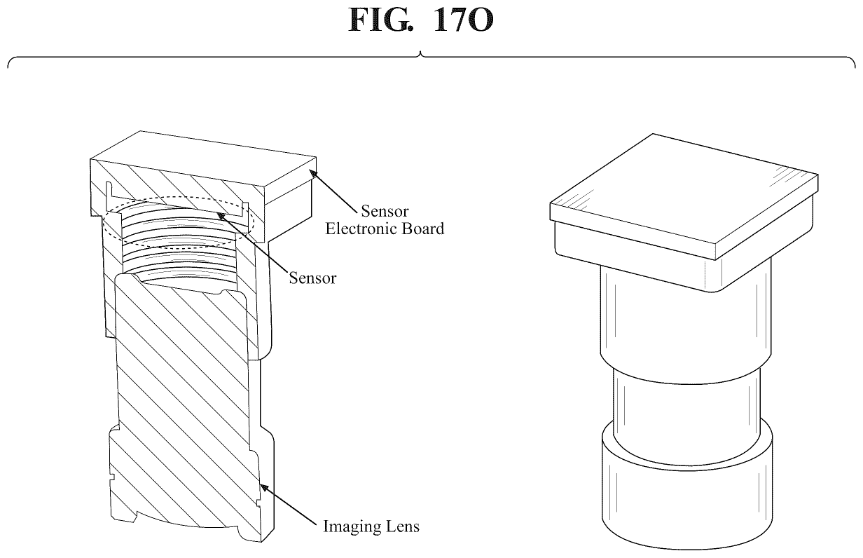

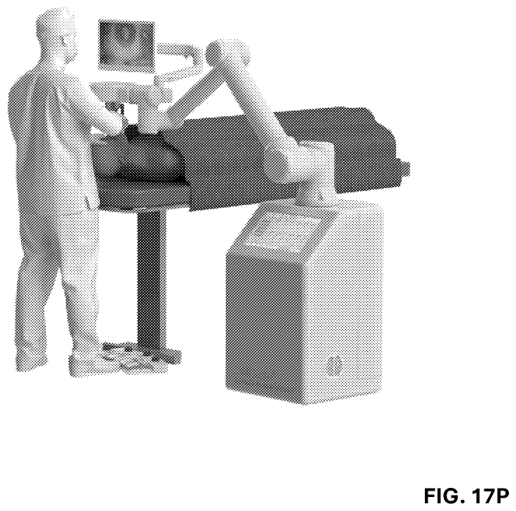

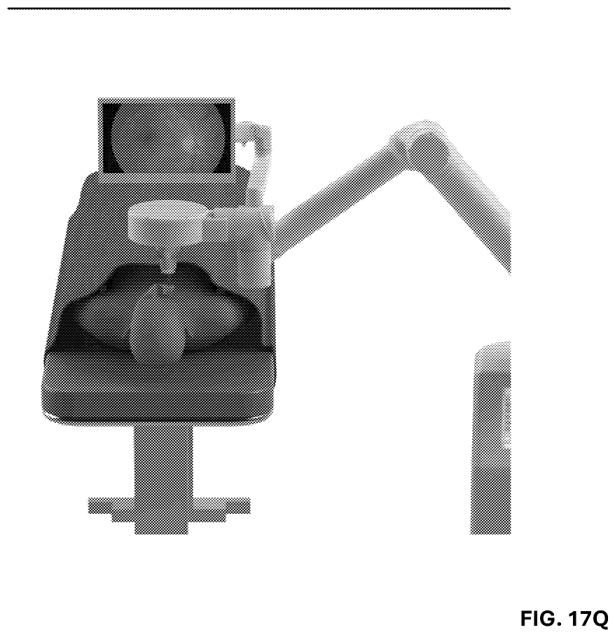

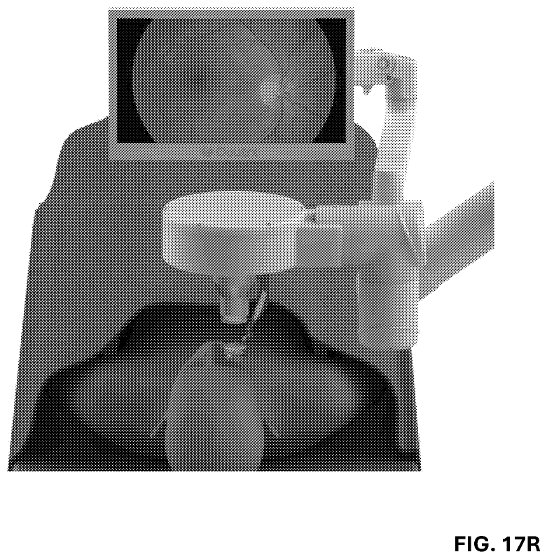

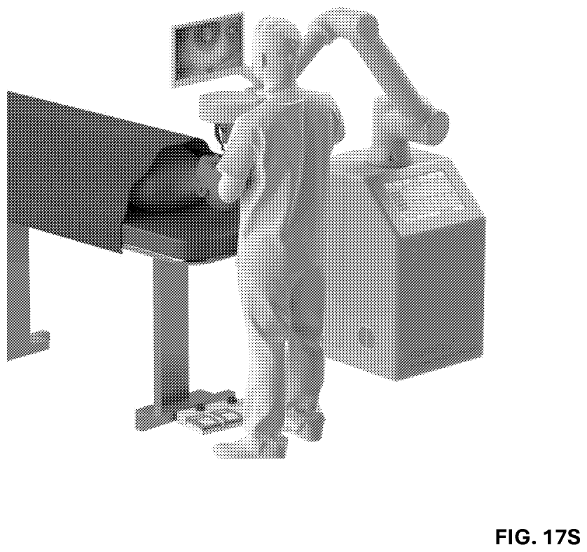

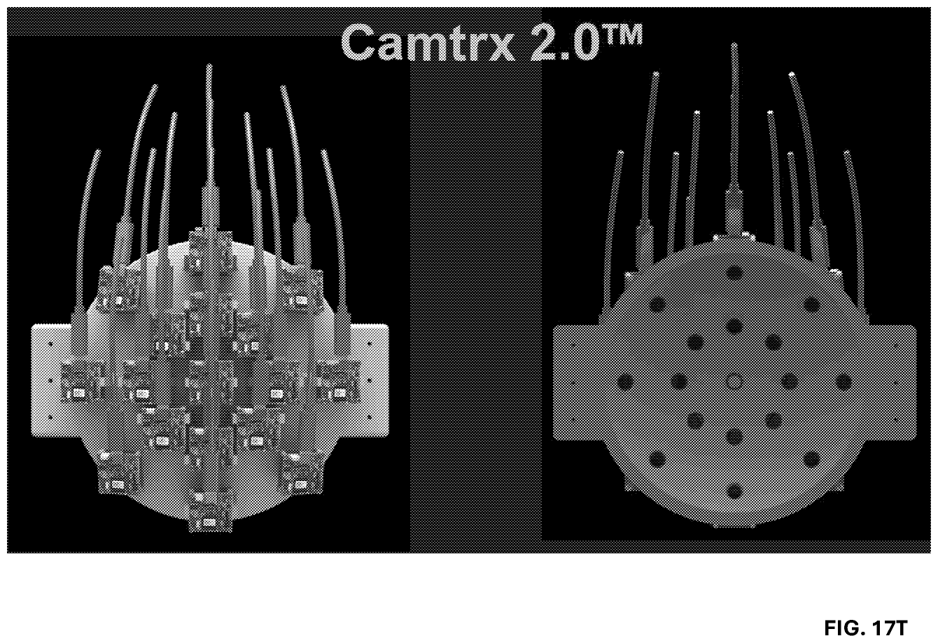

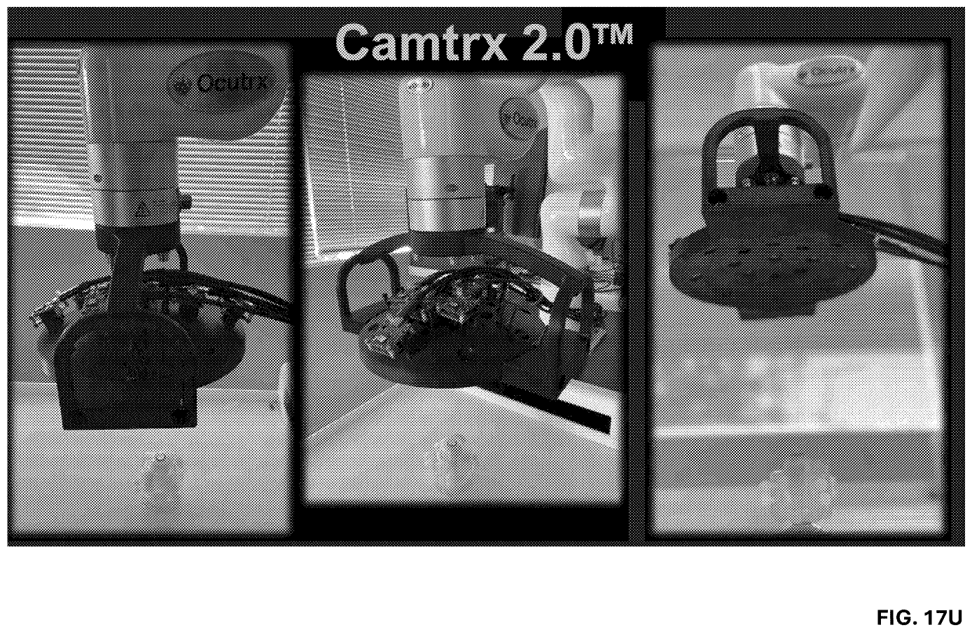

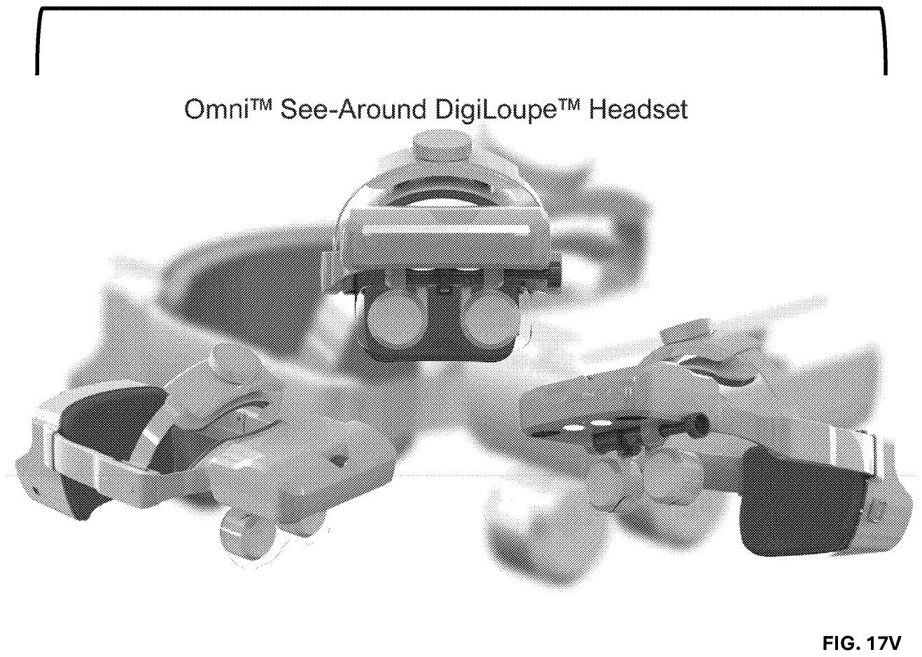

Referring to FIGS. 1-10 and FIGS. 17A-17U, in the illustrated embodiments, the lightfield imaging system 10 includes a lightfield microscope assembly 12 for imaging the volume of interest 14 such as, for example, a retina of a patient's eye, and a display device 16 for displaying three-dimensional (3D) video images of the volume of interest.

The lightfield microscope assembly 12 includes a microscope housing 18, a MAC sensor array 20 including a plurality of MAC sensors 22 mounted to the microscope housing 18, an objective lens assembly 24 mounted to the microscope housing 18 and configured to direct light rays from a volume of interest to the multiple source perspective sensor array 20, a magnification lens array 26 mounted to the housing for directing light rays from the objective lens assembly 24 to the multiple source perspective MAC sensor array 20, a user interface 28 for enabling a user to operate the lightfield imaging system 10, and a microscope controller 30 coupled to the display device 16, the lightfield microscope assembly 12, and the user interface 28. The microscope controller 30 includes a memory device 32 for storing computer-executable instructions thereon and one or more processors 34 for executing the computer-executable instructions for performing an algorithm for rendering 3D video images of the volume of interest onto the display device 16.

In the illustrated embodiment, the objective lens assembly 24 includes a folding mirror 36 and an adjustable objective lens 38. The folding mirror 36 is configured to rotate the light path from a vertical orientation to a horizontal orientation, which allows for a minimal vertical profile of the lightfield microscope assembly 12. The adjustable objective lens 38 images the volume of interest such as a surgical field, at a distance of infinity while maintaining near diffraction limited performance across the entire aperture of the objective lens 38. As a result of these properties, sub apertures may be positioned anywhere across the objective aperture using identical arrangements of imaging lenses. The adjustable nature of the objective lens 38 allows for a change in working distance as well as a fine focus mechanism without impacting the performance of the sub aperture images. The objective lens 38 may be truncated in the vertical direction to minimize the profile of the lightfield microscope assembly 12.

The magnification lens array 26 includes a rotatable magnification changer 40 which includes a plurality of magnification lens assemblies 42 with each magnification lens assembly 42 being configured to images the surgical field at a particular magnification. Magnification lens assembly 42 samples the objective aperture of the objective lens 38 with a series of sub apertures. Each sub-aperture images the surgical field onto the corresponding sensor 22 in the MAC sensor array 20. The optical prescription of each sub aperture is the same within a corresponding magnification lens assemblies 42. The different magnification lens assemblies 42, however, each use a different prescription to achieve different magnification. For example, the magnification lens array 26 may include a first module configured to generate a 1× nominal magnification, a second module configured to generate a 2× nominal magnification, a third module configured to generate a 4× nominal magnification, and a fourth module configured to generate an 8× nominal magnification. The rotatable magnification changer 40 also includes a magnification turn table which rotates the magnification lens assemblies 42 to position a corresponding magnification lens assembly 42 along the optical path between the objective aperture of the objective lens 38 and the MAC sensor array 20.

The multiple source perspective MAC sensor array 20 includes a plurality of MAC sensors 22 arranged in a sensor array including a series of high-resolution lightfield sensors. Each sensor captures a high quality, real time, image with a perspective view corresponding to the location of its corresponding sub aperture. The multitude of perspective views enables reconstruction of the three-dimensional surgical field while being highly insensitive to small obscurations. During operation, the lightfield microscope assembly 12 may simulate a continuous zoom mechanism by performing up to 2 times digital zoom, before simultaneously switching the rotatable magnification changer 40 to position a corresponding magnification lens assembly 42 along the optical path between the objective aperture of the objective lens 38 and the array of corresponding MAC sensors 22 and reverting to no digital zoom.

In some embodiments, the lightfield microscope assembly 12 includes four main components including a folding mirror 36, a common main objective 38, an array of optical relays 26 and a sensor array 20. The folding mirror is used to redirect incident light so that the optical axis is aligned horizontally rather than vertically. The mirror is situated with ample working distance to allow for surgical operations. Given the working distance and the low profile of a horizontally oriented microscope body and taking into account the height of a surgeon sitting in front of a patient, this allows for the installation of a three-dimensional display system situated above the microscope body but still close to the natural height of the gaze of the viewer. The common main objective follows the folding mirror and is used to collimate the light from the object field. This element is well corrected for all optical aberrations over a large aperture. This means that the following components are insensitive to lateral displacement, meaning that a variety of optical relay array configurations with different stop locations can be used with identical lenses.

The array of optical relays takes advantage of the all-digital nature the microscope by allowing a mechanical mechanism to switch between different arrays exhibiting differing magnification. In order to simulate a continuous zoom mechanism, the image is digitally magnified until it reaches the zoom level of the next component of the magnification changer, at which point the digital magnification is reset. This allows for substantial reduction in the complexity, and therefore cost and size, of the optical relay array.

Finally, a magnified image of the object field is projected onto one of several individual sensors. Each sensor records a differing perspective of the object. Using the disparity between the sensors, a full three-dimensional model of the object field can be derived. This model consists of a depth map and a colored image superimposed on the three dimension depth map. In addition, the use of a fiducial grid of structured light can be projected onto the object and observed by the sensor array in order to improve the accuracy of the depth map.

Using microscopy to derive a three-dimensional model of the object field has significant application in computational analysis. This includes structure identification for use in identifying critical structures or pathologies, which can be added as an overlay to the model itself. Further, the depth information provided by the microscope enables robust collision detection which can be used to trigger visual, audible, or tactile signals to warn the operator of an impending collision. However, in order to apply the model to surgical applications, the field must additionally be projected in such a way that it provides sufficient resolution, latency, and depth cues to the human visual system in order for an observer to effortlessly and intuitively perceive the three-dimensional nature of the image in real time.

Of the various methods established to create a display with some or all of these capabilities, by far the most common is eyewear based stereoscopic display. This method operates by displaying an image with a different perspective in each eye, usually through the use of polarized glasses, thereby inducing the perception of binocular disparity, also known as stereo parallax, which the observer interprets as depth information. While providing binocular disparity, this implementation fails to convey the other physical depth cues, namely accommodation, convergence, and motion parallax. In particular, along with binocular disparity, motion parallax is a dominant depth cue when the distance to the image presented is small as is generally the case when performing surgery. Further, the need for polarized glasses causes significant inconvenience in the dependency on the glasses as well as the attenuation of ambient light, causing the surrounding environment to appear dim. Therefore, alternative methods of three-dimensional display are desirable.

In some embodiments, the three-dimensional display is an augmented reality headset. This method features two high resolution digital displays, each relayed to a different eye. The digital image is superimposed over a transmitted view of the real world. This creates the perception of binocular disparity from the digital image that can be used to locate the magnified three-dimensional model in three-dimensional space. This model can be positioned in relation to real world objects as seen through the transmitted view. While this technique does require the use of a head mounted display system, the user is no longer constrained to viewing a monitor, but has complete freedom of movement while maintaining a clear view of the magnified image. In this process, situational awareness is preserved thanks to the real world view. In addition, the effect of motion parallax can be replicated by using SLAM spatial positioning to vary the perspective relative to the three-dimensional model as the user's gaze and head position changes with natural body movements. Furthermore, this image can be displayed in relation to objects in the real world such that the motion parallax matches that of real-world objects. Ultimately this provides an interactive and intuitive fusion of reality with a magnified digital overlay.

The three-dimensional display may also be an autostereoscopic display featuring eye tracking. This method utilizes the magnified three-dimensional model to generate a pair of two dimensional images from perspectives corresponding to the intraocular distance. The images are directed to the viewer's respective eyes by a series of lenticular lenses affixed to a very high resolution display screen. Adjusting the display pixels used in each image, output image angles track the eye position of a viewer over time as the head moves and the eyes rotate. This maintains the perception of binocular disparity over time. As part of measuring the location of the viewer's eyes, a dynamic pair of images can be generated from the magnified three-dimensional model. These images track the movement of the viewer such that perception of motion parallax can be achieved. The three-dimensional display may also be an integral imaging display. This kind of display utilizes the magnified three-dimensional model to generate an array of images each representing a different perspective. The images are directed through a two-dimensional grid of lenslets so that each of the images form a distinct view of the object and the views are visible as a function of the radial angular displacement from the display normal. Each view subtends an angle smaller than that of the intraocular distance while maintaining continuity across the viewing range. Therefore, each eye sees a different view at any given position. Due to the spatial dependence of the image, this technique conveys the sense of both binocular disparity and motion parallax in three dimensions. The fact that this technique does not require any form of active alignment, such as aiming the images using eye tracking, means that there is no chance of delayed reaction to the movement of the viewer. Further, because the display does not have to direct the images to a specific set of eyes, it can be simultaneously viewed by multiple viewers.

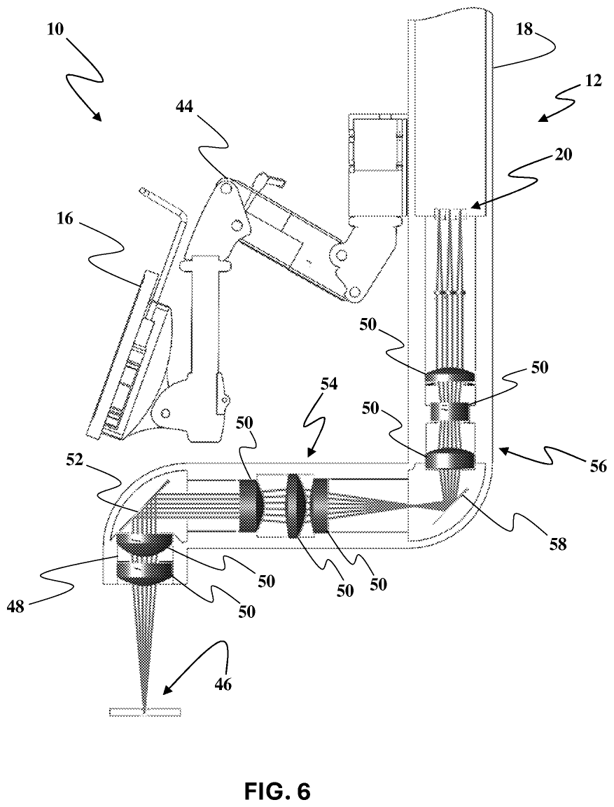

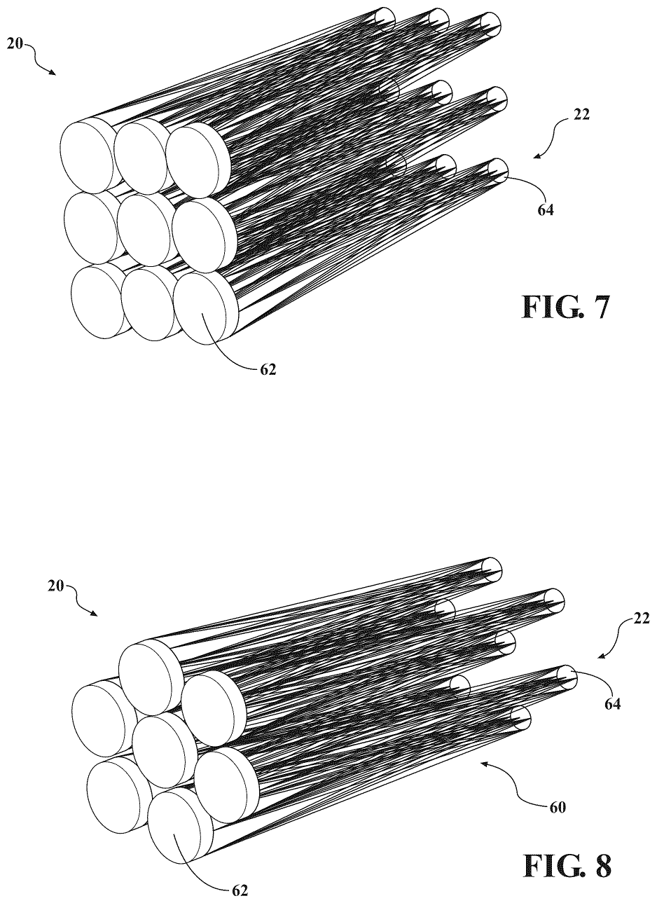

Referring to FIGS. 6-8, in some embodiments, the lightfield imaging system 10 may include a holographic display 16 mounted onto an articulating arm 44, with the microscope housing structure 18 is positioned over an object viewing plane 46. The objective lens assembly 24 includes a collimating objective 48 including two aspheric lenses 50 and a first turning mirror 52, an focusing relay 54 including three aspheric lenses 50, a pupil forming relay 56 including a second turning mirror 58 and three aspheric lenses 50. Each MAC sensor 22 may include a lens sensor pair 60 including a focusing lens 62 and an image sensor 64. In some embodiments, the multiple source perspective MAC sensor array 20 may include a nine-element orthogonal array (shown in FIG. 7) and/or a seven-element hexagonal array (shown in FIG. 8).

In some embodiments of the super stereo/polyscopic video microscope, an array of sensors is used to image a magnified object in real time through a common main objective and relay system. The overall imaging system consists of four complementary subsystems which include a collimating objective, a focusing relay, a pupil forming relay and a camera array.

Each subsystem is designed to perform a specific function, separately but complementary to the entire optical system. Therefore, anyone of the subsystems could be replaced in order to change the parameters of the optical system without compromising performance, for example, the objective lens could be exchanged in order to change the field of view of the system. Magnification of the entire system is set so that the desired field of view of the object fills the sensor area. By changing individual subsystems, the magnification of the overall optical system can be altered while keeping the working distance of the camera array constant. Therefore, the effective field of view could also be altered. Alternatively, the system could be configured to incorporate a zoom system that allows the magnification of the system to be altered dynamically.

The collimating objective consists of two aspheric singlet lenses which serve to collimate light from the object plane. Parts of the object that are located slightly before or after the effective focal length of the collimating objective will slightly diverge from the properties of the collimated light. Ultimately, these parts outside of the effective focal length will result in a blurred picture at the sensors which therefore defines our depth of field. Because the system is nominally collimated, there is an opportunity to fold in light which can be used for illuminating the object for collecting additional information as in Optical Coherence Tomography (OCT) without interfering with the function of the microscope. Additionally, an infinity corrected zoom system can be installed to change the field of view of the objective such that a varying magnification is detected by the sensors.

The focusing relay consists of three aspheric singlet lenses and is designed to collect the collimated light from the collimating objective and cause it to converge through the actual aperture stop of the system and form an intermediate focus. The placement of the aperture is critical because it will be used to define the location of the focusing lens array and the size is important because the image of the aperture stop must match/exceed the maximum extent of the array of focusing lenses.

The pupil forming relay consists of three aspheric singlet lenses and collimates the light from intermediate focus. In addition, it creates an image of the aperture stop at a location that is in front of the last lens of the group forming an exit pupil which is external to the rest of the microscope system. The distance between the last lens and the exit pupil determines the location of the camera array.

The camera array consists of a group of lens sensor pairs which each form an individual camera system composed of an aspheric singlet lens and an image sensor which is capable of capturing both still and moving images at high resolution. Each lens in the lens sensor pair focuses collimated light onto an associated sensor. The sensors are located at the exit pupil plane of the pupil forming relay in order to efficiently gather the incident light. The array can be any number of three or more lens sensor pairs. The sensors can be arranged in any of several or multiple configurations such as nine lens sensor pairs in an orthogonal arrangement or seven lens sensor pairs in a hexagonal arrangement or mixed sub aperture array in which a large central aperture is incorporated to provide a higher lateral optical resolution with smaller apertures arranged around the larger aperture. In order to capture as much light as possible, the size of the lenses should be comparable to the footprint of the sensor and supporting architecture. Additionally, the focal lengths of the lenses may vary so that they are imaging slightly different object planes which could be used with image processing to increase the depth of field. Alternatively, this can be achieved by varying the distance of the lenses to the sensors across individual lens sensor pairs so that they image slightly different object planes. Varying both the focal length and the distance of the lenses to the sensors can be used to stagger the supporting architecture of the sensors without varying the object plane. In an alternative configuration, a prism or a group of mirrors is used to split the light incident on each lens sensor pair to generate additional perspectives.

This system may be used to gather images of the object from a multitude of perspectives. Therefore, the plenoptic function of the lightfield may be constructed by comparing the location of features on each image using image segmentation techniques. These segmentation techniques include however not limited to edge detection segmentation, threshold segmentation, clustering and various convoluted or deep neural networks.

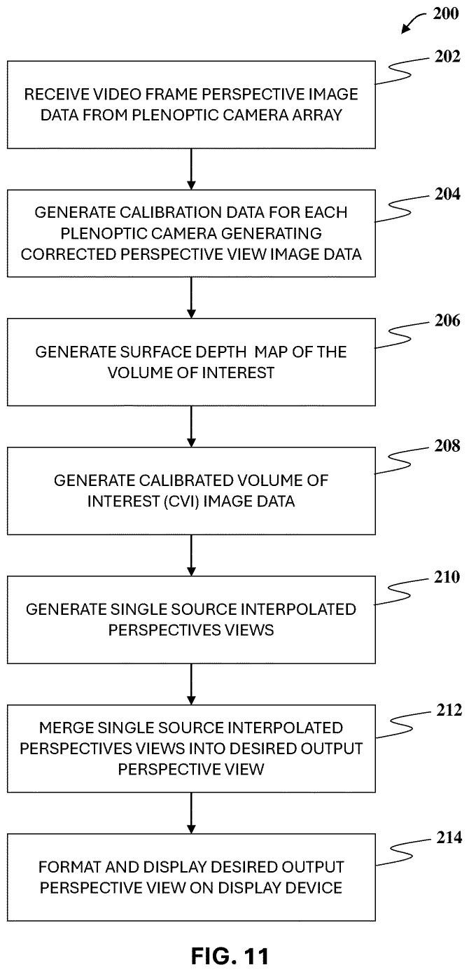

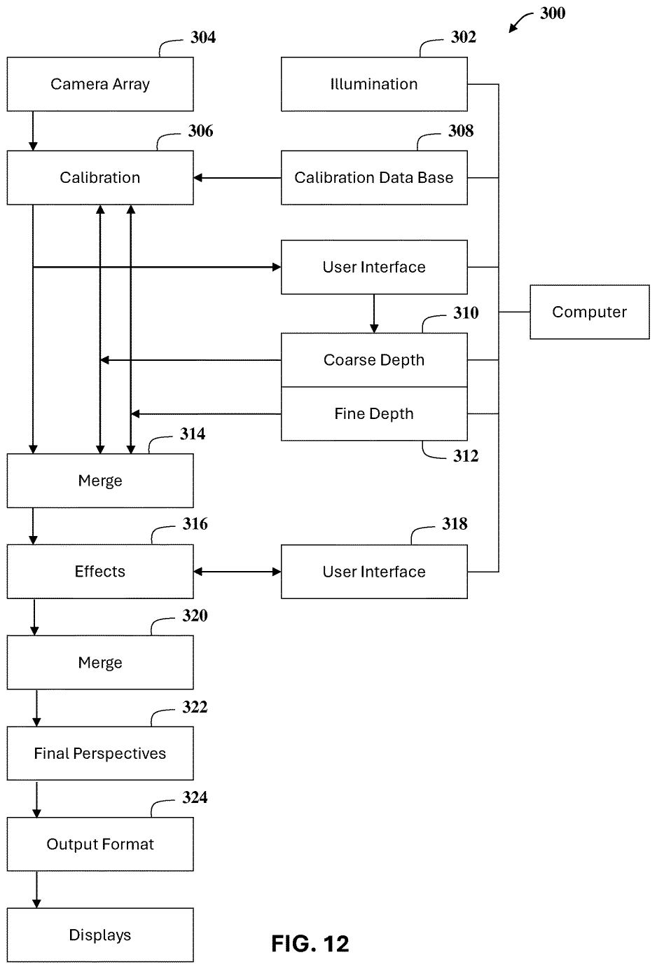

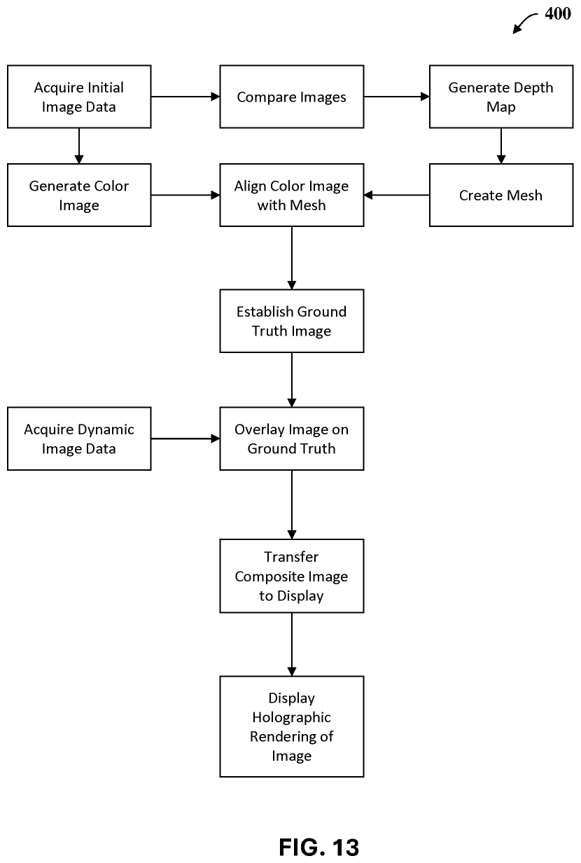

FIGS. 11-13 are flow charts illustrating algorithms 200, 300, and 400 executed by the one or more processors 34 for operating the lightfield microscope assembly 12 to display computer-generated images to the user using the display device 16. The algorithms 200, 300, and 400 include a plurality of steps. Each algorithm step may be performed independently of, or in combination with, other algorithm steps. Portions of the algorithms may be performed by any one of, or any combination of, the components of the lightfield imaging system 10.

In the illustrated embodiment, in algorithm step 202, the one or more processors 34 operate the multiple source perspective MAC sensor 20 to capture a video frame perspective image data of the volume of interest with each sensor in the MAC sensor array 20 capturing a different overlapping image perspective of the volume of interest.

In algorithm step 204, the processor 34 generates calibration data for each sensor in the MAC sensor array 20 indicating optical performance and physical sensor orientation of each sensor in the MAC sensor array, and generates corrected perspective view image data for each sensor in the MAC sensor array 20 based on the captured video frame perspective view image data received from each sensor in the MAC sensor array and the calibration data.

For example, the processor 34 may be programmed to perform Auto Calibration of Optics Performance (OP), View Geometry (VG) and Depth Map (DM). This is an operation done at startup which collects data to allow very precise placement of the field of interest, and all depth and image sensor components. The processor 34 then collects a detailed map of lens performance including chromatic geometric distortion, depth of focus and focus blur function, and a geometric map of the optics modulated transfer function including tangential and sagittal details. This information is used as the basis for computing all geometric relationships and processing requirements as well as optics performance optimization including geometric distortion by color component, distortion due to depth of focus, and modulated transfer function correction.

The mechanical fixture holding sensors, optics, and depth measurement components maintains alignment of the critical components to typically a few 10s of microns. System startup includes an auto-calibration process which produces a mathematical model of relative position and alignment of components to roughly one micron or less. This model is used as a frame of reference to tie all the relative positions and orientations together. This database is then used by the following operations to compute the desired lightfield perspectives.

Auto-calibration enables extensive optimization of optical performance and simplifies processing to enable the required high processing speed. Auto-calibration of all aspects of optical performance and physical sensor orientation allows multiple perspective views to collaborate constructively during operation. Collecting this information allows optical performance to be computationally improved while greatly simplifying and speeding the required processing. Any system used in the hand-eye coordination loop must keep latency to an absolute minimum making processing speed essential.

Advantages and Corrections enabled by calibration. Even the best quality lenses fall short of mathematical perfection. It is also challenging for a large assembly of components to maintain sub-micron alignment through manufacturing, shipment, use and maintenance. Auto-calibration allows physical precision and optical near perfection to be achieved in daily use. All critical physical and optical parameters are measured during calibration as well as evaluating the effectiveness of corrective processing actions such as increasing the range of useful focus throughout the volume of interest, correcting local color component frequency response and geometric distortion. This vastly improves computational correction effectiveness and quality while keeping computational processing requirements reasonable and processing latency low. As a result, practical day to day performance characteristics greatly exceed what would otherwise be possible.

Measurement of sensor orientation and optical performance. The calibration process measures effectively all optical and sensor characteristics including orientation, sensor pixel quantum efficiency and linearity and lens geometric distortion and modulated transfer function by region and separately for each color component over the entire volume of interest. Spectral characteristics and energy distribution of light sources and projected fiducials within the volume of interest are also collected.

In algorithm step 206, the processor 34 generates a surface depth map of the volume of interest based on the corrected perspective view image data. For example, the processor 34 performs Depth Map (DM) Acquisition as a continuous process operating at or above the frame rate frequency of the image sensor system. The processor 34 uses auto calibration information combined with current depth information to provide a high resolution depth map of the surface of interest which is current for each frame time.

The Depth Map is the distance from a reference plane at the optical sensor system to the surface of the object at the field of interest. Several methods are available to measure the depth field to the desired resolution. The use of near infrared fiducial pattern projectors and image sensors is described here. To minimize optical occlusion by hands or tools in and around the optical path, three projectors and three sensors are used. Each projector uses a point source and an x-y grid which appears as a square grid on a flat surface perpendicular to the optical axis. Grid spacing contracts as the surface approaches the optical sensor system. At maximum fiducial projection height and maximum depth to surface of interest, the grid spacing is at its maximum, which is often set to 1 mm. At maximum fiducial projector height and minimum useful depth, the grid spacing is approximately 80% of the maximum spacing. Lower fiducial projector height can increase the range from minimum to maximum spacing. Each of the three fiducial projectors is rotated 30 degrees around the optical axis, so the x grid lines are nominally at 0, 30, and 60 degrees while the y grid lines are at 90, 120, and 150 degrees. Any one of the three fiducial projectors and sensors is adequate to compute the depth map, providing good tolerance to obstructions. Individual angles+/−15 degrees are selected by frequency transform mask filtering, and spacing is converted to a depth map, the six sets of data are combined with the two highest and two lowest values discarded and the remaining two averaged. The data is low pass filtered to provide the result for this frame time. The grid resolution and field size result in relatively small data sets compared with perspective view images, allowing them to be processed rapidly. The entire depth perception system can be operated at a multiple of the optical frame rate, or phase shifted to provided new depth data at the beginning of image data processing to reduce latency.

The processor 34 then performs Depth Map and Perspective Views to Geometric Distortion Map (GD) as a geometric transform which occurs at each frame time. The processor 34 utilizes the auto calibration data which precisely positions the image sensors relative to the field of interest, and the depth map data, to compute the required geometric distortion map required to project each view onto the desired interpolated perspective view.

Depth Map (DM) to Geometric Distortion Map (GDM). Auto calibration data allows the geometric mapping of individual pixels of each perspective view to the corresponding region of the field of interest at maximum depth. Adding Depth Map information allows mapping to the actual surface presented by the object of interest. This is because reducing the depth from maximum changes the angle of the view slightly. If a binocular view is needed, this this is done for each real perspective which is a neighbor of the desired view. The approach can work with one or two reference perspectives for each desired perspective, but the idea number is six.

Processing Latency Depth Map rate of change is expected to be relatively slow and can tolerate more latency than perspective extraction. Removing Depth map computation from the critical latency path appears reasonable. If the second previous frame is used for depth calculation, the Depth Map data lags the current frame by two frame times, and assuming image acquisition at 100 frames per second (fps), Depth Map information would be 20 milliseconds old when used for perspective extraction. This allows perspective extraction to lag current frame acquisition by a total latency less than 50 milliseconds, including a 10 ms frame acquisition time. Display subsystem latency would add an additional latency delay.

In algorithm step 208, the processor 34 generates a calibrated volume of interest (CVI) image data for each sensor in the MAC sensor array 20 by mapping the corrected perspective view image data onto the generated surface depth map.

For example, the processor 34 may generate Geometric Distortion Map & Optics Performance Dataset to Elastic Convolution Transform control Dataset (ECTD). This operation occurs at each frame time. The processor 34 uses the Geometric Distortion map and the Optics Performance Dataset for each input Perspective View to generate an ECTD to drive an elastic convolution transform to convert that perspective and correct optics performance for each desired output perspective. Each individual pixel color component has a unique transform operation unique to its situation in the overall geometry and optical performance correction requirements. A unique ECTD is generated to process each input Perspective View, and multiple Perspective Views are typically required for each desired Interpolated View. Two Interpolated Views are required for binocular vision, and typically many IVs at a lower resolution are required for output to a lightfield display device).

Geometric Distortion Map to Elastic Convolution Transform control Dataset (ECTD). A Convolution Transform is a degenerate version of the more general ECT. A CT applies a convolution operation to the neighborhood of every pixel component in an image to implement a frequency response filer, edge detection, MTF correction, or similar convolution operation. In a stream based data flow a convolution transform adds a few lines of processing latency. For example, a 9×9 convolution transform performs 9×9×3 or 243 multiply-adds per pixel and adds 5 line times of processing latency. An ECT is a generalization of the Convolution Transform. The path through the source image is specified for each output line, and may be any line, arc, or path, which may be discontinuous. The convolution coefficients applied can be changed for each pixel, and can come from a large coefficient set. In addition, the size of the input and output image do not need to be the same. An ECT is used for geometric distortion correction, resizing, reshaping, variable frequency response filtering by pixel, variable rate geometric interpolation, and a large number of other operations including video effects and computational optics. A 10×10 ECT with the same input and output image size would typically add 5 lines of latency, depending on edge treatment options, plus the worst case vertical non-locality excursion. In most applications the worst case top and bottom non-locality is small, and worst case latency is usually in the range of 4 to 24 line times, but in the case of extreme geometry changes can be large. The ECTD is the dataset with controls the ECT path through the source image, providing the information on where to apply which convolution, and how to deal with edges. The ECTD specifies everything need to convert the input image to the desired output image.

Optimization of optical performance and conversion to a calibrated representation. During normal operation, a depth map of the surface of interest within the volume of interest indicates where a particular pixel in a particular view from a specific perspective view intersects that surface. This allows a specific geometric, MTF, and focus correction to be applied to that pixel. The Elastic Convolution Transform is well suited to performing such localized operations at high speed, potentially correcting sensor gain, linearity, MTF, focus, and geometric distortion with extremely low latency.

A Calibrated Volume of Interest (CVI). Converting all perspective views into the Calibrated Volume of Interest (CVI) reference frame is critical to employing these corrected source perspective views as an effective team to increase resolution and provide the correlated data to generate and output any number and orientation of interpolated perspective views.

Determining the surface depth map within the Calibrated Volume of Interest (CVI). A depth map of the surface of interest is key to simplifying the mapping of corrected perspective views into the calibrated volume of interest, and the remapping to interpolated perspectives. There are a number of approaches to generate the required depth map ranging from separate IR fiducial pattern emitters and sensors to approaches which utilize the primary image sensors. If fiducial or modulated amplitude emitters are used, it is desirable to use two or more emitters to better tolerate occlusions. Angular rotations of modulated patterns or use of individual color components can be used to discriminate between various emitters, allowing multiple depth results to be compared for improved robustness and accuracy. Modulated patterns superimposed on general illumination or color primary illumination can provide a suitable depth solution in constrained applications.

Exploit narrow spectrum illumination for improved correction. Utilizing narrow spectrum color primaries with a half power width on the order of 5 nm, rather than continuous spectrum primaries on the order of 150 nm wide can improve optical lens performance by reducing broad spectrum based geometric spread of image information. Sharper focus, greater depth of focus, reduced geometric distortion, improved correctability and better image detail result. Due to computational correction, narrow color primaries do not necessarily need to be centered on optical chromatic zero crossings, but can be chosen for other reasons such as tissue or sensor response, if desired. Display primaries are based on human color perception and industry standards. Converting from a set of narrow pseudo primaries to the output display color space typically requires color space conversion.

Optimization of optimizations. Many of the optical optimizations are inverse convolutions which do not have deterministic closed form solutions. Auto-calibration allows the system to experiment with various alternate corrective approaches to determine the best corrective performance possible. Corrections are applied to the source perspective view sensor data and can vary pixel by pixel and by depth of field and color component as needed to correct local error. Corrections can be a function of location in the volume of interest where the perspective viewing angle intersects the surface depth map. For example, this allows focal depth corrections to vary depending on distance above or below preferred focal distance for the specific pixel color component. MTF and geometric corrections operate in a similar way. Although the number of individual correction convolutions could in theory become vast, typically a few hundreds or thousands suffice for each lens.

In algorithm step 210, the processor 34 generates single source interpolated perspectives views for each sensor in the MAC sensor array 20 based on corresponding CVI image data for each sensor 22 in the MAC sensor array 20. For example, the processor 34 may generate the single source interpolated perspectives views for each sensor in the MAC sensor array 20 using Elastic Convolution Transforms.

For example, the processor 34 may perform Perspective View (PV) Acquisition and Corrected Perspective View (CPV) Generation. This operation occurs at each frame time. The processor 34 applies an ECT operation controlled by the specified ECTD for each input Perspective View, producing an output Corrected Perspective View. The CPV output will typically be represented at a higher resolution than the PV input to preserve information. Each CPV also acquires an additional pixel component in this process, which indicates the relative information significance of this pixel, which is an important factor when combining CPVs to produce each final Interpolated View.

Perspective View (PV) Acquisition to Corrected Perspective View (CPV) Generation. Each perspective view captured by an image sensor will potentially need lens roll-off compensation, noise filtering, geometrical distortion correction and modulated transfer function correction specific to each color component and location. Then convolution Bayer decoding and filtering. Using one CT stage and two ECT stages results in about 25 lines of total latency, depending on worst case geometric distortion correction required.

In algorithm step 212, the processor 34 merges the single source interpolated perspectives views into a desired output perspective view 66 of the volume of interest. For example, the processor 34 may generate Corrected Perspective Views to Interpolated Views (IV). This operation occurs at each frame time. The processor 34 merges the set of CPVs for each desired perspective output, preserving the available image resolution in each area of each output view in the process.

Corrected Perspective Views to Interpolated View (IV). The CPVs generated from the PVs neighboring the desired interpolated view will each need to go through an ECT programmed with a specific ECTD map to produce the desired result. After being geometrically transformed, the resulting IV image each represents that neighbor's version of the desired view, which should now align with other IVs for this output perspective to a sub-pixel level. If a single source perspective is available, the resulting IV from that view is the final view. If multiple source perspectives are utilized, the multiple IVs produced for each of the final output views must be merged in a way which preserves the best case resolution of each region of the image. This is done using an extra parameter in the ECTD program which indicates the weighting of each output pixel in each IV generated. This weighting is determined by the map of geometry of the source perspective and the map of the geometry of the surface of interest. The IVs for a given view are effectively averaged using that weighting factor for their relative significance, optimizing resolution throughput the resulting image.

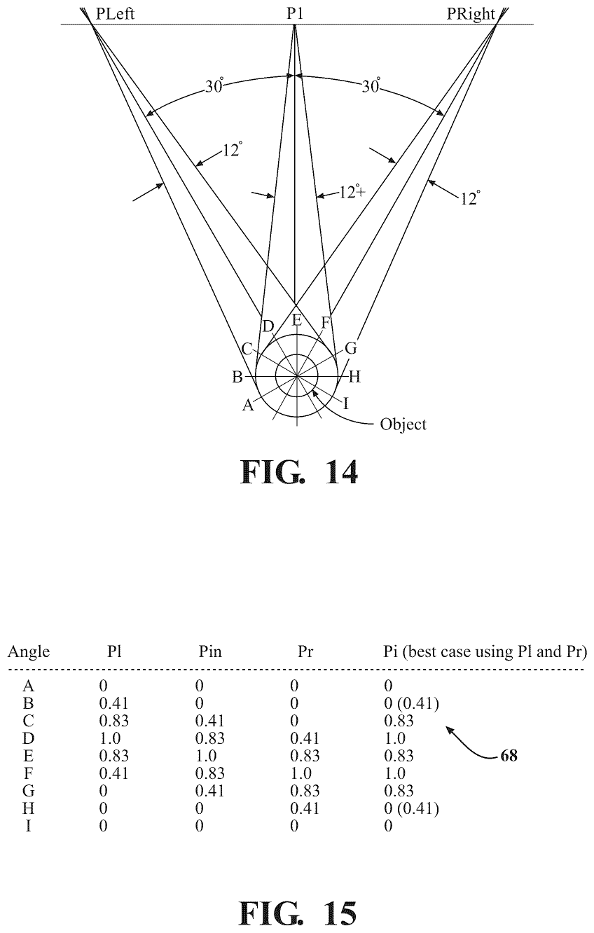

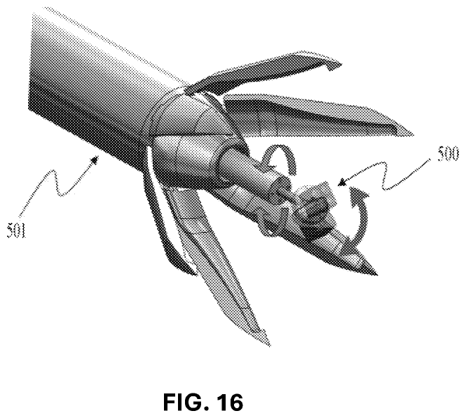

For example, as shown in FIGS. 14 and 15, in some embodiments, the processor 34 may assign a figure of merit value 68 for each pixel of each sensor in the MAC sensor array 20 indicating a significance of a corresponding pixel to the desired output perspective view and generate each single source interpolated perspectives view including a figure of merit value for each pixel. The processor 34 then merges the single source interpolated perspectives views into the desired output perspective view based on each figure of merit value of each pixel.

In some embodiments, the processor 34 may determining a relative location of each pixel with respect to the volume of interest based on the surface depth map and assign the figure of merit value for each pixel based on the determined relative location of each pixel.

Perspective Interpolation. Perspective interpolation is implemented by selecting the desired corrected source perspectives which are typically, but not necessarily source perspectives surrounding the desired perspective. Assume the source perspectives have been corrected into a common reference space. Using the surface depth map, ECT programs are generated for each of the source perspectives which will convert that source into a prototype version of the desired perspective. The prototyped desired perspectives include their potential information contribution to the desired perspective, plus the addition of a per pixel component representing the figure of merit for its corresponding pixel value. The figure of merit indicates how significant the pixel is to the desired perspective. A small range of merit values are typically adequate. For example, merit values of 0, 1, 2, or 3 indicating merits of none, poor, fair, and good is usually adequate. Once prototypes are generated using each of the desired perspectives, they are merged into an output image where each pixel is represented by the average value of the highest merit of the source prototypes.

There are advantages using input perspectives which both close and far from the desired perspective. As shown in FIG. 14 an object is observed from two perspectives, Pl (left) and Pr (right), with an interest in producing a Pi (interpolated) perspective. A through I represent ranges of surface angles which may be encountered. Due to geometric shortening, each of these surface angles is seen with a different resolution from each perspective. Pin (input) is a hypothetical input perspective at Pi for comparison to interpolated Pi results. The worst case relative resolutions (expressed in a range from 0 to 1) for each 30 degree step in surface angle from each perspective is shown in FIG. 15.

Useful resolutions at Pi (P interpolated) are actually higher than a hypothetical Pin resolution would be, except for surface angles in the neighborhood of E. A perfectly flat surface of interest would be “all E” and in that case Pi would exhibit a 17 percent lower resolution than Pin. This can largely be solved by providing additional source perspectives closer to Pi, or above and below Pi. For slopes near C, D, F and G, the interpolated Pi view has potentially much higher resolution than Pin. The maximum super resolution in this example is 2× in and around angles C and G. To actually represent this super resolution, Pi resolution would need to be twice that of Pin. Potential super resolution increases with increasing perspective separation angles. To retain and utilize the available resolution, Pi needs to be generated at twice the source resolution.

Low latency processing is essential to high speed analysis and performance optimization. Latency is the time that the image stream is delayed. Very low latency is required in the hand-eye coordination loop. Image sensor delay can be minimized by utilizing a rolling (continuous) data readout and display delay can be minimized by using a synchronous display phased appropriately for processing delay. Even with this finesse applied, image integration time and output display requirements leave very little time for processing. The current approach calculates the surface map slightly ahead of the image perspective processing by using earlier image sensor data. Input perspective correction and conversion to the Calibrated Volume of Interest (CVI), followed by generation of single source interpolated perspectives, then merge of perspective sources, and finally display output can occur with total processing latency a fraction of one frame time. To minimize latency, Elastic Convolution Transforms (ECT) are heavily relied upon as well as their ability to typically folding many operations together into each ECT step. Three stages of ECT are in the critical latency timing path, first to apply corrections, second to generate single source view interpolated output perspectives, and third to merge those prospective prototypes into output perspectives and finally formatted output.

Characteristics of an Elastic Convolution Transform (ECT). Elastic Convolution Transforms were developed to address the need for elastic (arbitrarily stretched or compressed image size) transformation of a source image to a destination image at minimal latency. Latency is determined primarily by data locality requirements. Assuming source and destination are processed in the same geometric orientation, locality is primarily dependent on the most extreme elastic distortion required, and the size of any required local convolution or transform. For typical optical “perfecting” operations, locality and hence latency can be well under 1/10 of a frame time. Geometric and MTF corrections can be applied, the image can be reshaped and resized, Bayer decoding and color conversions can be performed, and various filtering operations can be applied in the same process and latency.

Characteristics of Signal Resolution Representation (SRR) (QPE & ACQ). Images typically contain a great deal of quantum lightfield noise due to the random distribution of captured image illuminating photons, as well as thermal noise generated internal to the image sensor. As a result, lower frequency information is represented statistically rather than locally and the entire image frequency spectrum contains a great deal of noise information. This is the normal state of affairs and does not bother us visually because the visual cortex is so good at dealing with this aspect of reality. However, for relatively local operations such as color decoding and geometric and MTF corrections or any relatively local operation, a better representation of signal resolution and noise magnitude is desirable to avoid “baking the noise into the result”. A SSR representation utilizes sampling theory to optimize locality and resolution while minimizing noise energy. This is exactly what is desired for the optimization processes. A SSR transform can be folded into the ECT process, resulting in output signal resolution exceeding input resolution while noise energy is reduced. An optimal SSR representation of a 1K×1K image sensor with a 10 bit output and 16 quanta of average noise would see an increase of resolution to 16 bits or 30 dB at f0, and a typical reduction in noise magnitude on the order of 24 dB at Nyquist.

Locate probable occlusions “above” the surface of interest. Related to surface depth, detecting occlusions above the surface of interest and outside the volume of interest and determining which source perspectives may be involved is desirable. If nothing is done, depending on perspective merge, this would produce output which would appear to see through the occlusion with some transparency. If detected and a partial or complete perspective was eliminated, the occlusion could be effectively invisible.

Filter and Enhance images as desired. A number of popular image filtering and enhancement operations can be folded into the processing pipeline. The ECT is capable of phase contrast filtering which can provide dramatic results in some situations and is popular in microscope applications. Homomorphic filtering can be used to dramatically expand contrast of a specific region of color or luminance. General reshaping of the Modulated Transfer Function is available as well.

Exploit geometric and sampling theory based super-resolution. The combination of individual prototype interpolated perspectives (interpolated perspectives derived from a single source perspective) to produce the combined or final interpolated perspective exhibits two forms of potential super resolution. One is a direct consequence of geometric construction. When a surface of interest has regions at various angles, various viewing perspectives will provide differing resolutions for those regions. Regions which are nearly perpendicular to a particular perspective view axis will have high resolution. Regions which are nearly parallel to a particular perspective view axis will have very low or no resolution. If an interpolated view has a relatively low resolution region for which high resolution data is available from another view, then to preserve this available resolution, the interpolated view will need to be resampled at a higher resolution to “make room” for the higher resolution region data. As the cone of view and/or surface angles increase, this effect increases, and can become quite large. If output resolutions higher than source resolutions are desired, doubling the interpolated perspective resolution by a factor of 2× or more seems appropriate to provide for most of this effect.

The sampling based super-resolution mechanism depends on the fact that interpolated perspectives will be based on different pixel pitch due to mechanical offsets and viewing angle. These alternate sample grids each address some of the sampling phase and signal ambiguity which exists in a single perspective. Taking advantage of this by again utilizing a higher interpolated perspective resolution should retain a slight increase in frequency. The larger effect here is a reduction in noise. Combining two prototype perspectives should ideally provide a 3 dB improvement in signal to noise, as should each following doubling of perspectives. Combining interpolated perspectives from 8 different source perspectives should ideally be capable of providing a 9 dB signal to noise improvement.

Perform a merit based merge of interpolated perspective views into output perspective views. Each source perspective provides a candidate interpolated perspective to help create a desired interpolated perspective. In the extreme case, a single perspective could provide all desired output perspectives with some loss of information, quality and resolution. Normally a number of candidates corresponding to the number of source perspectives are combined to produce each output perspective. Each pixel of each source perspective has a figure of merit which indicates its relative contribution to the output perspective. The merge operation retains the highest available figure of merit data for each pixel, applying an average or regression analysis to multiple values at highest merit.

Arbitrary real time pan and zoom available within the volume of interest. The ECT used for primary signal processing is capable of arbitrary pan and zoom operations as desired.

In algorithm step 214, the processor 34 generates formatted output data based on image parameters of the display device 16 and displays the desired output perspective view 66 of the volume of interest on the display device 16 using the formatted output data.

Generate real time output for presentation on 2D video, stereoscopic and 3D displays. In the output stage data is formatted for the desired display(s). 2D display at HD, 4K, or 8K requires a single perspective. Stereoscopic display requires a left and right eye perspective, while current Lightfield monitors typically require an array of 45 perspectives.

Improve on currently available BIOM performance. BIOM lenses interface a wide field of view of typically 60 to 120 degrees, to a relatively narrow cone of 12 to 20 degrees. In the case of the Camtrx LightField3D™ approach, the cone of view can be much wider, which would appear to provide the opportunity for a more efficient BIOM lens.

Calibrated interaction with motion paths and micro-manipulation. The calibrated volume of interest ties a specific 3D volume and scale with all perspective image processing. A natural extension to the feature set would be to support motion path design, simulation, visualization, and control within this volume, which could then be interfaced with external servo device control if desired.

User Interface presentation and control. The ECT based image processing path can support User Interface Display on the generated perspective views, including grids, windows, prompts and other visual interaction.

Image Enhancement processes in the Elastic Convolution Transform. The ECTs being used to implement the perspective extraction are capable of doing more without impacting overall latency. Digital windowing and zoom are possible. Homomorphic and phase contrast filtering are popular in many medical applications for the ability to enhance low level contrast and detail dramatically. Boosting specific portions of the frequency spectrum, and special color combination sensitive operations are also possibilities.

Depth Measurement Artifacts. The depth measuring method described may produce local ambiguities in the depth map if the surface has deep holes, discontinuities, reflections, very steep transitions or similar surface anomalies. These could be reduced by applying a rule set filter. (not too low, not too high, not to steep, etc.) local ambiguities could produce local visual artifacts. An alternate method or a dual depth measurement method may be desired.

Second Order View Interpolation. The method described in detail above is a first order interpolation of a geometric perspective conversion. Protrusions, voids, steep transitions, internally generated shadows and reflections could all generate local artifacts under this form of perspective rotation. To improve on this, a second order interpolation would need to “understand” these special cases, generate a conceptual 3D model with correct shape, color, and specular or diffuse reflection, and then render the desired perspectives using a 3D ray tracing type approach. Although possible, it would be exceedingly difficult to do fast enough to support good hand-eye coordination.

In some embodiments, the one or more processors 34 may performing algorithm 400 for rendering 3D video images of the volume of interest onto the display device 16. For example, in algorithm step 302, the processor 34 may operate Illumination and Control using on axis external illumination which is particularly significant for fundus viewing, which may eliminate the need for invasive internal fiber optic illumination methods in most cases. The processor 34 may also operate hyper-spectral Illumination and Control for improved tissue visibility and identification, adding support for near infrared and possibly near ultraviolet wavelengths, emission and sensor polarization, and narrow spectrum pulsed illumination synchronized to image sensor integration time, to analyze differential absorption, reflection, auto-fluorescence and birefringence.

In algorithm step 304, the processor 34 operates the image acquisition sensor array including on the order of eight image sensors arrayed around a central axis and aimed so that individual optical axis all converge at a single point on the central primary axis at the bottom center of the volume of interest. Image Acquisition Hyper-Spectral Sensor Array (with optional filters and polarizer) may be used to support some hyper-spectral capabilities. A portion or potentially all image sensors can be replaced with high quantum efficiency broad spectrum sensors. These broad spectrum sensors would provide similar angular resolution and use the same lens assemblies. Optional polarizing or narrow wavelength filters may also be used. Camera lens assembly would support various optical wavelength pass and blocking filters and polarizing filters for various differential analytical capabilities to support hyper-spectral analysis of various optically active substances and tissues.

In algorithm step 306, the processor 34 performs source image perspective view auto-calibration. For each perspective view camera and lens assembly, the processor 34 performs: Frame storage and read/write interface portal for computer read/write access to image data used for collecting raw auto-calibration images, system testing, and development; Data storage and read/write interface to auto-calibration control data used to store the precomputed auto-calibration Elastic Convolution Transform (ECT) program which implements the desired calibration of each perspective view; and ECT Transform for image calibration based on auto-calibration data to obtain: Position & Geometric Orientation Correction; Geometric Distortion Correction; Wavelength/color and position specific MTF Correction; and Wavelength/color, position, and depth specific Focus Correction.

The processor 34 may also perform Hyper-Spectral Calibration with specific illumination, calibration target features and filters to fully map performance throughout desired spectrum. Bayesian super-resolution can under some conditions do an excellent job of correcting focus and point spread. If auto-calibration information can be converted into adequate prior constraints then a Bayesian inverse problem process could likely address these operations for both visible and extended spectrum.

In algorithm step 308, the processor 34 performs Auto Calibration Computer Interface.

In algorithm step 310, the processor 34 performs Coarse Depth Analysis. Coarse depth analysis endeavors to generate a depth and occlusion map for the cone of view in each frame time, with roughly 1 mm resolution within the volume of interest. The processor 34 may also perform Occlusion Detection and Perspective View Masking using Coarse depth analysis to detect occlusions unique to a single perspective or above the volume of interest. In either case, a low resolution occlusion mask indicates the occluded portion of particular perspective image(s) to later processing steps. The mask information is used later to either entirely remove the occlusion or provide a largely transparent or translucent analog.

In algorithm step 312, the processor 34 performs High Quality Low Latency Depth Analysis using Iterative Depth Cost. Higher quality depth information is desirable to enable better super-resolution results. High quality depth analysis computes the surface depth and detects occlusions within the volume of interest (VOI). Any improvement over Coarse Depth Analysis can provide some improvement in super-resolution results. Depth resolution on the same order as the linear pixel pitch within the VOI would be ideal.

In algorithm step 314, the processor 34 performs Depth Aware Perspective Merge including: Perspective Rotation, Translation, Projection, Magnification, Filtering by ECT; Perspective merit is derived from relative gradient which is derived from depth map and perspective; and Perspective Scale and Merge operation supporting Merit Based Super-Resolution. The processor 34 may also perform User Viewing Angle Optimized Perspective Merge; Scale and Merge with Oversampled Super-Resolution; Scale and Merge with Bayesian Super-Resolution; Hyper-Spectral feature detection with some basic hyper-spectral capabilities were added to provide possible solutions for specific procedures such as replacing dye in ILM peels, and improving blood transparency in neurological procedures; and Hyper-Spectral information to Pseudo-Visual conversion including NUV, NIR and differential information and any other analytical information folded into the visible representation, or possibly added to user interface mask or annotations.

In algorithm step 316, the processor 34 Image Enhancement Filtering User Options Implemented as an ECT processing stage including Frequency response reshaping, pass band control, noise reduction, etc.; Homomorphic filtering; Phase Contrast filtering; and Vector Operator Derived Filtering.

In algorithm step 318, the processor 34 performs Computer Interface Portal for Image Read/Write, Windowed UI and Diagnostic Access including Computer enabled user interface windowed displays and overlay functions; Initial development and testing support including: Computer Assisted Image Enhancement and advanced filtering; Computer Assisted Bayesian Super Resolution development; and Computer Assisted Feature Search, Measurement and Identification; support computer assisted advanced features in production model; and Generate Diagnostic Information and Metadata.

In algorithm step 320, the processor 34 Merges Output Perspective with User Interface Data & Annotation.

In algorithm step 322, the processor 34 Generates Final Perspective Views for the desired output(s) including: Generate Lightfield Monitor Resolution and Perspectives; Generate Stereoscopic Headset Resolution and Perspectives; and Generate Video Resolution Perspective.

In algorithm step 324, the processor 34 performs Image Output Formatting including: Lightfield Monitor 3D output formatting; Stereoscopic Headset stereoscopic output formatting; and Video output formatting.

In some embodiments, the processor 34 may be programmed to display the desired output perspective views 66 on a wearable augmented/extended reality (AXR) headset 70 adapted to be worn by a user. For example, in some embodiments, the lightfield imaging system 10 may include a wireless transceiver for use in wirelessly transmitting the formatted output data of the desired output perspective views to the AXR headset 70 for viewing by the user. Additional details of the AXR headset 70, which may be used in the present invention, are described in U.S. patent application Ser. No. 17/139,167 to David Kessler et al., filed Dec. 31, 2020, titled “Wearable Pupil-Forming Apparatus”; and U.S. patent application Ser. No. 18/531,248 to David Kessler et al., filed Dec. 6, 2023, titled “Augmented Reality Near-Eye Pupil-Forming Catadioptric Optical Engine in Glasses Format”, which are incorporated herein by reference in their entirety. The AXR headset 70 may be, for example, the ORLenz™ Extended Reality Visualization headset sold by Ocutrx™.

In some embodiments, the processor 34 may be coupled in communication with a controller of an All-Digital Multi-Option 3D Viewing Theatre (ADMO3DV) system 72 including a 3D autostereoscopic monitor (3DAM) 74, a 3D digital viewport (3DDV) device 76, and the AXR headset 70. The processor 34 may be programmed to transmit the formatted output data of the desired output perspective views 66 to the controller of the ADMO3DV system 72 to display the received images on the 3D autostereoscopic monitor 74, the 3D digital viewport device 76, and/or the AXR headset 70. Additional details of the All-Digital Multi-Option 3D Viewing Theatre system 72, which may be used in the present invention, are described in U.S. patent application Ser. No. 18/450,997 to Michael H. Freeman et al., filed Sep. 6, 2023, titled “Surgery Visualization Theatre”, which is incorporated herein by reference in its entirety. The All-Digital Multi-Option 3D Viewing Theatre system 72 may be, for example, the OR-Bot™ sold by Ocutrx™.

In some embodiments, the lightfield imaging system 10 may include the Camtrx LightField3D™ sold by Ocutrx™. The Camtrx LightField3D™ employs novel optical, lightfield, and signal processing techniques to combine high resolution, low latency, 3D perspective, and user configurable advanced analytical and image enhancement tools into an integrated product.

During operation of the lightfield imaging system 10, following power up, the user can specify illumination by a broad or narrow spectrum for each primary, as well as type of display (single perspective, stereoscopic, or lightfield). An auto-calibration process then measures various physical positions and orientations, as well as any optical distortion. Auto-calibration data is used to generate processes to calibrate depth perception measurement and image perspective input and generation of interpolated perspectives output. Measured displacements, geometric distortion and modulated transfer functions are all utilized to provide a calibrated common reference framework. In addition, this information is used to generate the corrective processes driving various Elastic Convolution Transform operators (ECT) to produce calibrated depth sensor data from the raw sensor data and to calibrate image sensor data from the raw perspective sensors, as well as generate the processes that drive the ECT processes which generate the interpolated perspectives.

Common Reference Framework (CRF). The common reference framework is a 3D map of the sensors and projectors and their relation to the volume of view, volume of interest and surface of interest and what corrections are required to map image sensor, depth fiducial and depth sensor data onto that framework. Auto calibration data is used to generate ECT programming to convert these various image sensor data sets onto this common reference framework.

ECT Programming. ECT programming is the control data structure which determines the specific action that ECT hardware will implement. ECT programming typically supplies at least a source address, destination address, and selection of desired process (convolution, LUT, etc) for each data element processed (sample, pixel, color component, etc.). Either source or destination addresses may be implied by some default progression or generator function in the case of a purely geometric transform. ECT processing is typically implemented in a Field Programmable Gate Array (FPGA) or Application Specific Integrated Circuit (ASIC). An ECT is well suited to implement an arbitrary elastic conversion with value specific processing, and can typically include non-linear data value mapping and frequency domain transforms with no added processing time.

Conversion of Auto-Calibration Data into ECT Programming. The auto calibration data and user option settings are used to generate three sets of ECT programming. These include three sets of transforms: #1-ECTs to convert raw depth data from each depth sensor into geometrically calibrated data in the 3D CRF for that sensor, #2-ECTs to convert each set of image sensor data and corrected depth data into 3D image data in the 3D CRF, and #3-ECTs to convert 3D CRE image data into the required planar perspective views needed for the selected output.

Depth Map Data Acquisition and Calibration. An accurate surface depth map in the CRF is critical for the 3D analysis of the image sensor source perspective correction ECT programs as well as the following perspective interpolation ECT programs. A surface depth measurement process collects depth image sensor data, then analyzes it for depth information and then uses an ECT programmed using auto-calibration data to map that depth map data onto the CRF, by removing any geometric or optical distortion. This depth information is critical to the analysis of source image perspectives as well as generation of interpolated output perspectives.

Input Perspective Correction ECT Program Generation. The required input geometric and optical distortion for each image sensor is known from autocalibration. With this data, the ECT transform control code to calibrate input image sensor data and depth data into 3D CRF format can be produced.

Interpolated Output Perspective ECT Program Generation. The output perspectives are generated from the 3D CRF image perspectives and depth map data. The required output perspectives are known when the output option is selected by user configuration. This provides the data to generate the individual ECT programs for each interpolated perspective.

### Actual Operational Processing

Depth Map Extraction. Depth processing consists of depth image sensor sampling, followed by depth analysis and finally calibration to the 3D CRF reference space. Depth analysis is done by local frequency component analysis. The raw depth grid is then mapped to the 3D CRF using auto calibration data. Depth analysis consists of dividing the depth image into overlapping tiles, windowing the tile to highlight central data, transforming the tile using a sample to frequency domain transform, masking to access the desired frequency components, and then using either a depth of focus, focal point spread or geometric projection line spread analysis to map the frequency data into depth data. Depth data can be significantly lower resolution than image pixel resolution. For example, if a roughly 1 mm depth resolution is adequate, a 50 mm diameter region of interest would easily be covered by a 100×100 depth data point grid. If a 2000×2000 pixel depth image sensor is used, 40×40 pixel overlapping tiles would be satisfactory for depth extraction.

Depth Map Calibration. Depth map calibration into 3D CRF is done by the ECT and control program created for that purpose using auto-calibration data. This compensates for any positioning, orientation, geometric or optical distortion detected during auto calibration.

Image Acquisition, Correction, Perspective Generation and Interpolation. Image data is collected from a number of image sensors covering a number of perspectives. Each image perspective has its own ECT program which converts that image data combined with the 3D CRF version of the current depth map, into 3D CRF space. Some image filtering and image enhancement operations can be folded into this transform to provide these capabilities with no increase in latency.

Perspective Interpolation. The surface depth map and corrected image perspectives are used to interpolate the required output perspectives using the 3D CRF image and depth data and the ECT transforms and controlling data sets generation from output selection. Each input perspective can be converted into a prototype of each desired output perspective. The desired output perspectives are then merged into the final perspectives by evaluating a per pixel merit function which indicates the quality of each contribution from each perspective. Some image filtering and image enhancement operations can be folded into this transform to provide these capabilities with no increase in latency.

Image Enhancement. Image enhancement can provide a wide number of user configurable services to improve clarity and utility. In many cases enhancement can be folded into other processes. In other cases typically involving full image forward and reverse transforms, additional latency may be required. Image enhancement includes ultra high quality real time image resizing to support desired resolutions and formats.

Image Output Formatting and Display. The image stream can be formatted for display on conventional, stereoscopic, or lightfield displays. Processing options can be provided to provide some or all of these formats concurrently. Output can be formatted into media formats for video recording or media compression.

Operational Timing Overview. Processing times estimated on 10 ms image acquisition integration time and mid-range FPGA part based processing time times Assumes 10 ms frame image acquisition time, and 5 ms processing time increments; t+N is N×5 ms before or after source images are acquired; t−2 is the beginning of the current view beginning of sensor integration; t−0 is the current view accessible at the sensor; t+4 is the current view ready for output to display device.

Depth Map Acquisition and Analysis. Acquire Depth Image t−3 & t−2; Analyze Depth Information t−1; Corrected Dept Image available t−0.

Image Acquisition, Correction, Perspective Generation and Interpolation. Acquire Perspective Images t−1 & t−0; Correct Perspective Images t+1.

Perspective interpolation transform generation. Needs processed depth data; Generate interpolation transforms t+1.

Perspective Interpolation. Generate Interpolated Perspectives t+2

Image Enhancement. Most cases of: Modification of frequency domain; Homomorphic filtering; Noise coring; Color space conversions; Pseudocolor processing; Folded operations no change in latency; Filters requiring forward and reverse full image transforms: Phase contrast filtering; Assured channel quality filtering/conversion; Perception filtering; High quality resizing; Forward and reverse transform 10 ms.

Image Output and Display. Formatted output t+3; Begin transfer to Display t+4; Nominal Processing Latency 20 ms; Frame to Display transfer 5 ms; Acquisition, processing, display 10 ms+25 ms+ (1000 ms/display frame rate).

Power up and Optional Selection of Spectral Illumination. On power up, the system performs self tests of all critical systems. After initial self test, the user can select from available spectral options, if their system includes this option. Narrow spectral primaries can be implemented either by using mono chromatic light sources for illumination, or narrow band filters applied to broadband sources, or notch filters with image sensors. Using narrow spectrum primary color component illumination has several potential benefits. A definite advantage is that the computational geometric correction and computational focus correction can do a much better job if lens geometric distortion and focus point spread are better controlled. This results in much sharper images and greater useful depth of focus. As an example, instead of relying on broad spectrum white light, LED illumination of RGB primaries of 650 nm, 550 nm, and 450 nm+/−5 nm would provide these advantages.

An additional area of potential benefit is the ability to utilize particular spectral components to provide increased tissue transparency or more selectivity of particular tissues. Any desired spectral component color primaries, pseudo-color space or other custom illumination should be selected before auto calibration, so the particular sources to be used are measured and calibration is optimized for their use. Imagery on display is converted to conventual human viewing color space for display.

Depth Perception Mechanisms. The Camtrx LightField3D™ microscope acquires multiple perspective views of the surface of interest within the volume of interest. The multiple perspectives provide information to interpolate perspective views for a three-dimensional display output, as well as minimizing visual interference by objects above the volume of interest such as tools or hands which would otherwise occlude the view. To accomplish this ability to look “through” or “around” occlusions, as well as providing a realistic 3D view of the surface of interest, multiple perspectives are captured by multiple image sensors with various perspective views. The wider the range of captured perspectives, the greater the ability to implement this “look around” or transparency feature. To construct the desired output perspectives from the available source perspectives with low processing latency suitable for good hand-eye coordination, a fast geometric construction method of perspective interpolation is desired. There are two general approaches possible. One approach to perspective interpolation is to use auto correlation or feature recognition in the various perspectives to detect reference objects and their orientation in the various perspectives, then use this information to generate a 3D volumetric model of the volume of interest, and then render the desire output perspectives using that 3D model. Unfortunately, a number of these steps require long computations resulting in unacceptable latency. An approach which can achieve the desired low processing latency is geometric perspective interpolation. If the relative positions, fields of view, and geometric and optical distortions, and the profile of the surface of interest are all known well enough, then desired output perspectives at high resolutions can be calculated rapidly. Geometric perspective interpolation requires a depth map of the surface of interest. Possibilities for depth map generation include near range LIDAR or high frequency SONAR as well as the proposed near InfraRed optical pattern projection, image capture and analysis. Each of these approaches are capable of producing a depth map with roughly 1 mm depth and positional resolution. The Camtrx LightField3D™ microscope could potentially use any of these mechanisms individually or in combination to create the desired surface depth map.

Several approaches can be used for near infrared optical depth measurement. The point spread function can easily be measured in the image resulting from projecting a pattern onto the field of interest and capturing the resulting picture. If optimum focus occurs at the maximum depth of the field of interest and is significantly out of focus at the minimum depth of interest, then the point spread function can be used to determine depth. A similar alternative relies geometric line spread by projecting a 2D grid and measuring the geometric divergence of that grid on the surface of interest. In both cases, local Fourier transforms can be used to directly measure the optical projections and provide the required depth map. These two optical methods are similar enough that they can in some cases be combined to provide a cross reference. In order to operate in spite of occluding objects, multiple fiducial depth projectors and sensors are desire.

Depth Map Processing delay relative to image processing latency. If image acquisition, image processing, and resulting perspective display are inserted into the hand-eye coordination loop, the quality, accuracy, and responsiveness of that coordination diminishes rapidly if image latency exceeds a few tens of milliseconds. Image Latency is the time from image acquisition until display. With training, a user can adapt to compensate to some extent, but it is very desirable to keep latency as small as possible. Toward this goal, the depth processing time is independent of the image processing path. This is reasonable because the depth map typically changes more slowly than the image, and when the depth map does change dynamically, the motion can typically be projected into the future by analyzing recent history for motion and providing a good estimate of future surface position. As a result, depth map processing latency is decoupled from image processing latency.

Perspective Acquisition. Images at various perspectives of the field of interest are acquired with multiple image sensors. These sensors either share a single optical path with multiple perspective optics, or individual cameras and lenses with their axis passing through the center of the cone of view. In the case of the shared optic, optical magnification is also provided in steps of 2×. This is in addition to magnification provided in the image signal processing path. In the case of camera arrays, they can be in a linear array or arc across the base of the cone of view. In the case of the arc configuration, it can be extended to extremes allowing excellent occlusion look-around. Four to six perspectives are typically distributed across the base of the cone of view, with two rows of three to five perspectives above and below the previous sensors, to provide a symmetrical frequency response in the interpolated perspectives.

Auto Calibration. Calibration assures best case performance by measuring positioning of critical components, and optical performance parameters and applying them to the correction process. This approach assures that positioning and orientation of sensors can be assured to on the order of one micron, while similar resolutions can be supported by the optical performance. This approach also simplifies assembly, shipment, maintenance, and assures proper operation by compensating for mechanical alignment, thermal expansion, and assures the use of actual illumination, as well as optical lens and sensor performance. During auto calibration, a test fixture is either attached or enabled and extended to sweep through the volume of interest. The test fixture provides a test pattern, and an actuator which can be accurately positioned to sweep the test pattern through the volume of interest. The Auto Calibration test pattern fills a plane of the field of interest and can precisely sweep the entire volume. The test pattern provides a reference geometric pattern which facilitates measurement of sensor and optics axis alignment, alignment angle, and scale, as well as the per color component MTF response and per color component optical geometric distortion at all locations in the volume of interest, and the illumination intensity profile for each color primary. This calibration includes both image sensors and depth sensor performance, and depth illumination primary.

Auto Calibration of Depth Map Pattern Projection. It is desirable that the Depth map data is very resistant to occluding objects above the volume of interest. This argues for multiple depth reference projection sources. For this reason, three projectors are anticipated, located in a ring with a projector sources every 120 degrees. If these are projecting x-y grids, rotating each by 30 degrees from the others provides grid lines at 0, 30, 60, 90, 120, and 150 degrees. This allows lines to be analyzed together or in part using local Fourier transforms both to select and to measure. All three sets of grids provide redundant depth measurement which should provide reasonable resistant to occlusion. Depending on the method of projection, either line separation or line spread can be used to analyze depth. Spectral filters often have some cross talk with other wavelengths. A near IR filter which passes the depth map will also pass some amount of visible wavelengths. The maximum possible spectral crosstalk magnitude should be much less than full scale sensor output and can be removed by retaining only signals exceeding a threshold.

### Depth Map Pattern Projection Methods: Point Spread; Line Spread

Auto Calibration Position, Orientation and Geometric distortion correction. It is assumed that each depth projection image will be slightly different, with differing geometric projection and slightly different optical behavior and alignment. The same issue is assumed for each depth projection sensor. Auto calibration collects the data which enables compensation for these issues in the depth projection analysis. Using the known depth and position information provided by the calibration target as it is swept through the volume of interest allows any geometric or optical distortion or alignment to be detected and a correction map to be generated so that all sensors agree using any or all projection sources and sensors in any combination.

Auto Calibration Depth correction data set generation. Sensor data (images) of the test pattern as viewed by the depth sensors is collected during autocalibration. Correcting for any geometric orientation of projectors and sensors and obtaining good agreement from each channel is critical to reliable determination of surface depth. In a relatively non time critical process, geometric and optical distortions are determined throughout each sample plane in the volume of interest. A transformation map describes the transformation required to map the source observation from each individual sensor to the desired result for each point of interest in each plane throughout the volume of interest. The size of this data set is manageable due to the fact that these parameters are highly correlated in the volume of interest and can be adequately represented at sample resolutions much lower than the image resolution. For example, a correction map of 100×100×50 entries which can be interpolated to full desired resolution would typically be suitable even for very high image resolution.

Operation. Operation consists of three primary concurrent processes which are surface depth map computation, image perspective acquisition, and image perspective interpolation and display. To keep latency as low as possible, surface depth map computation is done concurrently with the image processing but outside the latency path from sensor to display. Allowing image processing to use a slightly old surface map reduces latency by about a factor of two, and is typically tolerable because the surface map is typically less dynamic than changes of perspective or motion above the surface of interest.

Operational Depth. Required depth resolution is much less than required image resolution. The assumption is made and verified during auto-calibration that fiducial pattern projection and depth sensor axis alignment and placement are “close”, with close on the order of one millimeter. The geometric and optical error related to depth perception are mapped for the volume of interest during auto-calibration, with the assumption that geometrically imposed error will be minimal, and geometric corrections can be made after depth analysis, using an x, y, z index into the 3D correction data for each sensor. Sensors then “vote” for the actual depth. Depths above the top or below the bottom of the volume of interest are considered occlusions or voids. Depths within the volume of interest are valid. If a location has no valid votes, it is considered a void. Voids can be “filled” with the nearest valid depth, or set to the maximum depth.

Operational Depth Calculation. Depth images are cored to remove possible cross talk from visible primaries. Then depth images are divided into overlapping squares. For instance, if a depth sensor image is 2000×2000 pixels, and fiducial grid separation at maximum depth is on the order of 20 pixels, it could be divided into 100×100 or 10,000 squares of 40×40 pixels. The squares of depth data are Fourier transformed, and masked by the orientations of potential depth information. The largest remaining components are converted to frequencies, noise reduced by discarding the highest and lowest and averaging the remainder, which is then mapped to depth. A frequency based analysis can also be applied if the fiducial grid is a lens focused optical projection which is at sharp focus at maximum depth of interest, and is out of focus with increased point spread at minimum depth of interest.

Operational Depth Correction. If geometric distortion of the depth fiducial pattern is known to be significant enough to justify correction, a correction of the depth map shape can be done based on the auto-calibration information and using an elastic convolution transform to stretch the x, y geometry as required. The depth (z) information is considered to be correct based on the assumptions above, and only the x and y displacements need to be corrected.

Operational Depth Map and Depth Map Prediction. The depth map representing the surface profile is calculated for every input frame time with roughly 10 to 20 milliseconds of real time delay. If the surface profile is very dynamic, motion estimation can be applied to the current and historic depth maps, to predict future depth maps as required.

Image Acquisition and Correction. The Camtrx LightField3D™ microscope acquires multiple perspectives simultaneously with the ability to interpolate intermediate perspectives from the acquired perspectives. In order to accomplish this with minimal latency a geometric construction method is employed. Geometric construction requires the source image perspectives to be in a normalized form with accurate relative positioning and scaling of the image perspectives, correction of lens distortion, and the depth profile of the surface of interest. Normalization of sensor acquired image perspectives relies on information obtained during auto calibration. The calibration data is used to produce a specialized data structure for each image sensor which controls the ECT transform of each input frame from each image sensor into an idealized representation with a precisely known geometric relationship to all other captured perspectives. Interpolation of new perspectives requires generation of perspective interpolation control data. Perspective interpolation requires ECT processing and control for each source perspective and a merge operation to combine all source perspectives and resolve regional resolution priorities. Regional priorities are determined by how well a given source perspective can represent a region n the output perspective, which is dependent on the viewing angle and the surface angle. The preferred perspective for that region has the viewing angle closest to perpendicular to the surface in that region. The same perspective interpolation process can also add text, grids, windows and other user information if desired.

Optical distortion correction applied to each color component. A complex lens system can easily exhibit worst case geometric distortion exceeding many pixels at the image sensor. Making the problem even more severe, this distortion can be dramatically different for each color component. This can be devastating to high frequency resolution and image quality if not corrected. Fortunately, an ECT is an ideal process to correct for this distortion as well as providing a high quality convolution based color decode.

Filtering and image enhancement. A sequence of generic processing blocks can implement a wide range of useful operations. A nonlinear value remap, followed by a forward transform, nonlinear remap, multiplication by a frequency response map, nonlinear remap, and an inverse transform followed by a final nonlinear value map can provide a wide range of noise reduction, frequency domain modification, homomorphic, phase contrast, and other filtering operations which can increase quality and highlight selected features dramatically.

High Quality Image Resizing using ECT transforms. The Elastic Convolution Transform (ECT) used to correct geometric distortion and interpolate new perspectives can also be used to provide the desired output image resize, allowing source images to be scaled or stretched either up or down. In this case the ECT effectively implements a Lanczos windowed interpolation convolution which is considered to provide excellent image quality. In many cases where an ECT is being used for other image processing steps, a resize operation can be combined with no additional processing steps.

High Quality Transform Based Resizing using Image Enhancement Mechanism. The ultimate in resizing is full image transform based resizing, which can remove the majority of sampling noise and increase signal resolution while providing an ultra high quality resize.

Display on a Stereoscopic Headset. A stereoscopic headset provides a relatively high resolution left and right eye perspective view without constraining to viewer to a particular position. This has the potential to greatly improve the ergonomics of long and/or delicate procedures. Use of a stereoscopic headset with the Camtrx LightField3D™ microscope requires generation and output of left and right image streams of interpolated perspectives. The viewing perspective can be controlled by head position, orientation, or manual user interface control. Generating left and right eye perspectives require interpolating each view from available perspectives.

Display on a Lightfield Monitor. Current lightfield monitors display a “3D” image by optically filtering selected views based upon viewing angle. Current practice is to display an interleaved array of 45 different perspectives which present the appropriate perspectives by directional optical filtering and the actual eye positions and angles of view. Processing required to generate interpolated perspective views is largely proportional to the number of pixels required. Producing 45 perspectives at 1/45 resolution is only slightly more processing work than producing one perspective at full resolution. The primary increase in computational throughput over a stereoscopic view results from all source perspectives being active concurrently, and the additional formatting required for the output stream.

Recording output. Both stereoscopic and lightfield output can be recorded on appropriate video equipment or as media files when operating at a supported frame rate.

In some embodiments, the lightfield imaging system 10 may include: 1. Hardware and software comprising a non-transient computer model-view-controller (MVC) and video sensor processing control; 2. A microscope housing comprising: a. A power supply; b. A weighted base; c. An articulating or robotic arm; d. A computer controller with monitor; e. Wired and/or wireless video connections comprising: i. Transferring wired information to a 3D monitor or ii. Transferring wireless information to an Augmented Reality/Extended Reality or Virtual Reality-Mixed Reality headsets; f. An aiming function with an x, y-axis (mechanical and digital) module electronic controller; g. A focusing function with a z-axis (focus) (optical, mechanical, and/or digital) module electronic controller; h. A lighting mechanism for illuminating the subject (surgery) area; i. An optical and/or digital zoom-magnification mechanism; j. An external footpedal or other mechanism to control the above; 3. One or more microscope lens housings containing optical lenses culminating in a objective lens over the subject (surgery) site; 4. A microscope lens sequence consisting of: a. a collimating objective lens that gathers light from the object being observed; b. a relay lens that forms an intermediate image of the object; c. an aperture stop following the relay lens; d. a relay lens that collimates the intermediate image and forms an image of the aperture stop; 5. a video sensor array capturing images from the microscope lens sequence consisting of lens/sensor pairs comprising: a. at least more than two video sensors; b. aspheric focusing lenses attached to each video sensor; c. the lens/sensor pairs configured in an array where the lens/sensor pairs are located at the image of the aperture stop of the microscope lens sequence which focuses the photons which create the recorded image from different perspectives in real-time; d. an MVC data transfer protocol to separately transfer synchronized lens/sensor pair data; 6. A computer vision processing interface which includes a method of 3D reconstruction from the various lens/sensor pairs. 7. A computer vision processing interface to interpolate the necessary views needed to show a holographic image generated from the lens/sensor pairs imaging. 8. One or more holographic display which presents an effectively continuous views of the subject site interpolated from the lens/sensor pairs. 9. A method whereby an overlay of information is integrated into the real-time video feed such as highlighting specific areas of the 3D video based on parameters such as depth (such as in a surface mapping) or color (such as identifying a specific color).

In some embodiments, the lightfield imaging system 10 may perform a method of creating a 3D color mesh using a sampling of the plenoptic function derived from the different perspectives recorded by the sensors and a method of generating an array of images of the 3D color mesh for use in constructing a holographic video image.

The lightfield imaging system 10 may also include a holographic display which presents a live magnified 3D image of the object being observed.

Lightfield imaging has several advantages as compared to traditional two-dimensional imaging. Among these are holographic display, depth, and feature recognition, digital refocusing and autofocus, occlusion insensitivity, increased depth of field.

With the present invention, diagnostic data such as preoperative OCT can be overlayed on the three-dimensional image for subsurface feature display.

Camtrx Dual 6K 3D All-Digital Microscope Combined with Stereolenz 3D 8K “Glasses-Free” Monitor and Dynatrx Computer Vision Technologies for Better Examination of Internal Limiting Membranes for Retinal Surgeries

### Section A. Standard Surgery Optical Microscope Background

1, The Standard Optical Microscope (SOM). The typical SOMs used in surgeries, such as ophthalmic micro-laparoscopic surgeries, are also referred to as a light microscope. A light microscope is a type that commonly uses visible light and a system of lenses to generate magnified images of small objects. The design of the SOM is one of the oldest designs around and were possibly invented in their present compound form in the 17th century. Formerly, it was commonly known that there were three basic types of microscopes: (i) optical, (ii) charged particle (electron and ion), and (iii) scanning probe. Now Ocutrx is bringing a whole new type of microscope—the 3D All-Digital Microscope (3DADM) called the Camtrx™.

2. Legacy SOMs. Large manufacturers of the surgery SOMs include Zeiss, Alcon, Leica, Prescott, and others. Each of these manufacturers have recently added a digital component, but, due to the limitation of their lens barrel, the resolution of their sensors is poor. (See, Competitor Chart FIG. 1). Because each of these companies are relying on their legacy models to build on a digital element, the digital is limited by the optics which are primarily designed for viewing with the naked eye. Thus, the digital add-on to a SOM which primarily provides optical magnification and zoom, is limited. Most SOM's manufacturers typically boast 6× zoom but a fairly limited field-of-view and depth-of-field. Moreover, the resolution limit of optical microscopes at very-high magnifications typically distorts the image in a known manner, creating fuzzy discs that are surrounded by diffractions rings known as Airy discs. Out-of-focus light from points outside the focal plane further reduces image clarity.

Some of the known limitations of the legacy SOMs vis-à-vis a digital microscope include:
The most obvious disadvantage of a SOM is that it needs a very bright light to see microscopically, while digital microscopes can operate in approximately 10× lower light;
A SOM, being a light microscope, has a lower resolution compared to digital because the refracted light waves are spread out when viewed through the lens causing the image to blur;
The typical SOM cannot magnify as closely (only 6×) as a digital microscope because a digital microscope has both optical and digital zoom of a hundred times more;
A SOM cannot provide the best three-dimensional renderings. Although when using a stereo SOM, you can see 3D depth thanks to the fact that you are receiving two slightly different views of the object you are studying, the distance is based on maximum Interpupillary Distance (IPD) of a human's eye, while with an 3DAMD microscope on can apply disparity 3D imaging algorithms which makes for better quality 3D, so the SOM 3D is no comparison to a digital microscope set up for 3D imaging; and
A SOM requires the user to have an expectation of what/where the user wants to find, meaning that at high zoom, the perspective tends to be lost, while with a digital microscope, you can have a picture-in-picture which always references where you are in the larger structure to be viewed.

3. More pixel's equal better resolution. Since Ocutrx is not limited with legacy optics plus video, like many of its competitors, it has created a new type of 3D all-digital microscope (3DADM) for surgeries, which can provide many additional and beneficial features, beyond the reach of the legacy microscopes. For instance, each of the dual cinematic sensors are full 6K of resolution (6064×4040) per/sensor per/eye, providing a total pixel count of 24.5 million pixels per/eye throughput, or a total of 49 million pixels when viewed in 3D stereo vision.

Compare with both Zeiss and Alcon, where Zeiss SOMs use 4 k camera sensors, with 8.3 megapixels; and Alcon SOMs use 2 k sensors with 2.1 megapixels compared to Ocutrx's 24.5 megapixels per stereo channel. And while Ocutrx's Camtrx has 69 billion potential colors, both Zeiss and Alcon provide only 10 bits of color with 1 million potential colors.

Moreover, the smaller pixels found in the Competitor's sensors require that their “signal” is boosted. Since the fundamental limit of sensor resolution is determined in the analog world with the battle for higher resolutions being primarily a fight against electrical “noise” caused by the “boosting”.

Thus, the native dynamic range of the Camtrx sensors is greater than 14 stops each, while both Zeiss and Alcon provide only 10 stops. This lack of dynamic range combined with the Competitor's smaller pixels count is attempted to be offset by increasing the signal level of each sensor. This means that the Camtrx sensors provide a 16× dynamic range (the difference between the brightest pixel and the darkest pixel) over the competitors SOMs with video camera sensors.

In sensor signal processing, “noise” is a general term for unwanted aberrations that a signal may suffer during capture, storage, processing, transmission, or conversion. All sensors produce small, random changes in voltage potentials that combine throughout the circuitry and appear as a band of noise when viewed with an oscilloscope. Sensors with smaller pixels have a higher noise ratio because their signal is boosted for better clarity. On the other hand, sensors with greater “well” capacity, like the Camtrx sensors, are able to stabilize noise better creating a greater signal potential.

In contrast, sensors with smaller pixels, like the Competitors, must have their lower signal potential boosted which increases the noise, which then necessitates the Competitors to use post-processing techniques for de-noising to regain a usable image. This post-processing is partly why both Alcon and Zeiss SOM's experience relay “lag-times” of over 80 milliseconds, while the Camtrx lag time is less than 20 milliseconds.

The Camtrx sensor pixel size is a 4× increase in area over the Alcon nGenuity® SOM products; and an 9× increase in pixel size over the Zeiss Artivo® System. The larger pixels in the Camtrx dual 6K sensors results in the sensor's CMOS imaging gathering more light, color, contrast, and other information. Gathering more light, color, contrast, and other information permits the Camtrx 3DAMD to operate in surgeries either inside the eye or the body with a lower amount of light and still see a potential of 68 billion colors.

Resolution and Digital Magnification. The Ocutrx StereoLenz 8 k 3D Autostereoscopic monitor used with the Camtrx provides a native 3840×3840 resolution when at 28 inches from the surgeon's eye. Compare this to the Alcon nGenuity provides only 1920×1080 resolution on their monitors; and the Zeiss Artivo System provides 3840×1080 resolution. Thus, the StereoLenz 3D “glasses-free” monitor provides the best resolution in the field.

Moreover, when the Camtrx 3D All-Digital Microscope is linked with the StereoLenz 8K 3D monitor the combination can produce 10× to 90× optical/digital magnification at 4 k resolution; and 540× magnification at FHD resolution which is still good enough resolution to clearly identify objects. When considering viewing an ILM a surgeon could magnify a limited field-of-view resolving down to 4-8 microns (tested by USAF 1951 Resolution Chart Test). This magnification best all Competitors in the market by a huge quantity.

### Section B. Application of the CAMTRX 3DADM to Epiretinal Membrane Peels

1. Macular Peeling. Macular peeling refers to the surgical technique for the removal of preretinal tissue, epiretinal membrane (ERM), often called the internal limiting membrane (ILM) in the macula for several retinal disorders, ranging from epiretinal membranes (primary or secondary to diabetic retinopathy), retinal detachment to full-thickness macular holes, macular edema, foveal retinoschisis, and others. The technique has evolved in the last two decades, and the different instrumentations and adjuncts have progressively advanced turning into a safer, easier, and more useful tool for the vitreoretinal surgeon. However, the surgical technique for ILM peeling is demanding in terms of time and skill. Challenges include poor visibility of the thin transparent membrane and the small dimensions and the sensitivity of the macular tissue, which increase the risk of iatrogenic damage from surgical manipulation. These factors increase the risk of iatrogenic damage.

Complication 1. Light Toxicity. Pars plana vitrectomy was first introduced by Robert Machemer with contributions from Thomas M. Aaberg, who invented a single-port, multifunctional 17-gauge cutter, the vitreous infusion suction cutter. Pars plana vitrectomy allowed for the first time the removal of vitreous through a closed system, rather than through an open-sky technique. Since then, there have been innumerable advances in vitreoretinal surgery; significant improvements have occurred not only with vitrectomy probes, but also in other surgical technical aspects including fluidics, instrumentation, viewing systems, wound construction, and endoillumination.

Illumination of the retina and the vitreous cavity during surgery is accomplished by a fiber optic light source inserted in a light pipe or chandelier. Since 1982, it is well known that direct endobulbar illumination may cause light-induced retinal damage known as phototoxicity. Retinal Light Toxicity is a direct result of exposure time plus amount of light energy on the retina. Due to the small sensor and pixel size in all competitor SOM's, it is required that a halogen or xenon light be inside the eye during an ILM surgery. This direct endobulbar illumination during vitreoretinal surgery causes light-induced retinal damage known as phototoxicity or hototoxicity. The latest advancements have focused on increasing endoillumination safety by changing the light source, adding light filters, and increasing the working distance, as well as gaining an understanding of the potential interactions between light and vital dyes commonly used in vitreoretinal surgery.

Light-induced damage of retinal pigment epithelial (RPE) cells place through 3 different mechanisms: (i) photomechanical, (ii) photothermal, or (iii) photochemical. Photomechanical damage occurs when intense pulsed laser radiation produces vaporization, fragmentation, or disruption of retinal tissue. Thermal injury appears when the tissue temperature is raised more than 10 °C above usual, leading to protein denaturation, loss of tertiary structure of macromolecules, and fluidization of cell membranes. Photochemical harm occurs when high photon energies break molecular chemical bonds, causing free radical formation and increasing the levels of oxidative stress.

Complication 2. ILM Dyes. In addition, light induced into the eye during a ILM surgery has been studied as a possible cause for retinal pigment epithelial (RPE) cells damage especially when dye is (typically) induced, due to its absorption spectrum (700-800 nm) in front of the emission spectrum of current light sources employed in halogen and xenon light sources (380-760 nm). Some authors attributed an enhanced toxic effect of ICG staining with intense light exposure of an ILM surgery, such that some scientists have proposed to remove the sodium from the solvent for the dye preparation in order to reduce the cytotoxicity.

Because the ILM is thin and transparent, surgical remotion can become technically challenging even for experienced surgeons especially in difficult cases such as myopic macular hole or foveoschisis. Staining of the ILM with adjuvant dyes can make the procedure easier to perform and more effective, also reducing the operating time and the mechanical trauma to the retina. Several authors have reported the use of indocyanine green (ICG) and trypan blue for assisted ILM peeling in macular hole (MH) surgery but concerns soon appeared when evidence from several clinical reports and in vitro toxicity showed worse visual outcomes with both dyes.

In experimental models, it was demonstrated that subretinal delivery of ICG was able to induce as much RPE as photoreceptor and outer nuclear layer damage, especially if the eye was air filled. It has been hypothesized that the RPE damage could be related to direct toxicity of the dye to these cells. Persistence of the dye seen as fluorescence at the optic disk has been detected in eyes in which ICG was employed up to 2 years after the macular surgery.

Section C. Proposed New Methodology for Extraction of IML's with Camtrx and ORLenz.

Solution 1 Using Less Light with Camtrx. Ocutrx's dual 6K all-digital microscope “Camtrx™” uses sensors that are up to 10× better at capturing images than any other competitor (Alcon, Zeiss, Leica) (“Competitors” herein). This means that the same ILM surgery can be done with as much as 10× less light which reduces the incidence of light toxicity. In addition, the Camtrx sensors can capture up to 69 billion possible colors with its 12-bit sensors, while the 10-bit imaging on Alcon and Zeiss Standard Optical Microscopes can only sense and project up to 1 billion possible colors. Thus, the amount of light needed for ILM retinal surgery may be reduced by an estimated 10× while increasing the contrast and color of both the ILM and underlying healthy retinal surface.

Solution 2. Better Edge Detection. The main reason for dye injection during a ILM surgery is to help the surgeon determine the size and area of the ERM. However, with Camtrx's magnification (optical and digital) a surgeon may obtain 3D imaging of the ILM with clarity down to 4 microns. In addition, Camtrx has two methods to enhance the edges of the ILM.

Pixel Shifting for Hyperacuity Imaging. First, using Camtrx's Pixel-Shifting algorithms “edges” of the ERM can be identified by the Camtrx integrated Processing System by characterizing sub-pixel colors and contrast changes using Computer Vision techniques such as: Thresholding, Pixel/Dexel Classification, Color Detection, Object Detection, Semantic Segmentation and Negative Imaging. This is made possible by the billions of potential colors and the resolution of Camtrx which can detect colors, and differences in colors, some not even distinguishable by the human eye. Once categorized into an identifiable mapping, the model controller can highlight the edges of the ILM using a superimposed overlay on the live video feed.

The term Computer Vision is a catchall interdisciplinary scientific field that deals with how computers can gain high-level understanding from digital images or videos, beyond what a human can recognize or understand. The Ocutrx Computer Vision tasks include methods for acquiring, processing, analyzing, and understanding digital images or video, and extraction of high-dimensional data in order to produce pixel, dexel (sub-pixel), numerical, or symbolic information, which can used as analysis of the real-world information for specific characteristics.

The Camtrx Computer Vision is the CPU/GUP activated portion of the Dynatrx™ Operating System which provides the automatic extraction, analysis, and re-rendering of understanding of useful information from a single image or a sequence of images (See, Aperture Azimuth Rotation, below). It then takes this information and applies it to an algorithmic logic to achieve an instantaneous new visual understanding of the image or video presented to the viewer. The Camtrx version of Computer Vision processing keys on the algorithms that extract information from images or video and turns it into useful enhanced information for the project at hand. This enhanced image data can take many forms, such as video sequencing, views from multiple angles or cameras, or multi-dimensional data from a 3D imaging.

Pixel Shifting for Narrow FOV. Second, the Camtrx Dynatrx technology is also the mechanism underlying visual hyperacuity involving the imagery viewed including Pixel Shift which is a method in digital cameras for producing a super resolution image in a narrow field-of-view. The method works by taking several images, after each such capture moving (“shifting”) the sensor to a new position to produce a hyperacuity image or video.

Additional ILM Highlighting with AAR. The Camtrx 3D microscope uses an additional aspect of Aperture Azimuth Rotation (AAR) to enable the 3DADM to intermittently interrupt the live surgery video feed (when activated by the surgeon) to take a still image at 0 degrees aperture azimuth, then pivot the aperture azimuth 90 degrees for another image. These images are then “stitched” into a comprised single image in less than 1 second. Once this process has concluded, the resulting composite image is superimposed (Superimposed Overlaid Image or SOI) over the resuming live video feed and a better identification of the ILM edges may be understood.

Picture-on-Picture Feature. On a surgeon's command during the surgery, this superimposition can either remain in view as an overlay permanently or temporarily or be dissolved or replaced. As the surgeon proceeds with the removal of the ILM watching the 3D live video feed, the surgeon can, at any time, chose to refresh the SOI for an updated view of the remaining edges. This picture-on-picture SOI may be repeated as many times as necessary as the surgeon continues to peal the ILM so that the remaining areas of the “edges” are always highlighted with updates. Camtrx also can employ aperture azimuth rotation (AAR) which works by changing both the light distribution and camera angle from 0 degrees azimuth to 90 degrees azimuth, which provides alternate views of the same image extending over multiple adjacent pixels. This capability enables improved 3D perception of various structures by oversampling and creating a higher resolution composite image. This AAR technique can highlight tissues including inclined narrow structures such as an edge of retinal tear or a thin-film of tissue that could be otherwise difficult to perceive without this azimuth/angular change.

While some contrasts would be evident with a single sensor, with dual sensors one can calculate the extrinsic rotations of the three-dimensional angles captured by dual sensors to enhance areas to be identified by a quantum amount. This Stereoplotter technology is what allows the surgeon to observe previously difficult to see contours and features.

The Computer Vision Processor identifies the coordinate system x, y, z and calculates the light diffraction and color differentiation of the edges and projects a superimposed image of the composite of 3D imaging as an overlay on the streaming surgery video.

Picture-in-Picture Zoom Feature. When a surgeon begins to zoom in or magnify an image, a picture-in-picture will appear, which allows the user to keep their orientation and understand where they are located within the whole image. Fig. X Picture-in-Picture technology in the 3DADM system permits a surgeon to simultaneously watch two images or videos (primary and secondary). As the Primary Picture (the zoomed area) fills the entire screen or projection across a lens, the secondary picture automatically appears as a floating window pinned to a corner of the screen which permits the surgeon to keep tabs on what is happening in zoomed image and the larger FOV at one time. The Primary Picture is a digital image created by the Datrix Operating System and is viewable on the StereoLenz or an ORLenz Surgery headset.

The original digital signal is always maintained (stored) the in software, and as the magnification is increased a digitally reference copy of the Primary Picture appears once the user begins to zoom, and the image or video on the display becomes the primary picture, and a smaller screen will appear as the secondary picture. The centers of two related maps indicate the same x, y, z coordinates. The Secondary Picture map represents the area on a smaller scale, and while the Primary Picture is a digitally magnified image of the area of interest the Secondary Picture reminds the operator where he is zoomed to the “big picture”.

This utility is designed to simplify identifying where the viewer is in relation to the non-zoomed image. This feature permits the user to examine the same region of the image with different zoom levels with respect to the whole image before it was magnified. Through software and the controller, each picture is a dynamically linked map that follow the along same coordinates. Changing the coordinates of the center on one of them leads to an automatic displacement of the center in the same point of the second and a coordinate display unit informs of the current coordinates. Thus, when a user begins to magnify or zoom in on an image or video, a Secondary Picture appears on the StereoLenz or ORLenz headset or another 3D viewport and the larger, magnified image becomes the Primary Picture. The Primary Picture is magnified as specified by the user while the Secondary Picture captures the original coordinates of the Primary Picture before it was magnified. Through software control and menu selection, the Secondary Picture can be pinned to either the top left corner, top right corner, bottom left corner, or bottom right corner depending on the surgeon's preference, and can be shifted to a new location using virtual touch commands.

The Secondary image is a digitally altered subsampling of the primary image. Thus, the Secondary image fills the viewport showing a surgeon their region of interest, while the primary image is placed in a corner of the viewport to serve as an overall map of the complete FOV. The position of the secondary image is then indicated on the primary image via an overlay, whether varying capacity monochrome or color. Digital altering of the primary image can include digital zooming, color contrast enhancement, color picking, or other video processing system that is useful for the surgery.

Simulated OCT. The ORLenz utilizes Retinal Mapping Topography, which accurately maps the surface of the retina, increasing surgical information and improving patient safety.

### Ocutrx OR-Bot 3D Holographic Surgery Microscope and its Multi-Spectral Imaging™ Definitions: Including Key Terms, Industry Jargon, and Technical Concepts.

Area-of-Interest: In a video context, as used in this Paper, an “area-of-interest” (AOI) or “region-of-interest” (ROI) refers to a specific part of the video frame that the system focuses on to analyze, for processing or analysis purposes. AOIs/ROIs allow the LightField3D process to pinpoint specific regions within a video for detailed analysis or processing, rather than analyzing the entire frame.

Birefringence Detection and Analysis (BDA): BDA is also known as double refraction, is a method of identifying materials by their intrinsic birefringence, where light splits into two paths upon entering an anisotropic material, due to different refractive indices for different polarizations. Birefringence is also a means to measure optical anisotropy. It is defined as the maximum algebraic difference between two refractive indices measured in two perpendicular directions. As used in this Paper, BDA is the process of detecting in anisotropic materials, like human tissue (skin, ligaments and tendons, bone, and skeletal muscle) properties like skin lesions, collagen, cancerous tissues.

Blood Transparency: Blood transparency is the OR-Bot's method of turning blood in a AOI translucent or clear in real-time and combining that “see-through” visualization within a video. As described herein, a surgeon using the OR-Bot has the ability to “turn-on” the Blood Transparency subsystem and make the blood in a specific AOI appear transparent so that the tissue underneath is visible to the user.

Calibrated Volume of Interest (CVI): CVI refers to a specific, defined space within a system's view focused on an Area-of-Interest which is calibrated for a particular type of motion or measurement, output, or modulation, ensuring accurate and precise data capture and display.

Common Reference Framework (CRF); CRF is a 3D map created by the multiple sensors and their relation to the VOI and what corrections are required to map image sensors, depth fiducial and sensor depth data onto that framework.

Convolution Operation: Convolution Operations are mathematical operations used to combine two signals or functions, often used in image processing and signal processing tasks like filtering, modulating, combining, blurring, resolution enhancement, or edge detection.

Dynatrx™ Operating System: The Dynatrx operating system is an Ocutrx developed process and system within the OR-Bot's CPU and GPU that uses algorithms, and a set of instructions, to perform all the calculations and operations of the device. It is the engine that together with ECT provides the OR-Bot features, such as, (i) Super-Resolution (ii) Tomography; (ii) Blood Transparency; (iv) Birefringence Detection and Analysis; (v) Occlusion Insensitivity; (vi) Hyperspectral Tissue Imaging; (vii) Auto-Calibration; (viii) Depth Mapping; (ix) Extended Depth-of-Field; (x) Perspective and Presentation Control; (xi) View Geometry (xii) Super Magnification; (xiii) Picture-in-Picture; and (xiv) the Robotic Guidance System.

Elastic Convolution Transforms (ECT): ECTs are a hardware implementation friendly architecture for efficient, high quality, real-time, low latency signal processing that enables generalized programs to provide general “optical perfecting” and high quality resampling of multiple 2D sensor perspectives, allowing constructive perspective merging and depth analysis of that data into a high resolution 3D abstraction, followed by user specified rotation, translation, projection, filtering and formatting to provide selected viewing perspectives along with user specified data annotations all formatted for display on 2D and 3D output devices. ECT operations are typically configured by a software based optical calibration process, or software generated control provided by interactive user interface selection. ECTs can be dynamically configured by the output of other ECTs which allows rapid response to changes such as calculation of 3D depth and occlusion profiles, or iterative optimization algorithms such as are employed in image noise reduction or multiple perspective merge operations for super-resolution. However, in some applications, Ocutrx also uses CNN's for final image development. In essence, ECT is an elastic image capture, modulate, and reconstruction real-time method using algorithm-based position-specific convolution operations for signal processing, enabling flexible transformations of spatial-spectral characteristics with sub-pixel precision. ETC is used in the Camtrx 2.0 to address the need for elastic (arbitrarily stretched or compressed image sizes) transformation of a source image to a destination output image at minimal latency. The Camtrx 2.0 LightField3D Dynatrx video processing with ECT can produce video from capture to display with a latency well under 1/10 of a frame time or less than 20 milliseconds. The Ocutrx ECT architecture is an image processing building block developed to construct complex real time, ultra-low latency image processing systems in the OR-Bot. It supports many common image processing operations efficiently including arbitrary high quality off sample grid high quality resampling, pixel location specific optical corrections of modulated transfer function, focus, shape and frequency response, general frequency response filtering, nonlinear and directional filtering, histogram correction, noise reduction, gamma conversions, color conversions, 2D wavelet transforms, depth analysis, specialized nonlinear and directional filtering and ability to rotate, project and render 3D image data to various formats for display.

Hyperspectral Tissue Analysis (HSI): Hyperspectral tissue analysis is a non-invasive imaging spectroscopy to capture detailed spectral data from tissues, enabling non-invasive analysis of tissue characteristics, composition, and even subtle changes related to disease or injury.

IMU: Inertial Measurement Units (IMU) are fundamental components in modern navigation and motion tracking systems, including, but not limited to: MEMS, FOG, and RLGs.

Isosbestic Point: An isosbestic point is a specific wavelength where the absorbance of two or more chemical species is the same. An isosbestic point (from Greek “isos” meaning equal and “sbestos” meaning extinguishable) is a wavelength where the absorption spectra of two or more species intersect.

Light Field: Light field camera systems capture light rays from all directions, allowing for the creation of 3D images and the ability to adjust focus after capture. Light field cameras typically employ a microlens array in front of a single image sensor to capture light rays from multiple angles. Light Field traditionally describes the volumetric information of scenes by representing the intensity and frequency of light propagating in all directions through all points in space. A light field defines the light as a five-dimensional plenoptic function that characterizes typical x. y, z, planes and adds both angular degrees of freedom of light rays. When all of the dimensions of this function are captured, the comprehensive characterization of the light field allows for additional freedom for image processing and display, as compared to the constrained information captured by a stereoscopic 3D video system

Ocutrx LightField3D™ Imaging: The key differences in the OR-Bot's version of “light field” and the known technique is the acquisition method, where multiple discrete cameras, sensors, lasers, and/or IMU's are used versus a single camera with Microlens Array. A key advantage is that a multiple sensor approach maintains full digital resolution. In addition, the OR-Bot's novel approach maintains high base resolution and can achieve Super-Resolution, in contrast to traditional lightfield cameras which sacrifice spatial resolution for angular information. Another enhancement over typical light field systems is that the OR-Bot can enhance the display output. While both types of light field technologies can output to lightfield displays, the teaching of this patent has more flexibility in output formats and can generate enhanced views beyond what was directly captured, through intermediate algorithm modulation.

MAC: Means the multiple angle capture (MAC) sensors in the Camtrx microscope, which are placed in a calibrated sensor array.

Micro Lens Array: A microlens array is a grid-like structure composed of numerous small lenses, typically arranged in a regular pattern, used for various optical applications, such as beam shaping, light collection, light field 3D, and other imaging.

Multi-Sensor Multi-Spatial Tomography (MSMST): MSMST (Multi-Sensor Volumetric Tomography) is a non-coherent tomographic method of producing three-dimensional images of the internal structures of a solid object (such as the human body) by creating cross-sectional tissue images using multiple sensors. It includes Hyperspectral tissue analysis where the OR-Bot uses selected light wave lengths individually or in combination to highlight specific tissues; or uses vector operator or homomorphic filtering to accentuate features, tissues, or disease processes.

Occlusion Insensitivity (OD): Occlusion Insensitivity (OI) is a technique that enables visualization of a surgical field despite the presence of occluding structures. Through depth analysis, the system identifies occlusions unique to individual perspectives or positioned above the Volume-of-Interest (VOI). A low-resolution occlusion mask is generated for affected perspective views, which guides the perspective merge process. The system can either completely eliminate occluded regions or render them as semi-transparent overlays based on user preference. This process leverages redundant information from multiple perspectives to reconstruct occluded areas, ensuring continuous, uninterrupted visualization of the surgical field even when instruments, hands, or other objects would normally block the view.

Optical Modulation Transfer Function (MTF): MTF is a measure of how well an optical system (like a lens or set of lenses working together) can transfer contrast from an object to its image, quantified as a function of spatial frequency wavelength and position in the field of view, and is used to assess the performance of optical systems. MTF quantifies the ability of an optical system to reproduce the contrast of minute details (high spatial frequencies) in an image compared to the original object. A perfect optical system would have an MTF of 1 (or 100%) at all spatial frequencies, meaning it perfectly preserves contrast. However, real-world systems have limitations, and their MTF decreases with increasing spatial frequency, indicating a loss of contrast at finer details.

Optical Coherence Tomography (OCT): Optical Coherence Tomography, is a non-invasive technique that uses coherent light to create cross-sectional images of the retina and other tissues, aiding in the diagnosis and management of various eye and other medical conditions. OCT utilizes the principle of interferometry, where light beams are bounced off the tissue and a reference mirror, and the interference patterns are analyzed to create an image.

Perspective Interpolation: Perspective interpolation, as used in this Paper is the technique that ensures attributes like texture coordinates and colors are interpolated in a way that accounts for the perspective distortion introduced by 3D projections, preventing artifacts when rendering 3D scenes. When rendering 3D objects, attributes like texture coordinates are interpolated between the vertices of a triangle. However, if this interpolation is done directly in 2D, it can lead to artifacts, especially when dealing with perspective projections, as the distance between vertices affects how they appear on the screen. Instead of directly interpolating attributes, Ocutrx interpolates the attributes divided by the depth (or the reciprocal of the z-coordinate). This ensures that the interpolation is correct in the 3D space, even after the perspective projection. Thus, without perspective-correct interpolation, you might see artifacts like seams or distortions in textures, especially when viewing 3D objects from different angles or distances.

Plenoptic: Plenoptic, in common jargon, means relating to capture and display of the entire light field. One application is the display of computationally derived images from a given angular source or signal, with multiple images on the same monitor or display. The key differences in the OR-Bot's application of “plenoptic” is the acquisition method, where multiple discrete cameras and/or sensors and/or lasers, and/or UMI's are used versus a single camera with Microlens Array, which is typical in the common use of “plenoptic”.

Sensors: Sensor, as used in this Paper means information capturing and sending modules such as near infrared sensors, near ultraviolet sensors, and visible light sensors (from 250 nanometers to 1,000 nanometers), time-of-flight sensors, LIDAR sensors, IMU sensors, and/or laser sensors.

### SOM: Standard Optical Microscope.

Super-Resolution: Means a higher resolution than originally captured by one single sensor. It is the combination of interpolated perspectives to produce the combined or final interpolated viewing perspective. Ocutrx has developed the Super-Resolution technique in the Camtrx 2.0 microscope. Basically, it is a direct consequence of geometric construction of multiple captured images, much like the 360 degree “stitching” video technology. Thus, an area-of-interest viewed by the Camtrx microscope will have regions at various angles, various viewing perspectives and varying resolutions for that AOI. Regions which are nearly perpendicular to a particular perspective view axis will have the highest resolution, while regions of the AOI which are nearly parallel to a particular perspective view will have low or potentially no resolution. Thus, we can create an interpolated view from a relatively low-resolution region for which high resolution data is available from another view. Then we use our algorithms to “replace” the lower region data with higher resolution data. If display resolutions higher than source resolutions are desired, an on-demand continuous range of scaling of the interpolated perspective resolution which provides Super-Resolution is accessible.

Vector Domain Filtering (VDF): VDF filtering is algorithms that control a set of effects that can be applied to video footage to enhance its visual appeal. These effects can range from simple color corrections to complex visual transformations and merging of disparate images. Filters are used to adjust the brightness, contrast, saturation, and hue of the video footage. This is done through algorithms or sections of code that are designed to examine each input or output request for certain qualifying criteria and then process or forward it accordingly.

Volume-of-Interest (VOI): The VOI is the area or volume that a motion capture system, imaging system, or other measurement device focuses on and calibrates to ensure accurate data collection. Typically, VOI is the AOI throughout the depth of field in a volumetric format.

### The OR-Bot 3D Holographic Surgery Microscope

### A Brief History of Surgical Microscopes

The Standard Optical Microscope (SOM) has been used to provide exclusively optical visualization during surgery for over a century while the basic operating principles have remained unchanged. The typical SOMs used in surgeries, such as ophthalmic micro-laparoscopic surgeries, are also referred to as a light microscope. A light microscope is a type that commonly uses visible light and a system of lenses to generate magnified images of small objects. The design of the SOM is one of the oldest designs around and were possibly invented in their present compound form in the 17th century. Formerly, it was commonly known that there were three basic types of microscopes: (i) optical, (ii) charged particle (electron and ion), and (iii) scanning probe.

Large manufacturers of the surgery SOMs include Zeiss, Alcon, Leica, Prescott, and others. Some of these manufacturers have recently added a digital component whereby digital cameras replace human vision as the primary sensing mechanism. This creates a rudimentary digital-optical hybrid microscope that replicates the standard optical technologies used in the SOM to generate a stereoscopic digital image. Because each of these companies are relying on their legacy models to build on a digital element, the digital is limited by the optics which are primarily designed for viewing with the naked eye. Thus, in the marketplace the digital add-on to a SOM, which primarily provides optical magnification and zoom, is limited. Most SOM's manufacturers typically boast 8-10× zoom but a limited field-of-view and depth-of-field dependent on magnification.

Moreover, the resolution limit of optical microscopes at very-high magnifications are limited by diffraction which distorts the image in a known manner, transforming sharp points into fuzzy rings known as “Airy” discs. Out-of-focus light from points outside the focal plane further reduces image clarity. These abnormalities can be magnified when viewed through a 3D monitor that requires 3D glasses. Moreover, the smaller pixels found in the Competitor's sensors require that their “signal” must be “boosted” which is post-processing that adds both lag-time and fuzziness. Alcon and Zeiss each offer a 4K monitor that requires 3D glasses, which is about 12-year-old technology, the system is even more limited, however, when it is placed four or more feet away (as is the typical configuration), and the resolution is divided between the two eyes, a surgeon is likely only get about 1K or less of resolution.

Some of the known limitations of the legacy SOMs vis-à-vis the OR-Bot microscope include:
The most obvious disadvantage of a SOM is that it needs a very bright light to see microscopically, while digital microscopes can provide good image contrast in approximately 2× lower light. This digital factor is especially advantageous for retinal surgery where bright lights can limit surgery time and cause damage to the retina.
A camera-aided SOM, being a light microscope, exhibits resolution limited by diffraction from each sub aperture.
The typical SOM is limited by its optical zoom functionality, typically 6× as with Alcon, Zeiss and Leica. Digital microscopes, however, can supplement or replace optical zoom with digital zoom capabilities. When utilizing the digital zoom capabilities depth of field is maintained.
A SOM with cameras added cannot provide the best three-dimensional renderings. Although when using a stereoscopic 3D SOM, you can see 3D depth thanks to the fact that you are receiving two slightly different views of the object you are studying, the distance is based on maximum Interpupillary Distance (IPD) of a human's eye and doesn't equate well with a video stereoscopic image, while an all-digital microscope like the Ocutrx OR-Bot 3D Holographic microscope can magnify up to 240 times, and can apply disparity 3D imaging algorithms which makes for better quality holographic 3D, so the SOM 3D is no comparison to a digital microscope set up for 3D imaging.
A SOM requires the user to have an expectation of what/where the user wants to find, meaning that at high zoom, the perspective tends to be lost, while with a digital microscope, you can have a picture-in-picture which always references where you are in the larger structure to be viewed.
While a greater pixel count can contribute to enhanced resolution, it is essential to acknowledge that resolution is ultimately limited by the optical path and other factors. Ocutrx, unconstrained by traditional optics and digital camera limitations present in many competitive offerings, has developed an innovative 3D holographic surgical microscope.
The human visual system is polarization insensitive and limited to visible wavelengths. Digital systems are not constrained by these limitations and can supplement true color images with this additional spectral information.

There has been much interest in digitally enhanced surgical microscopes a few of which have recently entered the market, however, they continue to operate based on the principle of the SOM; i.e. a common main objective with two optical channels where cameras are used in place of the eye pieces, otherwise known as tube lenses.

In contrast, technology has been developed by Ocutrx in the area of light field image capture particularly for use in the field of surgery. The increased richness of the data acquired by light field technology enables computational imaging to take advantage of the angular information contained in the recorded light rays which is not available to traditional digital imaging. This enables, for example, the reconstruction of the three-dimensional surface of the object being viewed and, therefore, the generation of a multitude of perspectives for image analysis and display.

### OR-Bot Description and Use

### Product Overview

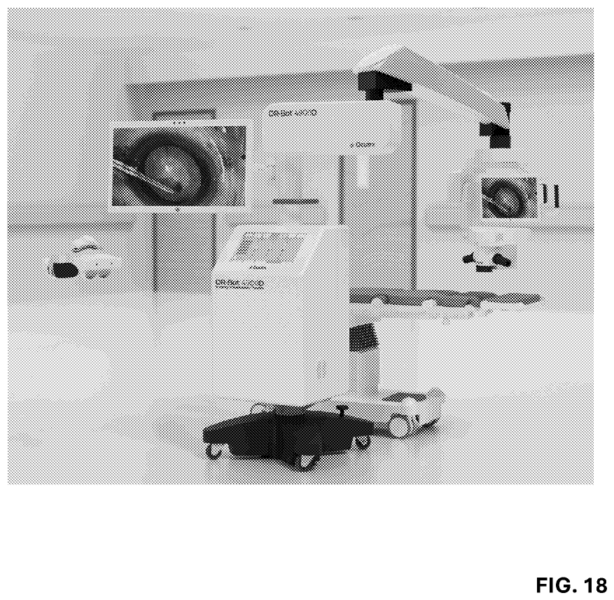

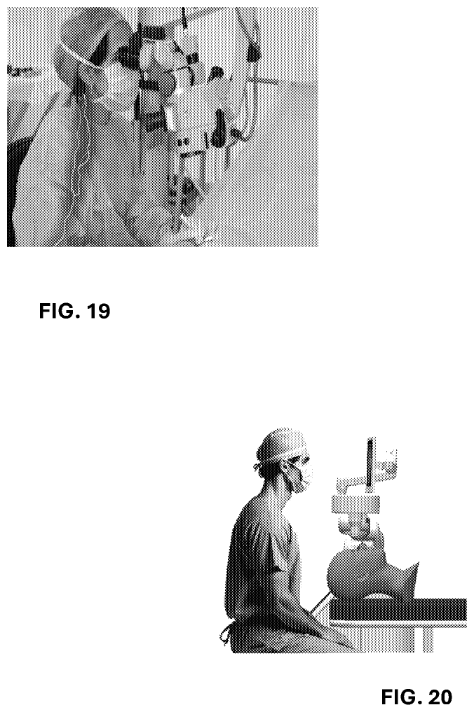

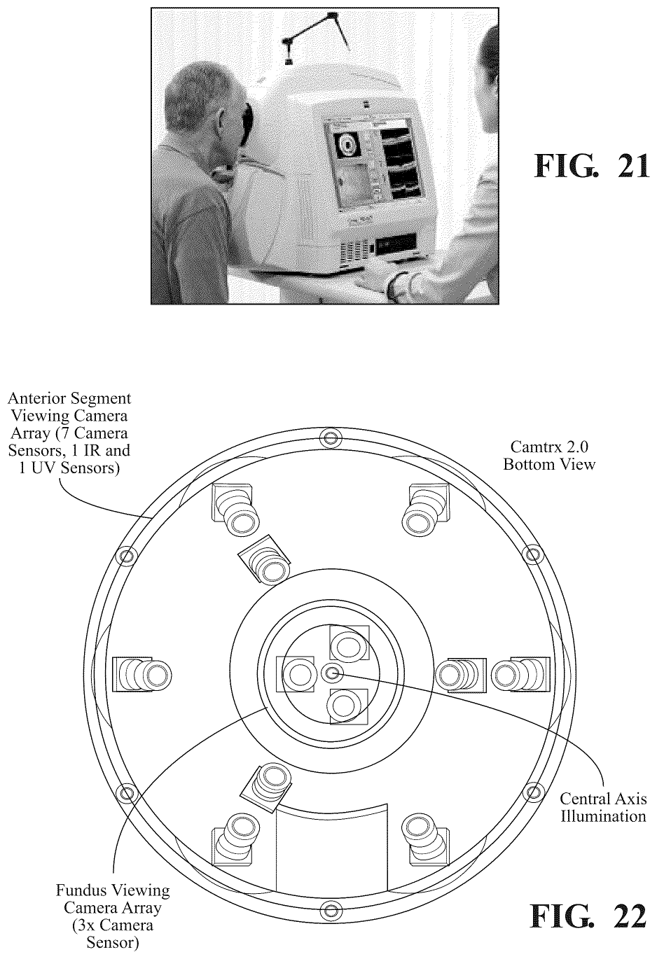

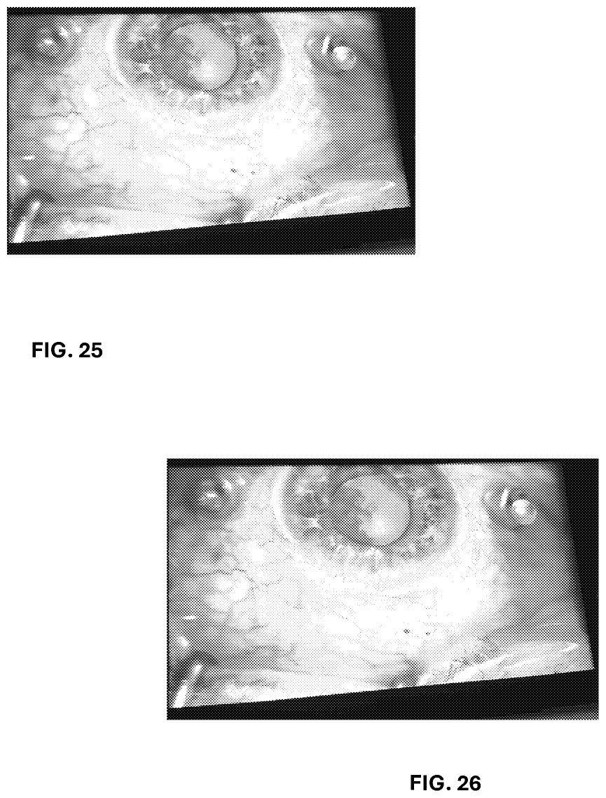

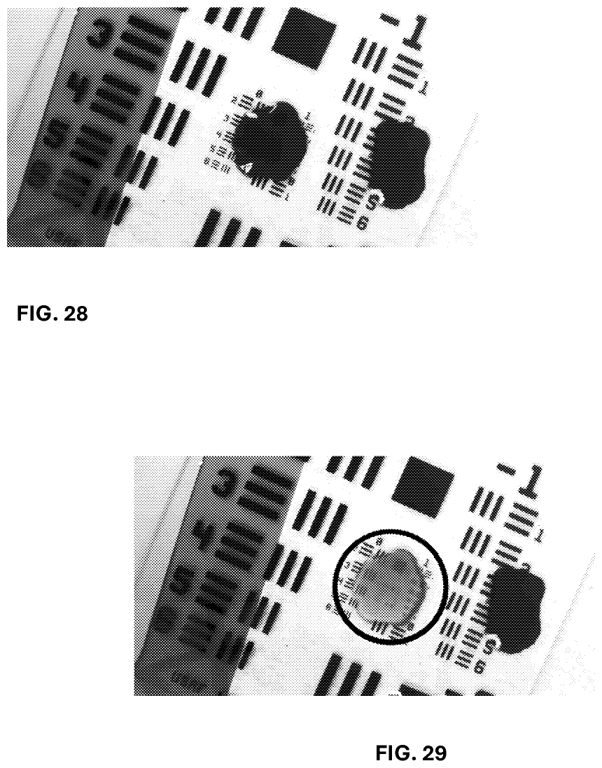

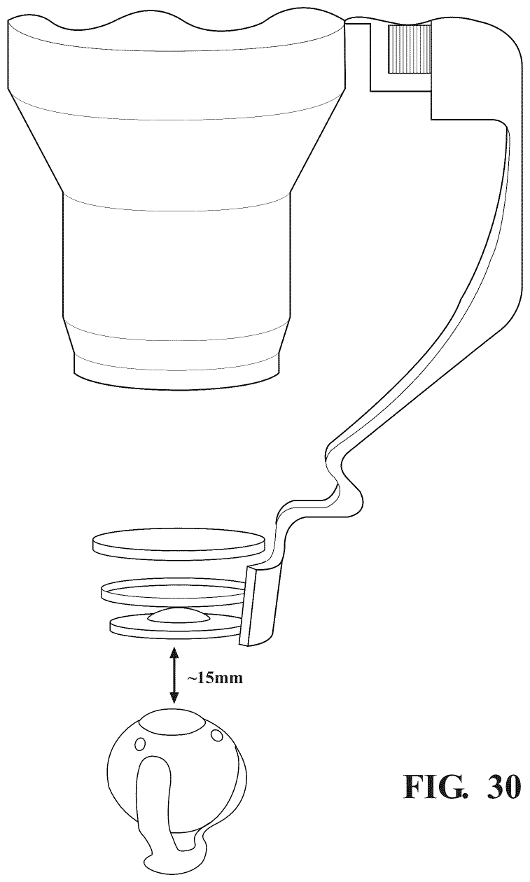

The new hyperspectral and multi-spectral next-generation of tomographic imaging processes are embedded in the Ocutrx all digital OR-Bot 3D Holographic Surgery Microscope (see FIGS. 18-31), which is intended for the operating room. The user population includes surgeons, clinicians, nurses, techs, and assistants. The typical environment would be in a surgery suite (OR) or in clinical diagnostic applications. Some of the surgeries which could benefit from the visualization innovations of the OR-Bot are:
Ophthalmic: Posterior Segment Surgery & Anterior Segment Surgery.
General Surgery
Cardiothoracic
Gynecology Obstetrics
Gynecologic Oncology
Neurosurgery
Spine Surgery
Orthopedic Surgery

The OR-Bot is an “all-digital” surgery holographic 3D visualization system which provides two (2) optional methods of viewing a surgery microscope feed in 3D.

Ocutrx is the only manufacturer offering the surgeon these two 3D viewing options; and the only company offering “glasses free” 3D monitors.

Further, the OR-Bot separates the existing standard optical microscope (SOM) “oculars” from the viewing experience, with its new Camtrx™2.0 3D microscope which is so small that the monitors are situated right in front of the surgeon's eyes and face. This is so that a surgeon's posture is no longer tied to the optics which force a surgeon to strain. This corrects the problem of legacy SOM's poor ergonomics, which produce back and neck strain and pain. On the other hand, the OR-Bot's optics/viewing independence gives the surgeon the opportunity for superior posture during surgeries which will result in less painful operations for a busy surgeon. Ocutrx's motto is, “keeping surgeries painless for the Surgeon™”.

The OR-Bot is a real-time light field 3D video imaging and display system which Ocutrx calls its LightField3D™ System.

It is controlled by the Dynatrx Operating System. The image capture system is presented on a plenoptic monitor in real-time on a holographic 3D monitor; or it can be augmented to a stereoscopic 3D system and displayed on a stereoscopic 3D monitor; or it can be augmented to display on a 2D monitor. The OR-Bot's digital system offers three unique visualization options depending on the surgeon's preference which are:
ORLenz® 5K Surgery AR/XR Headset; or
LightField3D holographic 8K autostereoscopic “Glasses-Free” Monitor (for surgeon viewing); and
StereoLenz™ 8K Autostereoscopic 3D “glasses free” Monitor (for nurse and tech viewing)

The OR-Bot comes with a cabinet, arm and an XY auto positioning system, computer monitoring/control system, and a foot pedal. There are two versions, one with an overhanging arm, and one with an underpinning arm.

### Unique Features of the LightField3D Imaging

The OR-Bot's plenoptic multi-sensor array with multiple perspectives enables:
Resistance to occlusions (fingers, tools, blood) between volume of interest and sensors
Can present occlusions as translucent clear areas allowing good view and contrast in the volume of interest underlying the overlaying object or tissue
Occlusion detection and processing allows complete occlusion elimination if desired.
Much improved depth information and depth perception
Multiple perspective view angles provide an abundance of 3D surface information which enables increased precise surface depth analysis, presentation and visualization
Provides multiple perspective view angles provide an abundance of surface texture, color, and contrast information for processing and enhancement, resulting in a more meaningful visualization.
Provides multi-view calibration & correction, analysis, and information merge followed by rendering the desired perspectives provides new degrees of freedom for image presentation to the user
Real time position, rotation, translation, zoom, and focal length selection and real time motion path animation to guide robotics on all of these parameters
Options to select and generate the presentation view provide the user with a profound new viewing and inspection experience. The user can easily zoom in on an area of interest, do a “fly over” for instance, of the fundus from a perspective inside the eye, exaggerate perspective, alter the viewing angle to see under or around occlusions, increase magnification by controlling zoom and adjusting any of the supported parameters.
Options to augment the visual field with digitally created 3D features such as highlights, outlines, indicators, notes, preoperative data, etc.
Audio, visual, and/or tactile indications of object spacing for precise instrument control and collision warning.
Provides a holographic 3D display in real-time (less than 20 milliseconds) that creates an intuitive, more natural visualization experience unmatched by existing digital viewing implementations and SOMs
Provides a holographic 3D display in real-time (less than 20 milliseconds)
Can output the display on a Lightfield3D monitor, stereoscopic 3D headset, or conventional video monitor technology
Resulting video views can be output to multiple monitors and displays
Advanced Filtering control provides the user with a unique range of image processing and viewing selection opportunities
Provides Vector Domain Filtering to enhance certain luminance or color gradients, or frequency domain filtering to reduce noise, enhance contrast or specific structures
Provides auto-calibration which collects specific relative placement and angular orientation, optical MTF function, optical geometric distortion, and optical depth-focus response
   The Problems with Existing OCT and OR-Bot's Solutions

As set out below, the Camtrx sensor's combined derived depth information from its multiple sensors can create a high-resolution depth map of the entire field-of-view or an AOI. Unlike traditional OCT the Ocutrx surface mapping is an overlay on the actual microscope view. As an improvement to OCT it uses the multi-sensor approach, as set out above, rather than extracting depth solely from reflected coherent probing and lateral information from various scanning patterns. It is infeasible to extract a reasonable latency volumetric image using scanning techniques, so real-time OCT must present a planar cross-sectional image as opposed to a complete volume. Thus, the OR-Bot can be used for diagnostic data such as preoperative OCT which, unlike traditional OCT, can be overlaid on the three-dimensional image for subsurface feature display. This means a surgeon does not have to view two separate monitors to get all the information. With OR-Bot, both preoperative and intraoperative details available at once as a calibrated overlay, which the surgeon can choose to “dial-up or dial-down” while watching the visible range surgery video.

All current OCT systems rely on complex interferometric designs that require precise optical alignment and coherent light sources. A traditional OCT scan is a procedure that involves using reflected visible light from a low-power laser to obtain images of a tissue like a retina—the principle is similar to ultrasound but uses light instead of sound. While these systems deliver viable clinical and surgical value, their complexity creates significant barriers to widespread adoption and cost constraints hinder their application to specialized settings. Some of the other problems with existing OCT, excluding high-costs, are: mirror artifacts (inverted artifacts); vignetting, or cut edge artifact; misalignment, or off-center artifact, or grid decentration artifact; out of range error, or out of register artifact; blink artifact; motion artifact; or segmentation error.

Some of the ophthalmic diagnostic and surgery indications for an OCT are:
Macular hole
Macular pucker/epiretinal membrane
Vitreomacular traction
Macular edema and exudates
Detachments of the neurosensory retina
Detachments of the retinal pigment epithelium (e.g., central serous chorioretinopathy or age-related macular degeneration)
Retinoschisis
Pachycormid
Choroidal tumors

Other current non-coherent imaging approaches in the market include:
Multispectral/Hyperspectral Imaging (MSI/HSI): These systems capture data across multiple spectral bands, providing compositional information about tissues, but typically lack the depth resolution of OCT and primarily offer surface imaging.
Snapshot Spectral Systems: Emerging technologies use diffractive optical networks or filter arrays to perform single-shot multispectral imaging, but most cannot provide true depth-resolved information.
Hybrid Approaches: Some researchers have experimented with combining spectroscopy with other modalities like photoacoustic imaging to enhance tissue differentiation, but these systems are still complex and expensive.

What is notably absent from the current landscape is a practical solution that offers both the depth resolution capabilities of OCT and the rich compositional data of spectral imaging. Ocutrx Multi-Sensor Volumetric Tomography (MSVT)

The Ocutrx approach fills this market gap by combining two powerful and novel techniques:
Multi-perspective camera array—Using 8-20 strategically positioned sensors and cameras that capture the same volume from different angles, Ocutrx can create an inherent ability to extract depth information; and
Synchronized spectral illumination-Pulsing different wavelengths of light in precise timing with sensor integration to capture how tissues respond to specific spectral bands.
By integrating perspective-based depth estimation with spectral differential analysis, MSVT achieves volumetric imaging without the need for interferometric components, significantly reducing system complexity while maintaining clinical utility. To accomplish this feat Ocutrx's Dynatrx Operating System uses ECT as an elastic image reconstruction real-time method using algorithm-based position-specific convolution operations for signal processing, enabling flexible transformations of spatial-spectral characteristics with sub-pixel precision.

### Key Technical Advantages

The microelectronic and biomedical engineers at the Genius Labs have crafted a number of compelling technical, clinical and surgical advantages in using the OR-Bot.

Depth Extraction Without Interferometry: By analyzing perspective differences between our camera array, MSMST can generate depth information without the complex optical arrangements required by OCT.

Material Differentiation: Different tissues respond uniquely to specific wavelengths. MSMST captures these “spectral fingerprints” to identify tissue types and visualize boundaries that may be invisible to conventional imaging.

Real-Time Processing: Our proprietary algorithms merge spatial and spectral information with minimal latency, enabling clinicians to visualize subsurface structures during procedures as an option or overlay.

### Competitive Positioning and Margin Potential

While existing multispectral imaging technologies can detect tissue composition differences, they typically lack the depth resolution needed for clinical subsurface imaging. Conversely, OCT provides excellent depth resolution but limited spectral information about tissue composition.

MSVT bridges this gap, offering:
Comprehensive volumetric data
Depth resolution sufficient for clinical decision-making
Through-tissue imaging to visualize subsurface features
Rich spectral information for tissue characterization
Real-time operation capability

The simplification of the optical architecture translates to significantly lower component costs compared to traditional OCT systems. Despite this cost advantage, the clinical value delivered remains comparable to high-end OCT for many applications. This unique value proposition creates the opportunity for substantially higher margins than existing imaging systems, while still offering a compelling price point to healthcare providers.

### Protected Technology

MSVT builds upon Ocutrx's existing patent portfolio covering multiple aspects of our multi-perspective imaging system, with specifically protected innovations in:
The camera array configuration and calibration methodology
Synchronized spectral illumination techniques
The processing pipeline that fuses spatial and spectral information

### Target Applications

Initial clinical applications are outlined here where MSVT shows particular promise:
Ophthalmology: Visualizing retinal layers and identifying pathologies with comparable clinical utility to OCT
Dermatology: Looking beneath the skin surface to evaluate lesions and visualize margins without invasive procedures
Surgical Guidance: Providing real-time subsurface visualization during procedures to identify critical structures

Ocutrx MSVT represents a fundamental rethinking of volumetric imaging for medical applications. By delivering valuable clinical insights at a new price-performance point, we are positioned to expand the addressable market significantly beyond what current OCT systems can reach, while maintaining strong margin potential. The OR-Bot Subsystems

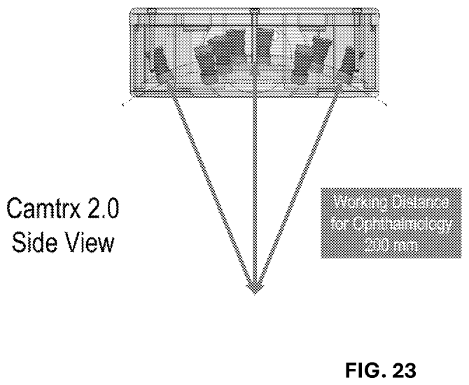

### Camtrx 2.0 Multi-Sensor Microscope & Holographic Display (FIGS. 22-23)

Camtrx Light field imaging has several advantages as compared to traditional two-dimensional imaging all other surgery microscope manufacturers use. Among these are 3D holographic display, depth, and feature recognition, digital refocusing and autofocus, occlusion insensitivity, increased depth-of-field and—the ability to turn blood translucent or clear.

The Camtrx microscope is a plenoptic light field microscope assembly which includes a microscope housing, a multiple source perspective lightfield camera and various sensors array including a plurality of sensors mounted to the microscope housing, an objective lens assembly mounted to the microscope housing and configured to direct all or many light rays from a volume of interest (subject, source, or image) to each of the sensors, and a microscope controller coupled to the plenoptic display device with the resulting video played in holographic 3D. One way the microscope is unique is that it houses a multiple of visual, infrared and ultraviolet sensors, lasers, and various filters depending on the need and type of surgery. The mechanical fixture holding sensors, optics, and depth measurement components maintain alignment of the critical components to typically a 1/10s. Camtrx Lightfield3D™ microscope platform. The current system already employs an array of 8-20 cameras sensors, and lasers configured around a central axis, with individual optical axes converging at a point on the primary axis at the bottom center of the volume of interest. This existing architecture provides an ideal foundation for our non-coherent tomographic imaging approach.

The Genius Labs photonic engineers carefully crafted the Camtrx sensors so each captured a different and highly calculated angle perspective. In some instances, the image may be an overlapping image perspective of the volume of interest or source, which generates a surface depth map of the VOI. This is based on the corrected perspective view image data, generating CVI intermediate image signal data for each plenoptic camera by mapping corresponding video frame perspective image data onto the generated surface depth map, and generating sole source interpolated perspectives views for each plenoptic camera based on corresponding CVI image data for each plenoptic camera.

The imaging system created by the Genius Lab photonic engineers increases the richness of the data acquired by Camtrx multi-sensor light field technology as compared with any other microscope. This improvement in the art enables computational imaging to take advantage of the pre-calculated angular information contained in the recorded light rays which are not available to traditional digital imaging. This enables, for example, the reconstruction of the three-dimensional surface of the object being viewed and therefore, the generation of a multitude of perspectives for image analysis and display. Likewise, the perspective range of the physical separation between the sensors in the multiple sensor array provides greater perspective differences than can typically be extracted from a single-lens lightfield camera.

Also, the LightField3D imaging system (hardware, software, and firmware) performs a method of creating a 3D color mesh using a sampling of the plenoptic function derived from the different perspectives recorded by the sensors along with a method of generating an array of images of the 3D color mesh for use in constructing the holographic video image.

The Camtrx microscope includes a computer/controller for storing computer-executable instructions for ECT, and one or more processors for executing the computer-executable instructions for performing proprietary algorithm processing for rendering 3D video images of the AOI onto the holographic monitor. The algorithm processing can also include executing from option controls the surgeon can initiate, which includes executable tasks such as video frames with part visible light camera sensors combined with part near-infrared sensors.

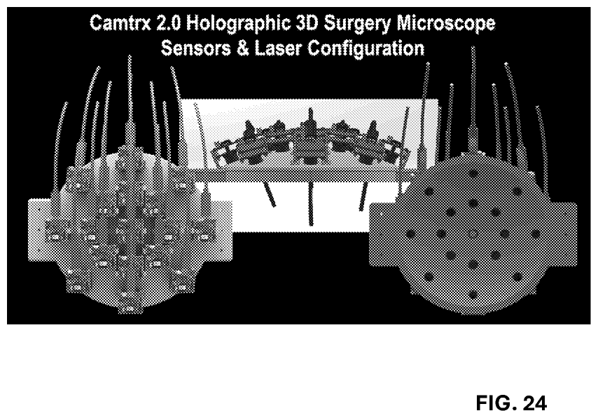

### The LightField3D Holographic Monitor (FIGS. 24-26)

The LightField3D Holographic Monitor creates a multi-view representation of the 4D light field by projecting light. Unlike standard 2-dimensional displays which require only one perspective view and autostereoscopic displays which require two, the Ocutrx OR-Bot incorporates the LightField3D Holographic Monitor which utilizes 45 separate perspective views to create a seamless holographic volumetric image. The Dynatrx Operating System is uniquely suited to generate these required views in surgical microscopy. The is viewable in real time by any number of observers while retaining certain visual queues whose absence renders traditional 3D imaging techniques fatiguing and uncomfortable. The overall visualization experience is relaxed and intuitive, creating the closest approximation of a real-world scene that can be rendered by modern digital technologies.

The LightField3D imaging system includes a monitor for displaying Three-dimensional (3D) video images. The one or more processors then perform the algorithm steps of merging the single or multiple source interpolated perspectives views into a desired output perspective view of the volume of interest, generating formatted output data based on image parameters of the display device, and displaying the controller desired output The real-time plenoptic display then gives a holographic video perspective view of the volume of interest on the display device using the formatted output data. Thus, viewers can see a slightly different viewpoint depending on their position vis-à-vis the display. In one embodiment of the invention the display presents forty-five (45) different images on the same display using lenslets on the single display monitor. When executed by the one or more processors the computer-executable instructions cause the one or more processors to perform an algorithm for rendering 3D video images of the volume of interest onto the monitor. monitors display a “3D” image by optically filtering selected views based upon viewing angle. The OR-Bot LightField3D monitor displays an interleaved array of 45 different perspectives of the combined captured image(s) which present the appropriate perspectives by directional optical filtering and the actual eye positions and angles of view. The Dynatrx operating system processing required to generate interpolated perspective views is largely proportional to the number of pixels desired. The primary increase in computational throughput over a stereoscopic view result from all source perspectives being active concurrently, and the additional formatting required for the output stream. The LightField3D display uses an “off-the-shelf” 2D 8K display monitor coupled with a proprietary front projection modulation panel to synthesize parallax images, offering a sense of depth and realism which looks holographic. And the resulting view is holographic without having to wear 3D glasses.

### The Dynatrx Operating System and Features

The Dynatrx Operating System executes several key processes with ultra-low latency providing real-time visualization of the surgical VOI. These processes include hyperspectral multi-perspective image acquisition, multiple volumetric tomographic model synthesis, feature identification, digital model augmentation many-view 2-dimensional image output and a user-facing control interface. Working in concert, the various processes offer surgeons and operating room attendants a feature rich, yet natural and intuitive visualization experience wholly unmatched by existing paradigms.

In order to perform all of its other functions, Dynatrx must interface with an imaging system, which provides high-resolution 2D images. This system may operate using a variety of optical and spectral modalities, such as visible spectrum colorized images, one or more narrow band infrared images and/or polarization sensitive images. Regardless of the imaging methodology, the imaging system must obtain multiple synchronized perspective views of the same VOI. The Camtrx 2.0 Multi-Sensor Microscope is the imaging system used in the Ocutrx OR-Bot; however this does not imply Dynatrx is limited by the particular methods of image acquisition. Dynatrx will continue to seamlessly integrate with new imaging techniques as they emerge.

Unique to Dynatrx is a process by which virtual 3D tomographic models are created using the various perspective views obtained by the imaging system. To generate these models, Dynatrx uses the ECT approach, which is typically implemented as a stream process, minimizing local storage requirements and making process steps independent of sensor frame integration time. Because multiple perspectives are used to generate the virtual model, the fidelity of the model is far more robust than is obtainable with stereoscopic images. By generating such 3D models for multiple imaging modalities, a composite model can be obtained which overlays the multiple models on top of each other. The comprehensive tomographic models of the VOI, as generated above, enable the detection of various features in 3 dimensions. Using a combination of spectral and hyperspectral contrast, boundaries between features in the VOI, such as tissue, fluids, pathologies, tools, implants and foreign objects. are used to identify sub-volumes with arbitrarily irregular surface geometry. This is in contrast to traditional digital imaging which is limited to the identification of the perimeter of an area. With these sub-volumes identified, the algorithms used by Dynatrx can sustain computational awareness of the geometric relationship between distinctive features in real time. The applications made possible by feature detection include image augmentation, tactile and/or audio feedback, pathology diagnosis, dynamic surgical plan adaptation and even autonomous robotic intervention.

Due to continuous updates to feature detection, it is possible to dynamically incorporate digital enhancements as part of the VOI. Based on user settings and live operator instructions, these enhancements in 3D space can optionally include pathology highlights, spacing indicators, text notations, 2D chart or video projection, tool transparency, preoperative volumetric data, implant placement markers, etc. In addition, Dynatrx can use selective composite model overlay expression, where the virtual 3D tomographic models representing different spectral modalities are “activated” for specific regions of the VOI. This creates a tomographic model which may include transparent monochrome regions where blood is present, and visible spectrum, colorized images where blood is absent. Further, 3D models generated by various hyperspectral techniques may be selectively applied to create, for example, regions which exhibit subsurface structures like blood vessels, bones and nerves.

The previous processes result in a single volumetric tomographic model which is synthesized from various perspectives and digitally augmented in real time. Because this is a fully realized 3D model, a series of virtual cameras can be used to simulate 2D perspective views of the VOI which are converted into a selectable standardized image file format. As the cameras are virtual they can be arranged around or within the VOI in any configuration. This allows for user operated viewing parameters like VOI orientation, adjustable depth perception, depth of field adjustment, dynamic zoom and subsurface rendering that cannot be replicated by traditional stereoscopic techniques. While these images can be utilized by any commercial display, the Ocutrx OR-Bot is equipped with a revolutionary holographic display system, the LightField3D Holographic monitor.

Finally, as opposed to the SOM or even current digital imaging technology, Dynatrx does not simply display a representation of the VOI. As detailed above, Dynatrx interfaces with the operator to dynamically tailor the visualization experience to the specific requirements of the procedure and operator. This is accomplished by a user facing control interface which uses video, audio and/or tactile inputs and outputs to communicate with the operator. Methods of interaction that are available as user controls include touchscreen interface, voice commands, SLAM technology, foot pedals, gesture recognition, eye tracking and hand tracking. Methods of relaying user feedback include digital augmentation of the VOI, traditional display methods, verbal instructions, haptic technology, audio signals and warning lights.

### The OR-Bot Hyperspectral Image Engine

### A New Way to Gather Information—Dynatrx and HIS

The Genius Lab photonic and biomedical engineers created an HSI monitoring system in the OR-Bot, which can provide insights into microcirculatory, tissue and organ perfusion, which is important for assessing the selected tissue or blood. Each pixel in a hyperspectral image or video frame contains a spectrum, revealing the unique “fingerprint” of the material or tissue at that location. When directed light from the OR-Bot interacts with tissue, it is either absorbed, reflected, and/or scattered in specific ways depending on the tissue's composition and properties. HSI captures these interactions and analyzes the resulting spectral data to identify and characterize different tissues, cell types, and even molecular components.

The Dynatrx combination of hardware and software developed creates a hyperspectral imaging system which operates within an extended optical spectrum spanning from near-ultraviolet (NUV) (approximately 250 nm) through the visible spectrum (400-750 nm) to near-infrared (NIR) at approximately 1000 nm, with particular emphasis on the 750-950 nm NIR “window” where biological tissues exhibit distinctive optical properties. The HIS engine employs a hybrid sensor configuration wherein there are a number of visible light sensors combined with broad-spectrum sensors sensitive to wavelengths from 250 nm to 1000 nm.

The HSI engine includes narrow-band illumination sources, and light-emitting diodes (LEDs) with approximately 10 nm spectral width, or lasers, which provide specific wavelength illumination across the extended spectrum. Key illumination bands include primary visible wavelengths (450 nm, 550 nm, 650 nm±5 nm), critical NIR bands (810 nm, 830 nm, 850 nm) for hemoglobin transparency, and specific wavelengths for collagen detection (520-570 nm). The illumination system incorporates synchronization with sensor integration time, enabling pulsed/feedback operations for differential imaging techniques. Individual spectral bands can be independently controlled for intensity and timing, allowing sequential or simultaneous multi-spectral illumination patterns.

The Genius Lab photonic engineers created optical filters and polarization components in the OR-Bot for spectral selectivity. NIR pass filters, narrow band-pass filters, and an interchangeable filter system accommodate different clinical applications. Polarizers for light sources and analyzers for camera lenses enable cross-polarization techniques critical for birefringence detection, and analysis particularly in the 520-570 nm range used for collagen structure visualization.

An expanded auto-calibration system accommodates the extended spectral range, utilizing specialized calibration targets with spectral reference materials. The calibration process measures sensor response curves for each spectral band, corrects for chromatic aberration across the extended spectrum, and calibrates polarization response characteristics.

The image processing pipeline incorporates separate paths for visible and extended spectrum data, with specific functions for crosstalk elimination between spectral channels and dark current/flat-field correction for each spectral band. Differential analysis algorithms process synchronized frames acquired with different illumination spectra to enhance feature extraction through background subtraction and comparative analysis.

Another tissue identification and evaluation is possible with the Ocutrx Hyperspectral approach. The Genius Lab bioengineers have created a method to have the Camtrx “ping” tissues with pulse lighting which is captured in a visible light sensor and NIR. Differential “reply” responses to specific wavelengths in the visible or extended spectrum are useful to highlight structures of interest or make specific components such as hemoglobin appear to be transparent, for example. Many components of tissue are best viewed in near infrared (NIR) optical wavelengths to avoid excess absorption by hemoglobin and water. In particular the spectrum from about 750 nm to 950 nm is particularly attractive for surgical use. In addition, tissue-specific spectral signature detection Dynatrx algorithms identify structures based on their unique spectral or biometric characteristics, with specialized functions for collagen birefringence detection, hemoglobin transparency tissue mapping, and Cytochrome C detection for tissue viability assessment.

The Dynatrx Operating Systems can also determine pseudo-color, which refers to remapping visible or non-visible optical wavelengths or their correlations or anti-correlations into wavelengths which are recognized visually. Near-ultraviolet (NUV) visible and near-infrared (NIR) as well as coupled or differential responses can be mapped into the human visual perception, to allow human vision to “see” specific tissues, or “see through” blood, for example.

### Tissue Tomography—Pulse Response and Illumination

The Multi-Sensor Volumetric Tomography system is an extension of our existing Camtrx technology in the OR-Bot. The implementation will utilize the current camera arrangement, maintaining approximately 10 degrees of separation between adjacent perspectives, but with strategic displacement across both X and Y axes within the viewing cone. This configuration enables optimal capture of parallax information for depth extraction while ensuring sufficient spectral sampling across the field of view. The cameras will be positioned to maximize the balance between perspective diversity and field overlap, providing the necessary data for robust volumetric reconstruction.

The Genius Lab bioengineers have figured out how to extend the current system's auto-calibration process to include spectral characteristics across multiple wavelengths. The existing calibration infrastructure already collects data for position, orientation, optical distortion, and MTF correction, which we will augment to include spectral response calibration. This comprehensive calibration ensures accurate registration between perspectives and wavelengths, critical for the spectral differential analysis at the heart of our approach.

For the illumination system, we will implement synchronized spectral lighting that pulses different wavelengths in coordination with sensor integration times. This approach allows us to capture differential responses between wavelengths, revealing subtle variations in tissue characteristics that would be invisible to conventional imaging. The illumination system will support near-infrared and potentially near-ultraviolet wavelengths alongside the visible spectrum, enabling enhanced tissue discrimination based on their unique spectral signatures.

The processing pipeline will be built upon our existing Elastic Convolution Transform (ECT) framework, which already provides geometric correction, perspective interpolation, and focus optimization. We will extend this framework to incorporate the additional spectral dimension, implementing depth extraction algorithms that leverage both perspective differences and spectral cues. The “iterative depth cost” approach documented in our system will be enhanced to incorporate spectral differential information, producing high-resolution depth maps while maintaining low processing latency.

For data fusion and volumetric reconstruction, we will implement a merit-based approach that combines information from multiple perspectives based on viewing angle, surface orientation, and spectral quality. This approach allows the system to prioritize the highest-quality information at each point in the volume, producing optimal results even when some perspectives may have limitations due to occlusions or reflections. The final volumetric representation will incorporate both structural and compositional information, allowing clinicians to visualize tissue boundaries and characteristics simultaneously.

The user interface will build upon our existing visualization capabilities, allowing clinicians to navigate through the reconstructed volume, adjust viewing angles, control enhancement filters, and select display formats according to their preferences. The system will support output to various display types, including stereoscopic headsets, light field monitors, and conventional video formats, providing flexibility for different clinical environments.

### Auto-Calibration

Auto-calibration is the systematic process that characterizes and compensates for the physical positioning, optical properties, and performance parameters of all imaging components. The system uses a specifically designed test pattern with fiducial markers that are swept through precise z-axis positions within the full volume of interest. For each perspective sensor, the system records the apparent position, size, and distortion of these markers, creating a comprehensive calibration dataset that maps distortion correction parameters as a function of x, y, z position. These parameters include per-pixel, per-wavelength correction factors for MTF (Modulated Transfer Function), geometric distortion, and intensity profile. This enables precise alignment of multiple perspectives while reducing mechanical precision requirements, as the system can compensate for manufacturing variations, misalignments, and thermal effects through software correction rather than requiring extreme mechanical precision.

### Extended Depth-of-Field

Extended Depth-of-Field is the capability to maintain focus clarity across a much greater depth range than is optically possible with conventional lenses. The system applies depth-specific Elastic Convolution Transform (ECT) operations that implement position-dependent deconvolution filters to compensate for the optical point spread function at different depths. By applying specific convolution parameters for different depth increments, the system effectively creates a computationally extended focal range many times greater than the natural depth of field of the optical components. This allows surgeons to maintain clear visualization of structures at different depths simultaneously without needing to physically refocus, significantly enhancing procedural efficiency and reducing the risk of missing critical details outside the natural focal plane.

### Perspective and Presentation Control

Perspective and Presentation Control is the functionality that allows operators to manipulate how the acquired multi-perspective image data is visualized. The system constructs a calibrated 3D model using 8-10 perspective views, allowing the user to dynamically navigate using six degrees of freedom (x, y, z translation and roll, pitch, yaw rotation). Images can be rendered from any arbitrary viewpoint with real-time perspective correction. Processing parameters can include frequency domain filters with adjustable bandwidth (0.5-2.5 octaves), homomorphic filters with up to 100:1 dynamic range expansion, and vector curl angle modulation with 10-50% modulation depth for texture enhancement. This separation of image acquisition from presentation enables surgeons to examine structures from angles physically impossible with conventional microscopes, while maintaining consistent orientation reference and applying visual enhancement techniques tailored to specific tissue visualization requirements.

### View Geometry

View Geometry refers to the spatial arrangement and optical configuration of the multiple image sensors that capture different perspectives of the field of interest. The system uses an array of sensors arranged in a semi-spherical configuration. Each sensor is positioned to have its optical axis pass through a common convergence point in the center of the volume of interest. Sensors are typically arranged with 10-20° separation in orientation sampling, with a 2:1 aspect ratio of their viewing ellipses aligned to provide optimal frequency coverage for merged super-resolution processing. This geometric arrangement determines the system's capabilities for occlusion handling, depth mapping, and perspective analysis, with specific configurations optimized for different surgical applications based on the expected field size, required depth range, and anticipated occlusion challenges.

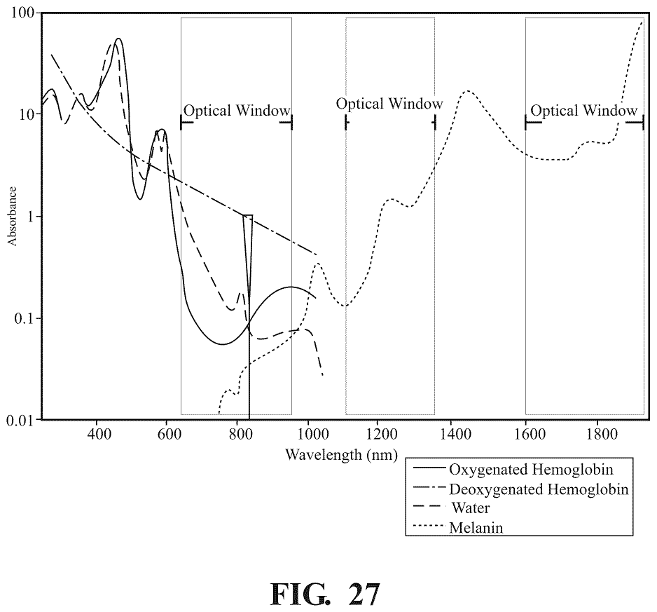

### Blood Transparency (FIGS. 27-29)

For over a century, surgical imaging has been reliant on relaying a real image directly to a pair of eyes. Thus, visualization in the operating room has been restricted by the limitations of the human visual system-eyes and magnification. With the advent of digital sensing, unexplored techniques using optical properties in combination with digital image processing can lead to enhanced visual perception in real time.

In examination, the Genius Lab bioengineers found that human blood samples exhibit very strong effective attenuation in visible wavelengths. Hence, bleeding during a surgical procedure can critically degrade the accessible contrast necessary for the identification of tissue features and pathologies. With healthy human blood, the absorption and scattering are both dominated by the presence of hemoglobin.

Hemoglobin, the primary oxygen-carrying protein in blood, presents a significant visibility challenge in surgical visualization due to its high optical absorption across the visible spectrum (400-750 nm). This high absorption results in substantial opacity of blood at even minimal thicknesses, severely limiting visibility of underlying tissues during surgical procedures, particularly in neurosurgery where bleeding is common and visualization of delicate neural structures is critical. Moreover, of the two options of removing the blood, suction and irrigation, only irrigation is viable in neurosurgeries because suction would remove brain cells. Yet, sometime irrigation does not do well due to the stickiness of brain blood. Of particular interest is the optical properties of hemoglobin in the presence or near-infrared illumination, where the attenuation is much weaker than in visible wavelengths. In addition, there is an Isosbestic Point in the wavelengths in this region, at about 810 nm, where the attenuation of oxygenated and deoxygenated hemoglobin converges. At this NIR wavelength, imaging through blood exhibits relatively low attenuation and insensitivity to oxygen concentration leading to improved contrast of tissue obscured by arterial or venous blood. The Genius Lab techs have discovered that NIR light can penetrate blood to a much greater degree than visible light, making this capability particularly valuable for procedures where blood might otherwise obscure the surgical field. Thus, the ECT hyperspectral imaging extant in this system specifically addresses this challenge by exploiting a critical physical property of hemoglobin: its dramatic reduction in optical absorption within specific NIR wavelength bands.

A spectroscopic analysis indicates that hemoglobin exhibits approximately 100 to 1000 times lower absorption in the 750-850 nm range compared to visible wavelengths, with a particular transparency “window” centered around 810 nm. This physical phenomenon creates an opportunity to effectively “see through” blood that would be completely opaque in conventional visible light imaging. NIR from about 750 nm to 850 nm is 100 to 1000 times more transparent to hemoglobin than visible light is. Using NIR imaging on this wavelength to provide some or all of the presented luminance information would provide a window through blood to the obscured tissue. It does not matter if the blood is oxygenated or deoxygenated. The OR-Bot system implements this capability through precisely calibrated narrow-band NIR illumination sources centered at 810 nm (+5 nm), with additional supporting bands at 830 nm and 850 nm to provide complementary spectral information. These wavelengths are carefully selected at the sensor signal level prior to the step where a visual frame is created to maximize hemoglobin transparency while maintaining adequate tissue contrast and sensor sensitivity. Specialized processing algorithms enhance the hemoglobin transparency effect by creating a synthesized pseudo-color visualization derived from the NIR spectral bands.

However, due to the presence of minimal ambient radiation in the near infrared, a light source must be introduced to illuminate the field to attain sufficient brightness of the obscured area. An unwanted consequence of the use of such a light source is specular reflection, which must be diffused.

Light incident on the surface of a blood sample will reflect such that a magnified version of the light source will be imaged with sufficient brightness to saturate the sensitivity of a sensor. To mitigate this problem, Ocutrx introduced a polarizing filter to the light source. Reflected light will maintain the polarization of the incident light, so a second polarizing filter, oriented perpendicular to the first, serves to eliminate specular reflections while attenuating scattered radiation from both the blood and posterior tissue by only 50%.

While the attenuation of the light through blood at 810 nm is dominated by absorption, scattering plays a significant role in image quality. Light scattering throughout the blood volume creates artifacts which degrade contrast in the image of the underlying tissue. However, awareness of this scattering enables the use of ECT image processing techniques to recover a substantial portion of the resolvable contrast. In this way, high resolution imaging of tissue obscured by blood is achieved.

Using multiple digital sensors, the contrast recovered as described above can be used to triangulate the location of features such as various tissue, pathologies and surface structure in 3-dimensional space. Using a sufficient number of sensors, even obscuring artifacts, such as a surgical tool, does not impede triangulation of various features. This allows for the construction of a real time tomographic model of the visual field, which is insensitive to the presence or introduction of blood.

Further, by using visible wavelength cameras, this model can be enhanced with an overlay colorizing the portion of the field unobscured by blood. The creation of such a ECT tomographic model enables novel avenues of user visualization, feature recognition and pathology identification of tissue hidden by blood despite its opacity to visual perception. Put simply a surgeon may view the normal visible image combined with the NIR image that makes blood clear.

The Dynatrx system can selectively replace visible-spectrum luminance information that would otherwise exist in a visible video frame and replaces the same with NIR-derived data while maintaining chrominance information from visible channels, and combining the two or more images creating a natural-appearing image that reveals structures behind or beneath blood. The Dynatrx Operating System then is able to take discrete area images from both sets of sensors and merge them at the signal lever to provide a modulated output, where the Surgeon can select an AOI within which to turn the blood clear by combining NIR portions of the video frame with visible light portions of the video frame.

Thus, variable operator controls can “blend” the imaging to have “two views” and adjust the contribution of visible and NIR spectral components, enabling them to optimize the visualization for specific surgical situations. For superficial bleeding, a partial blend may be preferable, while for visualization through substantial blood accumulation, a higher weighting of NIR information to the combined image provides maximum transparency. The OR-Bot accomplishes blood transparency by using two different sets of sensors. One set is a visual range camera and the other is a Near-Infrared (NIR) sensor.

Displayed output pseudo-color components could be obtained from specific spectral components in the NIR window as well, if desirable. Displayed output pseudo-color components could be obtained from specific spectral components in the NIR window as well, if desirable.

So far the Genius Lab engineers have been able to “see” through up to 5-7 mm. Remember, the 810 nm is where the oxygenated blood and deoxygenated blood visibility window converges. Although one should only see oxygenated blood outside a vein there is a variable. When you go lower than 810 nm it is better for deoxygenated blood, and when you go higher it is better for oxygenated blood. The IR sensor we selected can be dialed up or down to go from 650 nm up to 900 nm. So, the engineers created a metric where the surgeon can dial the IR up and down to get the best “see through” depending on the oxygenation of the blood in view.

In addition, filters for the light and diminishing scatter is of great importance. Filters and wavelengths for the light to best do away with as much “scatter” as possible so deeper is clearer, In this way we can determine the strength, intensity, and filtering of the wavelength of the light we need. Next, the surgeon metric permits a surgeon to be able to dial up or down the IR sensor for “searching” for best results, because what we are dealing with is both deoxygenated and oxygenated blood. Ocutrx's optical Engineer and photonics engineers are developing the technique to deal with (define) the scatter, which then we can use an inverse algorithm of that scatter which will allow us to “erase” the remaining scatter and quantify/recreate what is behind the blood.

### Surface Depth and Volumetric Mapping

The multi-sensor array also can generate a surface depth map of the VOI based on the corrected perspective view image data, generating a CVI data for each plenoptic camera by mapping corresponding video frame perspective image data onto the generated surface depth map, and generating sole source interpolated perspectives views. The auto calibration data is used to generate ECT programming to convert these various image sensor data sets onto this common reference framework. Depth and mapping processing consists of depth image sensor sampling, followed by depth analysis and finally calibration to the 3D CRF reference space. Depth analysis is done by local frequency component analysis. The raw depth grid is then mapped to the 3D CRF using auto calibration data.

Depth analysis also consists of dividing the depth image into overlapping tiles, windowing the tile to highlight central data, transforming the tile using a sample to frequency domain transform, masking to access the desired frequency components, and then using either a depth of focus, focal point spread or geometric projection line spread analysis to map the frequency data into depth data. Depth data can be significantly lower resolution than image pixel resolution. For example, if a roughly 1 mm depth resolution is adequate, a 50 mm diameter region of interest would easily be covered by a 100×100 depth data point grid. If a 2000×2000-pixel depth image sensor is used, 40×40 pixel overlapping tiles would be satisfactory for depth extraction.

Depth map calibration into 3D CRF is done by the ECT and control program created for that purpose using auto-calibration data. This compensates for any positioning, orientation, geometric or optical distortion detected during auto calibration.

Image data is collected from a number of image sensors covering a number of perspectives. Each image perspective has its own ECT and program which converts that image data combined with the 3D CRF version of the current depth map into 3D CRF space. Some image filtering and image enhancement operations can be folded into this transform to provide these capabilities with no increase in latency.

The surface depth map and corrected image perspectives are used to interpolate the required output perspectives using the 3D CRF image and depth data and the ECT transforms and controlling data sets generation from output From this the Dynatrx operating system creates occlusion identification, occlusion processing and a merit based geometric super-resolution is achieved with a relatively low depth map resolution with on the order of 0.5 to 1 mm quantification using an iterative depth algorithm. this invention

### Depth Mapping

The Genius Lab photonic engineers constructed the Camtrx Lightfield3D™ Microscope to utilize multiple perspective views to provide the ability to see around or through occlusions (hands and tools, etc.) above the surface of interest. This involves constructively combining the various perspective views which require the development of a depth map and gradient map. To create a depth map, information from the multiple-sensor array provides the geometric information, rather than extracting depth solely from angular information. Likewise, the perspective range of the physical separation between the sensors in the multiple-sensor array provides greater perspective differences than can typically be extracted from a single-lens lightfield camera. A surface depth measurement process collects depth image sensor data, then analyzes it for depth information and then uses an ECT program using auto-calibration data to map that depth map data onto the CRF, by removing any geometric or optical distortion. This depth information is critical to the analysis of source image perspectives as well as generation of interpolated output perspectives. Likewise, the perspective range of the physical separation between the sensors in the MAC sensor array provides greater perspective differences than can typically be extracted from a single-lens lightfield camera. An accurate surface depth map in the CRF is critical for the 3D analysis of the image sensor source perspective correction ECT programs as well as the following perspective interpolation ECT programs. A surface depth measurement process collects depth image sensor data, then analyzes it for depth information and then uses an ECT program using auto-calibration data to map that depth map data onto the CRF, by removing any geometric or optical distortion. This depth information is critical to the analysis of source image perspectives as well as generation of interpolated output perspectives. Thus, the Camtrx sensor derived depth information can use various methods to create a high-resolution depth map, rather than extracting depth solely from angular information.

The Dynatrx and ECT also permit for input perspective correction. The required input geometric and optical distortion for each image sensor is known from autocalibration. With this data, the ECT transform control code to calibrate input image sensor data and depth data into 3D CRF format can be produced. The output perspectives are generated from the 3D CRF image perspectives and depth map data.

The required output perspectives are known when the output option is selected by user option/configuration. This provides the data to generate the individual ECT programs for each interpolated perspective. The Camtrx Lightfield3D™ Microscope employs a sophisticated depth analysis processing pipeline that forms the core of its advanced surgical imaging capabilities. This system leverages multiple complementary approaches that can work independently or in concert to achieve unprecedented visualization in surgical environments. At the foundation of the depth system is a correlation-based multi-perspective analysis that utilizes 3-20 cameras arranged around a central viewing axis. Unlike traditional stereo systems with only two perspectives, this multi-perspective approach significantly improves robustness against occlusions and increases depth accuracy by analyzing corresponding regions between numerous perspective pairs. The system intelligently combines information from adjacent and diagonal perspective pairs, providing complementary information particularly valuable for identifying and handling occlusions that might otherwise obscure critical surgical areas.

A significant enhancement to the traditional correlation approach is the application of vector curl angle analysis, which computes gradient relationships between adjacent pixels and has proven particularly effective for enhancing subtle texture variations that might be imperceptible in direct intensity comparisons. This technique transforms regions with minimal visible textures into data-rich surfaces by emphasizing changes in gradient direction rather than intensity, making it especially valuable for surgical applications where tissue surfaces may appear relatively homogeneous in direct lighting but contain subtle textural information that can be amplified through gradient analysis. This enhancement significantly reduces ambiguity in challenging surfaces, providing more reliable depth estimates in areas that would otherwise create difficulties for correlation methods.

The iterative depth cost algorithm represents the core advancement for achieving high-resolution depth mapping while maintaining reasonable processing latency. This approach treats depth estimation as an optimization problem, seeking the depth values that minimize a “cost” associated with mismatches between multiple perspectives. The algorithm functions through several carefully designed strategies to maintain efficiency. First, it uses the depth map from the previous frame as an initial estimate, taking advantage of temporal coherence in most surgical scenarios. This dramatically reduces the search space and accelerates convergence for typical surgical procedures where movement is relatively constrained. Second, the algorithm employs a multi-resolution approach, starting with a low-resolution depth estimate and progressively refining it at higher resolutions. Third, and perhaps most innovatively, the algorithm employs a “sliding stripe” processing methodology that dramatically reduces latency by processing the image in bands that progress through the entire field. This stripe-based approach enables the system to begin processing the next iteration before the current one has completed, creating a pipeline of operations that significantly reduces overall latency.

An optional CNN-based depth processing component represents a complementary approach that can be particularly valuable for challenging cases. This neural approach uses a multi-band Gabor wavelet decomposition of the source perspectives to manage computational complexity while still achieving high-resolution depth estimates. The neural processing functions through a hierarchical process that mirrors the multi-resolution strategy in the iterative depth cost algorithm, beginning with analysis at a significantly reduced resolution and progressively refining it at higher resolutions. A distinctive advantage of the neural approach is its ability to incorporate learnable constraints about physical tissue properties and surgical conditions, potentially reducing ambiguity through contextual understanding. The system carefully constrains the neural component to focus on direct signal processing rather than high-level abstraction, avoiding potential hallucination problems that could otherwise introduce risk in surgical applications.

The integration of multi-spectral capabilities enhances the depth analysis from surface mapping to volumetric subsurface visualization. This is accomplished by incorporating sensors sensitive to wavelengths beyond the visible spectrum, particularly in the near-infrared range (750-950 nm). The multi-spectral approach allows the system to perform differential analysis based on how different wavelengths interact with and penetrate tissue.

Beyond simple penetration, the multi-spectral analysis enables sophisticated tissue differentiation through detecting specific optical signatures. For example, myelin's birefringence effect can be detected and used to identify nerve fibers, while Cytochrome C's specific spectral response allows differentiation between viable and non-viable neural tissue. For ophthalmological applications, the system can identify structures like collagen in epiretinal membranes through their unique birefringent polarization properties without requiring contrast agents or dyes.

The practical implementation of the Camtrx depth analysis system emphasizes flexibility and adaptability. The various depth analysis methods can be employed individually or in combination based on the specific requirements of the surgical procedure, with trade-offs between processing speed, depth resolution, and feature identification. Basic procedures might use simpler correlation approaches with minimal iterations to provide rapid visualization with moderate depth resolution of 0.5-1 mm. More complex procedures requiring exceptional precision might employ all available depth analysis techniques with maximum iterations to achieve the highest possible resolution of 0.1 mm or better. The system architecture allows these different modes to be switched dynamically during procedures, responding to changing surgical priorities without disrupting workflow. This adaptability enables surgeons to balance processing time against depth resolution based on the immediate requirements of each surgical phase, making the Camtrx system uniquely versatile among surgical visualization platforms. By combining surface depth information with spectral subsurface data, the system creates a comprehensive volumetric model that surgeons can explore interactively, visualizing both surface contours and critical subsurface structures with unprecedented clarity during surgical procedures.

### Super-Resolution

Super-Resolution, as used herein, means digitally boosting resolution by geometric merit-based processing. Or Super-Resolution can be produced by Bayesian techniques, or, Super-Resolution can be achieved by oversampling approaches. The result of Super-Resolution is that an image can be seen in a higher resolution than it was originally captured in. The LightField3D imaging system provides Interpolated Perspective views which exhibit Constructive Super-Resolution. A consequence of perspective view interpolation is that an output perspective view which is produced by combining two or more source perspectives requires more resolution than the individual input views. Thus, if a field of interest contains areas with a slope relative to a single perspective view, where the surface is not perpendicular to the axis of view, that area will have reduced resolution proportional to the slope, while perpendicular areas will have full resolution. Perspectives with different axis of view will see these sloping areas with either more or less resolution than the original perspective. This additional resolution can be preserved by the perspective interpolation process, if additional resolution is available in the constructed output. The magnitude of this resolution increase is dependent on the angle of slopes in the surface of interest as seen from various axis of view, and the divergence of the various axis of the contributing perspectives. Even a fairly modest sample perspective axis distribution and a relatively flat surface of interest can require more than a linear factor of two increase in output resolution relative to resolution or input perspectives, requiring more than four times the pixels in the output to preserve the available information.

A subtle but similar aspect is that each of the source perspectives has a different effective sampling grid due to axis tilt, relative to other perspectives, even when the surface of interest is completely flat and view axis separation is small. These viewpoints therefore contribute additional phase information as well, which can largely be preserved by using a higher resolution for the extracted perspective. Thus, we can create an interpolated view from a relatively low-resolution region for which high resolution data is available from another sensor. Using depth map data to generate gradient information and geometrically mapping this onto each sensor perspective allows each pixel derived from each sensor to be assigned a figure of merit. This merit can be utilized to determine and save for use the highest resolution information available for each region. The Dynatrx algorithms then “replace” the lower region data with higher resolution data. If output resolutions higher than source resolutions are desired, an on-demand 2× or if created from the interpolated perspective resolution which provides Super-Resolution.

Another way Super-Resolution can be achieved is that each image sensor's perspective is at an offset from the view axis, resulting in a slightly trapezoidal view of the volume of interest at each unique view angle. These sample grids when combined with precise auto-calibration information provide perspective unique sample data which is ideal for Super-Resolution processing. The Dynatrx operating system achieves the required processing at an adequately low processing time latency to avoid disrupting hand-eye coordination. The ECT output from the calibration process maps each source perspective onto a common reference framework. Taking the calibrated version of each sensor dataset generated from the source data at a resolution higher than the original source sample grid, then the unique perspective specific sample information can be preserved through the merge operation. In this case, a filter providing a high frequency boost operation can restore the amplitude and reveal much of this high frequency information, with no increase to processing latency. This combination of geometric and sampling based Super-Resolution increases the useful resolution.

### Robotic Guidance System

The Robotic Guidance System comprises the interfaces and processing components that provide spatial reference data to external robotic surgical instruments. The system generates a calibrated 3D reference frame derived from the depth mapping and multi-perspective imaging capabilities, enabling precise navigation and positioning of instruments within the operative field. This data includes comprehensive 3D positional coordinates with sub-millimeter spatial accuracy, surface gradients for optimizing approach angles, and occlusion maps identifying safe versus restricted zones. The interface uses standardized protocols compatible with major surgical robotics platforms, supporting both positional reference information and optional closed-loop feedback for instrument tracking. Through sophisticated spatial mapping algorithms, the system can establish correlations and mapping between different coordinate spaces-including the virtual image space, patient physical space, and robot motion space-providing the foundation for surgical robotic systems. By integrating the system's precise spatial mapping capabilities with robotic instrumentation, the guidance system enables computer-assisted procedures that combine human decision-making with machine-precision execution, particularly valuable for operations requiring manipulation of delicate structures or navigation through complex anatomical environments. TRIOME™ for Retinal Surgery

### A New Device to Replace the Biom (FIG. 30)

For retinal surgeries, the OR-Bot microscope incorporates the Ocutrx Triome™, which offers significant improvements over the Biom® manufactured by Oculus Surgical. A critical advantage of the Triome is its increased working distance, maintaining approximately 15 mm from the eye compared to the Biom's 1 mm proximity requirement. This greater standoff distance dramatically reduces the risk of accidental contact during procedures. Since most ophthalmic surgery patients are under local anesthesia only, eye movements often cause contact with the Biom, necessitating replacement of disposables or halting procedures for re-sterilization of reusables—both representing significant pain points for retinal surgeons. The Triome will be available in both disposable and reusable formats, each expected to cost substantially less than the Biom.

Beyond working distance, the Triome approach significantly improves the field of view capabilities. While traditional Biom lenses interface a wide field-of-view of typically 60 to 120 degrees but translate that to a relatively narrow cone of 12 to 20 degrees, the Triome enables a much wider cone of view. This expanded viewing angle, combined with the system's multiple perspectives, provides surgeons with unprecedented visualization of the surgical field. The Camtrx system enhances this visualization through computational super-resolution techniques that combine geometric and optional Bayesian approaches, effectively increasing resolution beyond the capabilities of individual sensors.

The Camtrx system dramatically extends the practical depth of field far beyond what is optically possible through computational analysis of point spread functions. By understanding how optical focus varies with depth and applying precise computational corrections, the system maintains sharp focus throughout the retinal depth range—a capability impossible with conventional optics alone. This computational focus enhancement eliminates the need for constant mechanical refocusing during procedures, allowing surgeons to concentrate on the surgical task rather than focus adjustments. The advanced filtering options also reveal subtle tissue features that would typically remain imperceptible. Surgeons can freely navigate the enhanced volume, adjusting viewing angles, magnification, and position in ways previously impossible, effectively performing a virtual exploration within the surgical field. By separating the physical optics from the processing and display systems, the Camtrx platform fundamentally transforms surgical visualization workflow, supporting versatile display formats from conventional monitors to stereoscopic headsets and light field displays, and ultimately delivering a level of visual control and precision previously unattainable in retinal surgeries.

### A Confluence of Mathematics, Statistic, & Processing Throughput

### INTRODUCTION

Recently there has been substantial progress made in the closely related image processing areas of solving inverse problems, statistical signal enhancement, and super resolution in both space and time. Processes based on both statistical image processing and on neural network-based processing both rely heavily on advances in Bayesian statistical optimization techniques which has begun to influence new product design and capabilities in recent years.

These processes improve the ability to distinguish signal from noise and allow information from multiple sensors and multiple time intervals to be combined constructively in ways that were previously considered impossible. The opportunity now exists to reinvent many optical applications to provide fundamental new capabilities and substantially improved technical performance, while adding new degrees of freedom to price-performance optimization. This applies both at the product and system level and in the fundamental design of components and sensors themselves.

A final challenge to broad application of these innovative technologies has been the difficulty of performing these relatively complex optimizations fast enough to meet real time performance and latency requirements for a broad range of applications. Ocutrx has developed a generalized approach to the Camtrx processing requirements which achieves the goal of ultra-low latency processing speeds needed for the demanding hand-eye coordination required for surgery. This combination of Ocutrx Genius Lab engineers creating new low-latency signal processing with suitable high speed computation enables products with an entirely new level of features.

### New Optical System Design Trends

### Multiple Sensor Utilization

Traditionally the primary way to improve sensor performance was to make a bigger sensor at a dramatically increased cost. Now it is possible to constructively merge multiple image data streams from multiple sensors, while preserving the information content of each signal source, providing an increase in sensitivity, signal to noise ratio and resolution, without significantly increasing the latency. The imaging performance improvements mentioned in sensor scaling can now be realized by using multiple sensors, thus avoiding the exponentially progressive tax imposed by the semiconductor yield curve.

The additional signal processing required is an added expense, but it is a linear addition rather than an exponential one, and it will shrink over time as specialized components enter production. Initial applications of this approach will tend to concentrate on applications where the new advantages are most apparent, such as provided by Camtrx and wide area imaging. Multi-sensor configurations and post processing are likely to replace most of the specialty high performance sensors in high performance applications.

In addition to improving cost-performance trade-offs for high end optical sensor configurations, effective use of multi-sensor arrays adds fundamental new capabilities, adding the ability to include perspective information, hyper-spectral information, and new degrees of freedom with temporal information.

### More Perspectives

Multiple views supplied by multiple sensors also combines multiple perspectives, where each sensor view is also providing additional perspective information. This can be optimized in a number of ways including a converging axis of view within a common volume of interest, or divergent but partially overlapping perspective views. Constructively combined multiple perspectives goes beyond what can be done by scaling up a single sensor, and allows depth analysis and occlusion resistance with additional processing. Humans have some limited occlusion resistance in one axis provided by the stereoscopic view and analysis by the visual cortex. Using an abundance of perspectives, excellent occlusion resistance can be provided within a volume of interest. Convergent perspectives are somewhat easier to process than divergent perspectives, but in general the same capabilities can be achieved for divergent partially overlapping perspectives.

### More Spectral Components

A portion of the multiple perspectives can support spectral components both inside and outside the visual spectrum. This can now be done to allow the addition of some level of optical analytical analysis of materials through hyperspectral imaging and bi.

### Constructive Merge of Temporal Image Streams

The constructive merge is tolerant of lower signal to noise data, and yields improved signal to noise in the merge process, making higher frame rate sampling easier to achieve with a given sensor. An image sensor capable of operating at high frame rates (or an array of lower frame rate sensors operating in poly-phase) can be used to constructively merge a multi-frame collection of image data in the time dimension, much like the multi-senor constructive merge of data in space. The result would typically provide an optical flow instead of a depth map, while improving the signal quality and time resolution of the output. High and ultra-high frame rate sensors can be used to exploit this super-resolution capability to improve resolution and signal quality in both time and space.

### Optics Optimization for Advanced Image Processing Applications

Now since in the Camtrx the particular individual optic product performance can be measured by the associated image processing, and characteristics can be computationally optimized in real-time during operation, such that many optical design constraints and trade-offs can be rebalanced or removed, either to reduce optics cost while preserving performance or striving to achieve higher performance than previously possible. MTF, focus and loss correction by color component, specific position, and feature depth are some. Geometric distortion correction by color component, specific position, and feature depth can also be achieved.

### Enhanced Perspective Presentation

One new feature of the Camtrx microscope system is the constructive merge of multiple perspectives which deals with more perspective degrees of freedom than the human visual system is prepared to see. This can be addressed to some extent by modulating luminance by the derived 3D surface curl angle to make perspective information in both X and Y dimensions more readily visible to humans.

### Hyper-Spectral Presentation

Optical spectra outside the human visual spectrum, as in the Ocutrx Camtrx can provide important additional information, and can be acquired by a portion of the sensors in a multi-perspective system and processed with other components to achieve a constructive information merge and enhancement. Presentation of hyper-spectral data must deal with the issue that these components are not directly visible. If only a few hyper-spectral relationships are important to a particular application, they can typically be mapped into some aspect(s) of the visual display space. Otherwise multiple windows of visual and pseudo-color information may be required.

### Hyper-Acuity Presentation

Hyper-Acuity presents another breakthrough. The human visual system can under good circumstances differentiate a well-defined visual feature at contrast levels down to about 1 part in 2000 in luminance, and somewhat less in color. Typically a feature will consist of a gradient with some noise, in which case visual differentiation drops to about one part in 100 and less. Now, with the Camtrx, given a region of the visual space to inspect, hyper-acuity based presentation can easily be specified and applied to increase visual differentiation by up to about 100 fold.

### Some New Product Areas

### Components and Subsystems

ASIC or FPGA based computational optics perfecting as an advanced system component

ASIC or FPGA based depth or optical flow processing as an advanced system component

ASIC or FPGA based constructive merge as an advanced imaging system component

ASIC or FPGA based high frame rate image sensor enhancement for high signal quality, high temporal and high spatial resolution sensors, visible and IR for tracking, targeting, and avoidance

### System Categories

### Micro-Camtrx Camtrx Made Laparoscopic:

A Camtrx derivative for smaller or laparoscopic internal volumes of interest could couple image sensors to bundled fused fiber optics to provide a micro-Camtrx multi-perspective bore scope for internal inspection. If the fiber optic bundles were fused only at either end, a flexible and potentially long bore scope, with integrated lighting and hyper-spectral capabilities could provide unique capabilities with the same attributes as the Camtrx microscope.

Wide Area Imaging (An example of Very Large & Expensive Sensor System Replacement):

There are many types of wide area imaging used for various scientific and reconnaissance applications. An example actually used by NASA and others in numerous projects utilizes a wide area imaging system designed to acquire 32K×32K pixel resolution images, process and compress that data at a rate of four frames per second. Some years ago these systems cost about $500,000,000 each, with about 20 sensor+coder+support systems purchased per year. However, a plenoptic multi-sensor version providing potentially better performance at much lower cost utilizing an array of 16×16 (or more) cameras with 2K×2K (or more) individual pixel resolution with data processed by an array of FPGAs or ASICs should be capable of providing superior image resolution, better spectral discrimination, and higher frame rates.

Replacing Large Expensive High Resolution and/or High Sensitivity Sensors Reducing Exposure Times and/or Illumination:

Very large sensors are often required for high resolution or high sensitivity or both. Due to the exponential reduction of yield relative to semiconductor size due to probability of captured process imperfections, such sensors are expensive. The ability to replace a large high resolution or high sensitivity sensor with one or more smaller sensors can often provide a dramatic system cost reduction. Computational image enhancement processes such as Bayesian statistical enhancement applied to noise reduction, multi-sensor super resolution, computational temporal integration, and temporal super-resolution combined with low latency processing methods can be enablers for such conversions as well as potentially reducing illumination, radiation and exposure time in medical and industrial applications. This applies to effectively all sensor arrays for electromagnetic radiation used for medical, industrial, scientific, earth resource, reconnaissance, and threat detection including sensors for multi-spectral, UV, visible, near, medium, and long IR imaging, X-rays, etc. Altera, Lattice, or Xilinx FPGA manufacturers may be interested in adding these capabilities to their tool libraries.

### Spacecraft External Omnidirectional Vision System:

Spacecraft have special problems with omnidirectional external visibility using either windows or articulated cameras for a number of reasons. The omnidirectional vision system has been given increasing attentions in recent years in many engineering research areas such as computer vision and mobile robot since it has wide field of view (FOV). Camtrx for spacecraft could provide Omnitrx™ omnidirectional visual capability. The typical solution is an array of fixed cameras covering every potential view of interest. However, these typical solutions have cross-fades which generates an image which looks reasonable but is actually lower quality than the individual source images. Ideally these fixed overlapped views in the fashion of the Camtrx features, could be exploited to provide super-resolution, improved quality, contrast, occlusion resistance, continuous synthetic perspectives, zoom and magnification, wide angle views and even compensate for individual failed cameras. The Camtrx tightly constrained volume of interest and converging perspectives simplify some of the image processing, but more complex geometric configurations are possible in expanding the physical size of the camera and sensor core. Diverging perspectives with some perspective overlap are computationally more difficult, but the potentially infinite volume of interest provides many new application opportunities. NASA's fixed image sensor array situational awareness & flight control system could benefit from the Ocutrx LightField3D technology.

### Image Sensors Specifically Optimized for Advanced Processing Capabilities:

Pixel readout noise is difficult to decrease below a certain level in a given semiconductor technology and operating temperature. Current image sensor design practice is to choose pixel size and integration time large enough to directly provide a visually substantial signal relative to the intrinsic readout noise without additional signal processing. This trade-off leads to larger & more expensive sensor devices with lower pixel image resolutions, longer integration times, more image aliasing and higher part costs than are in theory possible with appropriate post processing. Using new low latency statistical data analysis and optimization methods enables sensor design trade-offs to move toward higher temporal, spatial and spectral resolutions while maintaining or even improving signal quality. The potential advantage arises because the image data correlates over time and space and the quantum sampling noise in general does not, making it possible to statistically discriminate image data from sample noise. Image processing techniques such as Fourier analysis, wavelet transforms, statistical optimizations and inverse solutions supporting super-resolution can discriminate between correlated image information and uncorrelated sample noise. This Ocutrx Genius Labs approach offers:
Higher spatial frequency Bayer pattern color filters.
Direct hyper-spectral support using narrow component filters.
Higher spatial image resolution sample data
Higher temporal resolution sample data.
Higher image quality.
Much increased resistance to aliasing of optical input.
Nvidia, AMD, Intel, or ARM may be interested in adding such operators to their GPU hardware or software feature set.

### Pilot Night Vision Situational Awareness:

Traditional night vision aids have often supported a relatively limited field of view which constrains situational awareness and is far from ideal for congested or contested areas of operation for either piloted or remote operation. A plenoptic and/or multi-perspective array, potentially with various resolutions and various spectral sensitivity combined with low latency analysis and perspective integration can address this issue. Integrating data from multiple low resolution sensors and multiple sensor types can provide high quality, high resolution wide field operation while controlling costs.

### Wide Angle Night Vision Optics:

Traditional image intensifiers as well as Medium and Long Infrared (MIR, LIR) vision systems have typically provided a relatively narrow field-of-view, which is hazardous for typical users such as helicopter pilots and solders. With the Ocutrx Genius Labs Plenoptic sensor array, this issue could be fixed providing a very wide field-of-view.

### Camtrx Industrial Derivatives Replacing Typical Microscopes:

The Camtrx converging plenoptic or perspective views, combined with a compact volume of interest and the ability to independently auto-calibrate the sensor system provide an ideal configuration to apply perspective enhancement and super-resolved imaging. This architecture has multiple industrial applications including critical manufacturing process feedback, automated inspection, Optical 3D measurement, internal cavity inspection, and similar product maintenance and repair.

### Hyper Spectral Reconnaissance:

Hyper-spectral earth resources data has in the past been collected as a continuous strip image about 7000 pixels wide and arbitrarily long, in 35 color components covering ultraviolet through near IR, using a prism and 35 8K line scanners, or in some cases line scanners with narrow band optical filters. The non-imaging 1K portion was used for exposure calibration, image alignment and metadata. Bayesian noise reduction and super resolution analysis of this data stream which can be effectively over-sampled 35 fold could provide dramatic noise reduction, improved spatial resolution and increased contrast. Alternately, replacing line scanners with a frame capture arrangement similar to the wide area imaging system with various wavelength filters on some image sensors would provide a wide area imaging & hyper spectral system using conventional 2D image output which would be advantageous for some applications.

### Reducing Complexity and Improving Performance of Cooled and Supercooled Sensors:

Most long wave IR sensors as well as some low noise medium and near IR and a few visible light sensors are cooled or supercooled. Bayesian optimization of sensor data can significantly improve the sensor signal to noise ratio computationally, which may be able to reduce or eliminate cooling and thermal insulation in some applications which could reduce system size and complexity.

### New Automobile Safety Regulations Generate New Imaging Requirements:

Many countries are planning to add some IR imaging requirements for assisted or automated nighttime collision avoidance. Most low-cost IR sensors are relatively low resolution. A super-resolved IR sensor or sensor array like shown in the Camtrx sensor array with advanced processing may provide a good contender. Combining long wavelength IR sensors, noise reduction, medium and long wave IR sensors which are used in many military systems and some commercial products such as automobiles could use low latency Bayesian processing which would yield superior results to the regression analysis type noise reduction typically used. The LightField3D techniques can be used to create high-quality perspective integration to replace lower quality edge blending in applications like car surround viewing, or hemispherical projection used in simulator and some forms of dome projection simulators and dome entertainment to improve outcomes.

### Tele-Camtrx+Increased Standoff:

A telecentric lens is a special optical lens (often an objective lens or a camera lens) that has its entrance or exit pupil, or both, at infinity. The size of images produced by a telecentric lens is insensitive to either the distance between an object being imaged and the lens, or the distance between the image plane and the lens, or both, and such an optical property is called “telecentricity”. Telecentric lenses are typically used for precision optical two-dimensional measurements, reproduction (e.g., photolithography), and other applications that are sensitive to the image magnification or the angle of incidence of light. Configured for larger standoff distance and perspective separation and with suitable telecentric lenses would provide a Tele-Camtrx with the same improved occlusion resistance and perspectives, magnification and measurement capabilities over longer distances. This could be useful when dealing with hazardous materials, processes such as positional feedback for laser, water jet, or ion beam machining, or proximity issues such as limited mechanical access, chemical or biological hazard, or high radiation environment.

### Tracking:

High sensor frame rates improve temporal locality and result in much improved tracking performance. However, reducing sensor signal integration time lowers signal levels and signal to noise ratio. The solution is ultra-low latency post processing to reduce noise, improve signal resolution and generate optical flow vectors without introducing excess delay and would move the sensor design trade off toward better time resolution and tracking performance.

### Personal Situational Awareness:

Industrial, law enforcement and military situations can benefit from enhanced situational awareness. The Camtrx solution is a smaller device that could provide:
Extended perceptive acquisition
Extended visual perspective acquisition, potentially omnidirectional
Multi-spectral support of visual perception
Passive atmospheric audio information integration
Passive ground/surface conducted audio information integration
Active (ultrasonic sonar) audio information integration
Extended perspective presentation
Non-linear scaling of surround visual information
Windowing and panning of perspective
Visual and/or audio assisted awareness annotations

### Conclusion

The new forms of image sensor data fusion and analysis developed by the photonic, biomedical and mechanical engineers at Ocutrx Genius Labs can significantly improve realized resolution and image quality, providing substantial flexibility and performance opportunities over traditional optics and sensor operating constraints. This White Paper presents new forms and levels of signal enhancement, perspective projection and analysis, interpretation, and presentation. The Camtrx image processing speed, occlusion resistance, depth perception, contrast enhancement, and hyper-spectral sensing mapped into visual presentation being prime examples.

These capabilities enable numerous additional application areas which could benefit from similar image collection and signal processing technology. The application of Bayesian statistical analysis and optimization of multi-sensor constructive sensor data fusion, computational focus, depth analysis, occlusion tolerance, noise reduction and signal enhancement, high speed, low latency implementation of these and related methods enable new market opportunities in traditional categories, as well as entirely new product areas and feature sets.

Moreover, specifically the usage of image sensor arrays for plenoptic or multi-perspective based image acquisition, signal enhancement, data fusion, perspective model formation and presentation all utilizing low latency processing to enhance occlusion resistance, expand field of view, improve perspective, image quality, increase effective optical and sensor resolution can provide hyper-spectral and hyper contrast display capabilities in real time.

### Ocutrx Camtrx Lightfield3D™ Microscope—Data Paths and Processing High Level Block Diagram & ECT Elastic Convolution Transform Overview

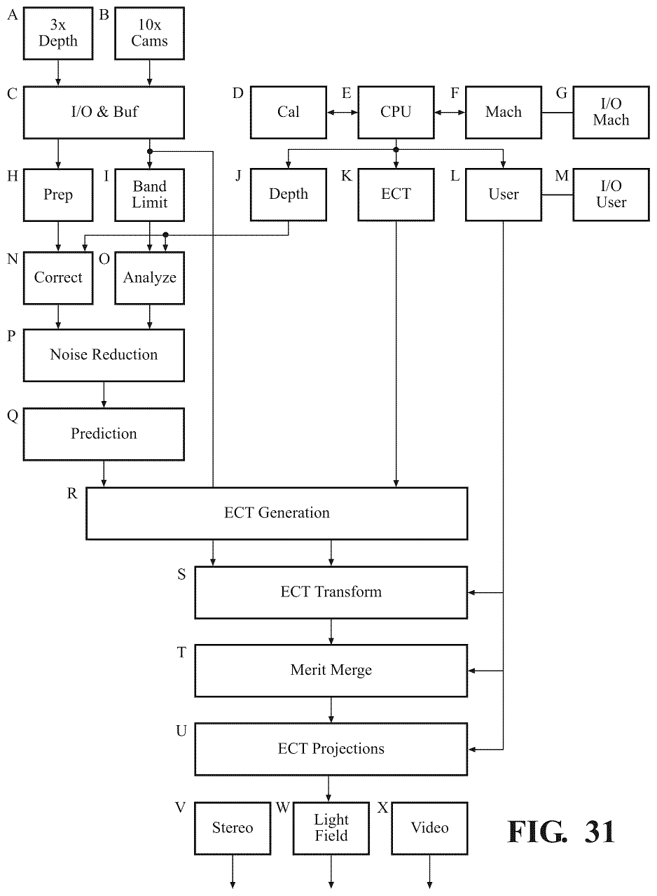

FIG. 31 is a block diagram indicating the primary data flow, processing, interconnection and dependence. It does not necessarily imply frame time synchronous process steps, but instead indicates significant processes and the general path of data flows, which all endeavor to introduce a minimum of latency.

Blocks A, B, C and their Depth Processing Successors

Accurate depth perception is a critical enabler to most of the image processing tasks. Based on software tests on the eye image and height data, it appears that a sample resolution of more than 30 mm/64 or 0.5 mm is desired. Roughly 0.25 mm over a 70 mm field of view yields a desired resolution of around 280 samples per X & Y dimension. If a depth range of interest is on the order of 15 to 25 mm, the desired height range would be at least 60 to 100 quanta. This is sufficient if the data is very accurate and clean. If there is significant noise, a higher sample resolution would be desired for noise reduction.

If a integrated optical depth sensor is available, it is likely that three or more sensors would be needed, arrayed 120 degrees apart around the base of the cone of view, to provide adequate occlusion resistance in the field of interest. The sensors would have different perspective views which would need to be geometrically corrected and combined. The sensors would need to be part of machine auto calibration to collect the required corrective dataset.

A multi-perspective visual image based depth approach has the advantage that the image sensors are a mandatory component of the design, rather than an additional mechanical and electronic complexity. The challenge is controlling the processing time required to obtain a quality depth map from multiple views. Luckily, the required depth map has much lower resolution requirements than the image resolution, on the order of ⅛ the resolution per dimension, which allows bandwidth reduction to increase signal to noise ratio 18 dB while reducing the total search space by a factor of 64. Using a sub-sampling hierarchy to minimize initial search space to minimize each following step would also provide acceleration.

The orientation of data delivery to A & B (rows or columns for example) generates the preference of order of following data processing to minimize processing latency.

Elastic Convolution Transforms are heavily utilized in this process.

### A. 3× Depth (Three Depth Sensor Inputs)

Interface to the three LIDAR type depth detectors, with any required handshake and data conditioning.

### B. 10× Cams (Ten Perspective View Camera Inputs)

The 10 perspective acquisition camera inputs and any required initial handshake or data conditioning

### C. I/O and Buffer (of Depth Sensor and Image Sensor Data)

Interface to depth sensors (if used) and perspective image sensors including any required buffering, data conditioning or reformatting.

### D. Cal (Auto-Calibration Data Base)

The calibration data base generated under control of the CPU and accessible to processing hardware directly as required or by provided CPU services.

### E. CPU

Processor supporting auto-calibration as well as system status verification and monitoring, and some user interface transactions. Some CPU prepossessing of the calibration database for easier application in the hardware processing path would reduce hardware complexity, cost, and design time.

### F. Mach (CPU Access to Remainder of Machine)

Machine interface including CPU friendly access to image and depth data, external control, user controls, and manipulation of the calibration process.

### G. IO Mach (CPU Access to Machine IO Interfaces)

Actual IO interfaces as required for machine setup and control of sensors and processing paths as well as other internal machine features and external user interfaces.

### H. Prep (Image Data for Depth Analysis)

Depth sensor data filtering or formatting in preparation for perspective correction

### I. Band Limit (Image Band Limit Reduction)

In preparation for image perspective based depth extraction, select several or all camera data sources, reduce X, Y sample bandwidth as required.

### J. Depth (Depth Correction Data)

Provide the portion of auto-calibration information required to project depth sensor data correctly onto target area of interest, as well as projecting camera date onto the area of interest. In both cases (if both processes are used) the goal is to align individual views precisely, and correct for any MTF or geometric distortion or variation in lighting intensity.

### K. ECT (ECT Calibration Data)

Calibration data to correct for position, alignment, modulated transfer function, geometric distortion, and illumination field.

### M. I/O User (CPU Access to User Interfaces)

User interface driven requests for display pan, zoom, 2d or 3D reference grids, information widows, annotations, phase contrast filtering, holomorphic filtering, or frequency response filtering.

### N. Correct (Correct Depth for Perspective of Off-Axis Depth Sensors)

Using calibration data, geometrically project the resulting depth images onto the base of the area of interest. Discard extreme values and average reasonable values

O. Analyze (Depth Information from Correlation of Projected 3D Volumes)

The required surface depth map requires dramatically less linear resolution than the desired image resolution. This low resolution combined with a recursive search starting at even lower resolutions allows the most probable surface height profile to be located rapidly. Initially at very reduced x,y and h resolution, project each prospective view onto the volume of interest to produce a 3D volume representing the potential height verses pixel value for each perspective view. For each x,y position the best correlation of the height column will occur at the surface height. The initial very low resolution height data can be used to narrow the autocorrelation search range of interest to provide process acceleration at progressively higher resolutions until the desired 3D surface map resolution is obtained.

### P. Noise Reduction (of Depth Information)

Typically selecting the most strongly connected and lowest energy surface map is a good strategy. Comparing results from various perspective sensor pairs is a potential strategy to deal with occlusions above the surface of interest. When available, comparing depth sensor data with optical data should help locate and classify occlusions and avoid low contrast depth ambiguities.

### Q. Prediction (Motion Prediction to Reduce Depth Latency)

Depth map generation and calibration is expected to be on the order of one or possibly two camera source frame times. To reduce image processing latency, the slightly out of date depth map is expected to be satisfactory to use for the depth input for image processing. If not, the slightly out of date depth map and its predecessors can be used to generate a first and second derivative of the current motion path, and this can be used to project the latest depth data into the present, generating a current depth map with effectively 0 latency. Lateral movement of occlusions introduces some complexity identifying them as objects and predicting their lateral versus vertical motion.

### R, S, T, U as an Image Processing Group

The data base information collected during auto-calibration is used to generate the control data to allow a set of ECT operations to correct positioning and optical issues. A merit based merge combines the best of individual perspectives, and ECT projections generate the desired perspective views at the desired angle and scale.

### R. ECT (Control Program) Generation

Calibration data, depth data and desired output projection allow generation of the appropriate ECT control programs. Image can be scaled, rotated, filtered, color converted, and other operations. Merit for each pixel is a function of desired perspective and the original and final image height gradient.

### S. ECT Transforms (Convert Source Images to a Calibrated Metric Space and Perspective)

Correct any optical geometric distortion, focus, and MTF issues, apply or correct rotation and projection geometry, generate the desired resolution and provide user selected filtering and

enhancement operations for each input perspective, producing a standardized, calibrated output representation for each input perspective.

### T. Merit Merge

Using the merit of each pixel, merge all 10 perspectives producing output which represents the average of the highest merit inputs at each point. Merit merge output typically has significantly higher resolution than the individual source images. In addition to combining the best aspects of each perspective view, the merge can add User Interface windows, highlights, overlays and other additions.

### U. ECT Projections

Using the output of the Merit Merge operation, Apply desired rotation, projection, pan, and resize to produce each of the desired output perspectives. Two medium resolution views for stereoscopic output, forty-five views for light field displays, and potentially multiple single perspectives as standard video at 2K, 4K, or 8K. With adequate ECT transform hardware resources, all can be generated and available simultaneously.

### Output Formatting

V. W. X. as a group. Display frame rate can potentially be independent of Camera and processing rate by decimating rates down, or weighted cross fading up locally to V, W, or X, or additional perspectives generated by block

### U. Image Pans and Zooms and Selectable Viewing Angles are all Possibilities.

### V. Stereoscopic Headset Out

Receive two medium resolution streams from ETC Projections block U and format for a stereoscopic output stream.

### W. Light Field Monitor Out

Receive forty five relatively low resolution light field images from ETC Projection block U and format into a frame stream containing a 9×5 array of perspective views for output to a light field display.

### X. Standard Video Out

Receive a standard video stream (2K, 4K, or 8K) from ETC Projections block U and format into a standard video stream.

### Elastic Convolution Transform (ECT) Overview

A number of blocks in the Camtrx data processing diagram are ECT processing blocks. This description of an ECT process provides some visibility into those functions.

### ECT Introduction

The ECT is a resampling and remapping operator which has the ability to input a data set in one sample domain and create a derivative with a potentially altered sample domain, geometry, and frequency response while adhering to sampling theory. The ECT is effectively statically or dynamically “programmed” with a traversal path through the source data, and the convolution operation(s) to be perform at each desired location on that traversal. Allowing the traversal path to be specified and the sampling point to be interpolated by the convolution at an arbitrary point between source samples provides powerful resizing, warping, geometric correction, and projection capabilities. Allowing each sample point to apply a potentially unique convolution allows for location specific filtering, local or height dependent computational focus correction, angle specific MTF correction, and sample grid interpolation.

A local convolution operator is typically used to interpolate the value at the new location based on a potentially large number of surrounding source data points. In addition to interpolating new sample grid data, the frequency response can be modified, and the created sample value can in some cases represent a significantly higher signal resolution and lower noise content. An ECT is well suited to “perfecting” lens optical response and geometry, geometric projections, transforming to Direct Resolution Representation, high quality resizing and resampling, Bayer color decoding and encoding, wavelet transforms, gradient and curl operations, and fiducial detection and analysis operations, homomorphic, phase contrast, location and phase dependent filtering, among others.

The Elastic Convolution Transform is a general framework and toolkit to approach image processing tasks rather than a single specific design. It is typically implemented in hardware, where only the specific features needed are included to reduce power and cost. Its initial form provided fast, flexible and effective ways to implement complex combinations of convolution transforms using minimum hardware resources. Later the need to address sampling theory consistent mappings from one domain into another for geometric transformations and optical system geometric corrections and projections lead to the “elastic” aspect. The approach has been commercially implemented in discrete logic, bit slice logic, standard cell gate arrays, FPGAs, and ASICs for a wide range of applications.

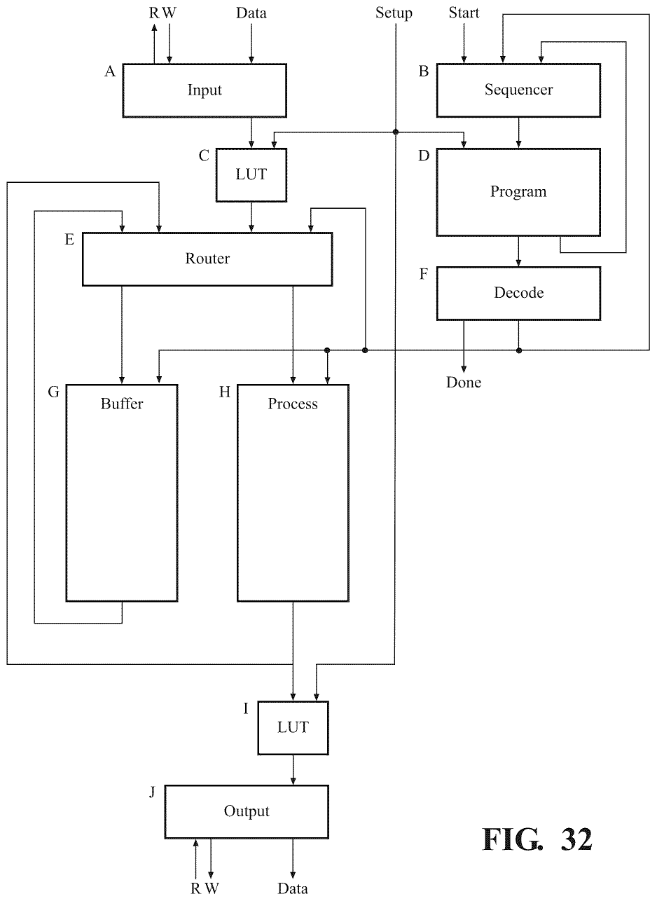

### ECT Functional Blocks (FIG. 32)

### A & J Input and Output

R and W refer to Ready and Write signals which are typical synchronous interface controls, usually tolerating at lease a few data cycles of write overrun when going non-ready. Although not absolutely essential, a robust formalized high speed handshake module at input and output has often been critical to achieving desired performance and reliability.

### B Sequencer

### ECT Program Counter

The ECT is typically controlled by a “ECT processing program” stored in block D. The sequencer steps through the “program” to implement the desired operation. In some cases this has included looping iterations and recursion, but more typically it consists of some hardware setup operations and then close to a one to one mapping of sequencer steps and corresponding outputs, although compound operations are common with multiple results generated per clock period.

### C & ILUT (Look Up Table for Nonlinear Data Transforms)

If non-linear operations are desired such as gamma correction or homomorphic filtering, a LUT on the input stream and output stream are useful applying and removing the “log”, “tanh—sfunction” mappings. For best signal performance, the LUTs provide more address bits and data bits of resolution than the signal needs to allow an expanded range for effectively lossless non-linear operations.

### D Program (ECT Instruction Set Code Storage)

An ECT program typically consists of some initialization for edge treatment, followed by one processing instruction for each output or output group. In the case of multiple processing paths, or poly-phase operation, there may be one instruction for a group of outputs. Initialization instructions typically set up top and bottom edge processing such as mirroring, or edge wrapping. Processing instructions typically indicate the x and y distance in the input sample space to move from the current position, and in most cases what convolution to apply, in order to generate an output in the output sample space. The output stream is typically in the desired order, but can be addressed writes to output if needed. In the typical “elastic” case the input and output space do not have a simple correspondence. Frequently there is a general geometric correspondence, worst case non-locality “reach” and the input can be addressed within some worst case range and the output stream can be produced in order. Resampling at locations “between” source pixels is dealt with by interpolating with the convolution, which may apply the desired response function and phase shift, and may in the extream case be unique for each output result. More commonly, a discrete number of phase shifts, or an approximation can be used. For example, if one sixteenth of a source sample interval is considered an adequate subsample resolution, then 16×16 or 256 sets of coefficients can be used to implement interpolation filters for each of the phases. Each ETC instruction then indicates the desired source pixel and phase position which selects the appropriate sub-pixel resolution coefficient set. ECTs are often designed to execute many source to destination operations in parallel to increase processing speed. Examples of common parallelism are processing all four components of a Bayer color pattern in parallel, all 4 pixels (often 12 or 16 components) of a 2D wavelet, or all three components of an RGB pixel, as well as frequently paralleling execution of neighboring groups.

### E Router (Data Recirculating and Edge Processing-Mirroring, Wrapping, Filling)

A portion of the source data set adequate to provide the necessary context of the desired convolution and any required non-linear path excursion is buffered in FIFO or RAM memory. This is managed by the router and can take the form of either a row or column dominate architecture. Source image data is typically either wrapped or mirrored from top to bottom and left to right. Typically for most filtering, reformatting, and wavelet operations, mirroring through the center of the edge pixels (rather than at the edge of the sample grid, i.e edcblabode not edcbalabcde) provides better reversibility and smaller compressed data sets. This edge treatment has become popular due to reversibility of this approach for sub-band and wavelet transform compressed image storage. Regards source locality or the lack thereof, if an ECT is to implement a 10×10 convolution using typical mirroring, and the worst case nonlinearity of the path through the source sample grid is +/−10 pixels, then the router will need to maintain a recirculating row or column buffer of at least 30 lines (or columns) as it progresses through the source image. The extend of the worst case deviation from linearity directly impacts the needed size of the buffer and necessary processing latency. Because the buffer retains and recirculates the data context as needed, the deviation from linear does not directly have a major impact on the required source or ETC processing bandwidth.

### F Decode (ETC Program Instruction to Control Signals)

Decode provides a mechanism to convert ECT instructions into control signals or sequences, store convolution tables, or otherwise reduce to size of the ECT instruction by encoding common fields.

### G Buffer (Row or Column Recirculating Source Context Memory)

Buffer is a row or column oriented storage element, typically largely depending on the preferred orientation of the data source od data destination. It needs to be capable of storing as many lines (or columns) as are required for the local context for convolutions. After each processing pass through a row or column, some portion of the Buffer contents becomes obsolete and is replace with new data by the Router, so it is typically much smaller than the source image size. The Buffer is typically constructed from discrete or onboard FIFO memory or RAM.

### H Process (Data Processing Operations)

The Process block implements the actual operations on source data to generate output results. It can typically range from fixed convolution networks, to fully programmable convolution processors. Special architectures for parallel processing of color components, or multiple values for speed are common. Phase aware operation can provide excellent quality Bayer color data processing where full band chroma is interpolated from appropriate color samples for each pixel position, and then used for full band chroma and luma generation if desired, without the usual Bayer pattern decode sensitivity to local noise. A small local phase shifted DFT or DCT transform can be applied, and the convolution can then serve as a mask to analyses the results, allowing local curl, gradient or directionality to be generated. Partial or full conversion to DRR (direct resolution representation) can be accomplished, which lowers the image sensor quantum noise energy while increasing the local low frequency signal resolution. In typical lens formed images, there is some effort to avoid aliasing by reducing the frequency response at X and Y Nyquest frequency by 12 to 18 dB. If one assumes almost all energy in the image above the lens roll off is noise, a significant amount of the thermal noise can be eliminated as in the interpolation transfer function below.

### Example of Interpolation Coefficients and Transfer Function

Although rare, a unique convolution kernel could be used for each source sample point in an ECT program, this results in a very large kernel storage and bandwidth requirement. A number of techniques are typically used to reduce ECT convolution storage size.

Integer convolution coefficients are typically in the 8 to 16 bit resolution range, typically scaled to sum to a power of two such as 2\hat{ }16. This avoids floating point operations and need for dividers and allows easy dynamic range extension by bit (6 dB) relative to the source samples when needed.

For symmetrical convolutions, folding at one or more of X,Y, or diagonal is often possible.

Resizing or geometric distortion correction requires off grid sampling which requires a combination of x and y phase shift. In many cases, a phase resolution of ¼ to 1/16 of the source sample grid provides adequate spatial resolution, while limiting coefficient set requirements to 16 to 256 kernels.

Poly-phase source data such as Bayer encoded color, or wavelet sub-band transforms can require four or more phases and their corresponding individual coefficient sets.

Combining necessary degrees of freedom for off grid resampling, asymmetrical MTF correction, focus correction, and poly-phase processing can produce an explosion in the number of required kernels. This can often be dealt with by increasing the size of the source context provided by the rolling source buffer, and the applying each of these processes individually,

Experience has shown that convolution sizes in the range of 5×5 to 10×10 are adequate for high quality results in most applications. Large kernels have actually proven to typically be more problematic than small ones for most applications.

### Example Phase Shifting Interpolation Kernel

One kernel from a set of discrete phase interpolation filters.

Phase offsets would typically range from 0/16 to 15/16 by 1/16 increments in both X and Y dimension, resulting in 256 possible source sample grid phase offsets.

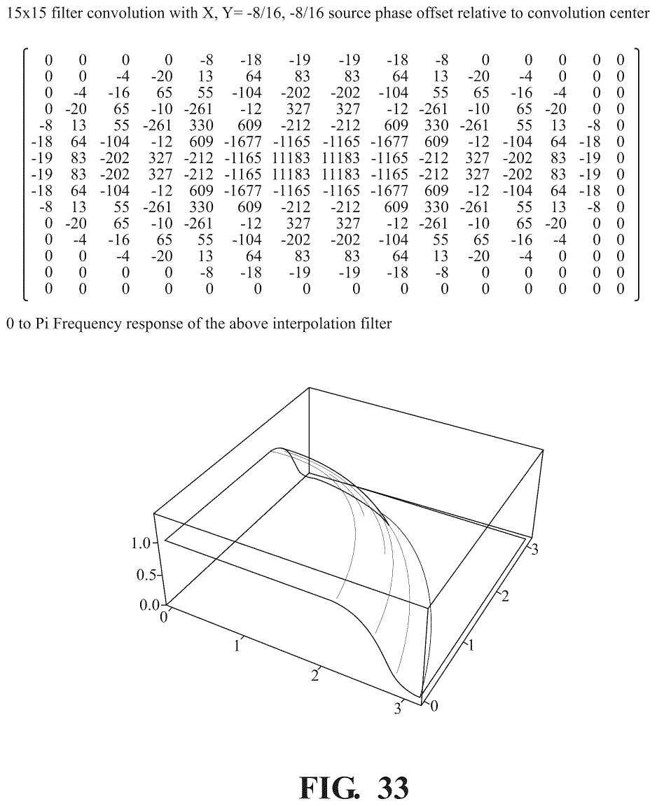

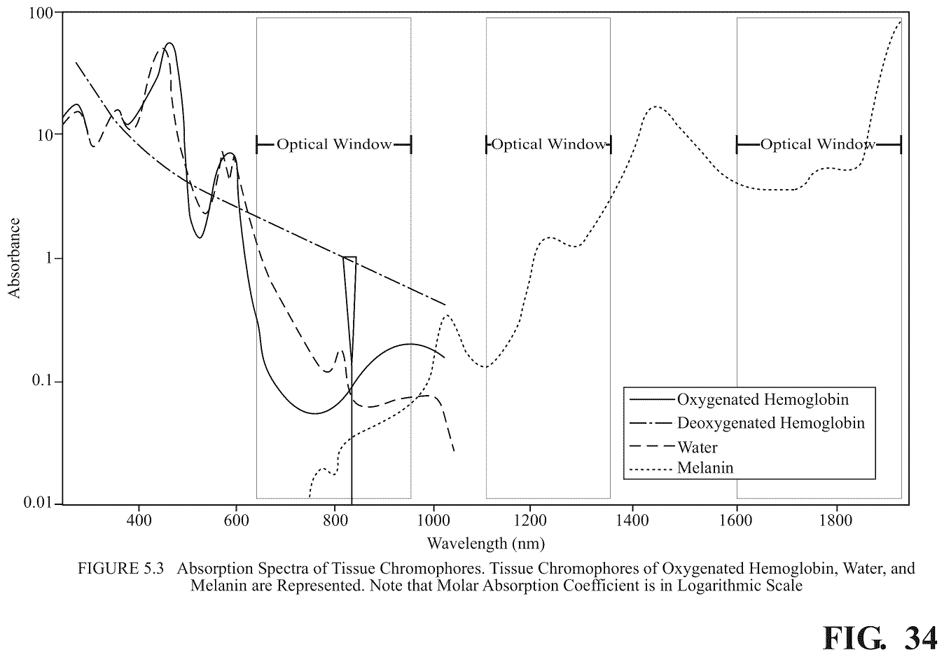

This 15×15 example (FIG. 33) is larger than is typically used for an ECT application.

This general shape of response is excellent for removing out of lens pass band thermal noise and provides an extra 6 dB of sample noise reduction at low frequencies relative to an “in phase” version.

### On the Issue of Neural Network Analysis Using Basis Functions to Minimize or Avoid Hallucinations

General Problem: Training Neural Networks for image analysis while allowing an ad-hoc recognition mechanism leads to the possibility of recognition and classification errors typically referred to as hallucinating. Extending this type of uncertainty to include medical equipment analyzing visual data is undesirable.

The source and potential solution to the risk of hallucination by Neural Networks:

It appears that hallucination problems arises primarily from an excessively simplified approach to solving relatively difficult abstraction and interpretation problem. The visual cortex ventral stream utilizes at least four levels of abstraction ranging from fundamental signal processing analysis through progressively more abstraction, providing contrast independence, scale independence, orientation and perspective independence, etc. Trying to accomplish complex classification tasks without an adequate hierarchy of generalization, classification, abstraction, cross-correlation and constraints appears to lead to the potential of serious and unconstrainable hallucination problems.

If neural networks are constrained to solve a relatively simple problem primary in the realm of direct signal processing, rather than abstraction classification, the hazard of erroneous abstraction can largely be avoided. Some ambiguity may remain due to lack of adequate contrast or texture, or occluded regions, which can all generally be detected or reasonably constrained by known requirements. Wild speculation can be avoided, and spurious results from questionable data can be contained or annotated as such.

### Depth, A Critical Camtrx Processing Task Addressable by Neural Networks:

In the Camtrx processing path, the single most difficult process to accomplish with adequate quality and speed is depth analysis, which all other processes depend upon for their specific analysis. High accuracy, resolution, and speed are all very desirable and limit the potential accuracy and resolution of all following operations. Multi-perspective depth analysis with occlusion detection and resistance can be viewed as solving for the individual 2D surface deformation map which would align one perspective with another perspective view. These deformation maps when combined with the perspective view geometry, yield relative surface depth. These maps should exhibit the properties of physical connectedness and boundedness which constrain results to be reasonable, even when non-informative.

A neural network directly implementing such perspective analysis at full required resolution would require a very large fan-in determined by the reach required by the most extreme surface excursion possible in the volume of interest. Assuming the current resolution, perspective angles and depth of the volume of interest, well over 250,000 inputs may be needed to generate each output for each perspective pair. Considering this single operation is needed millions of times, some reduction of this fan-in is desired. A multi-band Gabor wavelet decomposition of the source perspectives, similar to what the visual cortex uses for initial preprocessing can scale the task to vastly reduce fan-in requirements for an analyzing neural network, which would initially perform the task at a low resolution, and propagate that low resolution solution as a localizing constraint to minimize the fan in of the next level of refinement. An N octave 2D Gabor type wavelet analysis would reduce the neural network fan-in requirement at the lowest resolution by a factor of 2\hat{ }−(N*2). The resolution would double at each layer of analysis, but the reach of the required fan-in would be cut in half, making the throughput required for the desired resolution manageable when N is in the range of 5 or more.

Approach for Neural Network Depth Estimation with a Wavelet Resolution Pyramid

Each perspective view can be corrected to provide a standardized view which aligns and centers exactly in the volume of interest, matching all other views. Depth is computed using perspective pairs to detect surface height and collect data to deal with occlusions in and above the volume of interest. Excellent coverage can be provided by comparing adjacent pairs and diagonal pairs of perspectives which provides occlusion information, both in and above the volume of interest, and data to determine which occlusions apply to only one perspective. The previous frame time depth data can be used to provide the current frame time initial guess to accelerate analysis. A pyramid of progressively lower resolutions can be generated for each perspective view to also steer and accelerate depth analysis.

### 1. Perspective Calibration and Prepossessing

Starting with N calibrated perspectives, aligned on a single central point within the volume of interest.

The calibration process ensures that the relative position and angle of the two perspectives are precisely known, with accuracy of about ⅛ pixel pitch. Use of luminance curl angle would normalize luminance differences caused by perspective lighting differences and would typically replace need for feature extraction, which is an optional alternative.

### 1.5 Optional Feature Extraction of all Resolution Pyramids, if Non-Linear Coding or Curl Angle are not Adequate to Eliminate Minor Luminance Variation Due to Lighting and Angle.

2. Wavelet Decomposition of all Perspectives into Pyramids of Resolution

Wavelet decomposition produces a pyramid of progressively lower resolution representations of each perspective image, preparing for multi-resolution processing.

The low frequency representation provides high speed extraction of large structural features

### 3. Iterate Through Resolution Pyramids for Each Perspective Pair Using a Time Recursive Approach

### Using Previous Frame Depth as a Prior Speeds Evaluation

### Low to High Resolution Priors Speeds Evaluation of High Resolution

Starting with the lowest resolution, initialize to the depth map from previous frame time
Scale the previous depth estimation to the current resolution
use the depth estimate as a prior to accelerate the current depth estimation
apply stereo matching to the selected resolution to generate disparity or depth cost map

This creates a hierarchical depth map, progressively more accurate as resolution increases

### 4. Disparity Conversion

Geometrically Convert Disparity Map to Depth Map, or vise-versa as needed

### 5. Post-Processing Refinement:

Areas of perspective pair depth maps which appear to have depths outside the volume of interest can be considered occlusions. These areas can be removed from the image formation process if desired.
Detect maps with Occlusions above volume of interest
Detect maps with Occlusions within the volume of interest
Detect maps with no Occlusions
Apply real world Constraints to Depth Maps as needed
Preserve edges, but smooth non-edges to remove noise using bilateral or similar filtering

### 6. Multiple Non-Occluded Depth Cost Map Data can be Constructively Combined for Increased Resolution.

### Aspects of the Camtrix LightField 3D Microscope Project

### Overview:

### ECT

Image processing for applications such as remote piloting and surgical enhanced vision place great demand on very low latency processing. Many years ago, working in this application domain, I developed a general image processing approach which covers a wide range of image processing tasks while minimizing both processing latency and hardware implementation cost. I refer to this collection of techniques under the domain of Elastic Convolution Transforms (ECT).

The ECT approach is typically implemented as a stream process, minimizing local storage requirements to that needed by locality requirements, and making process steps independent of sensor frame integration time. As a result, ECT latency is typically represented as line times, where a line is a sensor intgration or frame output rate divided by the number of image lines, representing a processing latency, a (rolling) processing locality, and an ECT local information storage requirement.

### Camtrx Topics:

### Optical Correction Using an ECT in 9+L Line Times of Latency

Sub pixel accurate elastic geometric distortion correction and resolution resample (pan/zoom).
L is the maximum supported optical and geometric distortion
L=20 would provide for elastic correction within L/2 or a 10 pixel correction radius
Geometric, MTF and focus correction as a function of location
General frequency response filtering
General homomorphic filtering
Direct Resolution Representation noise reduction
High quality interpolation from Bayer to full band chroma representation
Conversion of optical sensor input to a calibrated metric space

Geometric merit merge based super resolution in 9 lines of latency
Can include general filtering and other functions
Can include windowing for User Interface, grids, magnification and other operations
Provides a roughly 2× resolution enhancement over single perspective

Multi-perspective Bayesian and Maximum Entropy super resolution
4 to 10 generation iterative process required
super resolution algorithm using ECTs in approximately 72 to 180 lines of latency

Multi-perspective optical depth analysis in one frame time of latency

3D rotations, projections, and zoom operations
Many 3D rotations, projections, and zoom operations can be supported at low latency
Separate formatting for
light field monitors
stereoscopic headsets
conventional HD video included

### Ocutrx Camtrx Lightfield3D™ Microscope Patent Updates

The discussed changes are intended to improve overall functionality and extend capabilities. In particular the addition of mechanisms suitable to directly view and identify ERMs in fundus surgery without dyes, and provide better overall tissue visibility and discrimination of viable and non-viable tissue in neurological procedures. These capabilities are provided by the addition of some selected hyper-spectral, pseudo-color and auto-fluorescence capabilities enabled by a more capable and flexible illumination and image sensor system capable of supporting the visible and near infrared (NIR) spectrums. Other improvements include changes to auto calibration which help enable the additional functionality and functional improvement, a substantial improvement to the high speed geometric super-resolution processing, and an improved depth map generation approach which dramatically increases depth map resolution while maintaining reasonable latency. Finally a method to support a Bayesian and Maximum Entropy approach to super resolution, noise reduction, and contrast enhancement at low processing latency.

### Improvements to Auto Calibration

Increasing the potential resolution of depth map generation to support additional features such as hyper-spectral support and improved focal correction increases the demand on auto calibration. Correction of geometric alignment, geometric & MTF lens distortion, and geometric projection previous to depth analysis and focus correction remains the same. Minimizing the impact of black level, gain and linearity of each camera channel is required to increase depth resolution. This can be accomplished by applying black field, flat field and linearity to auto-calibration of each channel before depth analysis. In theory, it may also be possible to achieve independence from these variations by applying a vector curl angle operator previous to depth extraction. Curl angle should be largely immune to specific levels. Reducing noise levels previous to depth analysis would also be desirable. The ECT operator can utilize Convolutions, Lapped Orthagonal Transforms (LOTs) or multiple band wavelets in addition to Look Up Tables (LUTS) for noise filtering, frequency response compensation, frequency specific noise reduction and signal linearity correction.

### Improved Depth Analysis

Originally a low resolution depth map (with resolution on the order of 1 mm) was proposed to minimize processing latency and allow reasonable image output rendering quality. This resolution is fine for general 3D rotation and projection requirements. It is less than ideal for computational focus optimization, or advanced super resolution and hyper-spectral processing. A depth resolution on the order of 0.1 mm or better would be preferred for these features.

To achieve this depth resolution, an iterative depth cost algorithm is typically used. The unique challenge is how achieve the desired resolution with the minimum number of iterations, and how to implement each iteration with the minimum possible time latency. The total number of iterations required can be minimized by starting the process assuming the previously calculated depth map, and evaluating current data starting at a fairly low resolution, and iterating at progressively higher resolutions until the desired resolution is achieved. The latency of each iteration (time until the next iteration can start) can be minimized by localizing each depth cost iteration into a local stripe of the image, which progresses through the entire image. The following iteration can start as soon as the stripe from the previous iteration has processed one stripe of information. If the depth cost algorithm can be localized into a process which can operate with 20 lines of locality, and 10 iterations are required, then 200 lines of latency (one tenth of a 2048 line image frame time) is the required added latency needed for high quality iterative depth cost analysis.

### Improved High Speed Geometric Super Resolution

The initial approach calibrated all channels to a common reference grid of samples at basically the same sample resolution as the source sensors and applied a merit (typically 0 . . . 7) to each sample from each source based on observation angle which was derived from a low resolution depth map, and then a merit merge was preformed to yield a weighted merge of perspectives. This preserved increased acuity resulting from favorable relative view angle of the surface slope, and avoided loss of acuity when the relative view of the slope was unfavorable.

A significant improvement in high speed Geometric Super Resolution (GSR) can be achieved by resampling each source to a common higher resolution sample grid with a significantly higher resolution (nominally 2× to 4× higher) than the source sensor grid. This preserves the unique high frequency information from each perspective. The same merit merge can be applied to weight individual perspectives based on relative view angle, but it is no longer an essential step. A convolution filer can apply a high frequency boost to recover a significant portion of the perspective dependent high frequency information with effectively no additional super-resolution processing latency.

### Bayesian Super Resolution & Image Enhancement

The image sensor array provides ideal source information for Bayesian analysis, noise reduction and super resolution. The plenoptic sensor array with expanded auto calibration now provides magnitude calibrated information resampled onto a common sample grid with unique perspective information. Each sensor samples a unique trapezoidal sample grid based on perspective view angle, assuring every pixel has a unique view or sample location, providing unique information. This diverse set of samples with high resolution 3D depth information is the ideal source data for Bayesian processing. Similar to latency issues for depth analysis, the key to fully exploiting Bayesian processing at low latency is to localize the iterative process step into a rolling stripe which can be passed through the image with minimum latency. This allows multiple iterations (typically on the order of 10) to be chained together and processed in much less than a single frame time. This improved localization also has a signal processing advantage over typical full frame processing. Bayesian processing makes improvements by solving the inverse sampling problem. The more accurate and local the prior statistics are, the more accurate the inverse solution will be.

### Enhanced Presentation Freedom

Traditional optical microscopes constrained the relative position and orientation of patient and surgeon. Camtrx separates optics and sensors from the processing and display to decouple the positional constraint, vastly improving positional freedom and ergonomics. The next step is allowing the user to control how sensor data is processes and presented, which requires capabilities for advanced image processing, rotation, translation, projection and presentation. A video demonstrating some of the image processing and presentation degrees of freedom provided for the user will be made available.
Ergonomic separation of acquisition and presentation (covered elsewhere)
Computationally extended depth of field (beyond prime optical focus)
Occlusion resistance (seeing around-through finger & instruments covered elsewhere)
Presentation control (position, orientation, focal lenght, and other details)
Advanced filtering, pseudo-color, and hyper-spectral processing and presentation
Conventional, Stereoscopic or Lightfield 3D image output display (covered elsewhere)

### Extended Depth of Field

Extending depth of field is achieved by computational focus enhancement controlled by depth of surface measured by perspective analysis, which allows prime focus to be maintained throughout the volume of interest, typically over a depth of 20 to 25 mm

### Perspective and Presentation Control

Control of how the optical data is presented allows the user to do a “walk about” around or within the current volume of interest, zoom in on specific features and view them at any desired angle or distance, while controlling the image processing resources to dial in advanced filtering, pseudo-color, or hyper spectral presentation features.

### Advanced Filtering

Homomorphic filtering can greatly enhance the visibility of low amplitude signals in luminance, chrominance, or derived signals such as hue or saturation, allowing subtle features which may normally be invisible to human vision readily apparent.

Any frequency response map can be applied in real time to any, all, or combinations of image components, and/or image regions, allowing operations like boosting overall sharpness, boosting only color sharpness, or blue sharpness, or some pseudo-color sharpness, or a phase contrast view of the red component, or a change applied only to a specific region of the image.

Vector and tensor filter operators can be applied to color or luminance components and combinations to enhance textures, improve 3D perception, display spectral coupling, and discriminate features. Image components can be processed in a linear, log, s-curve (scaled offset TanH derived adjustable S-curve) or a custom ad-hoc domain

### Pseudo-Color and Hyper-Spectral Image Processing Issues and Opportunities

Human vision is well attuned to the peak solar power output spectrum. However it is less well suited to differential and broad spectrum correlated color differentiation which would be useful for tissue analysis. Differential response to specific wavelengths in the visible or extended spectrum is useful to highlight structures of interest or make specific components such as hemoglobin appear to be transparent, for example. Many components of tissue are best viewed in near infrared (NIR) optical wavelengths to avoid excess absorption by hemoglobin and water. In particular the spectrum from about 750 nm to 950 nm is particularly attractive for surgical use.

Pseudo-color refers to remapping visible or non-visible optical wavelengths or their correlations or anti-correlations into wavelengths which are recognized visually. Near ultraviolet (NUV) visible and near infrared (NIR) as well as coupled or differential responses can be mapped onto the human visual perception, to allow human vision to “see” specific tissues, or “see through” blood, for example.

Hyper-spectral imaging typically refers to extending the visual range to include the near ultraviolet (250-300 nm) and the near infrared (750-950 nm) sometimes up to 1200 nm, and then measuring the response over many narrow bands often 5 nm to 10 nm wide. This allows vastly more information to be collected about the properties of tissues being viewed. Hyperspectral imaging can be configured and employed as a real time direct or differential spectrograph to see through selected obstacles such as hemoglobin and uniquely identify other materials such as Cytochrome c to identify viable tissue. The results can then be mapped onto the human visual spectrum for presentation.

Camtrx can provide these capabilities by replacing a portion of camera sensors with wide spectrum sensors, and supplementing specific spectra with narrow band LEDs of the desired wavelengths, which can be enabled individually or in groups or time modulated in sync with sensor image capture. The narrow band LED illumination can be additive to standard visual illumination, resulting in a “differential” hyper-spectral mode of operation, or used as the exclusive illumination providing a pseudo-color mode of image acquisition.

Alternate methods could employ optical filters, tunable optical filters, tunable LEDs or tunable laser illumination.

### Implementation

There are several possibilities to address camera requirements for hyper-spectral support. We currently expect to use 8 cameras for the conventional visual spectrum version. A minimum impact hyper-spectral derivative could replace four of the 8 current cameras with four wide spectrum cameras of the same physical size and lens type. Such sensors are currently available, designed for technical, medical, and security applications. These wide spectrum sensors are available color masked or unmasked. If and when desired, the lenses for these cameras could be fitted with a NIR pass filter to block visual illumination. Arrays of narrow band LEDs, each with 10 nm wide spectrum can be controlled in sync with image sample time. Up to (950-750)/10 or 20 sets of individual spectrums would be needed to cover the full NIR range, while (950-250)/10 or 70 types cover the full sampled spectrum. However, for most applications, only a handful would be required to stimulate differential responses, provide specific pseudo-color illumination, and stimulate specific auto-florescence. These would be operated either as pulsed, time multiplexed, or continuously at a single selected spectrum or as a collection of wavelengths. Other potential alternatives include increasing the number of cameras, such as a 6+3 or 8+4 configuration, or switching entirely to wide spectrum cameras.

### Lens Transmission Efficiency and Focal Length Issues

If optical glass lenses are used, no significant problems are expected regarding transmission efficiency from near ultra violet to near infrared. Spectra response can be added to the auto-calibration process if needed. There would be as light spread of prime focal depth in the NIR spectrum. Using a subset of cameras primarily for NIR spectrum components allows the spread to be compensated for by lens adjustment and/or computational focus enhancement.

Unique ERM Visualization without Dye

A number of optical characteristics result from the physical and biological properties of ERMs which are suitable for visualization without utilization of a dye applied during surgery. The simplest to detect and most unique to ERMs appears to be collagen structures which are unique in the neighborhood of the retina and form birefringent polarizations of spectral components in the near infrared. A few more of the many possibilities include:

### Relatively Unique Characteristics of ERMs

Polarization changes due to hyaluronic acid concentration and local hydration
A unique reflective spectral signature resulting from the high content of collagen and elastin
NADH and flavins concentrated in ERM have specific auto-fluorescence characteristics
Less unique to ERM but indicating oxidative stress and metabolic activity, respectively
Lipofuscin is highly auto fluorescent and is often found in ERM & RPE
Cytochrome C is highly photo-reactive in NIR and is often found in ERM & RPE tissue Improved Neural tissue visualization

It appears that the primary problem with visual differentiation in neurological surgery is the pervasiveness of hemoglobin and its high opacity over the entire visual spectrum. A secondary problem is general tissue discrimination. Fortunately, hemoglobin is roughly 100 times more transparent in the near infrared providing a window through this issue. Imaging and spectral analysis of both the visible and NIR spectrum and using that information to synthesize a visual pseudo-color presentation for display should vastly improve tissue visibility. Additional hyper-spectral techniques can be used to further improve tissue differentiation. Myelin produces a birefringence effect which can be detected and used to easily identify nerve fiber. Cytochrome

C is present in viable nerve cells and is readily detected by its narrow spectrum, allowing viable nerve tissue to be distinguished from less metabolically active tissues and non-viable nerve tissue. Additional hyper-spectral analysis should allow access to many new tissue analytic and visualization capabilities.

### High Level Camtrx Image Processing Path Block Diagram Description V7

### Block #1 Illumination and Control

### Addition: On Axis External Illumination

Camtrx now supports on axis external illumination which is particularly significant for fundus viewing.

This may eliminate the need for invasive internal fiber optic illumination methods in most cases.

### Addition: Hyper-Spectral Illumination and Control

For improved tissue visibility and identification, adding support for near infrared and possibly near ultraviolet wavelengths, emission and sensor polarization, and narrow spectrum pulsed illumination synchronized to image sensor integration time, to analyze differential absorption, reflection, auto-fluorescence and birefringence.

### Block #2 Image Acquisition Sensor Array

On the order of eight image sensors arrayed arrayed around the central axis and aimed so that individual optical axis all converge at a single point on the central primary axis at the bottom center of the volume of interest.

Addition: Image Acquisition Hyper-Spectral Sensor Array (with Optional Filters and Polarizer)

To support some hyper-spectral capabilities, a portion or potentially all image sensors can be replaced with high quantum efficiency broad spectrum sensors. These broad spectrum sensors would provide similar angular resolution and use the same lens assemblies.

### Addition: Optional Polarizing or Narrow Wavelength Filters

Camera lens assembly would support various optical wavelength pass and blocking filters and polarizing filters for various differential analytical capabilities to support hyper-spectral analysis of various optically active substances and tissues

### Block #3 Source Image Perspective View Auto-Calibration

For each perspective view camera and lens assembly:
Frame storage and read/write interface portal for computer read/write access to image data used for collecting raw auto-calibration images, system testing, and development
Data storage and read/write interface to auto-calibration control data used to store the precomputed auto-calibration Elastic Convolution Transform (ECT) program which implements the desired calibration of each perspective view
ECT Transform for image calibration based on auto-calibration data
Position & Geometric Orientation Correction
Geometric Distortion Correction
Wavelength/color and position specific MTF Correction
Wavelength/color, position, and depth specific Focus Correction

Addition: Hyper-Spectral Calibration requires specific illumination, calibration target features and filters to fully map performance throughout desired spectrum.

Addition/Option: Bayesian super-resolution can under some conditions do an excellent job of correcting focus and point spread. If auto-calibration information can be converted into adequate prior constraints then a Bayesian inverse problem process could likely address these operations for both visible and extended spectrum.

### Block #4 Auto Calibration Computer Interface

### Block #5 Coarse Depth Analysis

Coarse depth analysis endeavors to generate a depth and occlusion map for the cone of view in each frame time, with roughly 1 mm resolution within the volume of interest

### Occlusion Detection and Perspective View Masking

Coarse depth analysis detects occlusions unique to a single perspective or above the volume of interest. In either case, a low resolution occlusion mask indicates the occluded portion of particular perspective image(s) to later processing steps. The mask information is used later to either entirely remove the occlusion or provide a largely transparent or translucent analog.

### Block #6 New Addition: High Quality Low Latency Depth Analysis Using Iterative Depth Cost

Higher quality depth information is desirable to enable better super-resolution results. High quality depth analysis computes the surface depth and detects occlusions within the volume of interest (VOI).

Any improvement over Coarse Depth Analysis can provide some improvement in super-resolution results. Depth resolution on the same order as the linear pixel pitch within the VOI would be ideal.

### Block #7 Depth Aware Perspective Merge

Perspective Rotation, Translation, Projection, Magnification, Filtering by ECT
Perspective merit is derived from relative gradient which is derived from depth map and perspective
Perspective Scale and Merge operation supporting Merit Based Super-Resolution
Addition: User Viewing Angle Optimized Perspective Merge
Option/Addition: Scale and Merge with Oversampled Super-Resolution
Option/Addition: Scale and Merge with Bayesian Super-Resolution
Addition: Hyper-Spectral feature detection

Some basic hyper-spectral capabilities were added to provide possible solutions for specific procedures such as replacing dye in ILM peels, and improving blood transparency in neurological procedures

Addition: Hyper-Spectral information to Pseudo-Visual conversion

NUV, NIR and differential information and any other analytical information is folded into the visible representation, or possibly added to user interface mask or annotations.

### Block #8 Image Enhancement Filtering User Options Implemented as an ECT Processing Stage

Frequency response reshaping, pass band control, noise reduction, etc.
Homomorphic filtering
Phase Contrast filtering
Vector Operator Derived Filtering

### Block #9 Computer Interface Portal for Image Read/Write, Windowed UI and Diagnostic Access.

Computer enabled user interface windowed displays and overlay functions
Initial development and testing support
Computer Assisted Image Enhancement and advanced filtering
Computer Assisted Bayesian Super Resolution development
Computer Assisted Feature Search, Measurement and Identification
support computer assisted advanced features in production model
Generate Diagnostic Information and Metadata
   Block #10 Merge Output Perspective with User Interface Data & Annotation
   Block #11 Generate Final Perspective Views for the desired output(s)
Generate Lightfield Monitor Resolution and Perspectives,
Generate Stereoscopic Headset Resolution and Perspectives
Generate Video Resolution Perspective

### Block #12 Image Output Formatting

Light Field Monitor 3D output formatting
Stereoscopic Headset stereoscopic output formatting
Video output formatting

### Important Capabilities, Features, Additions

Optical approach utilizing an optical sensor array configuration enables:
High resolution eye and fundus viewing at a significant standoff distance
Very wide field view (potentially 180 degrees or more) continuous real time fundus or external eye viewing can be achieved at a significant standoff distance, facilitating access.
Significant perspective view angle separation can be supported, improving depth perception

Plenoptic camera array with multiple perspectives enables:
Resistance to occlusions (fingers, tools) between volume of interest and sensors
Can present occlusions as translucent low density “clouds”, but still allowing good view and contrast in the volume of interest
Occlusion detection and processing allows complete occlusion elimination if desired
Provides much wider available field of view than would typically be available
Provides much improve depth information and depth perception
Multiple perspective view angles provides an abundance of 3D surface information which enables increased precise surface depth analysis, presentation and visualization
Multiple perspective view angles provides an abundance of surface texture, color, and contrast information for processing and enhancement, resulting in a more meaningful visualization

### Multi-View Calibration & Correction, Analysis, and Information Merge Followed by Rendering the Desired Perspectives Provides New Degrees of Freedom for Image Presentation to the User

Real time position, rotation, translation, zoom, and focal length selection and real time motion path animation of all of these parameters.
Options to select and generate the presentation view provides the user with a profound viewing and inspection experience. The user can easily zoom in on an area of interest, new do a “fly over” of the fundus from a perspective inside the eye, exaggerate perspective by selecting a low numerical focal length, increase magnification by controlling zoom and adjusting any of the supported parameters
Real time multiple perspective output for display on a Lightfield monitor, stereoscopic headset, or conventional video monitor technology

### High Speed, Low Latency Processing

Use of numerous novel image processing techniques with improved mathematical locality to reduce processing latency to a fraction of sensor and display frame time.

### Lightfield, Stereoscopic and Conventional Display Presentation

Multiple views can be rendered in real time to support current and future light field monitors
Stereoscopic views can be rendered in real time to support current and future headsets.
Single views can be rendered for current television and monitor displays.

Advanced Filtering control provides user with a unique range of image processing and viewing opportunities.
Frequency domain filtering to reduce noise, enhance contrast or specific structures
Vector domain filtering to enhance certain luminance or color gradients
Homomorphic filtering to greatly increase contrast of a specific aspect

### Hyper-Spectral Tissue Analysis

Use selected light wave lengths individually or in combination to highlight specific tissues
Use selected light wave lengths individually or in combination with vector operator or homomorphic filtering to accentuate features, tissues, or disease processes

### Image Acquisition and Signal Processing Path Auto Calibration of Perspective Views

Auto calibration collects specific relative placement and angular orientation, optical modulated transfer function, optical geometric distortion, and optical depth-focus response
Auto calibration helps control physical structure cost
Auto calibration improves tolerance to shipping and produce movement
Auto calibration facilitates field maintenance
Auto calibration is an effective self diagnostic in regular use
Most importantly, auto calibration enables the realization of correctly aligned ultra high quality optical performance achieved through calibration and correction processes to enable advanced image processing and the resulting image projection, enhancement and presentation

### Operational Optical “Calibration”, “Perfection”, and Super Resolution Processing

Calibrate sensor orientation, optical Modulated Transfer Function (MTF), geometry, and sample grid using specialized low latency image processing (A single Elastic Convolution Transform (ECT) pass, typically requiring under 20 line times of latency)
Occlusion analysis uses image statistical characteristics to screen for occlusions significantly above the volume of interest, which can then be excluded from Depth Analysis. Occlusion analysis processing can be merged with the previous calibration process.
Depth Analysis uses a depth cost algorithm modified for ultra-low latency to generate a high resolution depth map from the non-occluded, calibrated perspective information.
A ten iteration depth cost analysis will take on the order of 200 line times of latency
Alternate low resolution depth analysis uses a perspective projection and comparison to generate a low resolution depth map directly from calibrated perspective information. A best connected surface search will take on the order of 50 line times of latency to produce a low resolution depth map.
Both depth methods can employ vector curl angle filtering to improve accuracy, reduce ambiguity and speed convergence.
With precise calibration and depth information the perspectives can be constructively combined for reduced noise, increased contrast, and increased resolution beyond individual sensor resolution.
A high processing speed approach in the frequency domain requires about 20 line times of latency, and can provide a roughly 3× increase in linear resolution over the initial sensor resolution (i.e. if full field resolution is 2000×2000→6000×6000)
A more complex and slower Bayesian super resolution & maximum entropy approach, optimized for low latency processing, would start with the frequency domain results and apply an iterative algorithm requiring 200 to 400 line times of latency.
The final result may provide two or more times the linear resolution of the frequency domain base resolution improvement. (i.e. if initial resolution from frequency domain processing is 6000×6000→12000×12000 or more) as well as providing reduced noise and increased contrast.

### The Camtrx Concept Provides a Number of Unique Features

Plenoptic acquisition and analysis enables N perspective views verses mono or stereo views N views enables new forms of perception to address key human visual limitations, When combined with suitable image processing the concept enables:
(1) Visibility around and/or through occlusions
(2) Unique omnidirectional perception of surface profiles, textures and tissues
(3) Differentiation of subtle color or contrast previously invisible

The super sampled perspective information resulting from N perspectives enables:
optimization of
(4) depth perception
(5) focus
(6) image noise reduction & improved contrast
(7) increased image resolution N perspectives enables addition of hyper-spectral perspectives
(8) enables real time differential analysis of composition
(9) enables human visual representation of analysis based information
(10) enables selective transparency
(11) enables highlighting specific analytical tissue features
(12) Unique image processing methods are used to support fine hand eye coordination
(13) External fundus illumination dramatically simplifies and speeds procedures
(14) Optical standoff distance improves mechanical access and simplifies sterile procedure
(15) Eye fundus view perspective enhancement
(16) Occlusion resistance for fundus procedures inside the eye
   Visibility Around and/or Through Occlusions

Human vision has some ability to deal with occlusions oriented in the vertical dimension due to its stereoscopic nature. A finger held vertically at arm length allows both the finger and the background to seen. Concentrating on the background results in the appearance of two semi-transparent fingers.

In contrast, a horizontal finger blocks the background view from both eyes due to alignment with the single perspective axis. Standard stereo microscope views duplicate this human perception limitation.

Camtrx prepossessing provides complete control of the occlusion perception process, allowing the nearer occlusion to be completely removed, or appear as a single semi-transparent image when in the volume of interest if desired. This is why more than two perspectives is essential to the Camtrx occlusion tolerance functionality. In general the more perspective views, the more capable the potential occlusion resistance can be.

### Unique Omnidirectional Perception of Surface Profiles, Textures and Tissues

In similar fashion, Human vision is more sensitive to surface texture in one orientation. The Camtrx view is effectively omnidirectional, and surface texture information can be rotated to the preferred visual orientation, or mapped into luminance to interface with human visual capabilities.

### Differentiation of Subtle Color or Contrast, Previously Invisible to Human Vision

Excellent human vision can discern a well defined transition in luminance on the order of one part in 2000 to 4000, with color discrimination typically much lower. Images with significant noise or transition gradient drops this to a range of one part in 100 to 200.

With the perspective oversampling combined with noise reduction processes and statistical analysis, Camtrx can resolve differences on the order of one part in 128,000 or better. Providing non-linear remapping and filtering of appropriate luminance and chrominance information into the human visual perception range allows very subtle detail to become clearly visible.

### Multiple Perspectives Provides Super-Sampling of the Volume of Interest.

### Depth Perception

Human perception works with two perspectives with relatively poor angular perspective and sensitivity calibration. Increasing the number of available perspectives, combined with the precision provided by perspective and response function auto-calibration provides the information needed to provide a very precise and calibrated depth map. This can be presented to the user as actual distance annotations or exaggerated visual perspective.

### Focus

Accurate depth measurement enables accurate computational focus enhancement, for improved resolution and higher contrast from each perspective

### Image Noise Reduction & Improved Contrast

N perspectives increases the oversampling of the area of interest, enabling the reduction of image noise by approximately N\hat{ }(½). The reduction of noise increases available feature contrast by a similar amount.

### Increased Image Resolution

N independent but tightly calibrated perspectives at R\hat{ }2 resolution combined with accurate depth information provides some additional information at up to N times the individual perspective sample frequency, providing some information at up to (R*N)\hat{ }2. This enable increased useful magnification.

Using N perspectives enables some perspectives to support hyper-spectral perspectives.

With an adequate number of perspectives available, some can be dedicated to optical wavelengths outside the human visual spectrum, allowing more analytical operation, with selected results mapped into the human visual spectrum for additional information presentation suitable to the human visual system. Combining hyper-spectral perspectives with selective hyper-spectral illumination adds a substantial range of analytical and visualization aids.

### Enables Real Time Differential Analysis of Tissue Composition

Various tissues and fluids have various components which have selective spectral reflectance, absorbance, auto-fluorescence or birefringence. Emitting appropriate spectral components, potentially time modulated relative to frame sample time in the illumination, and sensing appropriate, potentially different spectral components or polarizations, and appropriate additive or subtractive processing of sensor data allows significant tissue composition information to be collected in addition to the visual scene.

### Enables Human Visual Representation of Hyper-Spectral Analysis Based Information

The resulting information can be mapped into the human visual spectrum to either complement the standard visual image or replace it with a complete pseudo-color mapping of the analytical display.

### Enables Selective Transparency

Some procedures are visually hampered by substances such as blood hemoglobin, for instance. Hemoglobin is quite opaque in the visual spectrum but fairly transparent in the near IR around 810 nm. Mixing displayed visual luminance with this 810 nm IR signal could greatly improve this issue.

### Enables Highlighting Specific Analytical Tissue Features

Some procedures are currently complicated by the use of dye to make certain features visible. As one example, birefringence can be used to detect collagen chains which are a characteristic component of the ILM which is a common target of the dye based approach in eye surgery.

### Unique Image Processing Methods are Used to Support Fine Hand Eye Coordination

An optical instrument supporting human surgical hand eye coordination must minimize latency. A unique aspect of the Camtrx approach is supporting advanced processing methods in a fraction of a frame time. This is accomplished by converting a number of operations which would individually require one or more frame times, into a cascade of localized operations which each add a small number of line times to the overall process. This requires both reformulating the required math of the operations into local processes, and the hardware implementations into low latency solutions.

### External Fundus Illumination Dramatically Simplifies and Speeds Procedures

The standard BIOM lens and stereo microscope approach makes eye interior illumination difficult.

It is often accomplished surgically with a fiber optic appliance.

The Camtrx approach supports multiple perspective internal eye viewing with illumination supplied by an external on axis light source.

### Optical Standoff Distance Improves Mechanical Access and Simplifies Sterile Procedure

The Camtrx large standoff distance (50 mm or more) provides a very significant improvement in eye access compared with a BIOM lens effectively in contact with the eye lens.

### Eye Fundus View Perspective Enhancement

Current eye fundus viewing microscopes provide two perspectives with roughly 10 degree perspective separation. In addition to increasing the number of perspectives in use beyond two, Camtrx provides larger perspective separation which increases depth perception and fine surface detail. Due to the unique optical approach perspective separation should be at least 30 degrees and may approach 60 degrees and possible more.

### Occlusion Resistance for Fundus Procedures Inside the Eye

The two narrowly separated perspectives of stereo microscopes provide little to no occlusion resistance inside the eye. Multiple widely separated and fully surrounding perspectives along with suitable processing provide vastly improved tool occlusion resistance, providing the ability to see through occluding tools in the foreground for procedures inside the eye.

### Super Resolution Based Magnification and Image Enhancement:

### Background: (Summary of Initial Approach)

Assuming a configuration using multiple sensors with Rx×Ry pixel resolution and appropriate optics to cover the area of interest, Camtrx has individual sensor linear resolution of R=min (Rx,Ry)

If multiple sensors are arrayed around a view axis and all converging on the same volume and surface of interest, each sensor provides a unique perspective and additional high frequency information.

Accurate measurement of sensor and optics performance as well as actual individual camera alignment at system start up, followed by continuous computational calibration and correction of all image sources based on that calibration data during operation provides the ideal environment both for dealing with occlusions and providing output image super-resolution. An Elastic Convolution Transform (ECT) can readily be implemented in FPGAs or ASICs to provide such an operation at high quality and with very low processing latency. A varying surface height profile in the volume of interest presents surface angles providing regions with either higher or lower resolutions from each sensor. Using depth map data to generate gradient information and geometrically mapping this onto each sensor perspective allows each pixel derived from each sensor to be assigned a figure of merit. This merit can be utilized to preserve the highest resolution information available for each region. A completely flat surface of interest and typical sensor perspective angles results in an approximate 1.5×R increase in resolution, while a typical surface profile can easily provide an increase to on the order of 2×R.

New Addition—Improved Geometric Super Resolution with Zero Additional Time Cost:

Each image sensor perspective is at an offset from the view axis, resulting in a slightly trapezoidal view of the volume of interest at each unique view angle. These sample grids when combined with precise auto-calibration information provide perspective unique sample data which is ideal for super-resolution processing. The primary challenge is achieving the required processing at an adequately low processing time latency to avoid disrupting hand-eye coordination. The ECT output from the calibration process maps each source perspective onto a common reference framework. If this calibrated version of each sensor dataset is generated from the source data at a resolution higher than the original source sample grid, then the unique perspective specific sample information can be preserved through the merge operation. In this case, a filter providing a high frequency boost operation can restore the amplitude and reveal much of this high frequency information, with no increase to processing latency. This combination of geometric and sampling based super-resolution would increase the useful resolution.

### New Addition—Low Latency Version of Bayesian Super Resolution and Image Enhancement:

As mentioned previously, the calibrated sensor array provides ideal source data for super resolution processing, such as Bayesian analysis of the inverse problem of solving for the original high resolution source image, given multiple low resolution prespectives. The typical implementation is an iterative process introducing many frame times of latency, which is unacceptable in this application. Implementing this type of algorithm as a narrow slice moved across the image data (as an ECT like scanning process), can reduce the processing latency for 10 iterations from 10 frame times to 10 slice times which is on the order of 100 times less latency and would be acceptable. In addition, the necessary increased locality of the prior statistical constraints appears to improve performance and speed convergence. This approach can improve resolution and can also be configured with constraints which enhance contrast, reduce noise, and improve focus.

### Depth Map Processing

### BACKGROUND

The Camtrx Lightfield3D™ Microscope utilizes multiple perspective views to provide the ability to see around or through occlusions (hands and tools, etc.) above the surface of interest. This involves constructively combining the various perspective views which requires a depth map and gradient map.

Initial goals of occlusion identification, occlusion processing and a merit based geometric super-resolution could be achieved with a relatively low depth map resolution with on the order of 0.5 to 1 mm quantification. Higher depth resolutions were initially considered too computationally difficult to achieve in the available processing time.

The potential for dramatically improved image quality and magnification by means of improved geometric and over-sampling super-resolution or a Bayesian super resolution approach both require a surface depth map with a linear resolution close to the pixel pitch, (which is more than 20× better than the initial goal) which implies a roughly 20\hat{ }3 or 8000 fold increase in the computational burden of analyzing a volume based autocorrelation of perspective projections to yield a most strongly connected surface. The occlusion depth map has much more relaxed resolution requirements and could continue to function with a low resolution depth map.

### High Resolution Iterative Depth Map Processing:

The previous frame time depth map for the surface of interest is a reasonable initial guess for what the current depth map should be. Using an iterative depth cost algorithm reduces the 3D depth analysis problem to an iterative 2D problem. Iterative algorithms are typically avoided in low latency applications, but by using the sliding slice approach discussed for reducing latency of the Bayesian inverse problem processing, each iteration can be reduced to a modest number of line times of latency. The previous depth map used as the initial guess would typically start close to the current depth and rapidly converge on the current depth. Even in cases of rapid movement, this approach should still converge on the actual depth rapidly, especially if the depth cost algorithm utilized a geometrically decreasing uncertainty range in its iterations. In the case of rapid movement which is beyond the ability to converge to adequate accuracy, the significant depth error could generate some transient image blurring which would look like motion blur to the user.

### High Standoff Distance Fundus Viewing

### BACKGROUND

Eye fundus viewing is typically accomplished with a BIOM lens at or near the eye to optically couple the eye interior to a viewing microscope. There are optical, mechanical and sanitation drawbacks to this approach. In addition, fundus illumination then typically involves invasive in eye illumination approaches. Perspective view angle separation is typically small, reducing depth perception.

### External on Axis Wide Angle External Fundus Illumination

High standoff distance wide angle fundus illumination has been demonstrated as feasible and compatible with the Camtrx approach. A polarized on axis source and polarized sensor filter are likely required to control undesired reflections.

### High Standoff Distance Wide Angle Fundus Viewing

High standoff distance (50 mm and over) wide angle fundus viewing is feasible with the Camtrx approach. The extent of perspective angle separation related to potential user depth perception has not yet been determined or demonstrated.

### High Perspective (Wide View Angle Separation) Fundus Viewing

High standoff distance (50 mm and over) wide angle fundus viewing with up to 90 degree field of view and wide perspective angle separation is feasible.

### Camtrx Image Exploration User Paradigm

### BACKGROUND

Microscopes have traditionally been rather static, providing little freedom for change of perspective or movement etc. Camtrx attempt to allow the user the freedom to explore.

### User Freedom to Explore a Virtual Image Space

Once set up, calibrated, and operating, Camtrx provides a low latency motion stream of images of the volume of interest which can be processed and presented as the user desires. An array of perspectives is being captured and assembled into a real time database of the current “image” information, but the user has complete freedom over how this data with be rendered into an image or images and be presented to him. He can zoom in or out, change the relative viewing position and orientation, move to the very edge of the image and look across it, etc. Any viewing orientation or motion path he desires can be synthesized from the real time image database information. In addition to complete control of perspective, he can control an array of options to enhance, filter, highlight, measure, and/or record what he sees. Options such as a wide range of filters have control parameters which can be adjusted in real time and their effect instantly evaluated. The ability to rapidly dial in advanced filer parameters and see the result in real time will provide a dramatic improvement in viability and utility, particularly for fundus related procedures.

### Advanced Filtering Operations

### BACKGROUND

The initial disclosure did not mention specific filter operations for application support.

The ECT operator which is used pervasively in the proposed design has basic mechanisms for accurate conversion between sampling grids, mapping the component magnitude range, general convolution filtering, and remapping component magnitude. Additions to the basic operations can be provided to support typical color conversions, pseudo-color phase rotations, and vector operations among other operations. A number of filter types have already been very useful in preliminary image processing examples.

### Vector Operators Applied to Images

The standard vector operators (Div, Grad, Curl) can be applied to one or more of the image components and the result can be used to modulate one or more of the original image components.

As an example, the vector curl angle of luminance, phase rotated to imply the desired lighting angle, and then used to modulate luminance to a depth of about 25 to 50% provides a very realistic 3D surface texture. These operators are very sensitive to extremely subtle gradients and can make effectively invisible features in the original image obvious.

### Contrast and Aspect Magnification Operators

Human vision has difficulty discriminating slight changes in luminance and chrominance, especially if the transition is broad or noisy. Easy visualization of such changes is often the key to identifying the boundary of specific structures. (Good examples needed for all of these)

### Non-Linear Remapping

Non-linear remapping can expand a specific range of luminance or chrominance by up to 100 fold, making a nearly invisible transition obvious.

### Homomorphic Filtering

Homomorphic filtering uses non-linear remapping to expand the resolution of some critical portion of the transfer function, then applies a frequency response transformation to enhance the revealed aspect, and then typically inverts the non-linear transform to preserve the original contrast. The result is the dramatically increased visibility of some typically previously hidden aspect of the image.

### Pseudo Phase Contrast Filtering

Phase Contrast filtering is typically used by optical microscopes to add contrast to otherwise transparent specimens. A corollary to this operation can be done in the frequency domain of the image sample to accomplish the same goal of sharpening and increasing contrast.

### Coupled or Exchanged Component, Phase Shift, and Multi-Component Filtering

### Hyper-Spectral Operation for Neurological and Fundus Procedures

Background: In some fundus procedures, dye is introduced to identify a particular tissue of interest. This complicates the overall procedure. If an optical method can be used to uniquely identify the tissues of concern, the procedure would be greatly simplified. Extending illumination and image sensing beyond the viable spectrum as well as dividing the spectrum into narrower subdivisions, and supporting polarized illumination and sensing allows for a great deal more tissue discrimination.

In neurological procedures, the absorption and emission spectrum of hemoglobin makes it difficult for surgeons to see what they are doing. In additions, it would be desirable to have a visual method to discriminate between viable and non-viable nerve tissue.

In both cases, adding hyper-spectral capabilities to Camtrx should provide a solution.

### Adding Hyper-Spectral Imaging Capabilities

To convert the Camtrx from the visual spectrum to near IR (and potentially near UV as well) hyper-spectral operation, the main issue is replacing some or all of the camera sensors with a broader wavelength sensor, potentially covering near UV through near IR (roughly 250 to 1000 nm). One possible configuration is leaving half of the camera/sensors as they are, and replacing the other half with unmasked NUV to NIR capable sensors of approximately the same size and pixel resolution, which are available. Then add various narrow band LEDs to the illumination for specific wavelength illumination, and controls to potentially pulse them synchronously with sensor integration time to allow additive or subtractive response measurement. Provide polarization filters for the light sources used for birefringent imaging and polarized filters for the wide band sensors as well as optional narrow band filters for auto-florescence spectrum sensing. With these changes to the illumination, cameras, and optics, and some firmware and software changes, the Camtrx becomes a hyper-spectral capable device.

### Fundus ILM Identification

The ILM is a membrane on the surface of the fundus and is typically quite transparent in visible light, making it difficult to identify without dye. The birefringence of collagen in the ILM in the 550 to 570 nm wavelengths may provide an easy way to make the ILM visible without dye. Some preliminary tests indicate that non-linear remapping of color phase to greatly expand the contrast of specific color transitions may also assist in visualizing the ILM.

### Improved Neurological Surgical Procedure Visibility (FIG. 34).

NIR from about 750 nm to 850 nm is 100 to 1000 times more transparent to hemoglobin than visible light is. Using NIR imaging in this wavelength to provide some or all of the presented luminance information would provide a window through blood to the obscured tissue. Displayed output pseudo-color components could be obtained from specific spectral components in the NIR window as well, if desirable.

### Camtrx Lightfield3D™ Processes and Data Flow Overview

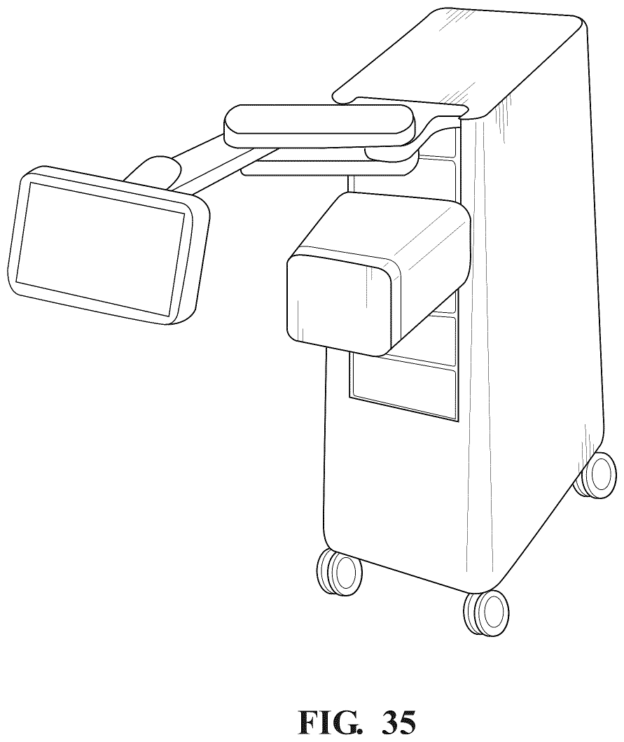

In one embodiment, the Camtrx LightField3D™ system (FIG. 35) employs novel optical, light field, and signal processing techniques to combine high resolution, low latency, 3D perspective, and user configurable advanced analytical and image enhancement tools into an integrated product. The processing steps to accomplish these results are outlined below.

### Operational Overview

Following power up, the user can specify illumination by a broad or narrow spectrum for each primary, as well as type of display (single perspective, stereoscopic, or light field). An auto-calibration process then measures various physical positions and orientations, as well as any optical distortion. Auto-calibration data is used to generate processes to calibrate depth perception measurement and image perspective input and generation of interpolated perspectives output. Measured displacements, geometric distortion and modulated transfer functions are all utilized to provide a calibrated common reference framework. In addition, this information is used to generate the corrective processes driving various Elastic Convolution Transform operators (ECT) to produce calibrated depth sensor data from the raw sensor data and to calibrate image sensor data from the raw perspective sensors, as well as generate the processes that drive the ECT processes which generate the interpolated perspectives.

### Common Reference Framework (CRF)

The common reference framework is a 3D map of the sensors and projectors and their relation to the volume of view, volume of interest and surface of interest and what corrections are required to map image sensor, depth fiducial and depth sensor data onto that framework. Auto calibration data is used to generate ECT programming to convert these various image sensor data sets onto this common reference framework.

### ECT Programming

ECT programming is the control data structure which determines the specific action that ECT hardware will implement. ECT programming typically supplies at least a source address, destination address, and selection of desired process (convolution, LUT, etc) for each data element processed (sample, pixel, color component, etc.). Either source or destination addresses may be implied by some default progression or generator function in the case of a purely geometric transform. ECT processing is typically implemented in a Field Programmable Gate Array (FPGA) or Application Specific Integrated Circuit (ASIC). An ECT is well suited to implement an arbitrary elastic conversion with value specific processing, and can typically include non-linear data value mapping and frequency domain transforms with no added processing time.

Conversion of Auto-Calibration Data into ECT Programming

The auto calibration data and user option settings are used to generate three sets of ECT programming. These include three sets of transforms: #1—ECTs to convert raw depth data from each depth sensor into geometrically calibrated data in the 3D CRF for that sensor, #2—ECTs to convert each set of image sensor data and corrected depth data into 3D image data in the 3D CRF, and #3—ECTs to convert 3D CRE image data into the required planar perspective views needed for the selected output.

### Depth Map Data Acquisition and Calibration

An accurate surface depth map in the CRF is critical for the 3D analysis of the image sensor source perspective correction ECT programs as well as the following perspective interpolation ECT programs. A surface depth measurement process collects depth image sensor data, then analyzes it for depth information and then uses an ECT programmed using auto-calibration data to map that depth map data onto the CRF, by removing any geometric or optical distortion. This depth information is critical to the analysis of source image perspectives as well as generation of interpolated output perspectives.

### Input Perspective Correction ECT Program Generation

The required input geometric and optical distortion for each image sensor is known from autocalibration. With this data, the ECT transform control code to calibrate input image sensor data and depth data into 3D CRF format can be produced.

### Interpolated Output Perspective ECT Program Generation

The output perspectives are generated from the 3D CRF image perspectives and depth map data. The required output perspectives are known when the output option is selected by user configuration. This provides the data to generate the individual ECT programs for each interpolated perspective.

### Actual Operational Processing

### Depth Map Extraction

Depth processing consists of depth image sensor sampling, followed by depth analysis and finally calibration to the 3D CRF reference space. Depth analysis is done by local frequency component analysis. The raw depth grid is then mapped to the 3D CRF using auto calibration data. Depth analysis consists of dividing the depth image into overlapping tiles, windowing the tile to highlight central data, transforming the tile using a sample to frequency domain transform, masking to access the desired frequency components, and then using either a depth of focus, focal point spread or geometric projection line spread analysis to map the frequency data into depth data. Depth data can be significantly lower resolution than image pixel resolution. For example, if a roughly 1 mm depth resolution is adequate, a 50 mm diameter region of interest would easily be covered by a 100×100 depth data point grid. If a 2000×2000 pixel depth image sensor is used, 40×40 pixel overlapping tiles would be satisfactory for depth extraction.

### Depth Map Calibration

Depth map calibration into 3D CRF is done by the ECT and control program created for that purpose using auto-calibration data. This compensates for any positioning, orientation, geometric or optical distortion detected during auto calibration.

### Image Acquisition, Correction, Perspective Generation and Interpolation

Image data is collected from a number of image sensors covering a number of perspectives. Each image perspective has its own ECT and program which converts that image data combined with the 3D CRF version of the current depth map, into 3D CRF space. Some image filtering and image enhancement operations can be folded into this transform to provide these capabilities with no increase in latency.

### Perspective Interpolation

The surface depth map and corrected image perspectives are used to interpolate the required output perspectives using the 3D CRF image and depth data and the ECT transforms and controlling data sets generation from output selection. Each input perspective can be converted into a prototype of each desired output perspective. The desired output perspectives are then merged into the final perspectives by evaluating a per pixel merit function which indicates the quality of each contribution from each perspective. Some image filtering and image enhancement operations can be folded into this transform to provide these capabilities with no increase in latency.

### Image Enhancement

Image enhancement can provide a wide number of user configurable services to improve clarity and utility. In many cases enhancement can be folded into other processes. In other cases typically involving full image forward and reverse transforms, additional latency may be required. Image enhancement includes ultra high quality real time image resizing to support desired resolutions and formats.

### Image Output Formatting and Display

The image stream can be formatted for display on conventional, stereoscopic, or light field displays. Processing options can be provided to provide some or all of these formats concurrently. Output can be formatted into media formats for video recording or media compression.

### Operational Timing Overview

Processing times estimated on 10 ms image acquisition integration time and mid-range FPGA. part based processing time times.
Assumes 10 ms frame image acquisition time, and 5 ms processing time increments
t+N is N×5 ms before or after source images are acquired
t−2 is the beginning of the current view beginning of sensor integration
t−0 is the current view accessible at the sensor
t+4 is the current view ready for output to display device

### Depth Map Acquisition and Analysis

Acquire Depth Image t−3 & t−2
Analyze Depth Information t−1
Corrected Dept Image available t−0

### Image Acquisition, Correction, Perspective Generation and Interpolation

Acquire Perspective Images t−1 & t−0
Correct Perspective Images t+1

### Perspective Interpolation Transform Generation

Needs processed depth data
Generate interpolation transforms t+1

### Perspective Interpolation

Generate Interpolated Perspectives t+2

### Image Enhancement

Most cases of:
Modification of frequency domain
Homomorphic filtering
Noise coring
Color space conversions
Pseudocolor processing
Folded operations no change in latency
Filters requiring forward and reverse full image transforms:
Phase contrast filtering
Assured channel quality filtering/conversion
Perception filtering
High quality resizing
Forward and reverse transform 10 ms

### Image Output and Display

Formatted output t+3
Begin transfer to Display t+4
Nominal Processing Latency 20 ms
Frame to Display transfer 5 ms
Acquisition, processing, display 10 ms+25 ms+(1000 ms/display frame rate)

### Power Up and Optional Selection of Spectral Illumination

On power up, the system performs self tests of all critical systems. After initial self test, the user can select from available spectral options, if their system includes this option. Narrow spectral primaries can be implemented either by using mono chromatic light sources for illumination, or narrow band filters applied to broadband sources, or notch filters with image sensors. Using narrow spectrum primary color component illumination has several potential benefits. A definite advantage is that the computational geometric correction and computational focus correction can do a much better job if lens geometric distortion and focus point spread are better controlled. This results in much sharper images and greater useful depth of focus. As an example, instead of relying on broad spectrum white light, LED illumination of RGB primaries of 650 nm, 550 nm, and 450 nm+/−5 nm would provide these advantages.

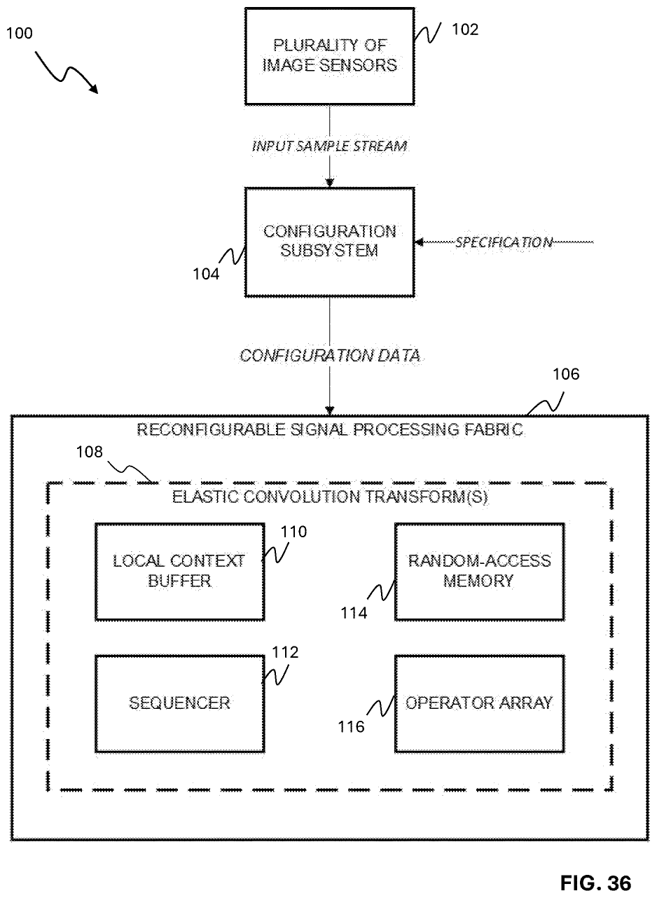

An additional area of potential benefit is the ability to utilize particular spectral components (FIG. 36) to provide increased tissue transparency or more selectivity of particular tissues. Any desired spectral component color primaries, pseudo-color space or other custom illumination should be selected before auto calibration, so the particular sources to be used are measured and calibration is optimized for their use. Imagery on display is converted to conventual human viewing color space for display.

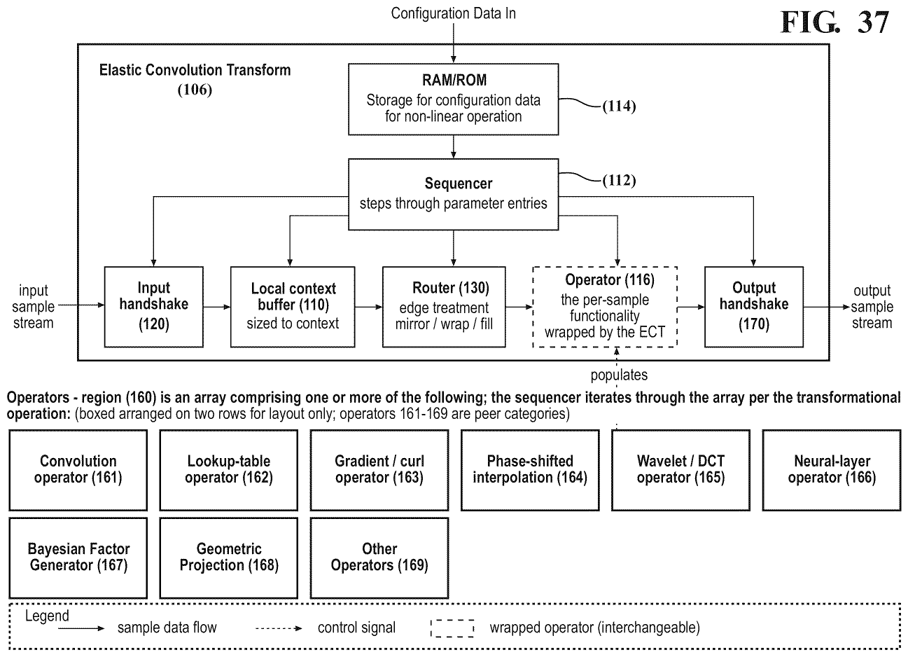

Typical visual image sensor may utilize color spectrum and R, G, B color primaries quantum efficiency and primary color filter response (FIG. 37). The same sensor can be used to collect infrared depth perception with a near IR wavelength in the 800 to 870 nm range.
Sample narrow band color primaries:
Single component red can be anywhere in the 640 to 710 nm range
Single component green can be anywhere in the 510 to 560 nm range
Single component blue can be anywhere in the 430 to 470 nm range
Peseudo color primaries can be used as well, in which case 350 to 750 nm are all possible
In the case of all single frequency and Peseudo color illumination, display would be in typical color primaries

### Depth Perception Mechanisms

The Camtrx LightField3D™ microscope acquires multiple perspective views of the surface of interest within the volume of interest. The multiple perspectives provide information to interpolate perspective views for a three dimensional display output, as well as minimizing visual interference by objects above the volume of interest such as tools or hands which would otherwise occlude the view.

To accomplish this ability to look “through” or “around” occlusions, as well as providing a realistic 3D view of the surface of interest, multiple perspectives are captured by multiple image sensors with various perspective views. The wider the range of captured perspectives, the greater the ability to implement this “look around” or transparency feature.

To construct the desired output perspectives from the available source perspectives with low processing latency suitable for good hand-eye coordination, a fast geometric construction method of perspective interpolation is desired. There are two general approaches possible.

One approach to perspective interpolation is to use auto corrolation or feature recognition in the various perspectives to detect reference objects and their orientation in the various perspectives, then use this information to generate a 3D volumetric model of the volume of interest, and then render the desire output perspectives using that 3D model. Unfortunately, a number of these steps require long computations resulting in unacceptable latency.

An approach which can achieve the desired low processing latency is geometric perspective interpolation. If the relative positions, fields of view, and geometric and optical distortions, and the profile of the surface of interest are all known well enough, then desired output perspectives at high resolutions can be calculated rapidly.

Geometric perspective interpolation requires a depth map of the surface of interest. Possibilities for depth map generation include near range LIDAR or high frequency SONAR as well as the proposed near InfraRed optical pattern projection, image capture and analysis. Each of these approaches are capable of producing a depth map with roughly 1 mm depth and positional resolution. The Camtrx LightField3D™ microscope could potentially use any of these mechanisms individually or in combination to create the desired surface depth map.

Several approaches can be used for near infrared optical depth measurement. The point spread function can easily be measured in the image resulting from projecting a pattern onto the field of interest and capturing the resulting picture. If optimum focus occurs at the maximum depth of the field of interest and is significantly out of focus at the minimum depth of interest, then the point spread function can be used to determine depth. A similar alternative relies geometric line spread by projecting a 2D grid and measuring the geometric divergence of that grid on the surface of interest. In both cases, local Fourier transforms can be used to directly measure the optical projections and provide the required depth map. These two optical methods are similar enough that they can in some cases be combined to provide a cross reference. In order to operate in spite of occluding objects, multiple fiducial depth projectors and sensors are desire.

### Depth Map Processing Delay Relative to Image Processing Latency

If image acquisition, image processing, and resulting perspective display are inserted into the hand-eye coordination loop, the quality, accuracy, and responsiveness of that coordination diminishes rapidly if image latency exceeds a few tens of milliseconds. Image Latency is the time from image acquisition until display. With training, a user can adapt to compensate to some extent, but it is very desirable to keep latency as small as possible. Toward this goal, the depth processing time is independent of the image processing path. This is reasonable because the depth map typically changes more slowly than the image, and when the depth map does change dynamically, the motion can typically be projected into the future by analyzing recent history for motion and providing a good estimate of future surface position. As a result, depth map processing latency is decoupled from image processing latency.

### Perspective Acquisition

Images at various perspectives of the field of interest are acquired with multiple image sensors. These sensors either share a single optical path with multiple perspective optics, or individual cameras and lenses with their axis passing through the center of the cone of view. In the case of the shared optic, optical magnification is also provided in steps of 2×. This is in addition to magnification provided in the image signal processing path. In the case of camera arrays, they can be in a linear array or arc across the base of the cone of view. In the case of the arc configuration, it can be extended to extremes allowing excellent occlusion look-around. Four to six perspectives are typically distributed across the base of the cone of view, with two rows of three to five perspectives above and below the previous sensors, to provide a symmetrical frequency response in the interpolated perspectives.

### Auto Calibration

Calibration assures best case performance by measuring positioning of critical components, and optical performance parameters and applying them to the correction process. This approach assures that positioning and orientation of sensors can be assured to on the order of one micron, while similar resolutions can be supported by the optical performance. This approach also simplifies assembly, shipment, maintenance, and assures proper operation by compensating for mechanical alignment, thermal expansion, and assures the use of actual illumination, as well as optical lens and sensor performance.

During auto calibration, a test fixture is either attached or enabled and extended to sweep through the volume of interest. The test fixture provides a test pattern, and an actuator which can be accurately positioned to sweep the test pattern through the volume of interest.

The Auto Calibration test pattern fills a plane of the field of interest and can precisely sweep the entire volume. The test pattern provides a reference geometric pattern which facilitates measurement of sensor and optics axis alignment, alignment angle, and scale, as well as the per color component MTF response and per color component optical geometric distortion at all locations in the volume of interest, and the illumination intensity profile for each color primary. This calibration includes both image sensors and depth sensor performance, and depth illumination primary.

### Auto Calibration of Depth Map Pattern Projection

It is desirable that the Depth map data is very resistant to occluding objects above the volume of interest. This argues for multiple depth reference projection sources. For this reason, three projectors are anticipated, located in a ring with a projector sources every 120 degrees. If these are projecting x-y grids, rotating each by 30 degrees from the others provides grid lines at 0, 30, 60, 90, 120, and 150 degrees. This allows lines to be analyzed together or in part using local Fourier transforms both to select and to measure. All three sets of grids provide redundant depth measurement which should provide reasonable resistant to occlusion. Depending on the method of projection, either line separation or line spread can be used to analyze depth. Spectral filters often have some cross talk with other wavelengths. A near IR filter which passes the depth map will also pass some amount of visible wavelengths. The maximum possible spectral crosstalk magnitude should be much less than full scale sensor output and can be removed by retaining only signals exceeding a threshold.

### Depth Map Pattern Projection Methods

Point spread
Line spread

### Auto Calibration Position, Orientation and Geometric Distortion Correction

It is assumed that each depth projection image will be slightly different, with differing geometric projection and slightly different optical behavior and alignment. The same issue is assumed for each depth projection sensor. Auto calibration collects the data which enables compensation for these issues in the depth projection analysis. Using the known depth and position information provided by the calibration target as it is swept through the volume of interest allows any geometric or optical distortion or alignment to be detected and a correction map to be generated so that all sensors agree using any or all projection sources and sensors in any combination.

### Auto Calibration Depth Correction Data Set Generation

Sensor data (images) of the test pattern as viewed by the depth sensors is collected during autocalibration. Correcting for any geometric orientation of projectors and sensors and obtaining good agreement from each channel is critical to reliable determination of surface depth. In a relatively non time critical process, geometric and optical distortions are determined throughout each sample plane in the volume of interest. A transformation map describes the transformation required to map the source observation from each individual sensor to the desired result for each point of interest in each plane throughout the volume of interest. The size of this data set is manageable due to the fact that these parameters are highly correlated in the volume of interest and can be adequately represented at sample resolutions much lower than the image resolution. For example, a correction map of 100×100×50 entries which can be interpolated to full desired resolution would typically be suitable even for very high image resolution.

### Operation

Operation consists of three primary concurrent processes which are surface depth map computation, image perspective acquisition, and image perspective interpolation and display. To keep latency as low as possible, surface depth map computation is done concurrently with the image processing but outside the latency path from sensor to display. Allowing image processing to use a slightly old surface map reduces latency by about a factor of two, and is typically tolerable because the surface map is typically less dynamic than changes of perspective or motion above the surface of interest.

### Operational Depth

Required depth resolution is much less than required image resolution. The assumption is made and verified during auto-calibration that fiducial pattern projection and depth sensor axis alignment and placement are “close”, with close on the order of one millimeter. The geometric and optical error related to depth perception are mapped for the volume of interest during auto-calibration, with the assumption that geometrically imposed error will be minimal, and geometric corrections can be made after depth analysis, using an x, y, z index into the 3D correction data for each sensor. Sensors then “vote” for the actual depth. Depths above the top or below the bottom of the volume of interest are considered occlusions or voids. Depths within the volume of interest are valid. If a location has no valid votes, it is considered a void. Voids can be “filled” with the nearest valid depth, or set to the maximum depth.

### Operational Depth Calculation

Depth images are cored to remove possible cross talk from visible primaries. Then depth images are divided into overlapping squares. For instance, if a depth sensor image is 2000×2000 pixels, and fiducial grid separation at maximum depth is on the order of 20 pixels, it could be divided into 100×100 or 10,000 squares of 40×40 pixels. The squares of depth data are Fourier transformed, and masked by the orientations of potential depth information. The largest remaining components are converted to frequencies, noise reduced by discarding the highest and lowest and averaging the remainder, which is then mapped to depth. A frequency based analysis can also be applied if the fiducial grid is a lens focused optical projection which is at sharp focus at maximum depth of interest, and is out of focus with increased point spread at minimum depth of interest.

### Operational Depth Correction

If geometric distortion of the depth fiducial pattern is known to be significant enough to justify correction, a correction of the depth map shape can be done based on the auto-calibration information and using an elastic convolution transform to stretch the x,y geometry as required. The depth (z) information is considered to be correct based on the assumptions above, and only the x and y displacements need to be corrected.

### Operational Depth Map and Depth Map Prediction

The depth map representing the surface profile is calculated for every input frame time with roughly 10 to 20 milliseconds of real time delay. If the surface profile is very dynamic, motion estimation can be applied to the current and historic depth maps, to predict future depth maps as required.

### Image Acquisition and Correction

The Camtrx LightField3D™ microscope acquires multiple perspectives simultaneously with the ability to interpolate intermediate perspectives from the acquired perspectives. In order to accomplish this with minimal latency a geometric construction method is employed. Geometric construction requires the source image perspectives to be in a normalized form with accurate relative positioning and scaling of the image perspectives, correction of lens distortion, and the depth profile of the surface of interest.

Normalization of sensor acquired image perspectives relies on information obtained during auto calibration. The calibration data is used to produce a specialized data structure for each image sensor which controls the ECT transform of each input frame from each image sensor into an idealized representation with a precisely known geometric relationship to all other captured perspectives.

Interpolation of new perspectives requires generation of perspective interpolation control data. Perspective interpolation requires ECT processing and control for each source perspective and a merge operation to combine all source perspectives and resolve regional resolution priorities. Regional priorities are determined by how well a given source perspective can represent a region in the output perspective, which is dependent on the viewing angle and the surface angle. The preferred perspective for that region has the viewing angle closest to perpendicular to the surface in that region. The same perspective interpolation process can also add text, grids, windows and other user information if desired.

### Optical Distortion Correction Applied to Each Color Component

A complex lens system can easily exhibit worst case geometric distortion exceeding many pixels at the image sensor. Making the problem even more severe, this distortion can be dramatically different for each color component. This can be devastating to high frequency resolution and image quality if not corrected. Fortunately an ECT is an ideal process to correct for this distortion as well as providing a high quality convolution based color decode.

### Perspective Interpolation

Perspective interpolation is implemented by selecting the desired corrected source perspectives which are typically, but not necessarily source perspectives surrounding the desired perspective. Assume the source perspectives have been corrected into a common reference space. Using the surface depth map, ECT programs are generated for each of the source perspectives which will convert that source into a prototype version of the desired perspective. The prototyped desired perspectives include their potential information contribution to the desired perspective, plus the addition of a per pixel component representing the figure of merit for its corresponding pixel value. The figure of merit indicates how significant the pixel is to the desired perspective. A small range of merit values are typically adequate. For example, merit values of 0, 1, 2, or 3 indicating merits of none, poor, fair, and good is usually adequate. Once prototypes are generated using each of the desired perspectives, they are merged into an output image where each pixel is represented by the average value of the highest merit of the source prototypes.

There are advantages using input perspectives which both close and far from the desired perspective. In FIG. 14, an object is observed from two perspectives, Pl (left) and Pr (right), with an interest in producing a Pi (interpolated) perspective. A through I represent ranges of surface angles which may be encountered. Due to geometric shortening, each of these surface angles is seen with a different resolution from each perspective. Pin (input) is a hypothetical input perspective at Pi for comparison to interpolated Pi results. The worst case relative resolutions (expressed in a range from 0 to 1) for each 30 degree step in surface angle from each perspective is given in the table in FIG. 15.

Useful resolutions at Pi (P interpolated) are actually higher than a hypothetical Pin resolution would be, except for surface angles in the neighborhood of E. A perfectly flat surface of interest would be “all E” and in that case Pi would exhibit a 17 percent lower resolution than Pin. This can largely be solved by providing additional source perspectives closer to Pi, or above and below Pi. For slopes near C, D, F and G, the interpolated Pi view has potentially much higher resolution than Pin.

The maximum super resolution in this example is 2× in and around angles C and G. To actually represent this super resolution, Pi resolution would need to be twice that of Pin. Potential super resolution increases with increasing perspective separation angles

To retain and utilize the available resolution, Pi needs to be generated at twice the source resolution.

### SUMMARY

As expected, adequate surrounding viewing angles and adequate angle separation enable an interpolated view with much better resolution than a single direct view.

### Filtering and Image Enhancement

A sequence of generic processing blocks can implement a wide range of useful operations. A nonlinear value remap, followed by a forward transform, nonlinear remap, multiplication by a frequency response map, nonlinear remap, and an inverse transform followed by a final nonlinear value map can provide a wide range of noise reduction, frequency domain modification, homomorphic, phase contrast, and other filtering operations which can increase quality and highlight selected features dramatically.

### High Quality Image Resizing Using ECT Transforms

The Elastic Convolution Transform (ECT) used to correct geometric distortion and interpolate new perspectives can also be used to provided the desired output image resize, allowing source images to be scaled or stretched either up or down. In this case the ECT effectively implements a Lanczos windowed interpolation convolution which is considered to provide excellent image quality.

In many cases where an ECT is being used for other image processing steps, a resize operation can be combined with no additional processing steps.

### High Quality Transform Based Resizing Using Image Enhancement Mechanism

The ultimate in resizing is full image transform based resizing, which can remove the majority of sampling noise and increase signal resolution while providing an ultra high quality resize.

### Display on a Stereoscopic Headset

A stereoscopic headset provides a relatively high resolution left and right eye perspective view without constraining to viewer to a particular position. This has the potential to greatly improve the ergonomics of long and/or delicate procedures. Use of a stereoscopic headset with the Camtrx LightField3D™ microscope requires generation and output of left and right image streams of interpolated perspectives.

The viewing perspective can be controlled by head position, orientation, or manual user interface control. Generating left and right eye perspectives require interpolating each view from available perspectives.

### Display on a Light Field Monitor

Current light field monitors display a “3D” image by optically filtering selected views based upon viewing angle. Current practice is to display an interleaved array of 45 different perspectives which present the appropriate perspectives by directional optical filtering and the actual eye positions and angles of view. Processing required to generate interpolated perspective views is largely proportional to the number of pixels required. Producing 45 perspectives at 1/45 resolution is only slightly more processing work than producing one perspective at full resolution. The primary increase in computational throughput over a stereoscopic view results from all source perspectives being active concurrently, and the additional formatting required for the output stream.

### Recording Output

Both stereoscopic and light field output can be recorded on appropriate video equipment or as media files when operating at a supported frame rate.

### Overview of an Elastic Convolution Transform (ECT)

The ECT architecture is an image processing building block developed to construct complex real time, ultra-low latency image processing systems in custom ASIC or FPGA hardware. It supports many common image processing operations efficiently including arbitrary high quality off sample grid high quality resampling, pixel location specific optical corrections of modulated transfer function, focus, shape and frequency response, general frequency response filtering, some nonlinear and directional filtering, histogram correction, noise reduction, gamma conversions, color conversions, 2D wavelet transforms, some specialized nonlinear and directional filtering and some ability to rotate and project image data in 3D.

ECTs support a sampling theory compliant method to resample an existing sampling grid image in a rectangular data set using a different and potentially nonlinear sampling pattern, independent from but overlapping with the original sample grid. Using this resample mechanism, an ECT can be provide arbitrarily high quality pan and zoom operations, but the primary intent is to correct for geometric or optical distortion at sub-pixel resolutions. Resampling of the original data along a specified path independent of the original sample grid utilizes a 2D convolver as an interpolator which can apply a custom, potentially asymmetrical convolution kernel to allow synthetic off-grid sampling at any arbitrary point with any desired frequency response or frequency compensation, concurrently supporting synthetic sample point resampling and frequency response reshaping.

Because the convolution can potentially apply unique kernel values for each individual sample, it can also support location specific filtering, and location specific sagittal and tangential MTF correction, computational position dependent and depth dependent focus correction, and lens position dependent high frequency roll off compensation and similar operations which can all potentially be convolved together and applied at the same time in a single pass through an ECT at low latency.

In most high speed image processing systems the critical performance throughput parameter is the amount of latency imposed on the stream of data out of the source image in either units of pixel or line times. Source image edge treatment is typically odd mirroring around the center of the edge pixels both horizontally and vertically which adds ½ of the convolution kernel vertical size to ECT processing latency. In addition, the maximum vertical range of sample excursions needs to be added to processing latency. The processing latency required for ECT processing which also provides geometric distortion and lens transfer function correction would be ½ the desired kernel size plus the maximum locality excursion required to implement the desired resampling path to correct lens geometric distortion. A typical application using a 10×10 convolution with a maximum path locality excursion of +/−5 lines would incur a total of 10/2+5+5 or 15 line time of additional latency delay. If a 2000×2000 pixel sensor was the image source, the ECT latency addition in frame times would be 15/2000 or 0.0075 of a frame time of additional delay to receive corrected data out of the sensor and ETC combination.

Adding a look up table on both the input and output of the ECT data streams allows image data conversion to or from linear or gamma data representation, remapping to correct for sensor linearity errors, or as non-linear data mapping which can be used with the convolution filter to implement homomorphic non-linear filtering operations used to enhance human visual contrast acuity.

Supporting a 2D poly-phase interpretation of the data stream enables color image data processing and high quality Bayer pattern color encoding and decoding. A poly-phase aware 10×10 convolution provides a uniquely high quality Bayer pattern color encode or decode and avoids the typical chrominance noise crosstalk into luminance which is so common at low light levels in most typical in Bayer decoders. The same poly-phase awareness mechanism directly supports multiple band 2D wavelet forward or reverse transforms in a single low latency pass.

The addition of multiple channel buffers and convolvers can support operations on arbitrary multi-component images at the same speed and latency as a monochrome operation.

With suitable programming and data buffering, an ECT can support arbitrary rotations, translations and projections as well as the planar transformations mentioned above.

### The Elastic Convolution Transform (ECT)

The ECT is a conceptual template for hardware design used to implement low latency image processing operators, typically in ASICs or FPGAs. It provides a general processing framework to model and implement a wide range of image processing operators with a minimum of processing latency. It assumes image sensor frame output is available as a stream of pixels and completes its assigned process while introducing a minimum possible latency delay to that stream determined by the required locality of the desired operation. For a surprisingly wide range of operations, the approach can keep latency down to a small number of line times. (i.e. a very small fraction of a frame time) For example, passing a 9×9 convolution filter over an image with edge mirroring introduces 5 line times of processing latency. For a 2K×2K image, with would represent 5/2000 or 1/400 of a frame time of latency to filter the image. In most cases a number of operations can be combined together without increasing latency.

A common application for an ECT is correcting for known optical artifacts, where each pixel can be treated to unique correction. An ECT can sample the acquired source image at synthetic data points off the source sample grid to correct for geometric distortion, by using the convolution as a high quality off grid interpolator. The unique per-pixel convolution can also correct for pixel specific asymmetrical response, as well as modulated transfer function and focus correction. These operations can all be done in a single pass where the latency is the combination of the locality requirement for the convolution and the maximum desired sample path excursion, which for a typical quality optic would result in a total of about 10 lines or less of total latency, or about 1/200 of a frame time for a 2K×2K image stream. ECTs can also be used for high quality image resizing, rotation, translation, projection, filtering, wavelet transforms, and high quality Bayer pattern encoding and decoding. among other operations.

### Inverse Problems

Inverse Problem statistical signal processing methods are a powerful tool which can be used used to constructively combine images from multiple sensors, enhance quality, and reduce noise, among other applications. They employ statistical models and sensor data to determine the most likely source which would produce the acquired image(s) given known degradation processes and known or likely source characteristics. High speed, high quality inverse problem solution at low latency is key to many advanced imaging techniques including constructive combination of multiple sensors, analyzing depth and perspective, reducing noise and increasing signal quality and resolution.

### Applying an ECT to Low Latency Iterative Bayesian Optimization

Iterative inverse solutions are typically required to implement some form of Bayesian statistical optimization process. Achieving high processing speed and low latency can be challenging. Such processes are often implemented to operate iteratively on entire frames, introducing many frame times of processing latency. This is potentially acceptable for photography and non-real time analysis applications, but would be useless for any real time hand-eye coordination or tracking and targeting application.

The approach is to “localize” these algorithms by use of local versions of global operators, such as windowed versions of mean, min, max, standard deviation, and others, allowing an iteration to be applied to a sliding stripe across the image which typically results in 10 to 20 line times of latency per iteration. Feeding the output of one iteration into the next allows 10 to 20 iterations to typically require 100 to 400 line times of latency, which is still a small fraction of a frame time. The localization of key parameters actually seems to typically improve algorithm performance and speed convergence.

### Fundus Viewing Issues, Assumptions, Observations, Opportunities, and Potential Stitching and Perspective Solutions

High quality viewing of up to 180 degrees or more of the eye fundus at a significant standoff distance has been demonstrated to be feasible. At least 220 degrees of internal view (110 degrees external) appears possible if desired.

A very wide fundus view appears to be somewhat antagonistic to good perspective view axis separation. Acquired image contrast ratios are dependent on control of internal and external lighting.

Contrast can be greatly enhanced by signal processing methods as needed.

Eye fundus internal illumination can be provided externally at the same standoff distance if required.

A single “on axis” fundus view can be combined with a reasonable “hypothetical” depth map to allow that view to be displayed and rendered from various perspectives to provide a very dramatic “appearance” of 3D perspective. However little if any “true” perspective information is available in this single view.

This same lack of perspective information is true if the fundus view is pieced together from a number of largely non-overlapping views.

Ideally we need a number of full views (at least two, preferably more) with significant axis displacement, or alternatively an adequate number of partial views with very substantial overlap. The second alternative is computationally much more complex as well as providing more questionable perspective and image quality.

### The Plenoptic Fundus Viewing Problem

Multiple perspective external views of the eye resolve potential ambiguities by rigorous sub-pixel sensor and optics calibration. Internal multiple perspective fundus viewing is more difficult because the patient's eye lens introduces an unknown into the optics.

A potential workaround can be accomplished using an “on axis” wide angle view as the reference view, and a number of full or nearly full views at various axis offset perspectives. This would allow a “relative calibration map” of available perspective views onto the reference view. By identifying image features and correlating them, a relatively “smooth” elastic transformation can be calculated for each perspective. This calibration can be kept to on the order of a second of real processing time in software. Once this is done, producing elastic convolution transform (ECT) data, ECTs can conform each perspective view to the reference in effectively real time. From this data set of multiple conformed perspective views, any desired perspective, including exaggerated or combined views can then be rendered.

If full fundus perspective views are not available due to optical constraints, a number of partial perspectives with significant overlap could be used. The overlap provides the multiple perspective information. Conforming these partial perspectives would be much more difficult and time consuming. As perspective view overlap decreases, available perspective information also decreases, until at minimal full coverage, there is effectively no addition perspective information contribution, just a single view.

### Possible Optical Challenges to Achieving Perspective Offsets

Experiments indicate that there is not much range for off axis perspectives while also acquiring wide angle fundus views. With my setups I was able to get a full perspective view at up to about 4 to 5 degrees off axis, and 60% of full perspective at about 7 degrees off axis Depending on camera optics and sensor sizes, this may not be enough.

Another issue is that although the eye view at these offsets was fine, the relatively large lenses of my SLR camera loose significant image contrast and detail even at these small offsets. Hopefully Steven's approach provides more flexibility.

Hopefully better optics will tighten the focus enough to allow more movement off axis. Decreasing the total field of view would narrow the focal cone and should allow more perspective separation.

Regards sensors, ideally I would like to see the central axis aligned full perspective view, with a minimum of two and up to six surrounding perspectives to enhance super-resolution and reduce perspective ambiguity. Increased views also increases occlusion resistance and potentially simplifies occlusion processing. Other geometries are possible, potentially requiring significantly more computational burden.

### Signal Processing System Associated with a Lightfield System

With reference to FIGS. 36 and 37, in one aspect of the present invention, a signal processing system 100 associated with a lightfield imaging system 10 is shown.

In the illustrated embodiment, the signal processing system 10 includes a plurality of image sensors 102, a configuration subsystem 104, and a reconfigurable signal processing fabric 106 is provided. The plurality of image sensors 102 produce input sample streams (see above).

The configuration subsystem 104 is configured to accept a specification. The specification includes calibration data characterizing the plurality of image sensors 102 and a selected output configuration. The configuration subsystem 104 is further configured to derive, from the specification, configuration data.

The configuration data includes a topology specification defining a plurality of elastic convolution transforms 108 and data connections between the elastic convolution transforms 108. The configuration data also includes, for each said elastic convolution transform 108, a corresponding transformational operation comprising a sequence of parameter entries. Each parameter entry specifies an offset in a source sample space and a selection from among a plurality of operators wrapped by the elastic convolution transform.

The reconfigurable signal processing fabric 106 is tuned by the configuration data to realize the plurality of elastic convolution transforms 108 connected according to the topology specification. Each elastic convolution transform 108 includes a local context buffer 110, a random-access memory 114, a sequencer 112, and an operator array 116.

The random-access memory 114 holds or or stores; (i) the corresponding transformational operation as a sequence of parameter entries and (ii) coefficient and table data for non-linear operations. The operator array 116 includes one or more operators selectable for application to sample data held in the local context buffer. The sequencer 112 is configured to iterate through the operator array 116 in accordance with the transformational operation.

Each elastic convolution transform 108 is configured within the reconfigurable signal processing fabric 106 to apply, continuously to a respective input sample stream. The operator or operators of the operator array 116, as specified by the transformational operation, at the source sample space offsets specified by the parameter entries, produce an output sample stream.

The output sample streams propagate through the tuned fabric 106 according to the topology specification at a sample rate higher than a frame rate of said plurality of image sensors 102. Each sample is a value within a defined sample space including zero. Propagation of the sample streams through the tuned fabric 106 is independent of the particular values carried by the samples. The specification influences operation of the tuned fabric 106 solely via the derived configuration data. The reconfigurable signal processing fabric 106 is arranged such that each elastic convolution transform 108 produces output samples with a per-ECT latency determined by the local context size required by the the operator array 116. The per-ECT latency is independent of frame completion of the plurality of image sensors 102.

A total latency from arrival of an input sample to production of the corresponding output sample is a sum of per-ECT latencies along the path through the topology traversed by the input sample, the total latency being less than one frame time of the plurality of image sensors 108.

The plurality of image sensors 102 receive light from a physical scene and produces the input sample streams in response thereto, and wherein the output sample streams produced by the tuned fabric 106 are provided to one or more display devices (see above) to generate a visible image of the physical scene. T the visible image includes a corrected and recombined representation of the physical scene with geometric, optical, and inter-sensor variations compensated in real time.

### Elastic Convolution Transform—Processing Requirements

Multi-sensor surgical visualization imposes a combination of constraints that conventional sequential computing architectures cannot meet. Sample streams from a plurality of image sensors must be transformed—corrected for sensor geometric and optical calibration, processed for 3D depth and occlusion analysis, filtered, and fused for super-resolution—then projected onto the surface of interest obtained from depth analysis, supplemented with application-related overlays, and formatted for delivery to one or more display configurations. All of this must happen with minimum delay to avoid perturbing the hand-eye coordination critical to surgical procedures.

Sensor and display frame rates should be as high as practical to minimize sampling acquisition and display delays. The required processing time from input sensor image data streams in to display image data streams out must introduce minimum delay, on the order of a single frame acquisition time and preferably less.

There are a vast number of per-image-element processing operations required from sensor input to display output, which can be grouped into a handful of major operations. Some of these operations—depth analysis, occlusion processing, and inverse-solution super resolution—require iterative optimization processes, potentially involving tens to hundreds of iterations within a single frame time. The latency budget cannot accommodate iteration in any sequential implementation: hundreds of iterations on twelve sets of sensor data exceeds the available milliseconds by orders of magnitude when each iteration requires reading and writing complete intermediate representations.

### The Streaming Architecture

Implementing the required processes within the available latency constrains the approach to implementation. The architecture implements all individual processing steps as streaming processes: each individual process step receives a stream of discrete image-related information, performs some processing, and produces a stream of derived discrete image-related information. The delay from a stream element entering a process to the corresponding derived element leaving that process is determined by the extent of the local information context required by the process—not by frame completion.

Multiple streaming processes are connected into chains, each accepting a stream of image-information elements, performing some processing step with the minimum local context required for that process, and outputting a stream of processed results. End-to-end latency is the sum of per-process latencies along the path from sensor to display, with each per-process latency proportional to local context size rather than frame size.

The latency benefit of this approach is large and quantifiable. Very simple operations such as homomorphic image-element-value remapping can be accomplished by a polyphase table-lookup operation, introducing a single picture-element of delay from stream-element in to stream-element out—a single element of delay being on the order of a frame time divided by frame resolution in picture elements. For a 60 Hz frame rate and a 2000×2000 sensor, this is approximately 4 nanoseconds. Operations requiring local row context, such as a 9×9 convolution filter, introduce at least 9 line times of processing latency from stream-element in to corresponding processed element out-approximately 8 microseconds at 60 Hz 2000×2000. Even complex iterative processes such as a single Metropolis-Hastings MCMC iteration of a Bayesian inverse-problem optimization can be accomplished in 5 to 16 line times of stream-processing latency, depending on the desired processing context size, which allows hundreds of such iterations within a single frame time.

These latencies are achievable because the streaming architecture localizes computation: each output sample depends only on a bounded neighborhood of input samples, and that neighborhood is held in local buffer memory adjacent to the operation logic. There is no round trip through general-purpose memory, no fetching of stored representations between processing steps, and no global control flow waiting for frame completion. The architecture is a configured signal processing fabric, not a sequential computer.

### The Elastic Convolution Transform

The architecture aggregates standard signal processing elements—line buffers, lookup tables, convolution filters, various other signal processing operators, and associated control and handshake logic—into stream processing blocks. When a processing block contains a convolution filter with associated line buffering to support the data-locality requirements of the required convolution size, it is referred to as a Convolution Transform (CT). When sample interpolation is required—for geometric distortion correction, geometric projection, or resampling at higher or lower picture-element resolution—the term Elastic Convolution Transform (ECT) refers to a process that requires additional context (and accepts the resulting latency increase), or that has an output stream rate differing from the input stream rate due to a resolution change.

The ECT 108, as illustrated in FIG. 37, is the structural building block of the architecture. Each ECT 108 is a defined region of the reconfigurable signal processing fabric containing seven constituent elements: an input handshake 120, a local context buffer 110, a router 130, a RAM/ROM 114 for non-linear operation data, a sequencer 112, an operator or operator array 116, and an output handshake 170. Multiple ECTs 108 are instantiated within the fabric and connected in streaming-process chains. Each ECT 108 operates continuously and autonomously: when input samples are present at its input handshake, it produces output samples at its output handshake at sample rate, with delay determined by its local context size.

### The ECT Internals

The ECT's 108 constituent elements work together to realize the streaming-process pattern. Input data arrives through the input handshake 120, which supports any ready/wait and data-valid handshake required and frequently buffers multiple image elements into a single I/O transaction to reduce external clock and handshake transition rates. From the input handshake, sample data flows into the local context buffer 110, which provides local storage for the context needed by the desired operation. For a 9×9 convolution filter, the context buffer holds nine streams of line information, supplying the operator with each line of result-producing context while one new line of data is transferred in and placed in the buffer in preparation for the next line of filter operation. If a change in geometry is desired—for geometric correction or geometric projection—the context buffer size increases to support the extent of the path excursion, with corresponding increase in processing latency.

The router 130 provides the correct geometric ordering of data supplied to the operator from the local context buffer, which is usually implemented as a rotating line buffer. The router also handles correct line mirroring at image boundaries—top, bottom, left, and right—producing synthetic samples that propagate through the remainder of the pipeline indistinguishably from sensor-originated samples. When the operation involves a change in geometry, the router is path-aware: it provides the correct neighborhood of information to the operator at each step along the geometric path.

The operator 116 performs the desired operation on each neighborhood of data supplied by the router to produce each element of output. Operator selection is configured per ECT and may take several forms. Filtering operations typically employ a convolution filter with constant coefficients. Geometric correction or resolution changes may employ a family of phase-shifting coefficient sets, allowing output samples to be produced at offsets intermediate between source sample grid positions. Geometric and modulated-transfer-function correction of optical alignment and response may, in the extreme case, employ a unique convolution for each value produced, but more typically can be supported with a few hundred unique coefficient sets. The operator catalog populating this position is enumerated as species 161 through 169 in FIG. 1, described in the next section.

The RAM/ROM 114 holds or stores configuration data required only when significantly different operations are needed for various image elements. The most common requirement is storage for sets of convolution coefficients used for filtering combined with resampling—for image resizing, geometric correction, or projection where off-grid results are required. A modest set of coefficients provides adequate phase resolution: 16 sets of convolution coefficients are adequate for quarter-pixel resampling resolution, and 256 sets for sixteenth-pixel resolution. Another common requirement is ROM data for table lookup providing non-linear remapping of input or output values for homomorphic filtering, gamma conversions, or similar operations. An ECT 108 performing only fixed-coefficient filtering with no per-sample variation does not require RAM/ROM.

The sequencer 112 coordinates the constituent elements. Its primary task is specification of line-buffer data, particularly for image edge data mirroring needed for edge treatment in convolution filtering and similar operations. For any nonlinear resampling required to provide geometric corrections, projections, or resizing, the sequencer is aware of the required path excursions and correctly specifies the necessary data and operations. The sequencer is realized as a finite-state machine with counters and addressing logic, configured for the specific transformational operation of its ECT 108—it issues read addresses to the local context buffer, drives the router for edge treatment and path excursions, directs the operator to the coefficient or table data it requires from RAM/ROM where applicable, and coordinates with the input and output handshakes.

Output samples leave the ECT 108 through the output handshake (170), which mirrors the input handshake in structure. Like the input handshake, the output handshake frequently buffers multiple image elements into a single I/O transaction to reduce external clock and handshake transition rates. The output handshake provides isolation between the ECT's internal pipeline and the downstream ECT 108 or final output destination.

### The Operator Catalog

FIG. 37 enumerates an operator catalog from which any specific ECT 108 may be populated. The catalog is non-exhaustive; additional operator species may be added by synthesizing new operator logic within an ECT 108. The enumerated species fall into three groupings by structural character: linear filtering and table-based operators 161, 162, 163, 165, geometric and resampling operators 106, 106, and iterative-capable operators 166, 167).

The convolution operator 161 applies a convolution kernel to a region of sample data drawn from the local context buffer, producing one output sample per cycle. Kernel coefficients are read from RAM/ROM under direction of the sequencer when per-sample variation is required. Kernel support sizes from 3×3 through 10×10 or larger are supported, with 5×5 through 9×9 typical for image-processing applications. The convolution operator is the historical ECT case in its narrowest form and remains the most common populating species.

The lookup-table operator 162 applies a non-linear transform to a sample value by indexing into a table stored in RAM/ROM. Typical applications include gamma correction, log/antilog transformation for homomorphic filtering, tanh or sigmoid remapping for compression-style operations, and inverse-gamma expansion. Table resolution is configurable; typical implementations use 10- to 16-bit input addressing with equal or greater output width to preserve dynamic range.

The gradient/curl operator 163 computes a spatial gradient, curl, or slope from samples in the local context buffer. Gradient operators produce vector-valued outputs (∂/∂x, ∂/∂y) from a region of samples, supporting feature extraction, edge-aware processing, and direction-sensitive analysis. Curl operators analyze local flow or orientation; slope operators produce scalar measures of local sample-value variation.

The wavelet/DCT operator 165 performs one stage of a wavelet decomposition, a discrete cosine transform block, a discrete Fourier transform block, a lapped-orthogonal-transform stage, or related sub-band transform. Stages may be cascaded across multiple ECTs to produce multi-resolution decompositions or frequency-domain processing pipelines, with each stage adding only its local-context-sized increment to total latency.

The phase-shifted interpolation operator 164 is the canonical “elastic” operator: it produces output samples at offsets intermediate between source sample grid positions using a bank of phase-shifted convolution kernels. Typical implementations provide phase offsets from 0/16 through 15/16 in 1/16 increments across both X and Y dimensions, producing 256 possible sub-pixel phase positions. The sequencer selects which phase-shifted kernel is applied for each output sample, with the kernels themselves stored in RAM/ROM. Combined with convolution, this operator realizes geometric resampling, rotation, and resolution change—the elastic property from which the ECT 108 takes its name.

The geometric projection operator 168 applies a specified geometric projection to samples from the local context buffer. Projection types include perspective correction, sensor-to-reference-frame registration, and reference-frame-to-output-view projection. Projection parameters—transformation matrices, sensor-specific distortion coefficients, output-view geometry—are supplied from the calibration data through the configuration step and stored in RAM/ROM. The geometric projection operator is the structural mechanism by which the architecture compensates computationally for manufacturing tolerance in the image sensors and optics, nulling departures from nominal geometry that would otherwise degrade output quality.

The neural-layer operator 166 computes, for each output sample, a weighted sum of samples within a specified neighborhood from the local context buffer followed by a selectable nonlinear activation, realizing the per-sample computation of a convolutional neural network layer. Weights and biases are read from RAM/ROM under direction of the sequencer. When neural-layer operators are instantiated in multiple ECTs connected in a chain, with each ECT 108 realizing one layer of a trained convolutional neural network, the chain realizes streaming neural-network inference at sample rate—a fundamentally different computation model from conventional batched inference, which requires complete intermediate tensors between layers.

The Bayesian factor generator 167 implements one factor of a Bayesian inverse-problem solution. The operator typically contains a random value generator selecting from a desired value distribution, producing a candidate modification to add to a current image element. The candidate is evaluated relative to a merit and regularization function as a potential improvement; only a sparse subset of image-element values are potentially modified per iteration. A cascade of Bayesian factor generator ECTs realizes Metropolis-Hastings MCMC optimization or similar Bayesian inverse-problem optimizations, with each ECT 108 in the cascade contributing one iteration. With per-iteration latency of 5 to 16 line times, hundreds of iterations are achievable within a single frame time—making real-time Bayesian super-resolution, depth reconstruction, occlusion resolution, and similar inverse problems tractable in this architecture where they are intractable in sequential implementations.

The remaining catalog slot 169 is an extension point. Additional operator species may be added by synthesizing new operator logic within an ECT. Candidates include noise-coring operators in collapsing and non-collapsing variants, pseudo-random value generators with specified distribution shapes for Monte Carlo methods, Bayer color decoders with phase-aware chroma interpolation, direct-resolution-representation converters, and other signal-processing operations suitable for per-sample execution.

### Cascades, Chains, and Topology

Single ECTs are rarely sufficient; the architecture's power comes from arrangements of multiple ECTs connected to realize the full sensor-to-display transformation. Several arrangement patterns appear repeatedly in practical applications.

The simplest arrangement is a sequential chain: each ECT's output sample stream becomes the next ECT's input sample stream, with the chain end-to-end latency equal to the sum of the per-ECT latencies along the chain. Chains realize composed transformations such as calibration correction followed by geometric projection followed by resampling, where each stage is a self-contained ECT.

Iterative refinement uses cascades of identical operator types, most importantly cascades of Bayesian factor generator ECTs 167. Each ECT 108 in the cascade contributes one iteration of the inverse-problem optimization. With per-iteration latencies of 5 to 16 line times and a frame time of approximately 16,700 microseconds at 60 Hz, hundreds of iterations fit within a single frame. The cascade approach is what makes statistically optimal sensor fusion—Bayesian super-resolution, Bayesian depth reconstruction, Bayesian occlusion resolution—practical in real time. In sequential implementations, hundreds of iterations across twelve sets of sensor data would require seconds of computation; in the cascade approach, the same iterations span a single frame time.

Multi-perspective imaging applications use a fan-in-then-fan-out arrangement. A plurality of input chains, each associated with a respective image sensor, processes the sample stream from that sensor through whatever calibration-correction, geometric-projection, and noise-reduction ECTs are required to bring it into a common reference representation. The outputs of all input chains converge on a merging ECT 108 (or short merging chain) that combines the sensor contributions into a single merged sample stream representing the unified observed scene. This merged stream then fans out to a plurality of output chains, each producing a sample stream tailored to a specific display configuration—a stereoscopic pair for one display, a multi-view light-field array for another, a conventional 2K, 4K, or 8K video stream for a third. Per-display chains can apply different output-specific transformations from a common merged source, supporting concurrent multi-format output without re-computation of the underlying scene reconstruction.

Topology arrangements are determined during the configuration step from the calibration data of the present sensors and the selected output configuration. Once configured, the topology operates continuously: sample streams flow through the configured arrangement at sample rate, with end-to-end latency determined by the longest path through the topology. Reconfiguration is required only when sensors are recalibrated or output configurations change—not during normal operation.

Terminology Table

| Ref. | | |
|---|---|---|
| No. | Element | Description |
| 108 | Elastic Convolution | Stream processing block realized as a defined region of the reconfigurable |
| | Transform | fabric, comprising elements 110-170; the structural building block of the |
| | | architecture |
| 120 | Input handshake | Synchronous interface accepting the input sample stream with valid/ready |
| | | handshake; frequently buffers multiple image elements per I/O transaction |
| 110 | Local context buffer | Memory holding the rolling window of input samples needed by the operator; |
| | | sized to the operator's context plus any geometric path excursion |
| 130 | Router | Logic providing correct geometric ordering of context-buffer data to the |
| | | operator, including edge mirroring at image boundaries and path-awareness for |
| | | geometric operations |
| 114 | RAM/ROM | Storage for non-linear operation configuration data - phase-shift coefficient |
| | | sets, lookup tables, neural weights, projection parameters - required when |
| | | per-sample variation is needed |
| 112 | Sequencer | Configured finite-state machine coordinating context-buffer addressing, edge |
| | | treatment, geometric path excursions, operator direction, and handshake timing |
| 116 | Operator | Per-sample functionality wrapped by the ECT; populated from species 161-169 |
| 161 | Convolution operator | Applies a convolution kernel to context-buffer data; the historical ECT case |
| 162 | Lookup-table operator | Applies non-linear transform via table indexing; gamma, log, homomorphic |
| 163 | Gradient/curl operator | Computes spatial gradient, curl, or slope from local context |
| 164 | Phase-shifted interpolation | Produces samples at sub-grid positions via bank of phase-shifted kernels; the |
| | | elastic property |
| 165 | Wavelet/DCT operator | Performs one stage of wavelet, DCT, DFT, or related sub-band transform |
| 166 | Neural-layer operator | Realizes one CNN layer per ECT; cascaded ECTs realize streaming inference |
| 167 | Bayesian Factor Generator | Implements one factor of Bayesian inverse-problem solution; cascaded ECTs |
| | | realize iterative Bayesian inference within one frame time |
| 168 | Geometric Projection | Applies geometric projection - perspective correction, sensor registration, |
| | | output-view projection |
| 169 | Other Operators | Extension slot for additional operator species not specifically enumerated |
| 170 | Output handshake | Synchronous interface producing the output sample stream; mirrors 110 in |
| | | structure |

### Mapping of Signal Processing System to the LightField3D System Described Above and Exemplary Embodiment

This section maps each the block diagram of the signal processing system 10 described above to the structural elements of the system architecture of the above referenced LightField 3D System, as well as to a concrete realization example and a pointer to written-description support. The mapping is a technical reference to accompany the revised claim language.

Terminology note: This sections aligns the vocabulary to the intended usage of “Elastic Convolution Transform” (ECT). The ECT is the container/wrapper that provides streaming infrastructure. An operator is the per-sample functionality that the ECT wraps. A given ECT wraps one or more operators; the architecture's reach comes from the ECT's ability to wrap any operator suitable for streaming execution, including convolution, LUT, gradient, phase-shifted interpolation, wavelet, DCT, neural-layer, noise-coring, and iterative-refinement operators.

The FPGA Realization column gives a concrete example of how each structural element is realized in a field-programmable gate array implementation (FPGA). The invention is not limited to FPGA realizations; the same mapping applies, with appropriate substitutions, to ASIC, GPU, CGRA, and hybrid realizations. FPGA is used as the example here because it is the clearest and most commonly described realization in the existing technical drafts.

### Section 1—Physical Endpoints

The input endpoint (image sensors observing a physical scene) and output endpoint (display devices presenting a visible image of that scene) bracket the architecture. Sample streams enter from the sensors; sample streams leave to the displays. The below table maps the terms in the signal processing system 10 to the LightField3D System described above and an FPGA realization or embodiment thereof:

| | | | |
|---|---|---|---|
| plurality | Two or more image | Sensors connect via MIPI CSI- | 3 depth sensors and 10 |
| of image | sensors mounted in | 2, LVDS, or SerDes to FPGA | perspective cameras; |
| sensors | a defined geometric | I/O; mounting fixture defines | Camtrx blocks A, B |
| | relationship to a | nominal geometry; calibration | |
| | scene, each producing | captures actual geometry | |
| | a digital sample | | |
| | stream at a specified | | |
| | frame rate | | |
| input sample | Ordered sequences | Deserialized pixel data | “stream of discrete image |
| streams | of digital sample | entering the fabric through | related information” |
| | values produced by | input I/O blocks, carrying | |
| | each image sensor | valid/ready handshake per | |
| | in raster or other | sample | |
| | defined scan order | | |
| receives light | Photons from the | External to the fabric; property | the surgical field as the |
| from a physical | observed physical | of the sensor and its optics | observed scene |
| scene | environment incident | | |
| | on the sensor optics, | | |
| | converted by the | | |
| | sensor to sample | | |
| | values | | |
| display | One or more physical | HDMI, DisplayPort, or MIPI | Camtrx blocks V |
| devices | displays receiving | DSI output driven by the | (stereoscopic headset), W |
| | output sample streams | fabric's output I/O blocks | (light field monitor), X |
| | and rendering them | | (standard video) |
| | as visible images | | |
| | perceivable by a | | |
| | human viewer | | |
| visible image | The rendered image | Rendered frame on the | the surgeon's view |
| of said | formed on the display | connected display; refresh rate | |
| physical | by the output sample | determined by the display and | |
| scene | stream, presenting | output stream | |
| | a view of the physical | | |
| | scene to the viewer | | |
| corrected and | Specific properties | Properties of the rendered | geometric correction, MTF |
| recombined | of the visible image: | image, produced by the | correction, multi- |
| representation . . . | geometric distortion | fabric's tuning; not a separate | perspective fusion |
| compensated in | removed, optical | structural element, but an | throughout |
| real time | aberrations compensated, | assertion about the output | |
| | multi-sensor | | |
| | contributions merged | | |
| | into a single coherent | | |
| | view, corrections applied | | |
| | within the latency budget | | |

### Section 2: The Specification

The specification is a concrete data structure. Its claim-relevant fields are enumerable, and each field has a defined meaning. Each field is populated by auto-calibration or by user selection of an output configuration. See below table:

| | | | |
|---|---|---|---|
| specification | A data structure stored in memory, | Memory region in BRAM, | Calibration database |
| | comprising at least the calibration | SDRAM, or external memory | (Camtrx block D) plus |
| | data sub-structure and the selected | accessible to the configuration | user-selected output |
| | output configuration sub-structure, | subsystem; structured records | parameters |
| | with defined field layout | with fixed or self-describing | |
| | | layout | |
| calibration data | Per-sensor sub-structure | Structured memory records, | Camtrx block D (Cal) and |
| characterizing said | containing: position vector, | one per sensor, populated by | extensive calibration |
| plurality of image | orientation, optical geometric | the auto-calibration process | description |
| sensors | distortion coefficients, MTF | and maintained across power | |
| | parameters, illumination field | cycles | |
| | samples, black level, gain, | | |
| | linearity, spectral response | | |
| selected output | Sub-structure containing: number | Structured memory record | User selection among |
| configuration | of output sample streams, per- | written by the user interface | stereo, light field, and |
| | stream resolution, per-stream | subsystem, read by the | 2K/4K/8K video outputs |
| | geometry (stereo, light-field, flat), | configuration subsystem | |
| | per-stream user parameters (pan, | during derivation | |
| | zoom, viewing angle, filter | | |
| | selection) | | |

### Section 3: Configuration Subsystem and Configuration Data

The configuration subsystem is a tuner: it produces configuration data that sets the reconfigurable fabric's state. Its output—the configuration data—is itself a concrete data structure with two components. The derivation from specification to configuration data is a deterministic function, not a compilation of authored source. See below table:

| | | | |
|---|---|---|---|
| configuration subsystem | Logical block comprising: storage | Embedded CPU (soft | Provisional Camtrx block |
| | for the specification, derivation | MicroBlaze or hard ARM in | E (CPU) performs |
| | logic implementing the | Zynq), state-machine logic in | calibration and program |
| | specification-to-configuration-data | a portion of the fabric, or | generation |
| | function, and an output interface | external microcontroller; AXI | |
| | for writing configuration data to | or similar bus to the fabric's | |
| | the fabric; operates at mode- | configuration interface | |
| | change rate | | |
| derive from said | A deterministic function | Firmware routine executed by | Provisional Camtrx block |
| specification | f(specification) → configuration | the configuration subsystem | R (ECT Generation): |
| configuration data | data; no intermediate human- | when the specification | “Calibration data, depth |
| | authored representation; same | changes; implementation runs | data and desired output |
| | specification always yields the | once per mode change | projection allow generation |
| | same configuration data | | of the appropriate ECT |
| | | | control programs” |
| configuration data for a | Data structure with two | Memory region holding the | ECT program |
| reconfigurable signal | components: (i) topology | data structure; written into the | |
| processing fabric | specification; (ii) per-ECT | fabric via the configuration | |
| | transformational operations. | interface (full or partial | |
| | Storable, transmissible, | bitstream, or configuration | |
| | enumerable | memory writes) | |
| topology specification | Graph description: a set of ECT | Data structure encoding the | Camtrx block diagram |
| | identifiers and a set of data | graph; used to configure fabric | explicitly shows topology |
| | connections (source-ECT, | interconnect routing and ECT | (blocks R, S, T, U and their |
| | destination-ECT pairs with | placement | connections) |
| | optional connection parameters) | | |
| transformational | Ordered list of parameter entries | Block RAM within the ECT | Camtrx ECT block D |
| operation comprising a | stored in the ECT's RAM/ROM, | region, holding the parameter | Program; RAM/ROM |
| sequence of parameter | traversed by the sequencer; each | entry sequence; addressed by | holds both parameter |
| entries | entry directs the sequencer through | the sequencer; may share | entries and coefficient data |
| | the ECT's operator array, | physical storage with non- | |
| | specifying which operator(s) to | linear operation coefficient | |
| | apply and at what source-sample | data | |
| | offset | | |
| parameter entry | Record with at least two fields: | Fixed-width memory word | ECT description; |
| | source offset (integer coordinates | with bitfields for offset and | parameter-entry framing |
| | in source sample space) and | operator selector; read | |
| | operator selector (index into the | sequentially by the sequencer; | |
| | ECT's operator array); may | decoded into control signals | |
| | include additional fields for edge- | that activate the selected | |
| | treatment mode, operator-internal | operator and address the | |
| | parameters, or output routing | context buffer | |
| offset in a source sample | Integer displacement from current | Bitfield within parameter | traversal path description |
| space | source sample position, specifying | entry, consumed by addressing | |
| | which source sample the parameter | logic within the ECT to index | |
| | entry references as the basis for its | into the local context buffer | |
| | output sample | | |
| selection from among a | Index or selector value choosing | Bitfield within parameter | sequencer iteration through |
| plurality of operators | which of the operators in the | entry, consumed by operator- | operator array |
| wrapped by said Elastic | ECT's operator array is applied for | selection logic within the ECT | |
| Convolution Transform | the current parameter entry; the | | |
| | sequencer iterates through | | |
| | selections in accordance with the | | |
| | transformational operation | | |

### Section 4: Reconfigurable Signal Processing Fabric and ECTs

The fabric is the physical substrate tuned by the configuration data. The ECT is the container realized within the fabric; the operators are the per-sample functionalities wrapped by each ECT. Each ECT is a bounded physical region of the fabric with defined constituent parts; each operator is concrete logic wrapped within it. See below table:

| | | | |
|---|---|---|---|
| reconfigurable signal | Physical hardware containing | FPGA (e.g., Xilinx | FPGA and ASIC |
| processing fabric | configurable logic elements, | UltraScale+, Intel Agilex, | realizations; references |
| | configurable interconnect, and | Lattice) with LUTs, BRAM, | FPGA/ASIC as typical |
| | embedded memory, capable of | DSP slices, and programmable | |
| | being tuned by configuration data | routing. Also encompasses | |
| | to realize the specified ECTs and | CGRA, GPU with graph- | |
| | their data connections | configured shader pipelines, | |
| | | ASIC with reconfigurable | |
| | | interconnect, or hybrid | |
| | | realizations | |
| tuned by said | The fabric's physical state is set by | Fabric configured via its | “continual tuning of the |
| configuration data | the configuration data: | configuration interface: | data” framing; |
| | interconnect routing, logic element | bitstream load, partial | configuration description |
| | function selection, memory | reconfiguration region load, or | |
| | contents all derived from | configuration memory writes | |
| | configuration data | for dynamically reconfigurable | |
| | | logic | |
| Elastic Convolution | Container/wrapper realized as a | A placed-and-routed region of | Camtrx ECT block |
| Transform (ECT) | defined region of the fabric, | FPGA logic (LUTs, BRAM, | diagram; ECT as |
| | providing the streaming | DSP slices) synthesized to | wrapper/container; FIG. 37 |
| | infrastructure that wraps one or | implement the ECT's | shows constituents with |
| | more operators; each ECT | constituent elements; one or | reference numerals |
| | comprises a local context buffer | more operators synthesized | |
| | (120), a RAM/ROM (140) holding | within the region | |
| | both the parameter-entry sequence | | |
| | and non-linear operation | | |
| | coefficient data, a sequencer (150), | | |
| | an operator array (160) of one or | | |
| | more operators, input handshake | | |
| | (110), output handshake (170), and | | |
| | router (130) for edge treatment | | |
| local context buffer (120) | Memory within an ECT holding a | Block RAM (BRAM) within | Camtrx ECT block G |
| | rolling window of recent input | the ECT region, configured as | (Buffer); |
| | samples, sized to accommodate the | a line buffer or column buffer | |
| | worst-case source-offset | per the ECT's orientation; | |
| | magnitude specified by the ECT's | depth set to approximately | |
| | transformational operation | (context_size + | |
| | | worst_case_nonlinearity)/2 | |
| | | per Kenbe's sizing formula | |
| random-access memory | RAM/ROM holding two distinct | BRAM within the ECT region, | RAM/ROM specification |
| (140) | types of configuration data sharing | partitioned for sequential | confirmed as dual-role |
| | physical storage: (i) the | access (by sequencer for | |
| | transformational operation as a | parameter entries) and random | |
| | sequence of parameter entries the | access (by operators for | |
| | sequencer steps through, and (ii) | coefficient tables); read | |
| | coefficient and table data for non- | bandwidth provisioned to | |
| | linear operations indexable by | sustain sample-rate operation | |
| | operators of the operator array | | |
| sequencer (150) | Logic that steps through the | Finite-state machine with | Camtrx ECT block B |
| | transformational operation's | program-counter logic reading | (Sequencer); operator array |
| | parameter entries and iterates | from RAM/ROM, decoding | iteration capability |
| | through the operator array in | source-offset and operator- | |
| | accordance with each entry; the | select fields, issuing read | |
| | mechanism by which a single ECT | addresses to the context | |
| | can realize iterative computations | buffer, and activating | |
| | by walking through multiple | operators of the operator array | |
| | operator instances | | |
| operator array (160) | Array of one or more operators | Multiple operator logic blocks | array with iteration; FIG. 1 |
| | within the ECT, each operator | synthesized within the ECT | shows operators |
| | being a structurally realized per- | region; shared resources | |
| | sample functionality; the | (multipliers, accumulators) | |
| | sequencer iterates through the | may be time-multiplexed | |
| | array per the transformational | under sequencer control; | |
| | operation; the array may comprise | operator selector activates | |
| | operators of one or more types, | specific logic paths per | |
| | enabling multi-function ECTs and | parameter entry | |
| | iterative computations within a | | |
| | single ECT | | |
| operators wrapped by | The set of per-sample | Logic blocks synthesized | operator species in FIG. |
| said Elastic Convolution | functionalities an ECT is | within the ECT region, one per | 371 |
| Transform | structurally capable of performing; | operator instance; operator | |
| | enumerated species include | selector activates specific | |
| | convolution (161), lookup-table | logic paths per parameter entry | |
| | (162), gradient/curl (163), phase- | | |
| | shifted interpolation (164), | | |
| | wavelet/DCT (165), neural-layer | | |
| | (166), Bayesian Factor Generator | | |
| | (167), Geometric Projection (168), | | |
| | and others (169) | | |
| data connections | Physical or logical data paths | FPGA interconnect | Camtrx block diagram |
| between said Elastic | carrying sample streams from one | (configured by fabric routing), | shows connections between |
| Convolution Transforms | ECT to another within the fabric, | inter-ECT FIFO buffers, or | processing blocks |
| | according to the topology | shared BRAM accessed by | |
| | specification | adjacent ECTs | |
| apply . . . continuously to | The ECT's tuned state produces | Pipelined logic in the ECT | streaming process |
| its input sample stream | output samples as a continuous | region producing an output | description |
| | function of incoming input | sample each clock cycle when | |
| | samples; no discrete execution | valid input is present | |
| | cycle; presence of input triggers | | |
| | production of output | | |
| propagate through the | Sample streams flow from ECT to | Output port of one ECT drives | description of stream flow |
| tuned fabric | ECT along the topology's data | input port of next via fabric | |
| | connections | interconnect; pipelined | |
| | | valid/ready handshake | |

### Section 5: Operational Properties

These are the runtime properties the tuned fabric exhibits. Each is a consequence of the structural arrangement and is observable at the level of sample streams and timing. See table below:

| | | | |
|---|---|---|---|
| sample rate higher than | The fabric consumes and produces | Fabric clocked at a rate | numerical examples: ·4 ns |
| a frame rate | samples at a rate equal to the | accommodating sample-rate | per LUT sample, ·8 μs |
| | sensor sample output rate (pixels | processing (e.g., 250 MHz for | through 9 × 9 convolution at |
| | per second), which exceeds the | 2000 × 2000 @ 60 fps with | 60 Hz 2000 × 2000 |
| | frame rate by the pixel count per | headroom) | |
| | frame | | |
| sample is a value within | Samples are represented as fixed | Sample representation (e.g., | treatment of streams |
| a defined sample space | or floating point values within a | 16-bit signed integer, 10-bit | |
| including zero | defined numeric range; zero is a | unsigned) with zero as a | |
| | valid representable value | specific bit pattern | |
| propagation . . . is | Sample propagation through data | Data paths and pipeline stages | continuous streaming |
| independent of the | connections and application of | operate unconditionally on | process description |
| particular values carried | ECT operations does not depend | every sample; no conditional | |
| by said samples | on sample values; no value- | routing based on sample value | |
| | dependent gating or routing | | |
| specification influences | During sample-rate operation, the | No data path exists between | Architectural consequence |
| operation . . . solely via | fabric does not access the | the specification memory and | of the tuning approach; |
| the derived | specification; all specification- | the ECTs during operation; the | supported by the software- |
| configuration data | derived information is captured in | configuration subsystem's | hardware partition diagram |
| | the configuration data already | output, once loaded, is the | |
| | loaded into the fabric | only coupling | |
| per-ECT latency | Latency from input sample arrival | Set by the depth of the local | “delay from stream |
| determined by the local | to corresponding output sample | context buffer within the ECT; | element in to |
| context size | production, within a single ECT, | buffer depth sized per Kenbe's | corresponding information |
| | equals the time required to | formula (approximately half | out determined by the |
| | accumulate the local sample | the sum of context size and | extent of the local |
| | context needed by that ECT's | worst-case nonlinear traversal) | information context” |
| | operator array | | |
| per-ECT latency being | An ECT begins producing output | Input buffer fill level triggers | streaming process |
| independent of frame | samples as soon as it has sufficient | output production; no frame- | description; explicit |
| completion | local context, without waiting for | complete signal gates output; | contrast with sequential |
| | any frame-level boundary | pipeline flows continuously | frame-based processing |
| total latency . . . sum of | End-to-end latency for any output | Cumulative pipeline depth | Direct consequence of |
| per-ECT latencies along | sample equals the sum of per-ECT | through the topology from | pipelined topology; |
| the path | latencies of the ECTs traversed by | input to output, measured in | numerical examples |
| | the corresponding input samples | clock cycles; determinable by | illustrate |
| | from sensor to display | static analysis of the topology | |
| total latency being less | For all source-to-output paths, sum | Design constraint on the | a design requirement |
| than one frame time | of per-ECT latencies is less than | topology; ensured by | grounded in surgical |
| | the reciprocal of the frame rate | bounding per-ECT buffer | visualization use |
| | | depths and topology path | |
| | | length | |

### Notes on Specific Terms:

### “Elastic Convolution Transform”

Per inventor confirmation, the ECT is the container/wrapper that provides streaming infrastructure around an operator. The name is established terminology within the inventor's prior work and should be retained in the claim language. The spec should define ECT as: a defined region of reconfigurable fabric comprising a local context buffer, a program memory, a sequencer, an operator selector, input/output handshake, and router for edge treatment, and wrapping one or more operators selectable per output sample. This definition distinguishes the ECT from the operator it wraps, which is essential for both claim construction and the dependent-claim hierarchy.

### “Operator” and “Operator Array”

An operator is the per-sample functionality realized within an ECT. Operators currently enumerated in FIG. 1 include: convolution (161), lookup-table (162), gradient/curl (163), phase-shifted interpolation (164), wavelet/DCT (165), neural-layer (166), Bayesian Factor Generator (167), Geometric Projection (168), and other operators (169). The list is extensible; additional operators can be added by synthesizing their logic within an ECT's operator array and extending the operator-selector field of parameter entries.

The operator array (160) is the structurally realized collection of operators within a given ECT. Per inventor confirmation, the operator array is iterated over by the sequencer, not selected-from once per output sample. This iteration capability is what enables a single ECT to realize computations like iterative Bayesian inference: an operator array comprising multiple Bayesian Factor Generators, walked in sequence by the sequencer, produces successive refinement factors within the same ECT. The iteration happens at sample rate, inside the ECT, without requiring the iteration to be distributed across multiple ECTs in the topology (though topology-level unrolling is also supported). This is the structural basis for the iterative-refinement dep claim family.

### “RAM/ROM” (140)—Dual Role

Per inventor confirmation, the RAM/ROM (140) within each ECT holds two distinct types of configuration data in shared physical storage: (i) the transformational operation expressed as a sequence of parameter entries traversed by the sequencer, and (ii) coefficient and table data for non-linear operations indexable by operators during computation. This is an accurate description of the FPGA engineering-one BRAM serves both purposes- and both the parameter-entry sequence and the coefficient data are produced by the configuration subsystem's derivation from the specification.

### “Reconfigurable Signal Processing Fabric”

This term is deliberately broader than “FPGA.” It encompasses any hardware substrate whose data path and interconnect can be tuned by configuration data to realize a specified ECT topology. Clear members include FPGAs, CGRAs, and ASICs with reconfigurable interconnect. Less obvious but included: a GPU whose shader graph is configured from the derivation's output, or a CPU with vector extensions whose ECT topology is realized as a sequence of vector operations. The spec should teach these as alternative realizations, with FPGA as the preferred embodiment.

### “Tuned”

The word “tuned” carries useful physical connotations (analog filter tuning, mechanical tuning) that support the signal-processing-system character of the invention. For claim construction, the spec should define “tuned” as: the physical configuration of the fabric is set such that the fabric realizes the specified ECTs and their wrapped operators when input samples are applied.

### “Configuration Subsystem”

The configuration subsystem is a physical block with defined inputs and outputs: it reads the specification from memory, runs the derivation, and writes the resulting configuration data to the fabric's configuration interface. It operates at mode-change rate (i.e., only when the specification changes), not at sample rate. The software-hardware partition diagram shows the configuration subsystem as a distinct labeled block.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification. It will be apparent to one having ordinary skill in the art that the specific detail need not be employed to practice according to the present disclosure. In other instances, well-known materials or methods have not been described in detail in order to avoid obscuring the present disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

The invention has been described in detail with particular reference to a presently preferred embodiment, but it will be understood that variations and modifications can be effected within the spirit and scope of the disclosure. The presently disclosed embodiments are therefore considered in all respects to be illustrative and not restrictive. The scope of the invention is indicated by any appended claims, and all changes that come within the meaning and range of equivalents thereof are intended to be embraced therein.

What is claimed is:

1. A signal processing system, comprising:
a plurality of image sensors producing input sample streams;
a configuration subsystem configured to accept a specification including calibration data characterizing the plurality of image sensors and a selected output configuration, and to derive, from the specification, configuration data, the configuration data including:
(i) a topology specification defining a plurality of elastic convolution transforms and data connections between the elastic convolution transforms, and
(ii) for each said elastic convolution transform, a corresponding transformational operation including a sequence of parameter entries, each parameter entry specifying an offset in a source sample space and a selection from among a plurality of operators wrapped by the elastic convolution transform;
a reconfigurable signal processing fabric tuned by the configuration data to realize the plurality of elastic convolution transforms connected according to the topology specification, each elastic convolution transform including a local context buffer, a random-access memory, a sequencer, and an operator array, the random-access memory holding; (i) the corresponding transformational operation as a sequence of parameter entries and
(ii) coefficient and table data for non-linear operations, the operator array including one or more operators selectable for application to sample data held in the local context buffer, the sequencer configured to iterate through the operator array in accordance with the transformational operation, each elastic convolution transform configured within the reconfigurable signal processing fabric to apply, continuously to a respective input sample stream, the operator or operators of the operator array as specified by the transformational operation, at the source sample space offsets specified by the parameter entries, thereby producing an output sample stream;
wherein the output sample streams propagate through the tuned fabric according to the topology specification at a sample rate higher than a frame rate of said plurality of image sensors;
wherein each sample is a value within a defined sample space including zero, and wherein propagation of the sample streams through the tuned fabric is independent of the particular values carried by the samples;
wherein the specification influences operation of the tuned fabric solely via the derived configuration data;
wherein the reconfigurable signal processing fabric is arranged such that each elastic convolution transform produces output samples with a per-ECT latency determined by the local context size required by the operator array, said per-ECT latency being independent of frame completion of the plurality of image sensors, and
wherein a total latency from arrival of an input sample to production of the corresponding output sample is a sum of per-ECT latencies along the path through the topology traversed by the input sample, the total latency being less than one frame time of the plurality of image sensors;
and wherein the plurality of image sensors receives light from a physical scene and produces the input sample streams in response thereto, and wherein the output sample streams produced by the tuned fabric are provided to one or more display devices to generate a visible image of the physical scene, the visible image including a corrected and recombined representation of the physical scene with geometric, optical, and inter-sensor variations compensated in real time.

2. The signal processing system, as set forth in claim 1, wherein the plurality of images sensors are mounted in a defined geometric relationship to a desired scene, each image sensor producing a digital sample stream at a specified frame rate.

3. The signal processing system, as set forth in claim 2, where the plurality of image sensors include a plurality of depth sensors and a plurality of perspective sensors.

4. The signal processing system, as set forth in claim 1, wherein each parameter entry in the sequence of parameter entries includes a source-sample offset, and an operator selector, wherein each selector entry directs the sequencer which operator in the operator array to apply and at the respective source-sample offset.

5. The system processing system, as set forth in claim 4, wherein each parameter includes one or more of the following: edge-treatment mode, operator-internal parameters, and output routing.

6. The system processing system, as set forth in claim 1, wherein the reconfigurable signal processing fabric is set by the configuration data resulting in the tuned fabric, the configuration data including one or more of the following: interconnect routing, logic element function selection, and memory contents.

7. The system processing system, as set forth in claim 1, wherein the local context buffer of each elastic convolution transform including memory within the respective elastic convolution transform configured to store a rolling window of recent input samples, the rolling window being sized to accommodate worse-case source offset magnitude defined by the transformation operation of the respective elastic convolution transform.

8. The system processing system, as set forth in claim 1, wherein the sequencer is defined by logic that steps through the sequence of parameter entries as respective transformational operations.

9. The system processing system, as set forth in claim 1, wherein each operators in the operator array includes one of the following: lookup-table, gradient/curl, phase-shifted interpolation, wavelet/DCT, neural-layer, Bayesian Factor Generator, and Geometric Projection.

10. A signal processing method, including the steps of:
producing input sample streams by a plurality of image;
accepting, at a configuration subsystem, a specification including calibration data characterizing the plurality of image sensors and a selected output configuration;
deriving, from the specification, configuration data, the configuration data including:
(i) a topology specification defining a plurality of elastic convolution transforms and data connections between the elastic convolution transforms, and
(ii) for each said elastic convolution transform, a corresponding transformational operation including a sequence of parameter entries, each parameter entry specifying an offset in a source sample space and a selection from among a plurality of operators wrapped by the elastic convolution transform; and,
tuning a reconfigurable signal processing fabric by the configuration data to realize the plurality of elastic convolution transforms connected according to the topology specification, each elastic convolution transform including a local context buffer, a random-access memory, a sequencer, and an operator array, the random-access memory holding:
(i) the corresponding transformational operation as a sequence of parameter entries and
(ii) coefficient and table data for non-linear operations, the operator array including one or more operators selectable for application to sample data held in the local context buffer, the sequencer configured to iterate through the operator array in accordance with the transformational operation,
continuously applying, by each elastic convolution transform configured within the reconfigurable signal processing fabricm to a respective input sample stream, the operator or operators of the operator array as specified by the transformational operation, at the source sample space offsets specified by the parameter entries, thereby producing an output sample stream, wherein the output sample streams propagate through the tuned fabric according to the topology specification at a sample rate higher than a frame rate of said plurality of image sensors, wherein each sample is a value within a defined sample space including zero, and wherein propagation of the sample streams through the tuned fabric is independent of the particular values carried by the samples, wherein the specification influences operation of the tuned fabric solely via the derived configuration data;
producing, via the reconfigurable signal processing fabric, by each elastic convolution transform output samples with a per-ECT latency determined by the local context size required by the operator array, said per-ECT latency being independent of frame completion of the plurality of image sensors, wherein a total latency from arrival of an input sample to production of the corresponding output sample is a sum of per-ECT latencies along the path through the topology traversed by the input sample, the total latency being less than one frame time of the plurality of image sensors, and wherein the plurality of image sensors receives light from a physical scene and produces the input sample streams in response thereto; and
providing the output sample streams, produced by the tuned fabric, to one or more display devices to generate a visible image of the physical scene, the visible image including a corrected and recombined representation of the physical scene with geometric, optical, and inter-sensor variations compensated in real time.

11. The signal processing method, as set forth in claim 10, wherein the plurality of images sensors are mounted in a defined geometric relationship to a desired scene, each image sensor producing a digital sample stream at a specified frame rate.

12. The signal processing method, as set forth in claim 11, where the plurality of image sensors include a plurality of depth sensors and a plurality of perspective sensors.

13. The signal processing method, as set forth in claim 10, wherein each parameter entry in the sequence of parameter entries includes a source-sample offset, and an operator selector, wherein each selector entry directs the sequencer which operator in the operator array to apply and at the respective source-sample offset.

14. The system processing method, as set forth in claim 13, wherein each parameter includes one or more of the following: edge-treatment mode, operator-internal parameters, and output routing.

15. The system processing method, as set forth in claim 10, wherein the reconfigurable signal processing fabric is set by the configuration data resulting in the tuned fabric, the configuration data including one or more of the following: interconnect routing, logic element function selection, and memory contents.

16. The system processing method, as set forth in claim 10, wherein the local context buffer of each elastic convolution transform including memory within the respective elastic convolution transform configured to store a rolling window of recent input samples, the rolling window being sized to accommodate worse-case source offset magnitude defined by the transformation operation of the respective elastic convolution transform.

17. The system processing method, as set forth in claim 10, wherein the sequencer is defined by logic that steps through the sequence of parameter entries as respective transformational operations.

18. The system processing method, as set forth in claim 10, wherein each operators in the operator array includes one of the following: lookup-table, gradient/curl, phase-shifted interpolation, wavelet/DCT, neural-layer, Bayesian Factor Generator, and Geometric Projection.
